(19) United States
(12) Patent Application Publication
(10) Pub. No.: US 2009/0185821 A1
(43) Pub. Date: Jul. 23, 2009

(54) Electrophotographic photoreceptor, and image formihg appratus and process cartridge using same

(75) Inventors: Takafumi Iwamoto, Numazu-shi (JP); Nozomu Tamoto, Numazu-shi (JP); Hiromi Tada, Numazu-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD, Tokyo (JP)

(21) Appl. No.: 12/319,806

(22) Filed: Jan. 12, 2009

(30) Foreign Application Priority Data
Jan. 10, 2008 (JP) 2008-003116
Nov. 17, 2008 (JP) 2008-282899

(51) Int. Cl. G03G 21/18; G03G 15/02; G03G 5/07; G03G 15/00

(52) U.S. Cl. 399/111; 430/58.65; 430/58.7; 399/159

(57) ABSTRACT

An electrophotographic photoreceptor including a conductive substrate; a charge generation layer comprising a metal phthalocyanine pigment as a charge generation material, located overlying the conductive substrate; a charge transport layer comprising a charge transport material having a triarylamine structure, located overlying the charge generation layer; and a cross-linked charge transport layer formed by hardening a radical-polymerizable monomer having no charge transport structure and a radical-polymerizable compound having a charge transport structure, located overlying the charge transport layer. The electrophotographic photoreceptor satisfies the following equations (1) and (2):

−0.16≦Ip(T)−Ip(G)≦0.07 (1)

0.07<Ip(O)−Ip(G)≦0.33 (2)

wherein Ip(G), Ip(T), and Ip(O) represent ionization potentials of the charge generation layer, the charge transport layer, and the cross-linked charge transport layer, respectively.

### BACKGROUND OF THE INVENTION

1. Field of the Invention

The present invention relates to an electrophotographic photoreceptor. In addition, the present invention also relates to an image forming apparatus and a process cartridge using the electrophotographic photoreceptor.

2. Discussion of the Related Art

Organic photoreceptors are widely used in electrophotography recently. Organic photoreceptors have an advantage over inorganic photoreceptors in that usable materials that are responsive to various lights such as visible light and infrared light are easily developed. In addition, such usable materials are environment-friendly and the cost of manufacturing is low. However, organic photoreceptors generally have lower physical and chemical strength than inorganic photoreceptors. As a consequence, the surface of an organic photoreceptor is easily abraded or scratched with long-term use, resulting in poor durability and unreliable image forming.

A typical electrophotographic image forming apparatus includes a photoreceptor, a charger configured to charge a surface of the photoreceptor, a latent image forming device configured to form an electrostatic latent image on the charged surface of the photoreceptor, a developing device configured to adhere a toner to the electrostatic latent image to form a toner image, a transfer device configured to transfer the toner image onto a recording medium, and a cleaning device configured to remove residual toner particles that remain on the surface of the photoreceptor without being transferred onto the recording medium.

The surface of the organic photoreceptor is chemically and physically degraded by being repeatedly subjected to the processes of charging, developing, transferring, and cleaning. As a result, abrasion and scratching of the surface of the organic photoreceptor is accelerated, degrading the resultant image quality at an early stage. Accordingly, the organic photoreceptor is required to have high abrasion resistance. In attempting to improve abrasion resistance of the organic photoreceptor, one proposed approach involves providing a protective layer on an outermost surface thereof.

It is more preferable that such a protective layer has an improved mechanical durability. One proposed approach to improve mechanical durability of a protective layer involves including inorganic fine particles therein. For example, Unexamined Japanese Patent Application Publication No. (hereinafter “JP-A”) 2002-139859 discloses an electrophotographic photoreceptor including, in order from an innermost side thereof, a conductive substrate, a photosensitive layer, and a protective layer including a filler.

Another proposed approach to improve mechanical durability involves increasing the surface hardness of a photoreceptor. For example, JP-2001-125286-A and JP-2001-324857-A each disclose a photoreceptor having a specific surface hardness. When a photoreceptor is charged by a charger employing a magnetic brush method, magnetic particles may undesirably adhere to the photoreceptor. It is disclosed therein that such a photoreceptor is prevented from being scratched by the adhered magnetic particles because of its high surface hardness. JP-2003-098708-A also discloses a photoreceptor having a specific surface hardness for the purpose of preventing abrasion of the surface when being cleaned by a blade.

In attempting to improve the surface hardness of photoreceptor, one proposed approach involves including a cross-linked material such as a heat-hardening resin and an ultraviolet-hardening resin in a protective layer, as disclosed in JP-A-05-181299, JP-2002-006526-A, and JP-2002-082465-A. Such a protective layer has an improved resistance to abrasion and scratching.

As another approach, JP-2000-284514-A, JP-2000-284515-A, and JP-2001-194813-A each disclose a photoreceptor having a protective layer which includes a siloxane resin having charge transport ability to improve resistance to abrasion and scratching.

As another approach, Japanese Patent No. (hereinafter JP) 3194392 discloses a photoreceptor having a charge transport layer that is formed from a monomer, a charge transport material, and a binder resin each including carbon-carbon double bonds (C═C bonds) to improve a resistance to abrasion and scratching.

For the same purpose, JP-2004-30245 1-A discloses a photoreceptor having a charge transport layer that is formed by hardening a tri- or poly-functional radical polymerizable monomer having no charge transportable structure and a monofunctional radical polymerizable monomer having a charge transportable structure; and JP-2005-99688 discloses a photoreceptor having a protective layer that is formed by hardening a tri- or poly-functional radical polymerizable monomer having no charge transportable structure and a radical polymerizable compound having a charge transportable structure, in which a filler is further dispersed.

Accordingly, a resistance to abrasion and scratching is dramatically improved by including a hardening resin, preferably in combination with a filler, in a protective layer.

However, the life of photoreceptor is not sufficiently lengthened thereby because the bright section potential is increased, which may cause deterioration of image density or blurring of a resultant image (this phenomenon is hereinafter referred to as image blurring) due to a provision of the protective layer. When the dark section potential is increased in accordance with the increase of the bright section potential, the electric field intensity may also increase. As a result, background portions of a resultant image are soiled with toner particles (this phenomenon is hereinafter referred to as background fouling). In addition, such an increase of the bright section potential is considered to contribute to formation of negative ghost image, which is generally caused when a photoreceptor is charged to the opposite polarity by a transfer bias having the opposite polarity. Consequently, the potential of the photoreceptor cannot be neutralized by exposure of light, in other words, the last electrostatic latent image cannot be completely removed.

Accordingly, it is important to prevent such an increase of the bright section potential to reliably produce high quality images.

The increase of the bright section potential is mainly caused due to charge trapping in an interface between a charge generation layer and a charge transport layer, in an interface between a charge transport layer and a protective layer, or in the bulk of a charge transport layer or a protective layer. In particular, charge trapping in an interface between a charge generation layer and a charge transport layer or in an interface between a charge transport layer and a protective layer has a significant effect on the increase of the bright section potential. Accordingly, one proposed approach to decrease the bright section potential involves including a charge transport material which has a smaller ionization potential in a charge transport layer so as to reduce a charge injection barrier from a charge generation layer to the charge transport layer, as disclosed in JP-2007-072139-A.

In a case in which a titanyl phthalocyanine pigment, which generally has a low ionization potential, is included as a charge generation material, a charge transport material needs to have an ionization potential equal to or less than that of the titanyl phthalocyanine pigment.

Another proposed approach to decrease the bright section potential involves reducing a charge injection barrier from a charge transport layer to a protective layer. For example, when a charge transport material included in a protective layer has a smaller ionization potential than that included in a photosensitive layer, charge injection between the photosensitive layer and the protective layer is accelerated, as disclosed in JP-2002-207308-A.

As another example, when the ionization potentials of a charge generation material and a charge transport material are optimized, and a charge transport material included in a protective layer has an ionization potential smaller than or equal to that included in a charge transport layer, the residual potential is suppressed from increasing, as disclosed in JP-2000-292959-A.

Accordingly, these references indicate that the bright section potential can be decreased when a charge transport material included in a protective layer has a smaller ionization potential than that included in a photosensitive layer.

Further, it is known that formation of negative ghost image can be suppressed by reducing a charge injection barrier from a charge transport layer to a protective layer. For example, JP-2003-186222-A discloses that as a difference in ionization potential between a photosensitive layer and a protective layer becomes smaller, formation of negative ghost image can be more reliably suppressed. JP-04-284459-A discloses that as a difference in oxidation potential between a charge transport material included in a photosensitive layer and that included in a protective layer becomes smaller, increase of the bright section potential can be more reliably suppressed.

Accordingly, the bright section potential of a photoreceptor can be decreased or formation of ghost image can be suppressed, in other words, high quality images can be produced when a charge transport layer includes a charge transport material having an ionization potential equal to or smaller than that of a charge generation material and a protective layer includes a charge transport material having an ionization potential equal to or smaller than that included in the charge transport layer.

However, in a case in which a titanyl phthalocyanine pigment, which generally has a low ionization potential, is included as a charge generation material, a charge transport material included in an outermost layer of a photoreceptor may be inevitably low, possibly causing image blurring with repeated use. As described above, the surface of a photoreceptor easily deteriorates because of being exposed to the processes of charging, developing, cleaning, etc., repeatedly. In particular, since a photoreceptor is exposed to oxidizing gases such as ozone that are produced in the charging process, a charge transport material in an outermost surface is degraded, lowering the resistance of the photoreceptor. As the ionization potential of the charge transport material becomes smaller, lowering of the resistance is further aggravated. For the above reasons, image blurring occurs in repeated use in this case.

JP-2001-255685-A discloses a photoreceptor in which the difference in ionization potential between a photosensitive layer and a hardening resin layer, and a temporal response of the photoreceptor are specifically defined. It is disclosed therein that such a photoreceptor is capable of reliably forming a dot image even under high-temperature and high-humidity conditions or low-temperature and low-humidity conditions. Referring to examples, a photoreceptor including a Y-form titanyl phthalocyanine as a charge generation material is disclosed in which the ionization potential of a charge transport layer is considerably larger than that of a charge generation layer. Such a photoreceptor may be resistant to image blurring, however, the bright section potential thereof may be hardly decreased. By contrast, referring to comparative examples, another photoreceptor is disclosed in which the ionization potential of a charge transport layer is smaller than that of the titanyl phthalocyanine and is considerably smaller than that of a protective layer. It is apparent that such a photoreceptor has a degraded chargeability.

As described above with reference to JP-2000-292959-A, residual potential can be suppressed from increasing when the ionization potential of a charge transport material included in a protective layer is smaller than or equal to that included in a charge transport layer. However, in such a case in which a charge transport material having a small ionization potential is included in the protective layer that is provided on a surface of a photoreceptor, image blurring may occur. Although JP-2000-292959-A describes nothing about image quality, the photoreceptor disclosed therein is considered to cause image blurring when exposed to oxidizing gas atmosphere, even if residual potential can be suppressed from increasing.

A metal phthalocyanine pigment is widely used as a charge generation material because of having high sensitivity, and generally has a small ionization potential. In a case in which such a metal phthalocyanine pigment is used, in order to suppress increase of the bright section potential, the ionization potential of a charge transport material included in a charge transport layer and a protective layer needs to be smaller than that of the metal phthalocyanine pigment. As a consequence, image blurring may occur, while increase of the bright section potential is suppressed. Accordingly, it is difficult for a photoreceptor including a metal phthalocyanine pigment to decrease the bright section potential and to reliably produce high quality images at the same time.

It is generally known that high quality images can be reliably formed when an additive is included in a photosensitive layer and/or a cross-linked surface layer. In particular, it is effective to include an antioxidant in a photosensitive layer. The amount of the antioxidant in a layer is preferably as large as possible so that an antioxidant property is sufficiently expressed. However, in a case in which the antioxidant has no charge transport ability, a charge transport ability of the layer decreases as the amount of the antioxidant increases. Consequently, the bright section potential may increase.

In particular, differences in ionization potential among a charge generation layer, a charge transport layer, and a protective layer are large, in other words, a charge injection barrier are large, the bright section potential may easily increase.

JP-2007-279678-A, JP-2007-272191-A, and JP-2007-272192-A each disclose an electrophotographic photoreceptor in which an antioxidant having a charge transport ability is included in a photosensitive layer and/or a cross-linked surface layer so that high quality images are reliably produced. However, a charge transport material included in a charge transport layer of the photoreceptors disclosed therein has a large ionization potential. When such a charge transport material is used in combination with a metal phthalocyanine pigment (i.e., a charge generation material) having a small ionization potential, the difference in ionization potential between the charge transport material and the charge generation material is large. As a consequence, the bright section potential may easily increase.

JP-2000-242008-A, JP-11-352710-A, JP-08-082941-A, JP 3287126, and JP-07-244389-A each disclose an electrophotographic photoreceptor including an antioxidant in combination with a distyryl compound so that electrophotographic properties thereof are reliable. Although the resultant images are not evaluated therein, these photoreceptors are considered to cause image blurring by exposure to NOx in a case in which the distyryl compound is present on an outermost surface of the photoreceptor, because the distyryl compound has a small ionization potential.

### SUMMARY OF THE INVENTION

Accordingly, an object of the present invention is to provide an electrophotographic photoreceptor that has an improved abrasion resistance and an extended lifetime, and is capable of reliably suppressing increase of the bright section potential, formation of negative ghost, image blurring, and background fouling.

Another object of the present invention is to provide an image forming apparatus and a process cartridge that are capable of reliably forming high quality images.

To achieve such objects, the present invention contemplates the provision of an electrophotographic photoreceptor, comprising:

a conductive substrate;

a charge generation layer comprising a metal phthalocyanine pigment as a charge generation material, located overlying the conductive substrate;

a charge transport layer comprising a charge transport material having a triarylamine structure, located overlying the charge generation layer; and

a cross-linked charge transport layer formed by hardening a radical-polymerizable monomer having no charge transport structure and a radical-polymerizable compound having a charge transport structure, located overlying the charge transport layer,

wherein the following equations (1) and (2) are satisfied:

−0.16≦Ip(T)−Ip(G)≦0.07 (1)

0.07<Ip(O)−Ip(G)≦0.33 (2)

wherein Ip(G), Ip(T), and Ip(O) represent ionization potentials of the charge generation layer, the charge transport layer, and the cross-linked charge transport layer, respectively;

and an image forming apparatus and a process cartridge using the above electrophotographic photoreceptor.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an embodiment of a photoreceptor of the present invention;

FIG. 2 is a schematic view illustrating an embodiment of an image forming apparatus of the present invention;

FIG. 3 is a schematic view illustrating an embodiment of a process cartridge of the present invention;

FIG. 4 is an X-ray diffraction spectrum a titanyl phthalocyanine, obtained with a characteristic X-ray specific to CuKα having a wavelength of 1.542 Å;

FIG. 5 is a diagram illustrating an image for evaluating negative ghost; and

FIG. 6 is an example of negative ghost.

### DESCRIPTION OF THE PREFERRED EMBODIMENTS

Generally, the present invention provides an electrophotographic photoreceptor (hereinafter simply “photoreceptor”) including, in order from an innermost side thereof, a conductive substrate, a charge generation layer, a charge transport layer, and a cross-linked charge transport layer. A metal phthalocyanine pigment that has a small ionization potential and high sensitivity is included in the charge generation layer as a charge generation material. A charge transport material is included in the charge transport layer so that the difference in ionization potential between the charge transport layer and the charge generation layer is −0.16 to 0.07. The cross-linked charge transport layer is formed on a surface of the photoreceptor so that the difference in ionization potential between the cross-linked charge transport layer and the charge generation layer is 0.07 to 0.33. Such a photoreceptor has an improved abrasion resistance and an extended lifetime, and is capable of reliably suppressing increase of the bright section potential, formation of negative ghost, image blurring, and background fouling.

Although the ionization potential of the cross-linked charge transport layer is larger than that of the charge transport layer, the photoreceptor of the present invention is capable of suppressing increase of the bright section potential. One possible reason for this is that unlike the photoreceptor disclosed in JP-2000-292959-A having a protective layer including a hardening resin and a charge transport material, the photoreceptor of the present invention includes the cross-linked charge transport layer in which a charge transport material itself is cross-linked, serving as a protective layer. Another possible reason is that the thickness of the cross-linked charge transport layer is smaller than that of the charge transport layer. Further, when the cross-linked charge transport layer is formed from a radical-polymerizable compound having acryloyloxy group and/or methacryloyloxy group, or when the charge transport layer includes a distyrylbenzene derivative as a charge transport material, increase of the bright section potential, image blurring, and formation of ghost can be more reliably suppressed.

Preferred embodiments of photoreceptors of the present invention will be described in detail with reference to the drawings.

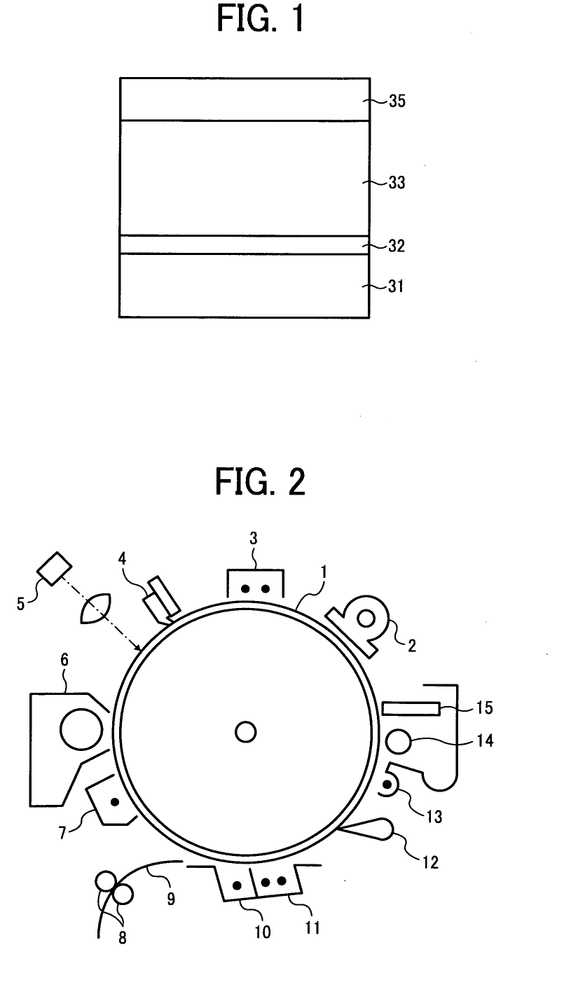

FIG. 1 is a schematic view illustrating an embodiment of a photoreceptor of the present invention. A photoreceptor illustrated in FIG. 1 is a multi-layer photoreceptor including, in order from an innermost side thereof, a conductive substrate 31, a charge generation layer 32, a charge transport layer 33, and a cross-linked charge transport layer 35.

### (Conductive Substrate)

Suitable materials for the conductive substrate 31 include material having a volume resistivity not greater than 10¹⁰ Ω·cm. Specific examples of such materials include, but are not limited to, plastic films, plastic cylinders, or paper sheets, on the surface of which a metal such as aluminum, nickel, chromium, nichrome, copper, gold, silver, platinum, and the like, or a metal oxide such as tin oxides, indium oxides, and the like, is formed by deposition or sputtering. In addition, a metal cylinder can also be used as the conductive substrate 31, which is prepared by tubing a metal such as aluminum, aluminum alloys, nickel, and stainless steel by a method such as a drawing ironing method, an impact ironing method, an extruded ironing method, and an extruded drawing method, and then treating the surface of the tube by cutting, super finishing, polishing, and the like treatments. In addition, an endless nickel belt disclosed in Examined Japanese Patent Application Publication No. (hereinafter JP-B) 52-36016 and an endless stainless belt can be also used as the conductive substrate 31.

Further, substrates, in which a conductive layer is formed on the above-described conductive substrates by applying a coating liquid including a binder resin and a conductive powder thereto, can be used as the conductive substrate 31.

Specific examples of usable conductive powders include, but are not limited to, carbon black, acetylene black, powders of metals such as aluminum, nickel, iron, nichrome, copper, zinc, and silver, and powders of metal oxides such as conductive tin oxides and ITO.

Specific examples of usable binder resins include thermoplastic, thermosetting, and photo-crosslinking resins, such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinyl formal, polyvinyl toluene, poly-N-vinylcarbazole, acrylic resin, silicone resin, epoxy resin, melamine resin, urethane resin, phenol resin, and alkyd resin. Such a conductive layer can be formed by coating a coating liquid in which a conductive powder and a binder resin are dispersed or dissolved in a proper solvent such as tetrahydrofuran, dichloromethane, methyl ethyl ketone, toluene, and the like solvent, and then drying the coated liquid.

In addition, substrates, in which a conductive layer is formed on a surface of a cylindrical substrate using a heat-shrinkable tube which is made of a combination of a resin such as polyvinyl chloride, polypropylene, polyester, polystyrene, polyvinylidene chloride, polyethylene, chlorinated rubber, and polytetrafluoroethylene-based fluorocarbon resin, with a conductive powder, can also be used as the conductive substrate 31.

### (Photosensitive Layers)

Next, photosensitive layers including the charge generation layer 32 and the charge transport layer 33 will be described in detail.

### (Charge Generation Layer)

Description is now given of the charge generation layer 32. The charge generation layer 32 includes a charge generation material as a main component and optionally includes a binder resin, if desired. In the present embodiment, metal phthalocyanine pigments are preferable for the charge generation material.

Specific examples of suitable phthalocyanine pigments include, but are not limited to, compounds having the following formula (7):

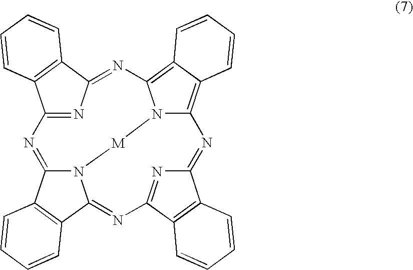

wherein M (central metal) represents a metal atom such as Li, Be, Na, Mg, Al, Si, K, Ca, Sc, Ti, V, Cr, Mn, Fe, Co, Ni, Cu, Zn, Ga, Ge, Y, Zr, Nb, Mo, Tc, Ru, Rh, Pd, Ag, Cd, In, Sn, Sb, Ba, Hf, Ta, W, Re, Os, Ir, Pt, Au, Hg, Tl, La, Ce, Pr, Nd, Pm, Sm, Eu, Gd, Th, Dy, Ho, Er, Tm, Yb, Lu, Th, Pa, U, Np, and Am, or an oxide, a chloride, a fluoride, a hydroxide, or a bromide thereof.

In addition to the above-described metal phthalocyanine pigments having a basic phthalocyanine skeleton having the formula (7), metal phthalocyanine pigments having a multimeric structure such as dimmer or trimer or a highly polymeric structure are also suitable for the charge generation material. In addition, the basic phthalocyanine skeleton may have a substituent. Among various metal phthalocyanine pigments, titanyl phthalocyanine containing TiO as the central metal, chlorogallium phthalocyanine, and hydroxygallium phthalocyanine are preferable because of their high photosensitive properties. It is known that metal phthalocyanine pigments have various crystal forms. For example, titanyl phthalocyanine has α, β, γ, m, and Y forms, and copper phthalocyanine has α, β, and γ forms. It is known that different crystal forms have different properties even if the central metals are the same. It is also known that photoreceptors using phthalocyanine pigments having different crystal forms have different properties as disclosed in “Polymorphism of Oxotitanium Phthalocyanine and Applications for Electrophotographic Receptors”, Enokida et al., Electrophotography (DENSHISHYASHIN GAKKAISHI), Vol. 29, No. 4, p. 16 (1990). Accordingly, photosensitive properties of a photoreceptor largely depend on the crystal from of metal phthalocyanine.

Among various metal phthalocyanine pigments, titanyl phthalocyanine pigments are preferable. Specifically, a titanyl phthalocyanine crystal having a maximum diffraction peak at a Bragg angle 2θ(±0.2°) of 27.2° with respect to a characteristic X-ray specific to CuKα having a wavelength of 1.542 Å is preferable because of its excellent sensitivity, especially for use in high-speed image forming apparatuses. More specifically, a titanyl phthalocyanine crystal having a maximum diffraction peak at a Bragg angle 2θ(±0.2°) of 27.2°, main peaks at 9.4°, 9.6°, and 24.0°, a lowest-side-angle diffraction peak at 7.3°, and no diffraction peak within a range between 7.3° and 9.4° and at 26.3° is more preferable because of its large charge generation efficiency, good electrostatic properties, and resistance to background fouling.

The above-described charge generation materials can be used alone or in combination.

Specific examples of optionally-usable binder resins for the charge generation layer 32 include, but are not limited to, polyamide, polyurethane, epoxy resins, polyketone, polycarbonate, silicone resins, acrylic resins, polyvinyl butyral, polyvinyl formal, polyvinyl ketone, polystyrene, poly-N-vinylcarbazole, polyacrylamide, polyvinyl benzal, polyester, phenoxy resins, vinyl chloride-vinyl acetate copolymer, polyvinyl acetate, polyphenylene oxide, polyvinyl pyridine, cellulose resins, casein, polyvinyl alcohol, and polyvinyl pyrrolidone. These binder resins can be used alone or in combination.

The charge generation layer 32 preferably includes the binder resin in an amount of 0 to 500 parts by weight, and more preferably 10 to 300 parts by weight, based on 100 parts by weight of the charge generation material.

The charge generation layer 32 can be formed by applying a charge generation layer coating liquid on the conductive substrate 31 or an undercoat layer (to be described later) by a typical method such as a dip coating method, a spray coating method, a bead coating method, a nozzle coating method, a spinner coating method, and a ring coating method, followed by drying. The drying is performed using an oven or the like. The drying temperature is preferably 50 to 160° C., and more preferably 80 to 140° C. The resultant charge generation layer 32 typically has a thickness of 0.01 to 5 μm, and preferably 0.1 to 2 μm.

The charge generation layer coating liquid is prepared by dispersing a charge generation material, optionally together with a binder resin, in a solvent using a typical disperser such as a ball mill, an attritor, a sand mill, a bead mill, and an ultrasonic disperser. The binder resin may be added either before or after dispersing the charge generation material in the solvent. The charge generation layer coating liquid may further include an additive such as an intensifier, a dispersant, a surfactant, and a silicone oil, and a charge transport material to be described later. The charge generation layer coating liquid typically includes the binder resin in an amount of 0 to 500 parts by weight, and preferably 10 to 300 parts by weight, based on 100 parts by weight of the charge generation material.

Specific examples of usable solvents for the charge generation layer coating liquid include, but are not limited to, isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, and ligroin. Among these solvents, ketone solvents, ester solvents, and ether solvents are preferable. These solvents can be used alone or in combination.

### (Charge Transport Layer)

Description is now given of the charge transport layer 33. The charge transport layer 33 includes a charge transport material and a binder resin as main components. The photoreceptor of the present invention includes a charge transport material having a triarylamine structure, and may optionally include an electron transport material and a hole transport material. Here, charge transport materials include both electron transport materials and hole transport materials.

Specific examples of usable electron transport materials include, but are not limited to, electron acceptable materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, diphenoquinone derivatives, and naphthalene tetracarboxylic acid diimide derivatives. These electron transport materials can be used alone or in combination.

Specific examples of usable hole transport materials include, but are not limited to, poly-N-vinylcarbazole and derivatives thereof, poly-γ-carbazolylethyl glutamate and derivatives thereof, pyrene-formaldehyde condensates and derivatives thereof, polyvinyl pyrene, polyvinyl phenanthrene, polysilane, oxazole derivatives, oxadiazole derivatives, imidazole derivatives, monoarylamine derivatives, diarylamine derivatives, stilbene derivatives, α-phenylstilbene derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, distyryl derivatives, and enamine derivatives. These hole transport materials can be used alone or in combination.

As the charge transport material having a triarylamine structure, a distyryl compound having two styryl groups is preferably used. Because of having a large π conjugation, such a distyryl compound has a high mobility, thereby easily transporting charges. Accordingly, the distyryl compound can more reliably suppress increase of the bright section potential than a charge transport material having an equivalent ionization potential.

More specifically, a distyrylbenzene derivative having the following formula (3) is preferable:

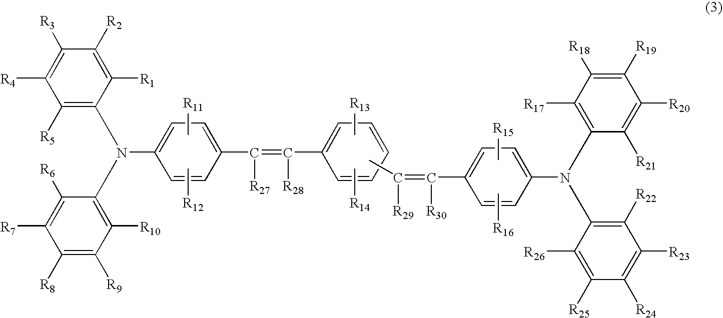

wherein each of R₁ to R₃₀ independently represents a hydrogen atom, an alkyl group having 1 to 4 carbon atoms, an alkoxy group having 1 to 4 carbon atoms, or an aryl group which is substituted with a hydrogen atom, an alkyl group having 1 to 4 carbon atoms, or an alkoxy group having 1 to 4 carbon atoms.

The distyrylbenzene derivative having the formula (3) has multiple triarylamine structures each having a high charge transport ability. Further, a large π conjugation is spread throughout a molecule via an aromatic group in the center of the molecule. Since the triarylamine structures are apart from each other, intermolecular charge transfer easily occurs.

Such a distyrylbenzene derivative can be synthesized by a method disclosed in JP 2552695, the disclosure of which is incorporated herein by reference.

Specific examples of usable distyryl compounds include, but are not limited to, the following compounds Nos. 1 to 8:

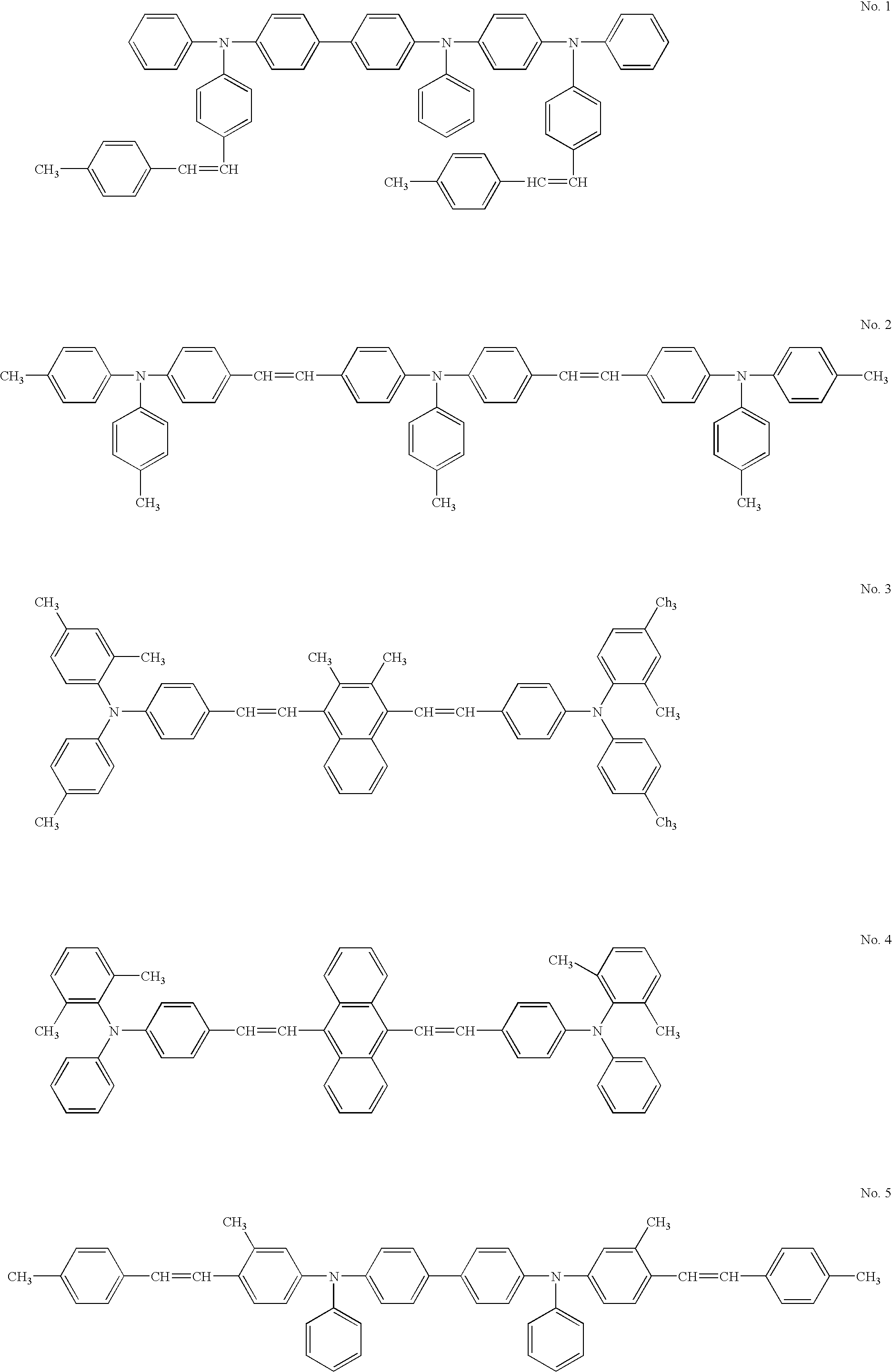

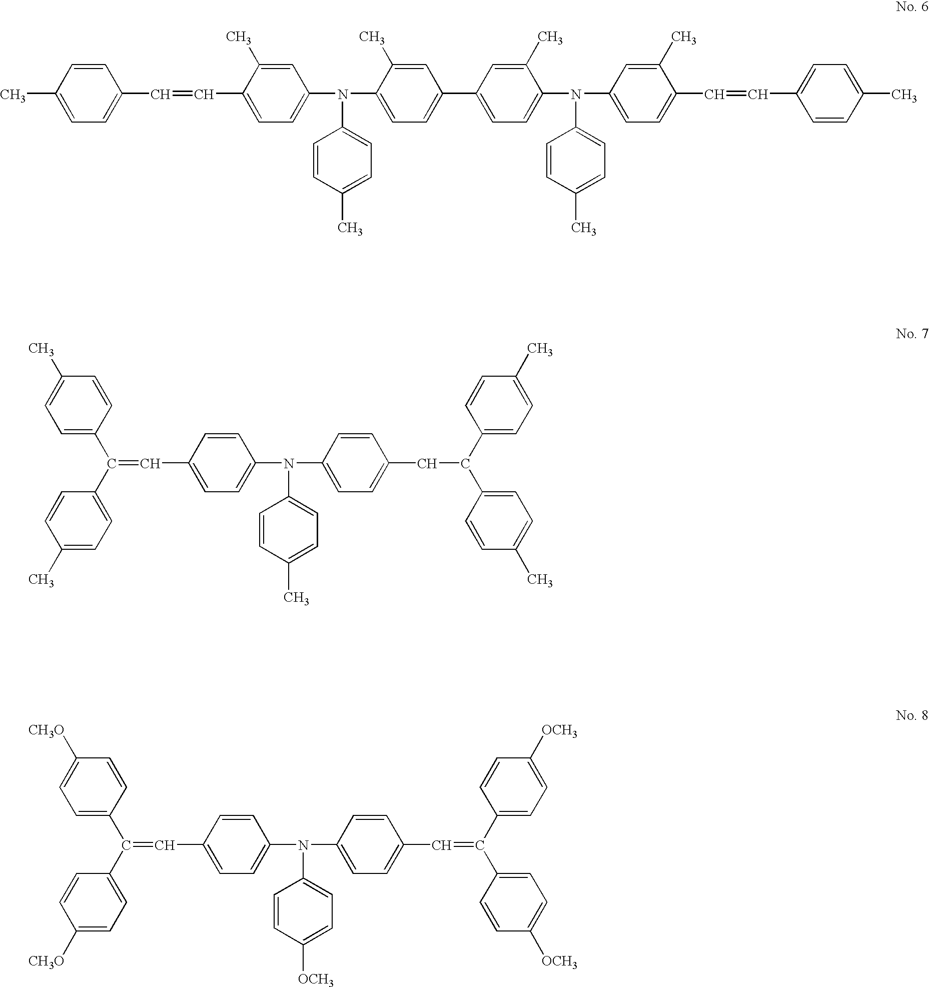

Specific examples of usable distyrylbenzene derivatives having the formula (3) include, but are not limited to, the following compounds Nos. 1 to 52:

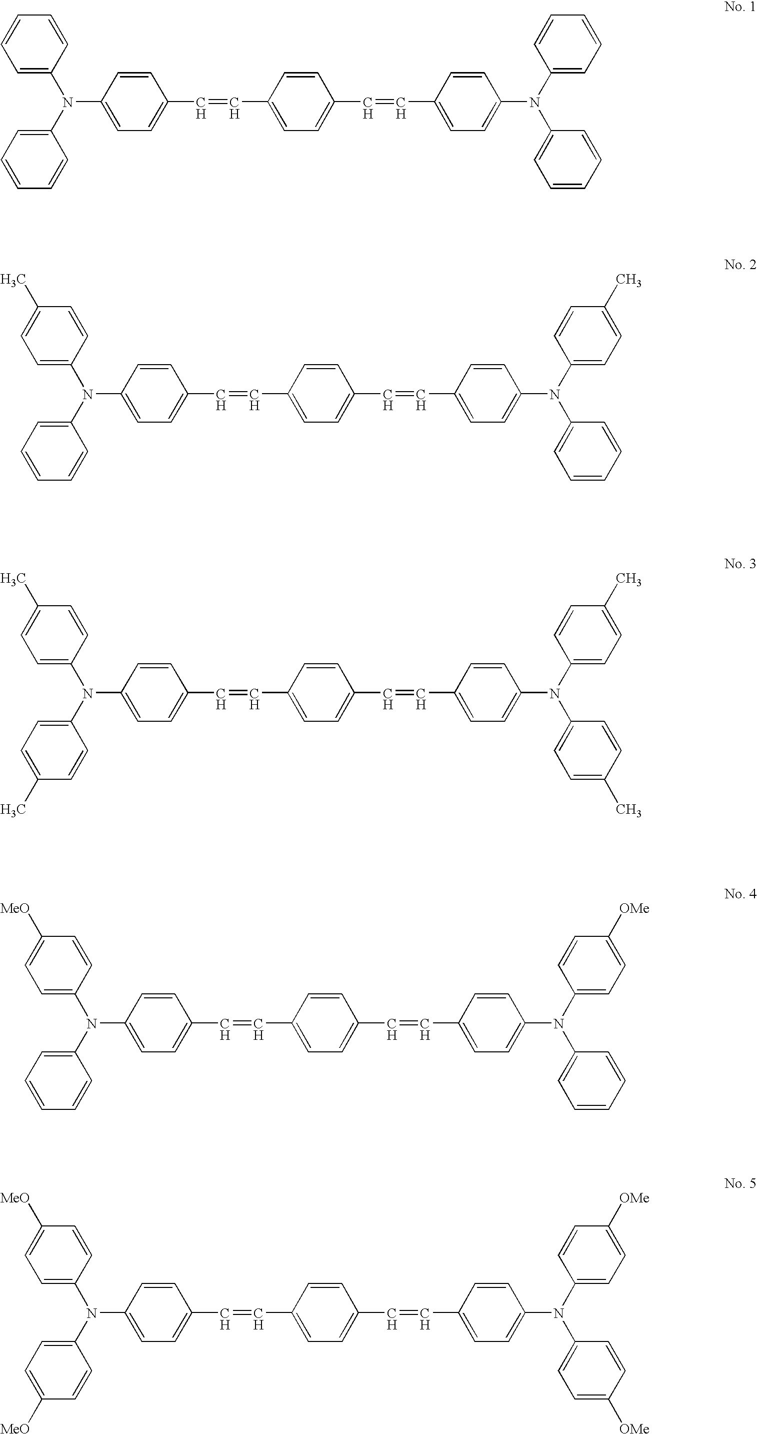

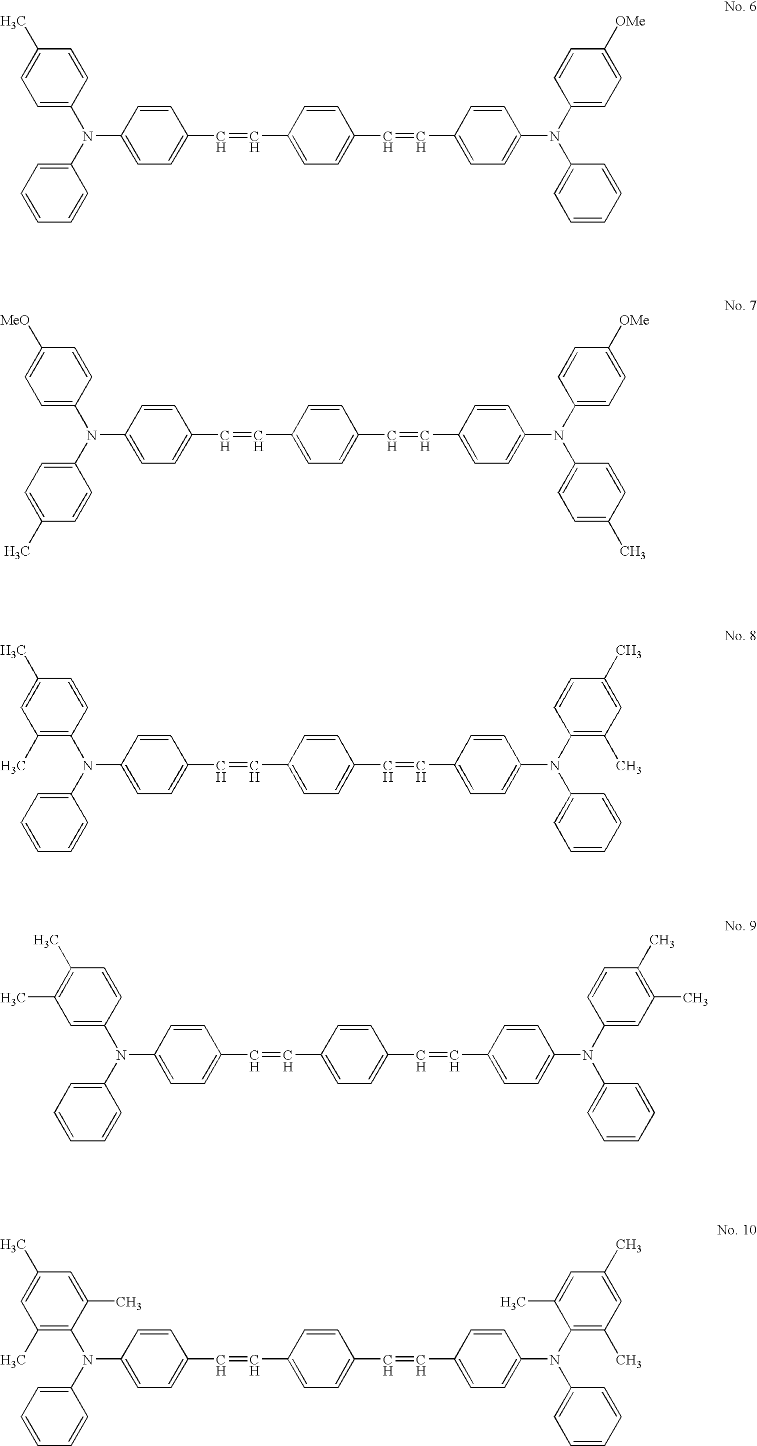

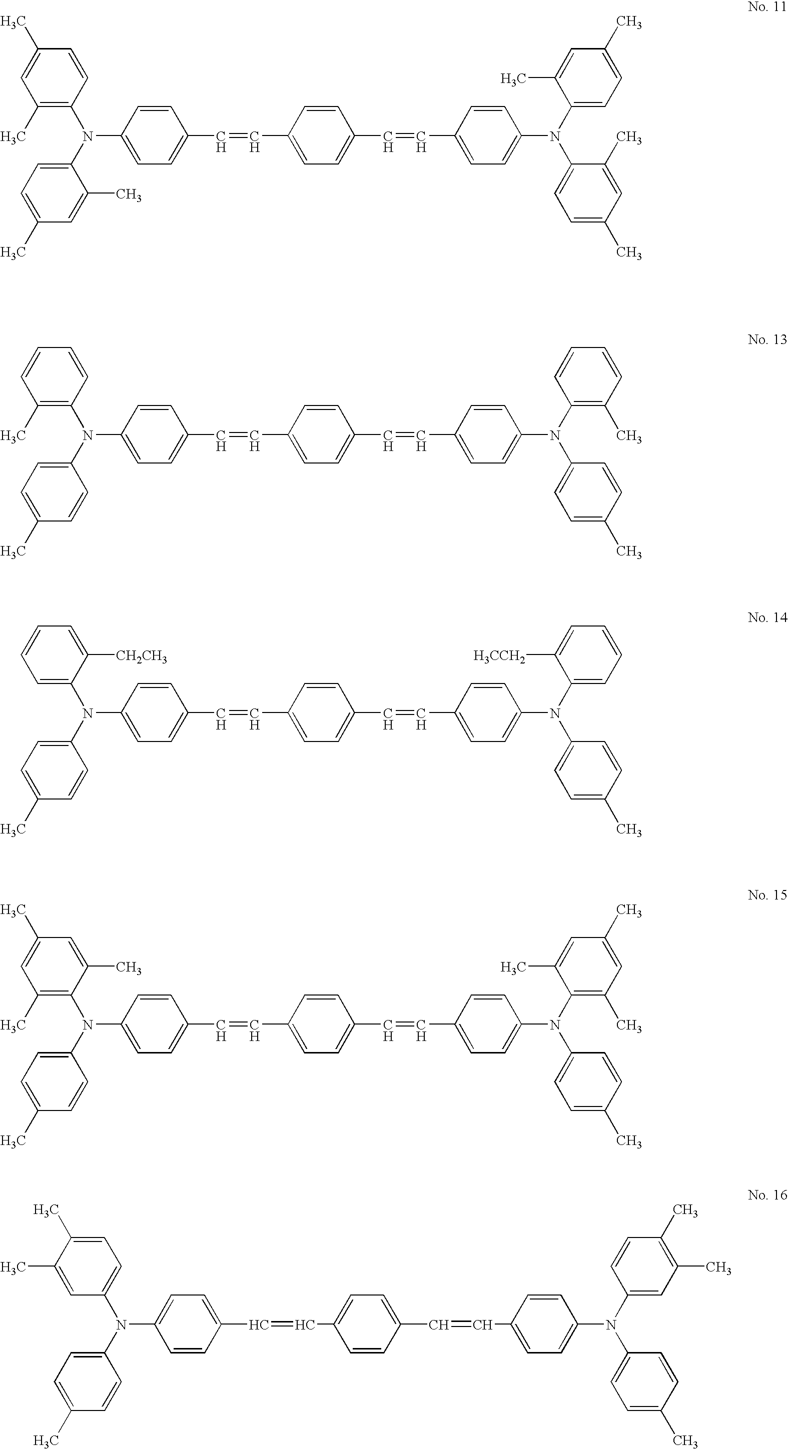

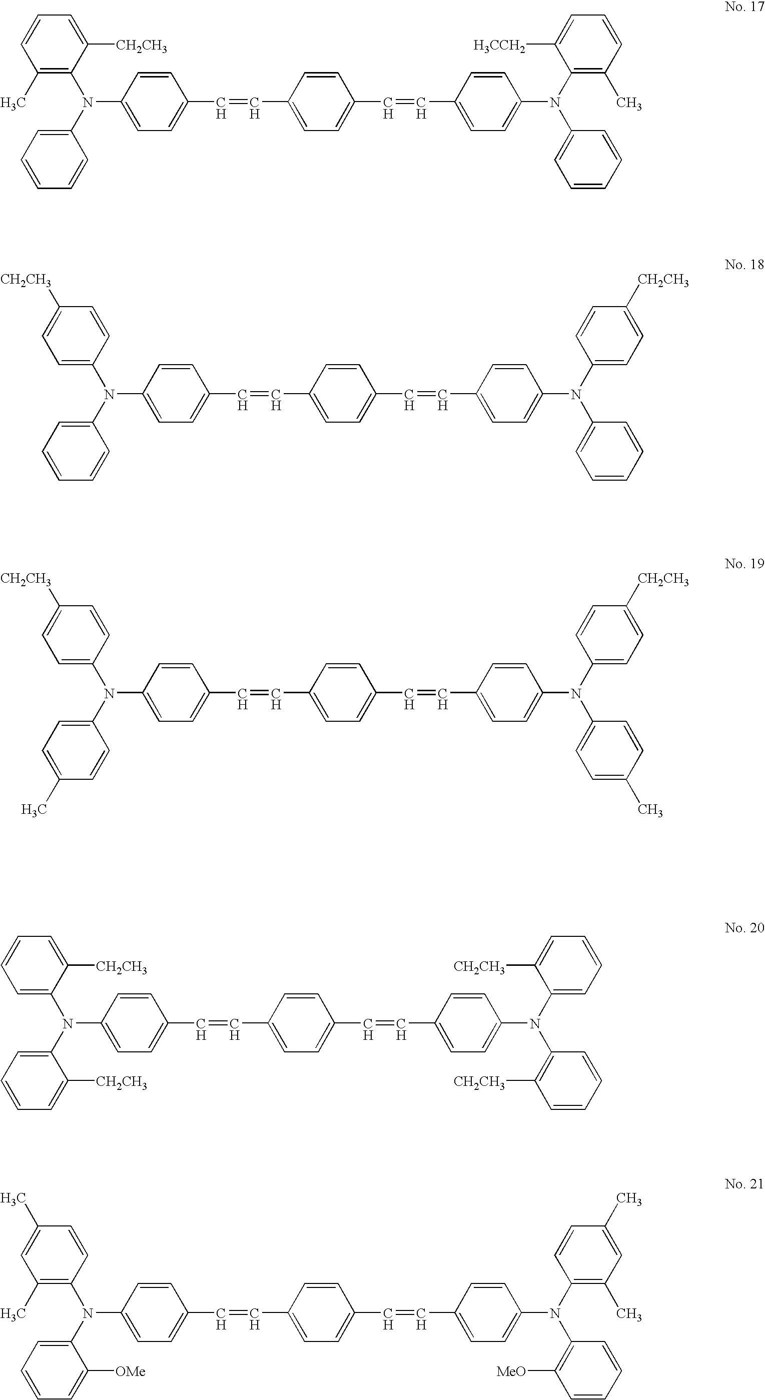

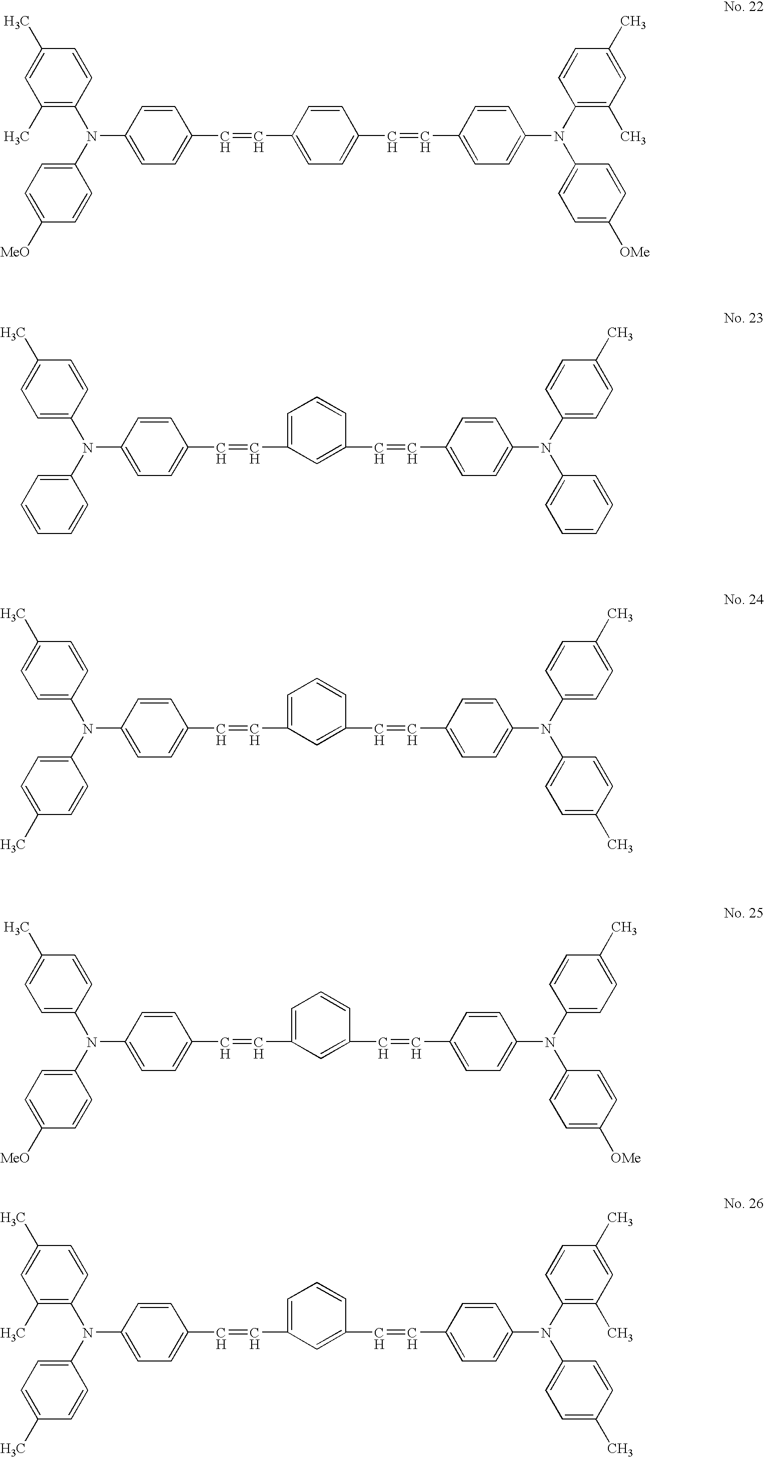

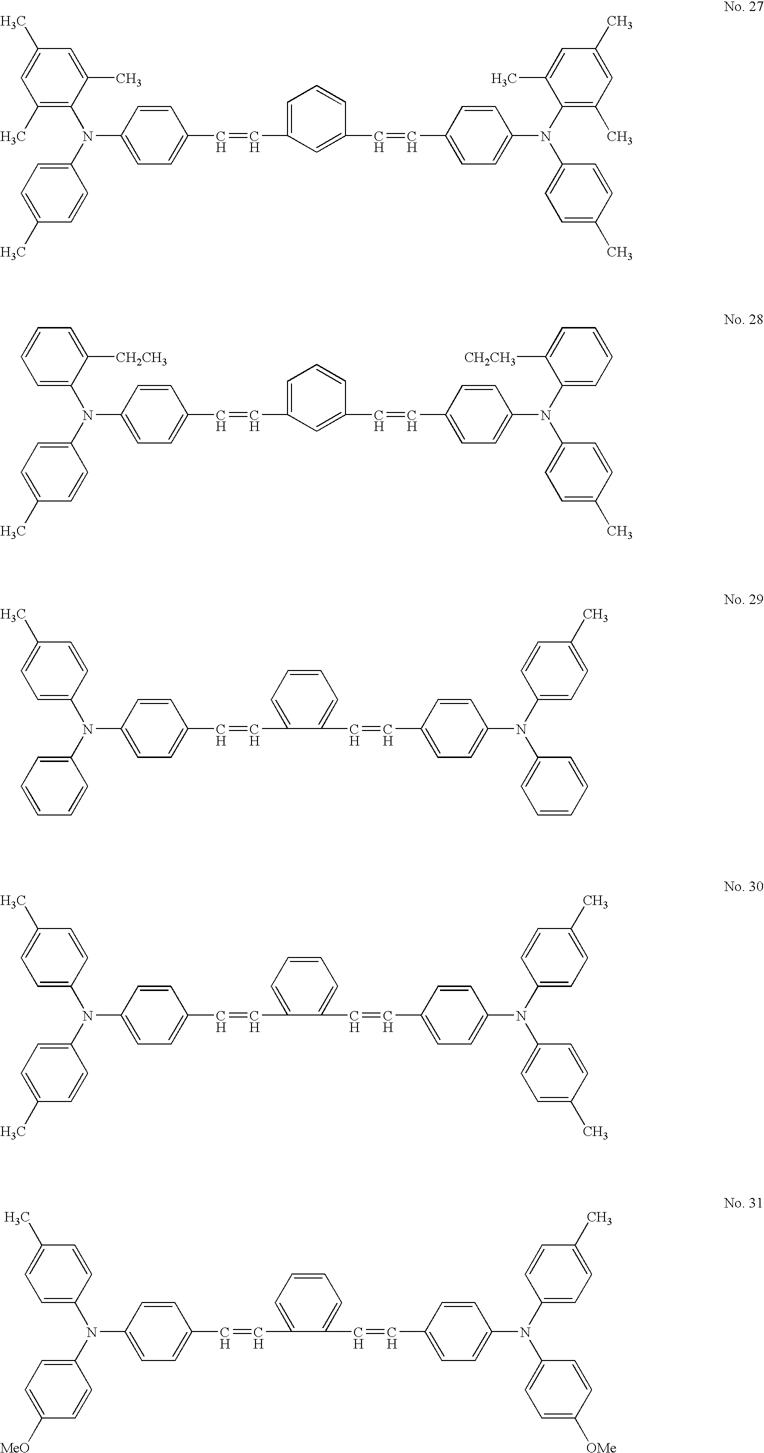

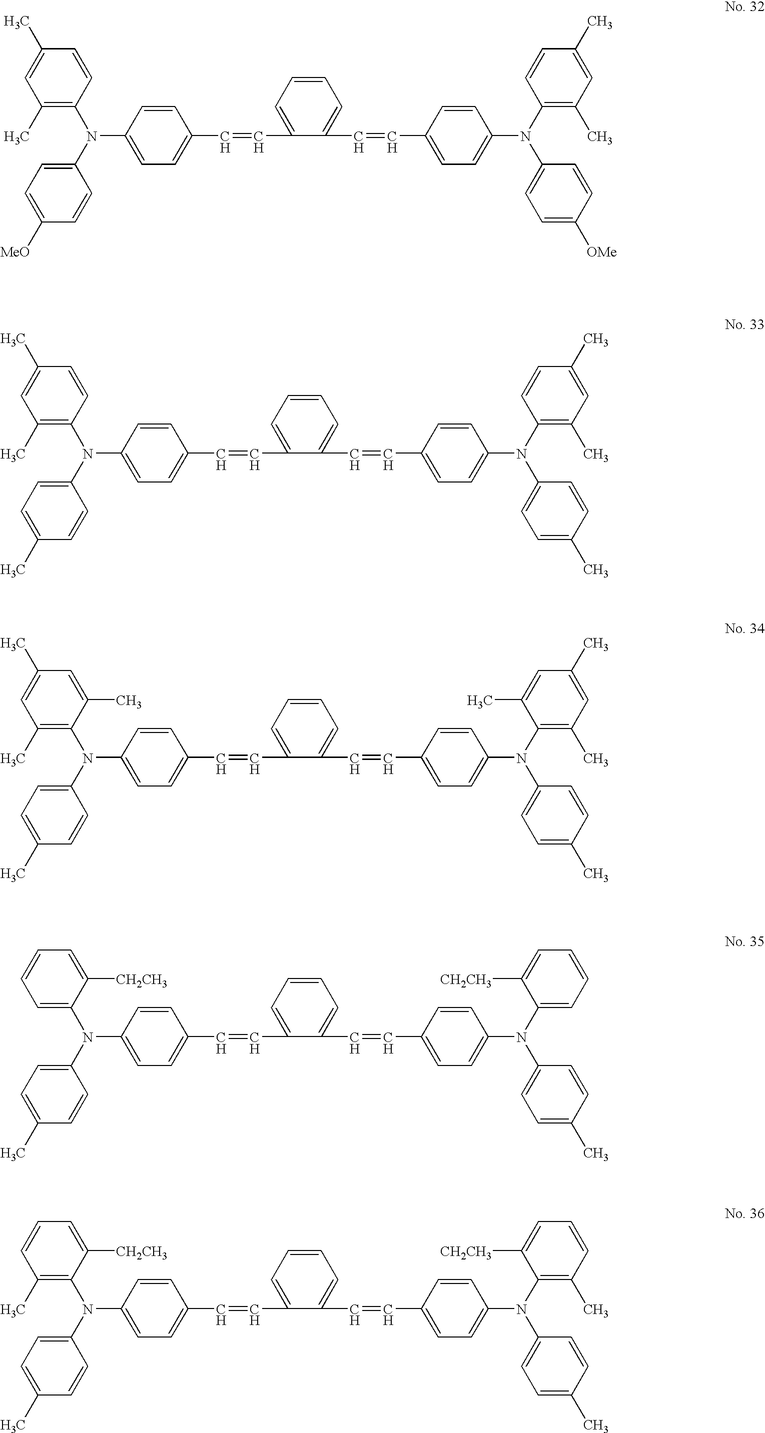

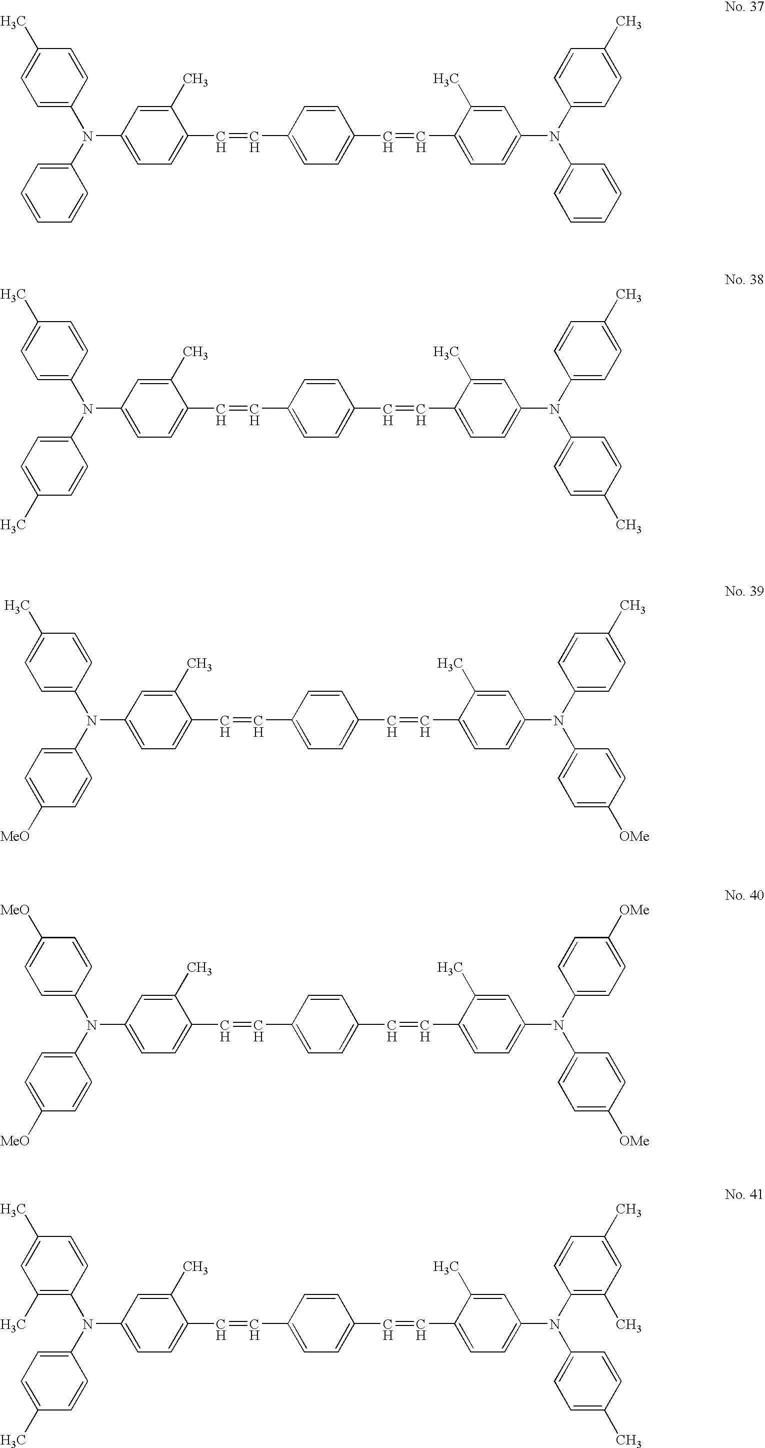

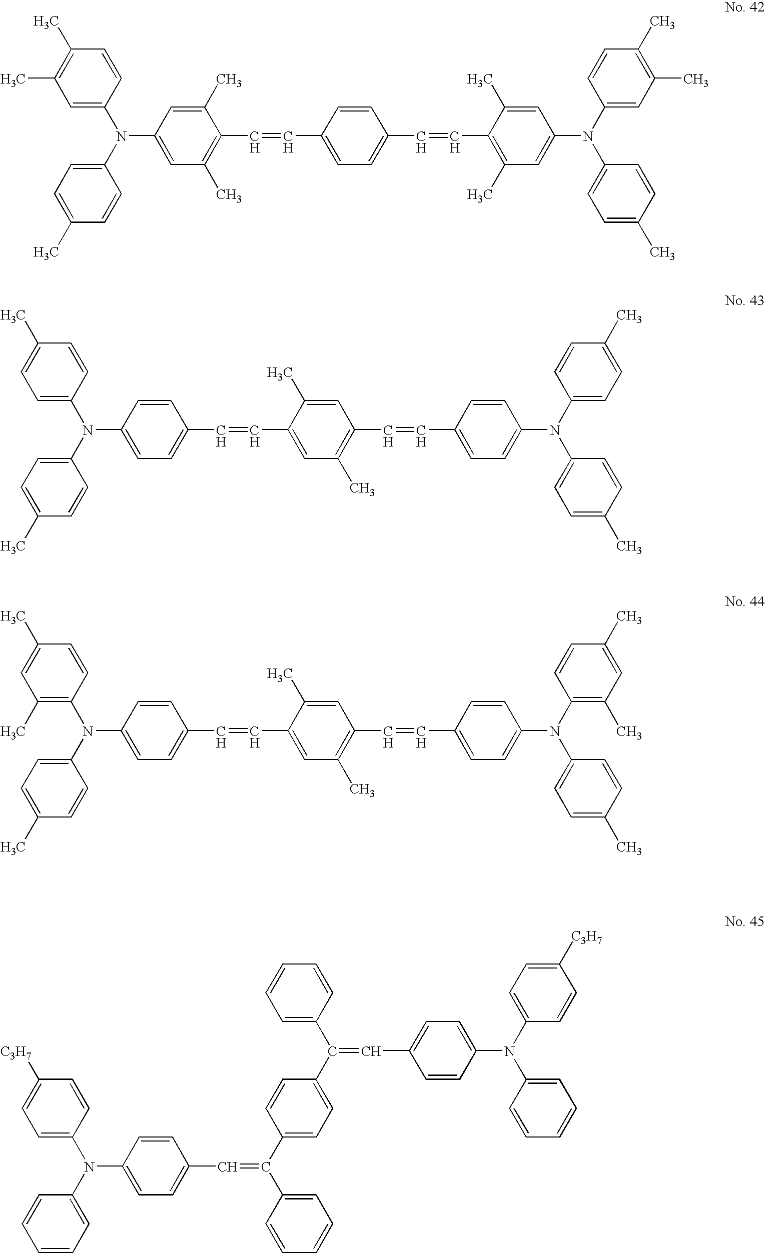

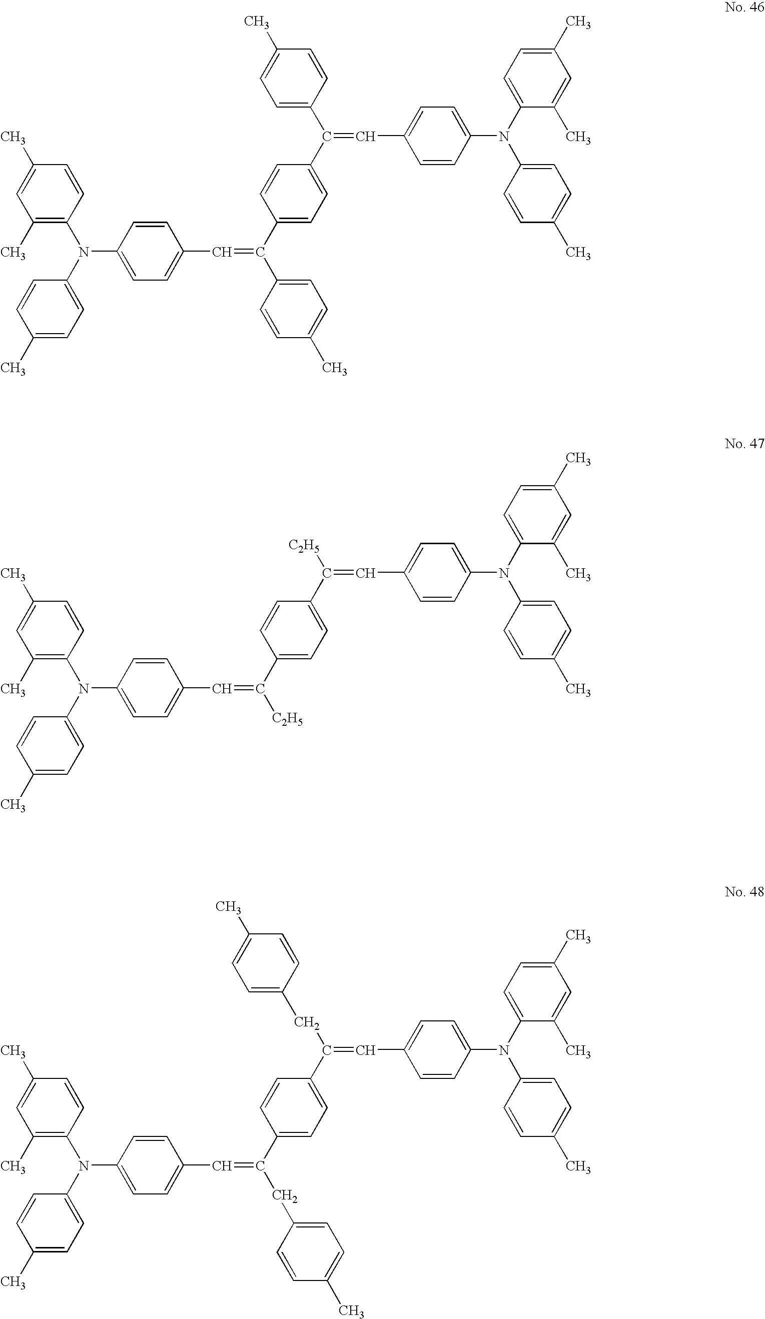

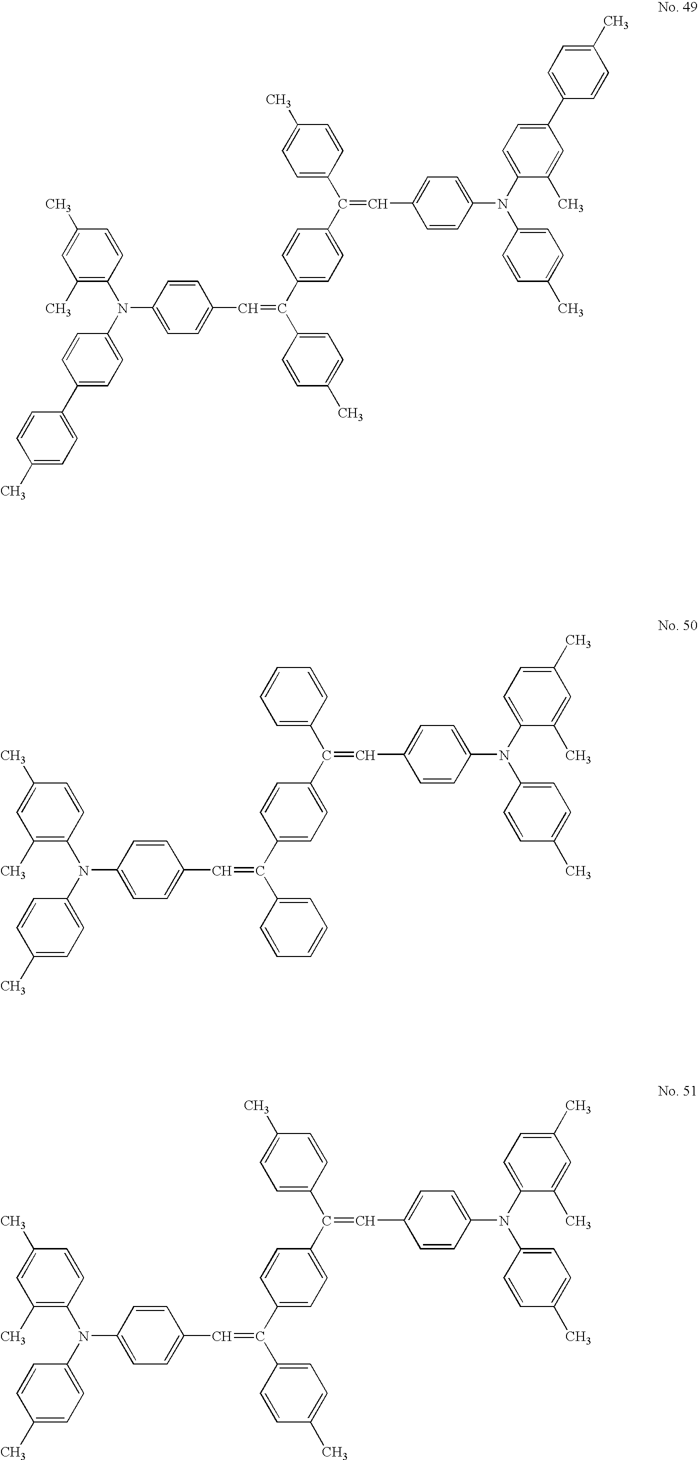

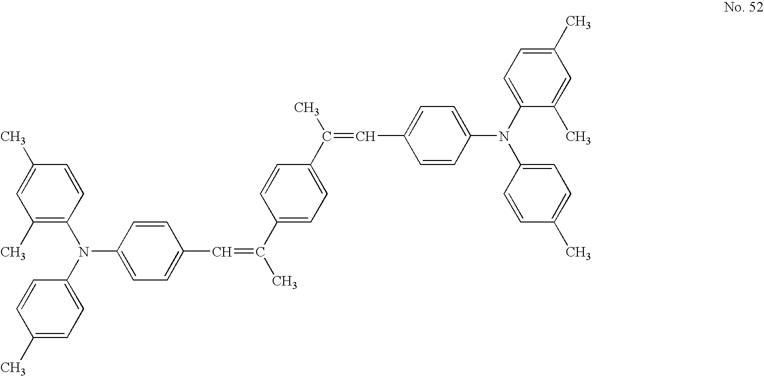

In particular, when at least one of R₃, R₈, R₁₉, and R₂₄ is methyl group in the formula (3), the bright section potential is reliably decreased.

Specific examples of usable binder resins for the charge transport layer 33 include, but are not limited to, thermoplastic and thermosetting resins such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinyl formal, polyvinyl toluene, poly-N-vinylcarbazole, acrylic resin, silicone resin, epoxy resin, melamine resin, urethane resin, phenol resin, and alkyd resin.

In addition, charge transport polymers can be also used as the binder resin for the charge transport layer 33. Specific examples of such charge transport polymers include, but are not limited to, polycarbonate, polyester, polyurethane, polyether, polysiloxane, and acrylic resins having a skeleton of arylamine, benzidine, hydrazone, carbazole, stilbene, or pyrazoline; and polymers having a polysilane skeleton.

Specifically, polycarbonates having a triarylamine structure in a main chain and/or side chain thereof are preferably used. More specifically, the following compounds (I) to (X) are preferable for the charge transport polymer:

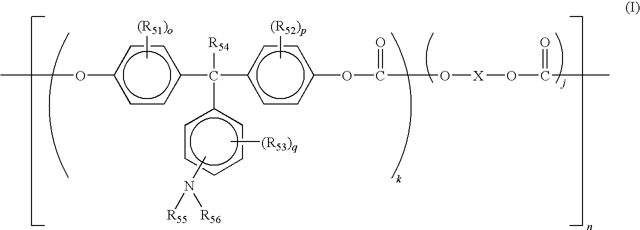

wherein each of R₅₁, R₅₂, and R₅₃ independently represents a substituted or unsubstituted alkyl group or a halogen atom; R₅₄ represents a hydrogen atom or a substituted or unsubstituted alkyl group; each of R₅₅ and R₅₆ independently represents a substituted or unsubstituted aryl group; each of o, p, and q independently represents an integer of 0 to 4; k represents a numeral of 0.1 to 1 and j represents a numeral of 0 to 0.9; n represents an integer of 5 to 5000; and X represents a divalent aliphatic group, a divalent alicyclic group, or a divalent group having the following formula:

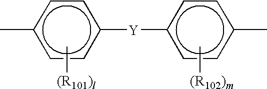

wherein each of R₁₀₁ and R₁₀₂ independently represents a substituted or unsubstituted alkyl group, a substituted or unsubstituted aryl group, or a halogen atom; each of 1 and m independently represents an integer of 0 to 4; and Y represents a single bond, a linear, branched, or cyclic alkylene group having 1 to 12 carbon atoms, —O—, —S—, —SO—, —SO₂—, —CO—, —CO—O-Z-O—CO— (Z represents a divalent aliphatic group), or a group having the following formula:

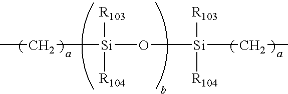

wherein a represents an integer of 1 to 20; b represents an integer of 1 to 2000; each of R₁₀₃ and R₁₀₄ independently represents a substituted or unsubstituted alkyl group or a substituted or unsubstituted aryl group, wherein R₁₀₁, R₁₀₂, R₁₀₃, and R₁₀₄ may be the same or different from the others;

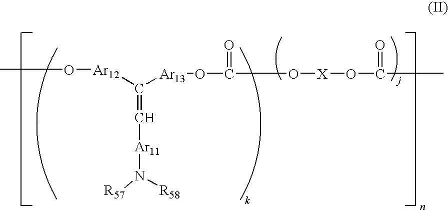

wherein each of R₅₇ and R₅₈ independently represents a substituted or unsubstituted aryl group; each of Ar₁₁, Ar₁₂, and Ar₁₃ independently represents an arylene group; and X, k, j, and n are as defined in the formula (I);

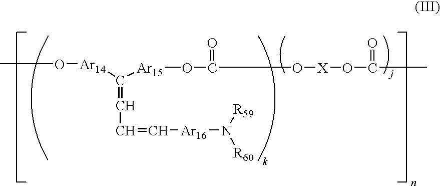

wherein each of R₅₉ and R₆₀ independently represents a substituted or unsubstituted aryl group; each of Ar₁₄, Ar₁₅, and Ar₁₆ independently represents an arylene group; and X, k, j, and n are as defined in the formula (I);

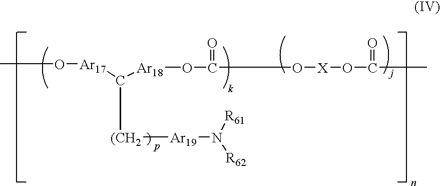

wherein each of R₆₁ and R₆₂ independently represents a substituted or unsubstituted aryl group; each of Ar₁₇, Ar₁₈, and Ar₁₉ independently represents an arylene group; p represents an integer of 1 to 5; and X, k, j, and n are as defined in the formula (I);

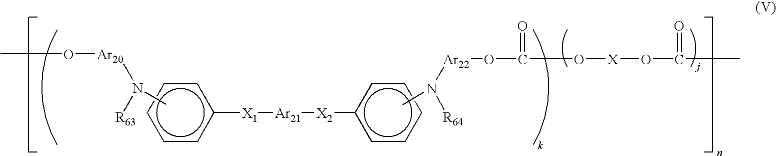

wherein each of R₆₃ and R₆₄ independently represents a substituted or unsubstituted aryl group; each of Ar₂₀, Ar₂₁, and Ar₂₂ independently represents an arylene group; each of X₁ and X₂ independently represents a substituted or unsubstituted ethylene group or a substituted or unsubstituted vinylene group; and X, k, j, and n are as defined in the formula (I);

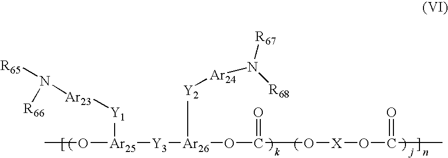

wherein each of R₆₅, R₆₆, R₆₇, and R₆₈ independently represents a substituted or unsubstituted aryl group; each of Ar₂₃, Ar₂₄, Ar₂₅, and Ar₂₆ independently represents an arylene group; each of Y₁, Y₂, and Y₃ independently represents a single bond, a substituted or unsubstituted alkylene group, a substituted or unsubstituted cycloalkylene group, a substituted or unsubstituted alkylene ether group, an oxygen atom, a sulfur atom, or a vinylene group; and X, k, j, and n are as defined in the formula (I);

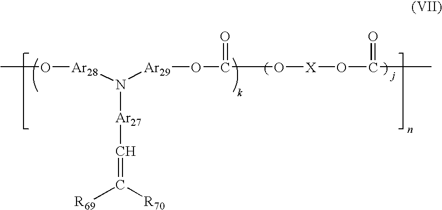

wherein each of R₆₉ and R₇₀ independently represents a hydrogen atom or a substituted or unsubstituted aryl group, and R₆₉ and R₇₀ may share bond connectivity to form a ring; each of Ar₂₇, Ar₂₈, and Ar₂₉ independently represents an arylene group; and X, k, j, and n are as defined in the formula (1);

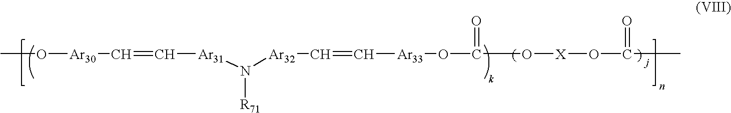

wherein R₇₁ represents a substituted or unsubstituted aryl group; each of Ar₃₀, Ar₃₁, Ar₃₂, and Ar₃₃ independently represents an arylene group; and X, k, j, and n are as defined in the formula (I);

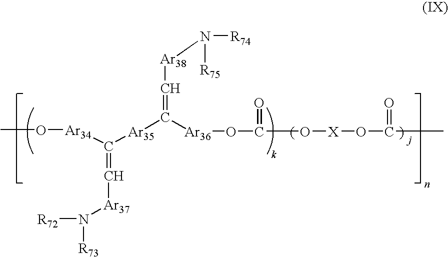

wherein each of R₇₂, R₇₃, R₇₄, and R₇₅ independently represents a substituted or unsubstituted aryl group; each of Ar₃₄, Ar₃₅, Ar₃₆, Ar₃₇, and Ar₃₈ independently represents an arylene group; and X, k, j, and n are as defined in the formula (I); and

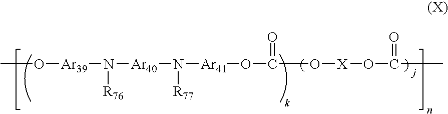

wherein each of R₇₆ and R₇₇ independently represents a substituted or unsubstituted aryl group; each of Ar₃₉, Ar₄₀, and Ar₄₁ independently represents an arylene group; and X, k, j, and n are as defined in the formula (I).

Although being described in the form of alternating copolymer, the above-described compounds (I) to (X) may be in the form of random copolymer.

The charge transport layer 33 preferably includes the charge transport material in an amount of 20 to 300 parts by weight, and more preferably 40 to 150 parts by weight, based on 100 parts by weight of the binder resin. The charge transport polymer is used alone or in combination with the binder resin.

Specific examples of suitable solvents for forming the charge transport layer 33 include, but are not limited to, tetrahydrofuran, dioxane, toluene, dichloromethane, monochlorobenzene, dichloroethane, cyclohexanone, methyl ethyl ketone, and acetone. These solvents can be used alone or in combination.

The charge transport layer 33 may optionally include a plasticizer or a leveling agent, if desired. Specific examples of usable plasticizers include, but are not limited to, dibutyl phthalate and dioctyl phthalate. The charge transport layer 33 preferably includes the plasticizer in an amount of 0 to 30 parts by weight based on 100 parts by weight of the binder resin. Specific examples of usable leveling agents include, but are not limited to, silicone oils such as dimethyl silicone oil and methylphenyl silicone oil and polymers and oligomers having a perfluoroalkyl group in a side chain thereof. The amount of the leveling agent is preferably 0 to 1 parts by weight based on 100 parts by weight of the binder resin.

The charge transport layer 33 preferably has a thickness of 30 μm or less, and more preferably 25 μm or less, from the viewpoint of resolution and responsiveness. Although depending on a system (in particular a charging potential) to be used, the charge transport layer 33 preferably has a thickness of 5 μm or more.

When the charge transport layer 33 further includes at least one of the compounds having the formulae (4), (5-1), (5-2), or (6), to be described in detail later, images are more reliably produced. Moreover, when these compounds are used in combination with an antioxidant, images are much more reliably produced.

In particular, the compounds having the formulae (4), (5-1), (5-2), or (6) contribute to reliable image formation even when a photoreceptor is repeatedly used. The reason is not yet cleared, and while the present inventors do not wish to be bound to a specific mechanism of action for how it works, it is considered that an alkylamino group, which is a strong basic group, included in these compounds neutralizes oxidizing gases and ionic substances that may degrade image quality. It is also considered that an amino group substituted with an aromatic hydrocarbon group, which is a functional group having excellent charge transport ability (described in a technical document “Guiding concept for developing better charge transporting organic materials”, Takahashi et al., Electrophotography (DENSHISHYASHIN GAKKAISHI), Vol. 25, No. 3, p. 16 (1983)), included in these compounds improves charge transport ability thereof. When these compounds are used in combination with another charge transport material, the charge transport layer 33 may have a higher sensitivity and images are more reliably produced in repeatedly use.

Specific examples of the compounds having the formula (4) includes the following compounds (4-1) to (4-5).

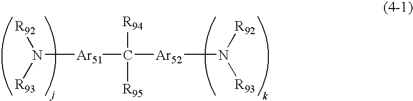

wherein each of R₉₂ and R₉₃ independently represents an alkyl group having 1 to 4 carbon atoms which may be substituted with an aromatic group, and R₉₂ and R₉₃ may share bond connectivity to form a heterocyclic group containing a nitrogen atom; each of j and k independently represents an integer of 0 to 3 wherein both j and k do not represent 0 simultaneously; each of R₉₄ and R₉₅ independently represents a hydrogen atom, a substituted or unsubstituted alkyl group having 1 to 11 carbon atoms, or a substituted or unsubstituted aromatic group; and each of Ar₅₁ and Ar₅₂ independently represents a substituted or unsubstituted aromatic group;

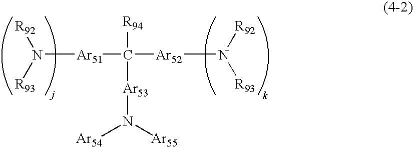

wherein each of R₉₂ and R₉₃ independently represents an alkyl group having 1 to 4 carbon atoms which may be substituted with an aromatic group, and R₉₂ and R₉₃ may share bond connectivity to form a heterocyclic group containing a nitrogen atom; each of j and k independently represents an integer of 0 to 3 wherein both j and k do not represent 0 simultaneously; R₉₄ represents a hydrogen atom, a substituted or unsubstituted alkyl group having 1 to 11 carbon atoms, or a substituted or unsubstituted aromatic group; and each of Ar₅₁, Ar₅₂, Ar₅₃, Ar₅₄, and Ar₅₅ independently represents a substituted or unsubstituted aromatic group, and Ar₅₄ may share bond connectivity with Ar₅₅ or Ar₅₃ to form a heterocyclic group containing a nitrogen atom;

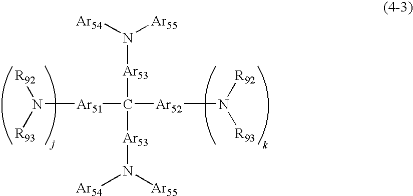

wherein each of R₉₂ and R₉₃ independently represents an alkyl group having 1 to 4 carbon atoms which may be substituted with an aromatic group, and R₉₂ and R₉₃ may share bond connectivity to form a heterocyclic group containing a nitrogen atom; each of j and k independently represents an integer of 0 to 3 wherein both j and k do not represent 0 simultaneously; and each of Ar₅₁, Ar₅₂, Ar₅₃, Ar₅₄, and Ar₅₅ independently represents a substituted or unsubstituted aromatic group, and Ar₅₄ may share bond connectivity with Ar₅₅ or Ar₅₃ to form a heterocyclic group containing a nitrogen atom; and

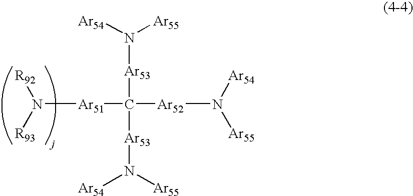

wherein each of R₉₂ and R₉₃ independently represents an alkyl group having 1 to 4 carbon atoms which may be substituted with an aromatic group, and R₉₂ and R₉₃ may share bond connectivity to form a heterocyclic group containing a nitrogen atom; each of j and k independently represents an integer of 1 to 3; and each of Ar₅₁, Ar₅₃, Ar₅₄, and Ar₅₅ independently represents a substituted or unsubstituted aromatic group, and Ar₅₄ may share bond connectivity with Ar₅₅ or Ar₅₃ to form a heterocyclic group containing a nitrogen atom.

Specific examples of suitable alkyl groups for R₉₂ and R₉₃ in the formulae (4-1) to (4-4) include, but are not limited to, methyl group, ethyl group, propyl group, and butyl group. Specific examples of suitable aromatic groups for R₉₂, R₉₃, and Ar₅₁ to Ar₅₅ in the formulae (4-1) to (4-4) include, but are not limited to, aromatic hydrocarbon groups having 1 to 6 valences derived from aromatic hydrocarbon rings such as benzene, naphthalene, anthracene, and pyrene; and aromatic heterocyclic groups having 1 to 6 valences derived from aromatic heterocyclic rings such as pyridine, quinoline, thiophene, furan, oxazole, oxadiazole, and carbazole. Specific examples of suitable substituents in the formulae (4-1) to (4-4) include, but are not limited to, alkyl groups such as methyl group, ethyl group, propyl group, and butyl group; alkoxy groups such as methoxy group, ethoxy group, propoxy group, and butoxy group; halogen atoms such as fluorine, chlorine, bromine, and iodine; and aromatic groups. Specific examples of suitable heterocyclic groups containing a nitrogen atom formed by R₉₂ and R₉₃ in the formulae (4-1) to (4-4) include, but are not limited to, pyrrolidinyl group, piperidinyl group, and pyrrolinyl group. Specific examples of suitable heterocyclic groups containing a nitrogen atom formed by aromatic groups in the formulae (4-1) to (4-4) include, but are not limited to, aromatic heterocyclic groups derived from N-methyl carbazole, N-ethyl carbazole, indole, and quinoline.

Specific preferred examples of the compounds having the formulae (4-1) to (4-4) include, but are not limited to, the below-listed compounds.

| Compound | |
|---|---|
| No. | Chemical Formula |
| (4-1)-1 | 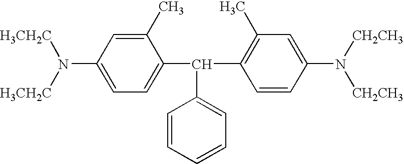 |
| (4-1)-2 | 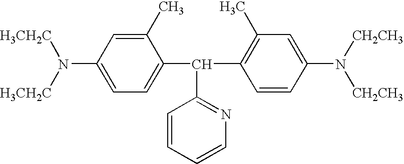 |
| (4-1)-3 | 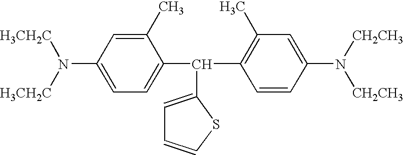 |
| (4-1)-4 | 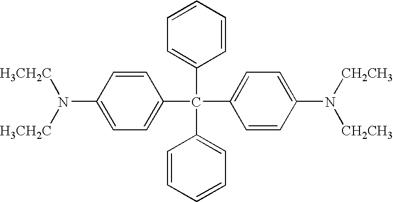 |
| (4-1)-5 | 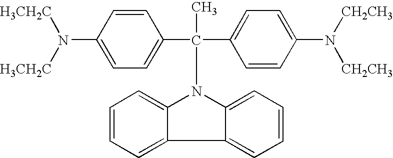 |
| (4-1)-6 | 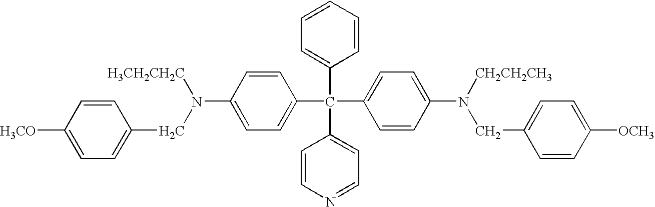 |
| (4-2)-1 | 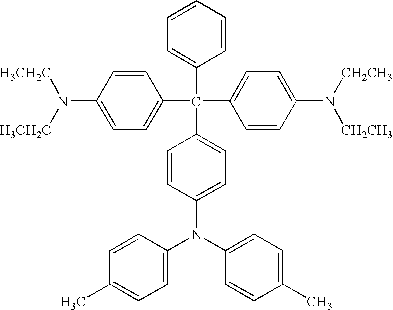 |
| (4-2)-2 | 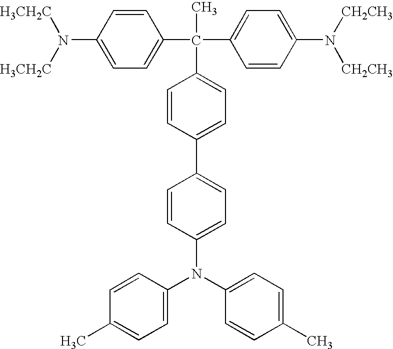 |
| (4-2)-3 | 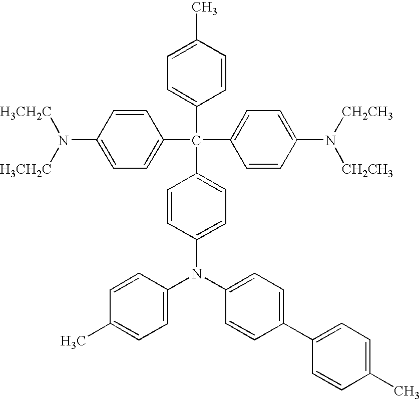 |
| (4-2)-4 | 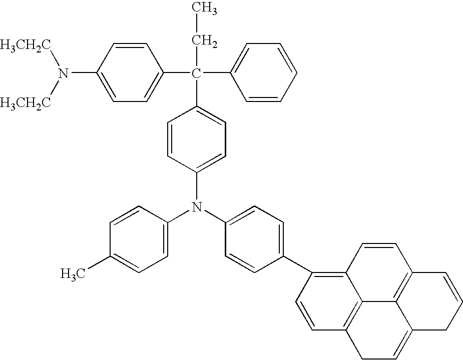 |
| (4-2)-5 | 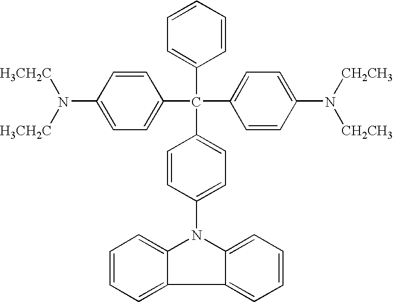 |
| (4-2)-6 | 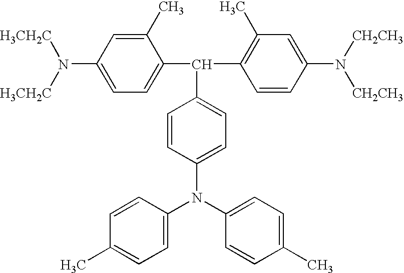 |
| (4-2)-7 | 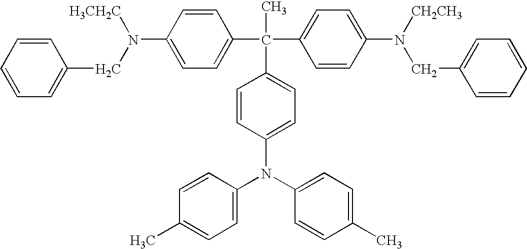 |
| (4-3)-1 | 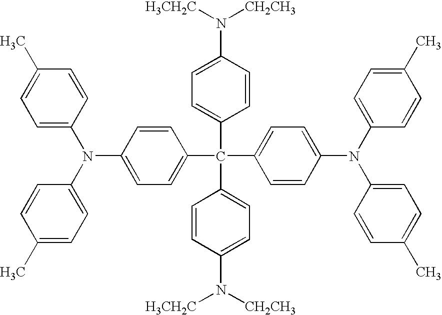 |
| (4-3)-2 | 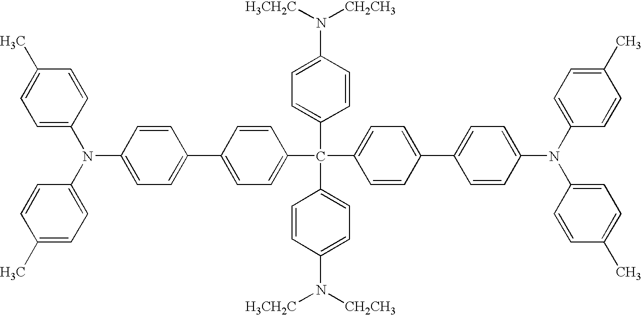 |
| (4-3)-3 | 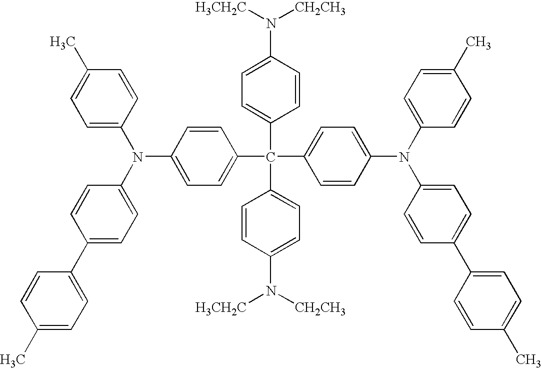 |
| (4-3)-4 | 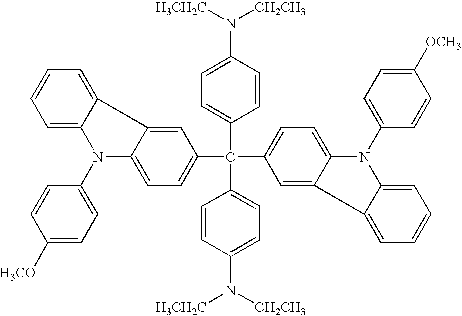 |
| (4-3)-5 | 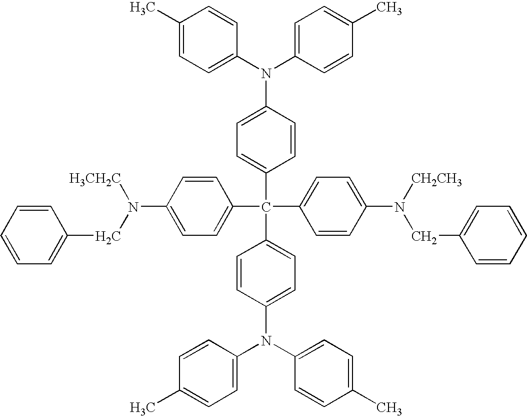 |
| (4-4)-1 | 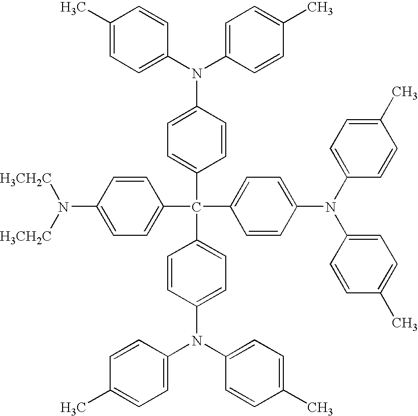 |
| (4-4)-2 | 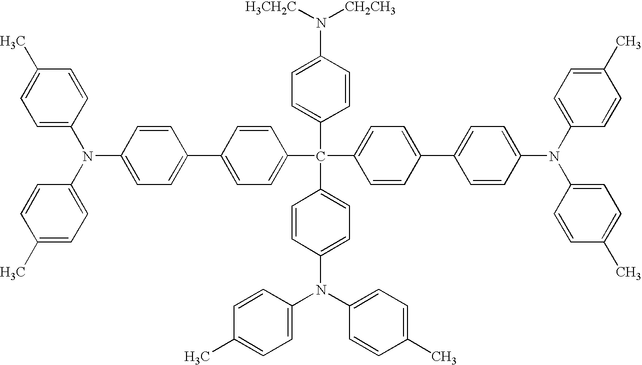 |
| (4-4)-3 | 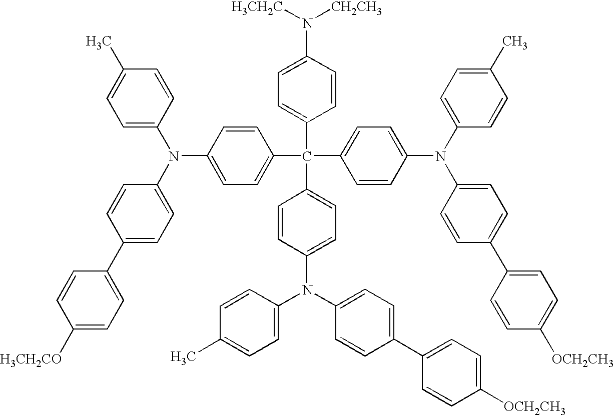 |
| (4-4)-4 | 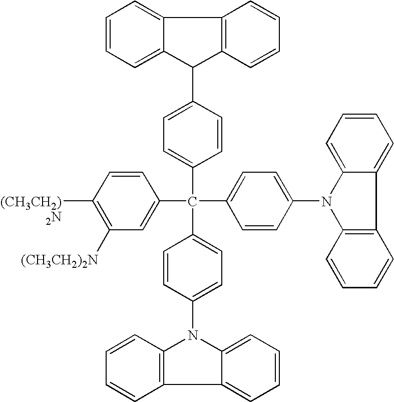 |
| (4-4)-5 | 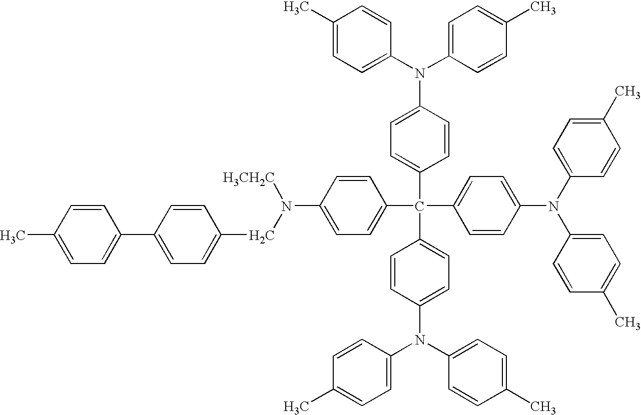 |

Description is now given of the compounds having the following formulae (5-1) and (5-2):

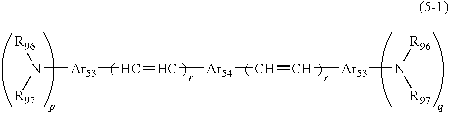

wherein each of R₉₆ and R₉₇ independently represents a substituted or unsubstituted aromatic hydrocarbon group or a substituted or unsubstituted alkyl group, and R₉₆ and R₉₇ may share bond connectivity to form a heterocyclic group containing a nitrogen atom; each of Ar₅₃ and Ar₅₄ independently represents a substituted or unsubstituted aromatic group; each of p and q independently represents an integer of 0 to 3 wherein both p and q do not represent 0 simultaneously; and r represents an integer of 1 to 3; and

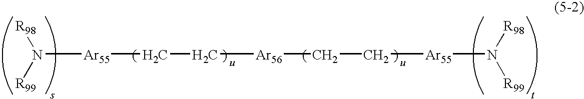

wherein each of R₉₈ and R₉₉ independently represents a substituted or unsubstituted aromatic hydrocarbon group or a substituted or unsubstituted alkyl group, and R₉₈ and R₉₉ may share bond connectivity to form a heterocyclic group containing a nitrogen atom; each of Ar₅₅ and Ar₅₆ independently represents a substituted or unsubstituted aromatic group; each of s and t independently represents an integer of 0 to 3 wherein both s and t do not represent 0 simultaneously; and u represents an integer of 1 to 3.

Specific examples of suitable aromatic hydrocarbon groups represented by R₉₆ to R₉₉ in the formulae (5-1) and (5-2) include, but are not limited to, aromatic hydrocarbon groups derived from aromatic hydrocarbon rings such as benzene, naphthalene, anthracene, and pyrene. Specific examples of suitable alkyl groups represented by R₉₆ to R₉₉ in the formulae (5-1) and (5-2) include, but are not limited to, methyl group, ethyl group, propyl group, butyl group, hexyl group, and undecanyl group. Among these groups, alkyl groups having 1 to 4 carbon atoms are preferable. Specific examples of suitable aromatic groups represented by Ar₅₃ to Ar₅₆ in the formulae (5-1) and (5-2) include, but are not limited to, aromatic hydrocarbon groups having 1 to 4 valences derived from aromatic hydrocarbon rings such as benzene, naphthalene, anthracene, and pyrene; and aromatic heterocyclic groups having 1 to 4 valences derived from aromatic heterocyclic rings such as pyridine, quinoline, thiophene, furan, oxazole, oxadiazole, and carbazole. Specific examples of suitable substituents in the formulae (5-1) and (5-2) include, but are not limited to, alkyl groups such as methyl group, ethyl group, propyl group, butyl group, hexyl group, and undecanyl group; alkoxy groups such as methoxy group, ethoxy group, propoxy group, and butoxy group; halogen atoms such as fluorine, chlorine, bromine, and iodine; and aromatic groups. Specific examples of suitable heterocyclic groups containing a nitrogen atom formed by R₉₆ and R₉₇ or R₉₈ and R₉₉ in the formulae (5-1) and (5-2) include, but are not limited to, pyrrolidinyl group, piperidinyl group, and pyrrolinyl group. Specific examples of suitable heterocyclic groups containing a nitrogen atom further include, but are not limited to, aromatic heterocyclic groups derived from N-methyl carbazole, N-ethyl carbazole, indole, and quinoline.

Specific examples of the compounds having the formulae (5-1) or (5-2) include compounds disclosed in JP-58-57739-B and JP 2529299, the disclosures of each of which is incorporated herein by reference. The compound having the formula (5-1) can be produced by so-called Wittig reaction or Wittig-Horner reaction in which a triphenyl phosphonium salt or a phosphonate, respectively, is reacted with an aldehyde. The compound having the formula (5-2) can be produced by reduction of the compound having the formula (5-1).

Specific preferred examples of the compounds having the formulae (5-1) and (5-2) include, but are not limited to, the below-listed compounds.

| No. | Chemical Formula |
|---|---|
| (5-1)-1 | 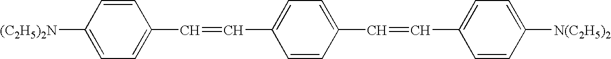 |
| (5-1)-2 | 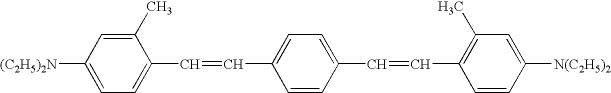 |
| (5-1)-3 | 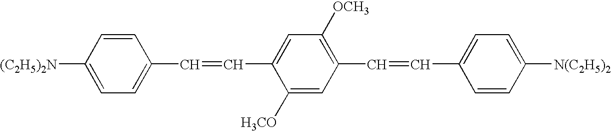 |
| (5-1)-4 | 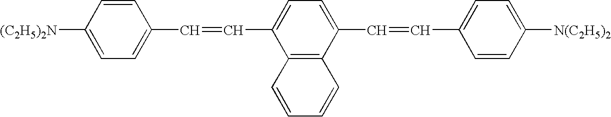 |
| (5-1)-5 | 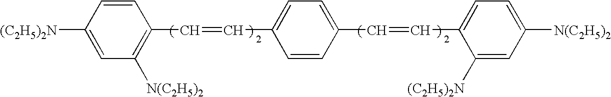 |
| (5-1)-6 | 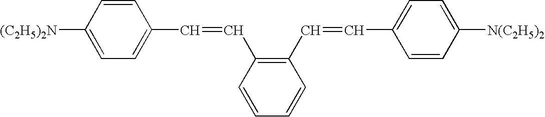 |
| (5-1)-7 | 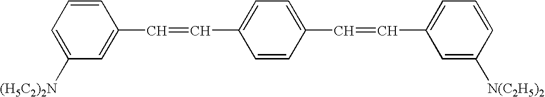 |
| (5-1)-8 | 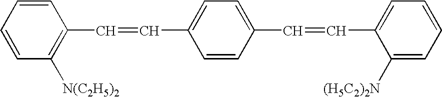 |
| (5-1)-9 | 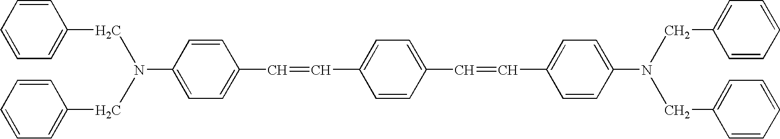 |
| (5-1)-10 | 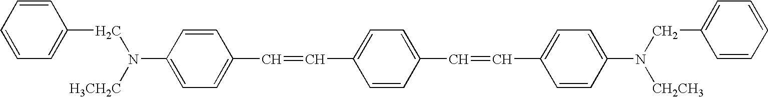 |
| (5-1)-11 | 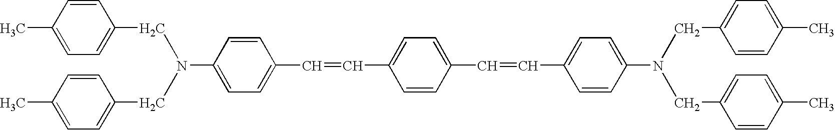 |
| (5-1)-12 | 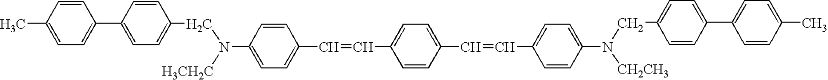 |
| (5-1)-13 | 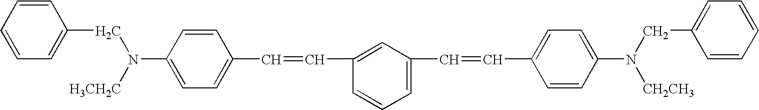 |
| (5-1)-14 | 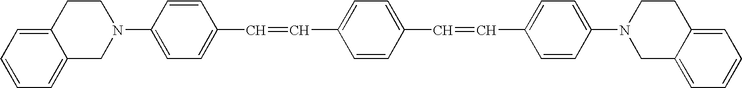 |
| (5-1)-15 | 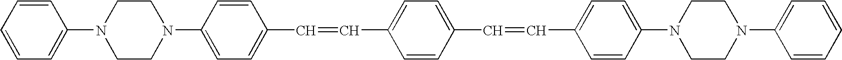 |
| (5-2)-1 | 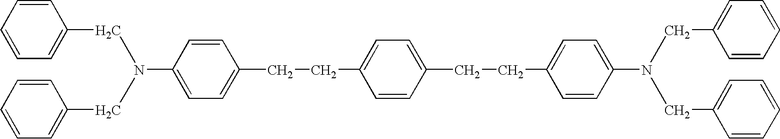 |
| (5-2)-2 | 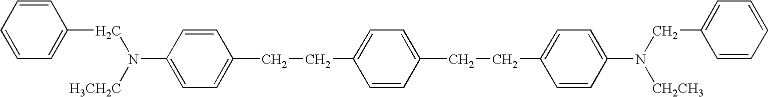 |
| (5-2)-3 | 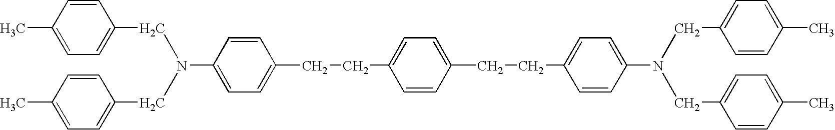 |
| (5-2)-4 | 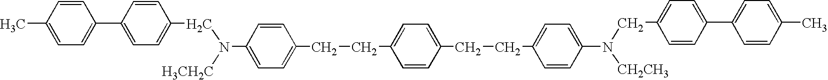 |
| (5-2)-5 | 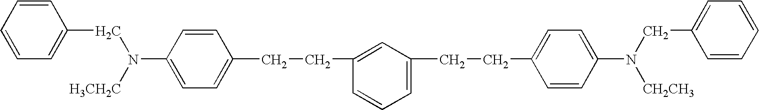 |
| (5-2)-6 | 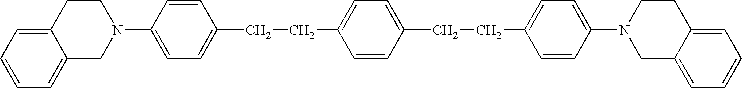 |
| (5-2)-7 | 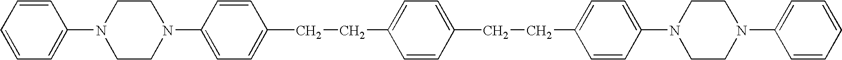 |
| (5-2)-8 | 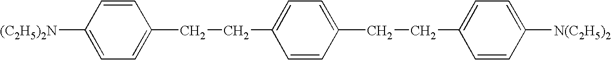 |
| (5-2)-9 | 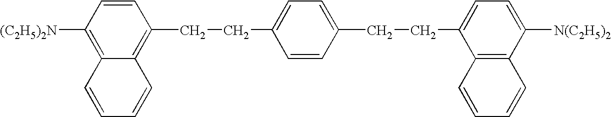 |
| (5-2)-10 | 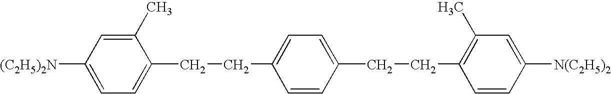 |
| (5-2)-11 | 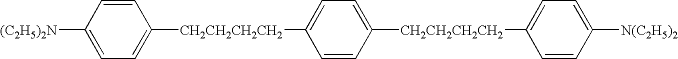 |
| (5-2)-12 | 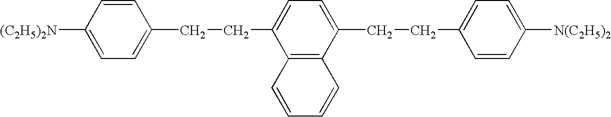 |
| (5-2)-13 | 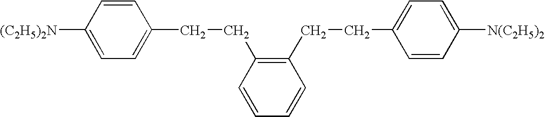 |
| (5-2)-14 | 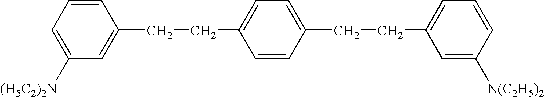 |
| (5-2)-15 | 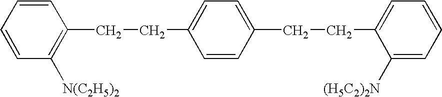 |

Description is now given of the compound having the following formula (6):

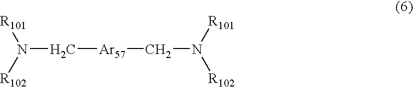

wherein each of R₁₀₁ and R₁₀₂ independently represents a substituted or unsubstituted alkyl group or a substituted or unsubstituted aromatic group wherein at least one of R₁₀₁ and R₁₀₂ is a substituted or unsubstituted aromatic group, and R₁₀₁ and R₁₀₂ may share bond connectivity to form a substituted or unsubstituted heterocyclic group containing a nitrogen atom; and Ar₅₇ represents a substituted or unsubstituted aromatic group.

Specific examples of the compound having the formula (6) include intermediates of dyes and precursors of polymers disclosed in JP-62-13382-B, U.S. Pat. No. 4,223,144, U.S. Pat. No. 3,271,383, and U.S. Pat. No. 3,291,788, the disclosures of each of which is incorporated herein by reference.

The compound having the formula (6) can be easily produced by a method described in a reference entitled “A new synthesis of bisbenzils and novel poly(phenylquinoxaline)s therefrom” (E. Elce and A. S. Hay, Polymer, Vol. 37, No. 9, 1745 (1996)). Specifically, the compound having the formula (6) can be produced by reacting a dihalogen compound having the following formula (8) with a secondary amine compound having the following formula (9) in the presence of a basic compound at room temperature to 100° C.:

BH₂C—Ar₁CH₂B (8)

wherein Ar₁ represents a substituted or unsubstituted aromatic group and B represents a halogen atom;

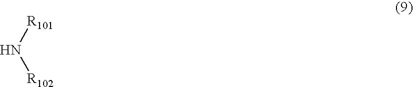

wherein each of R₁₀₁ and R₁₀₂ independently represents a substituted or unsubstituted alkyl group or a substituted or unsubstituted aromatic group wherein at least one of R₁₀₁ and R₁₀₂ is a substituted or unsubstituted aromatic group, and R₁₀₁ and R₁₀₂ may share bond connectivity to form a substituted or unsubstituted heterocyclic group containing a nitrogen atom.

Specific examples of usable basic compounds include, but are not limited to, potassium carbonate, sodium carbonate, potassium hydroxide, sodium hydroxide, hydrogenated sodium, sodium methylate, and potassium-t-butoxide. Specific examples of usable solvents for the above-described reaction include, but are not limited to, dioxane, tetrahydrofuran, toluene, xylene, dimethyl sulfoxide, N,N-dimethylformamide, N-methyl pyrrolidone, 1,3-dimethyl-2-imidazolidinone, and acetonitrile.

Specific examples of suitable alkyl groups represented by R₁₀₁ and R₁₀₂ in the formulae (6) and (9) include, but are not limited to, methyl group, ethyl group, propyl group, butyl group, hexyl group, and undecanyl group. Specific examples of suitable aromatic groups represented by R₁₀₁, R₁₀₂, and Ar₅₇ in the formulae (6) and (9) include, but are not limited to, aromatic hydrocarbon groups derived from aromatic hydrocarbon rings such as benzene, biphenyl, naphthalene, anthracene, fluorene, and pyrene; and aromatic heterocyclic groups derived from aromatic heterocyclic rings such as pyridine, quinoline, thiophene, furan, oxazole, oxadiazole, and carbazole. Specific examples of suitable substituents in the formulae (6) and (9) include, but are not limited to, alkyl groups such as methyl group, ethyl group, propyl group, butyl group, hexyl group, and undecanyl group; alkoxy groups such as methoxy group, ethoxy group, propoxy group, and butoxy group; halogen atoms such as fluorine, chlorine, bromine, and iodine; aromatic hydrocarbon groups; and heterocyclic groups derived from pyrrolidine, piperidine, piperazine, and the like. Specific examples of suitable heterocyclic groups containing a nitrogen atom formed by R₁₀₁ and R₁₀₂ in the formulae (6) and (9) include, but are not limited to, condensed heterocyclic groups in which an aromatic hydrocarbon group is condensed with pyrrolidinyl group, piperidinyl group, pyrrolinyl group, and the like.

Specific preferred examples of the compounds having the formula (6) include, but are not limited to, the below-listed compounds.

| Compound | | | |
|---|---|---|---|
| No. | Ar₅₇ | R₁₀₁ | R₁₀₂ |
| 1 | 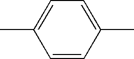 | —CH₃ | 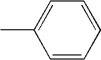 |
| 2 | 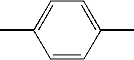 | —CH₂CH₃ | 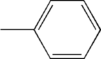 |
| 3 | 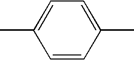 | —CH₃ | 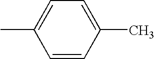 |
| 4 | 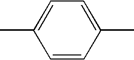 | —CH₂CH₃ | 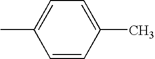 |
| 5 | 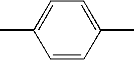 | —CH₂CH₂CH₃ | 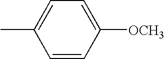 |
| 6 | 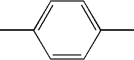 | —CH₂CH₃ | 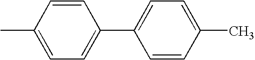 |
| 7 | 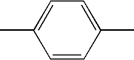 | 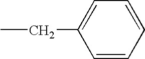 | 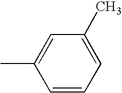 |
| 8 | 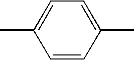 | 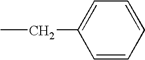 | 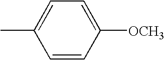 |
| 9 | 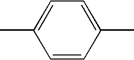 | —CH₂CH₃ | 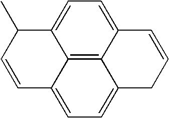 |
| 10 | 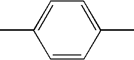 | 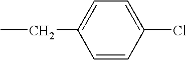 | 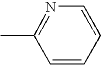 |
| 11 | 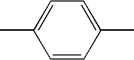 | —CH₂CH₃ | 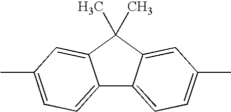 |
| 12 | 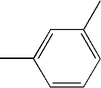 | —CH₂CH₃ | 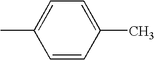 |
| 13 | 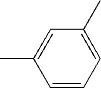 | 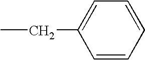 | 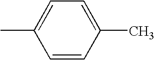 |
| 14 | 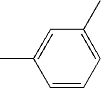 | 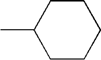 | 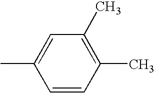 |
| 15 | 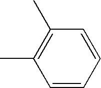 | —CH₂CH₃ | 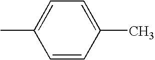 |
| 16 | 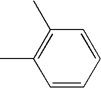 | —CH₃ | 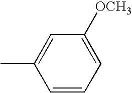 |
| 17 | 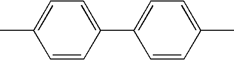 | —CH₂CH₃ | 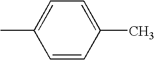 |
| 18 | 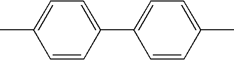 | 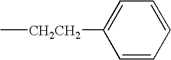 | 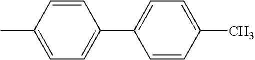 |
| 19 | 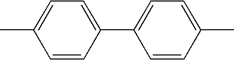 | —CH₃ | 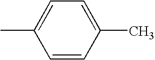 |
| 20 | 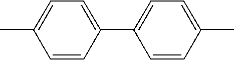 | —CH₂CH₃ | 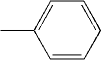 |
| 21 | 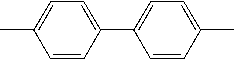 | 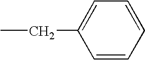 | 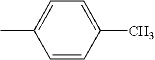 |
| 22 | 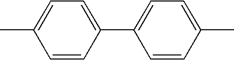 | 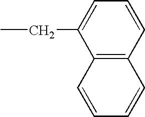 | 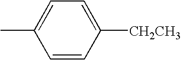 |
| 23 | 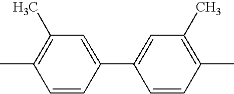 | —CH₂CH₃ | 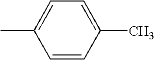 |
| 24 | 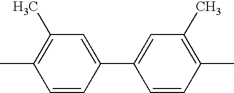 | 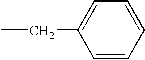 | 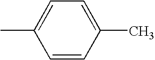 |
| 25 | 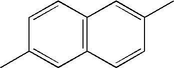 | —CH₂CH₃ | 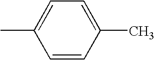 |
| 26 | 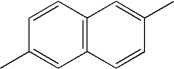 | —CH₃ | 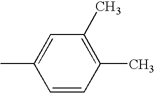 |
| 27 | 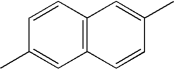 | 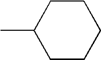 | 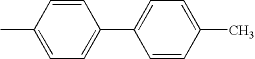 |
| 28 | 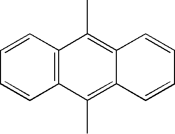 | —CH₂CH₃ | 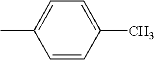 |
| 29 | 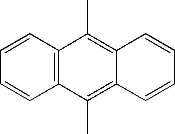 | —CH₃ | 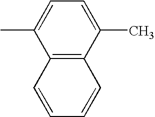 |
| 30 | 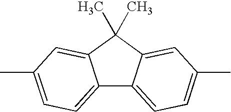 | —CH₂CH₃ | 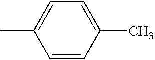 |
| 31 | 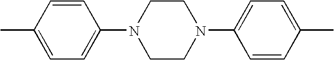 | —CH₂CH₃ | 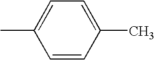 |
| 32 | 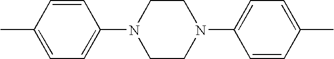 | —CH₂CH₃ | 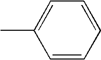 |
| 33 | 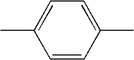 | —CH₂CH₃ | 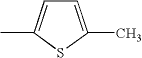 |
| 34 | 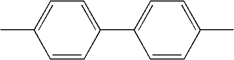 | 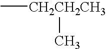 | 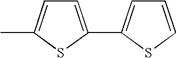 |

| | | |
|---|---|---|
| 35 | 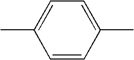 | 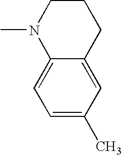 |
| 36 | 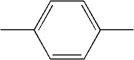 | 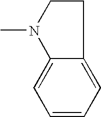 |
| 37 | 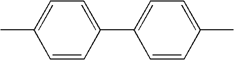 | 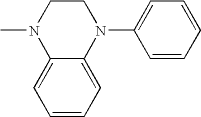 |

In the compounds Nos. 35 to 37, functional groups corresponding to R₁₀₁ and R₁₀₂ are described as —NR₁₀₁R₁₀₂.

In order to improve environmental resistance so that high quality images are reliably produced, an antioxidant may be included in the charge generation layer 32, the charge transport layer 33, the cross-linked charge transport layer 35, an undercoat layer (to be described later), and/or an intermediate layer. In particular, it is most effective to include an antioxidant in the charge generation layer 32.

As the antioxidant, phenol compounds, p-phenylenediamines, hydroquinones, organic sulfur compounds, and organic phosphor compounds can be used.

Specific examples of usable phenol compounds include, but are not limited to, 2,6-di-t-butyl-p-cresol, butylated hydroxyanisole, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocopherols.

Specific examples of usable p-phenylenediamines include, but are not limited to, N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

Specific examples of usable hydroquinones include, but are not limited to, 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

Specific examples of usable organic sulfur compounds include, but are not limited to, dilauryl-3,3′-thiodipropionate, distearyl-3,3′-thiodipropionate, and ditetradecyl-3,3′-thiodipropionate.

Specific examples of usable organic phosphor compounds include, but are not limited to, triphenylphosphine, tri(nonylphenyl)phosphine, tri(dinonylphenyl)phosphine, tricresylphosphine, and tri(2,4-dibutylphenoxy)phosphine.

The above-described compounds are well known as antioxidants for use in rubbers, plastics, oils, and fats, and are commercially available.

A layer preferably includes the antioxidant in an amount of 0.01 to 10 parts by weight based on total weight of the layer. The amount of the antioxidant included in the layer is preferably as large as possible so that an antioxidant property is sufficiently expressed. However, if the antioxidant is excessively included in the layer, the bright section potential may increase. The photoreceptor of the present invention that satisfies the equations (1) and (2) causes a more slight increase of the bright section potential than related-art photoreceptors even when a large amount of an antioxidant is included therein.

### (Cross-Linked Charge Transport Layer)

Description is now given of the cross-linked charge transport layer 35. The cross-linked charge transport layer 35 is required to have charge transport ability while maintaining abrasion resistance. Therefore, the cross-linked charge transport layer 35 is formed by a hardening reaction between a radical-polymerizable monomer having no charge transport structure and a radical-polymerizable compound having a charge transport structure. The hardening reaction is defined as a reaction in which a low-molecular-weight compound having a plurality of functional groups or a high-molecular-weight compound forms intermolecular bonds (such as covalent bonds) upon application of energy such as heat, light, and/or electron beam, resulting in formation of a three-dimensional network structure.

Hardening resins are classified into heat-hardening resins that are polymerized upon application of heat, light-hardening resins that are polymerized upon exposure of lights such as ultraviolet light and visible light, and electron-bean-hardening resins that are polymerized upon exposure of an electron beam. A hardener, a catalyst, a polymerization initiator, and the like, may be used in combination with these hardening resins.

In order to harden such a hardening resin, a reactive compound (such as a monomer and an oligomer) needs a functional group that is polymerizable. Specific examples of suitable functional groups that are polymerizable include, but are not limited to, acryloyl group and methacryloyl group. As the number of functional groups per molecule of the reactive compound increases, particularly exceeds 3, the resultant three-dimensional network structure becomes stiffer. As a consequence, the resultant layer has high hardness and elasticity and improved smoothness, providing a highly-durable photoreceptor that produces high quality images.

A radical-polymerizable monomer having no charge transport structure and a radical-polymerizable compound having a charge transport structure are subjected to a hardening reaction on the conductive substrate 31 so that a three-dimensional network structure is formed thereon. It is effective to previously add a hardener, a catalyst, a polymerization initiator, and the like, to accelerate the hardening reaction. In this case, the resultant cross-linked charge transport layer may have an improved abrasion resistance, and electrostatic properties thereof hardly deteriorate because unreacted functional groups remain only slightly. Further, crack and deformation hardly occur therein because the hardening reaction is evenly performed, providing good cleaning performance.

First, the radical-polymerizable monomer having no charge transport structure will be explained in detail. Here, the radical-polymerizable monomer having no charge transport structure is defined as a monomer that has neither hole transport structure such as triarylamine, hydrazone, pyrazoline, and carbazole nor electron transport structure such as condensed polycyclic quinone, diphenoquinone, an electron acceptable aromatic ring having cyano group or nitro group, and further has a radical-polymerizable functional group that has a carbon-carbon double bond. For example, 1-substitied ethylene functional groups and 1,1-substituted ethylene functional groups are preferable for the radical-polymerizable functional group.

The 1-substitied ethylene functional group is represented by the following formula (10):

CH₂═CH—X₁— (10)

wherein X₁ represents an arylene group such as phenylene group and naphthylene group which may have a substituent, an alkenylene group which may have a substituent, —CO—, —COO—, —CONR₇₈ (R₇₈ represents a hydrogen atom, an alkyl group such as methyl group and ethyl group, an aralkyl group such as benzyl group, naphthylmethyl group, and phenethyl group, or an aryl group such as phenyl group and naphthyl group), or —S—.

Specific examples of the 1-substitied ethylene functional groups having the formula (10) include, but are not limited to, vinyl group, styryl group, 2-methyl-1,3-butadienyl group, vinyl carbonyl group, acryloyloxy group, acryloyl amide group, and vinyl thioether group.

The 1,1-substitied ethylene functional group is represented by the following formula (11):

CH₂═CY—X₂— (11)

wherein Y represents an alkyl group which may have a substituent, an aralkyl group which may have a substituent, an aryl group such as phenyl group and naphthyl group which may have a substituent, a halogen atom, cyano group, nitro group, an alkoxy group such as methoxy group and ethoxy group, —COOR₇₉ (R₇₉ represents a hydrogen atom, an alkyl group such as methyl group and ethyl group which may have a substituent, an aralkyl group such as benzyl group and phenethyl group which may have a substituent, an aryl group such as phenyl group and naphthyl group which may have a substituent, or —CONR₈₀R₈₁ (each of R₈₀ and R₈₁ independently represents a hydrogen atom, an alkyl group such as methyl group and ethyl group which may have a substituent, an aralkyl group such as benzyl group, naphthylmethyl group, and phenethyl group which may have a substituent, or an aryl group such as phenyl group and naphthyl group which may have a substituent)), and X₂ represents X₁ in the formula (10), a single bond, or an alkylene group, wherein at least one of Y and X₂ is oxycarbonyl group, cyano group, an alkenylene group, or an aromatic group.

Specific examples of the 1,1-substitied ethylene functional groups having the formula (11) include, but are not limited to, α-chlorinated acryloyloxy group, methacryloyloxy group, α-cyanoethylene group, α-cyanoacryloyloxy group, α-cyanophenylene group, and methacryloylamino group.

The above X₁, X₂, and Y may be further substituted with a halogen atom, nitro group, cyano group, an alkyl group such as methyl group and ethyl group, an alkoxy group such as methoxy group and ethoxy group, an aryloxy group such as phenoxy group, an aryl group such as phenyl group and naphthyl group, or an aralkyl group such as benzyl group and phenethyl group.

Among these radical-polymerizable functional groups, acryloyloxy group and methacryloyloxy group are preferable.

The radical-polymerizable monomer having no charge transport structure preferably has 3 or more functional groups so that the resultant three-dimensional network structure has a high cross-linking density, which provides high stiffness and elasticity and an improved smoothness. Such a resultant layer has a high resistance to abrasion and scratching.

In some cases, volume contraction occurs depending on hardening conditions or used materials, because multiple bonds are formed quickly. Consequently, internal stress is generated in the resultant layer, possibly causing crack and peeling. This problem may be solved by using a monofunctional or difunctional radical-polymerizable monomer in combination.

A radical-polymerizable monomer having no charge transport structure and 3 or more functional groups, which provides an improved abrasion resistance, will be described in detail below.

For example, a compound having 3 or more acryloyloxy groups can be produced by an esterification reaction or a transesterification reaction of a compound having 3 or more hydroxyl groups with an acrylic acid, an acrylic halide, or an acrylate. A compound having 3 or more methacryloyloxy groups can be produced in a similar way. Multiple radical-polymerizable functional groups included in such a compound may be, but need not necessarily be, the same.

Specific examples of suitable radical-polymerizable monomers having no charge transport structure include, but are not limited to, trimethylolpropane triacrylate (TMPTA), trimethylolpropane trimethacrylate, alkylene-modified (hereinafter “HPA-modified”) trimethylolpropane triacrylate, ethyleneoxy-modified (hereinafter “EO-modified”) trimethylolpropane triacrylate, propyleneoxy-modified (hereinafter “PO-modified”) trimethylolpropane triacrylate, caprolactone-modified trimethylolpropane triacrylate, epichlorohydrin-modified (hereinafter “ECH-modified”) trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl)isocyanurate, alkyl-modified dipentaerythritol tetraacrylate, alkyl-modified dipentaerythritol triacrylate, dimethylolpropane tetraacrylate (DTMPTA), pentaerythritol ethoxy tetraacrylate, EO-modified phosphate triacrylate, 2,2,5,5-tetrahydroxymethyl cyclopentanone tetraacrylate, 2-ethylhexyl acrylate, 2-hydroxyethyl acrylate, 2-hydroxypropyl acrylate, tetrahydrofurfuryl acrylate, 2-ethylhexyl carbitol acrylate, 3-methoxybutyl acrylate, benzyl acrylate, cyclohexyl acrylate, isoamyl acrylate, isobutyl acrylate, methoxy triethylene glycol acrylate, phenoxy tetraethylene glycol acrylate, cetyl acrylate, isostearyl acrylate, stearyl acrylate, styrene monomer, 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, neopentyl glycol diacrylate, EO-modified bisphenol A diacrylate, EO-modified bisphenol F diacrylate, and neopentyl glycol diacrylate. Among these compounds, trimethylolpropane triacrylate (TMPTA), HPA-modified trimethylolpropane triacrylate, EO-modified trimethylolpropane triacrylate, PO-modified trimethylolpropane triacrylate, and ECH-modified trimethylolpropane triacrylate are preferable.

Specific examples of suitable radical-polymerizable oligomers having no charge transport structure include, but are not limited to, epoxy acrylate oligomers, urethane acrylate oligomers, and polyester acrylate oligomers.

These compounds can be used alone or in combination.

With regard to the radical-polymerizable monomer having no charge transport structure and 3 or more functional groups, the ratio of the molecular weight to the number of the functional groups is preferably 250 or less so that cross-linking bonds are densely formed in the resultant cross-linked charge transport layer. When the ratio is greater than 250, the resultant cross-linked charge transport layer may be too soft, degrading abrasion resistance. In such a case, a modified monomer having too long a modified group is not preferably used alone.

The cross-linked charge transport layer 35 typically includes the radical polymerizable monomer having no charge transport structure and 3 or more functional groups in an amount of 20 to 80% by weight, and preferably 30 to 70% by weight. When the amount is too small, the three-dimensional cross-linking density in the resultant layer is too small, providing a similar abrasion resistance to a typical layer including a thermoplastic binder resin. When the amount is too large, the amount of a charge transport compound may be reduced, degrading electric properties of the resultant layer. Accordingly, an optimum amount of the radical polymerizable monomer having no charge transport structure is 30 to 70% by weight

Next, the radical-polymerizable compound having a charge transport structure will be explained in detail. Here, the radical-polymerizable compound having a charge transport structure is defined as a monomer that has either hole transport structure such as triarylamine, hydrazone, pyrazoline, and carbazole or electron transport structure such as condensed polycyclic quinone, diphenoquinone, an electron acceptable aromatic ring having cyano group or nitro group, and further has a radical-polymerizable functional group that has a carbon-carbon double bond.

Although the number of functional groups in the radical-polymerizable compound having a charge transport structure is not limited, a monofunctional compound is preferable from the viewpoint of electrostatic properties and quality of the resultant layer. A difunctional compound may increase the cross-linking density, however, a charge transport structure therein may be very bulky. As a consequence, a large distortion may be generated in the resultant layer, possibly increasing internal stress therein. In addition, such a difunctional compound cannot reliably retain an intermediate (such as cation radical) during charge transportation, possibly causing charge trapping, which degrades sensitivity and increases residual potential. In particular, a compound having 3 or more functional groups considerably causes such a phenomenon.

A radical-polymerizable compound having a triarylamine structure as a charge transport structure is preferable because of its high charge transport ability. The reason for this is considered that the triarylamine includes a lot of hopping sites and π conjugation is spread thereover. In addition, the triarylamine is easily conjugated when being in a state of radical cation. Specifically, compounds having the following formulae (1) and (2) provide high sensitivity and good electric properties:

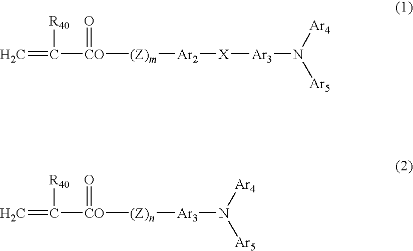

wherein R₄₀ represents a hydrogen atom, a halogen atom, an alkyl group which may have a substituent, an aralkyl group which may have a substituent, an aryl group which may have a substituent, cyano group, nitro group, an alkoxy group, —COOR₄₁ (wherein R₄₁ represents a hydrogen atom, an alkyl group which may have a substituent, an aralkyl group which may have a substituent, or an aryl group which may have a substituent), a halogenated carbonyl group, or —CONR₄₂R₄₃ (wherein each of R₄₂ and R₄₃ independently represents a hydrogen atom, a halogen atom, an alkyl group which may have a substituent, an aralkyl group which may have a substituent, or an aryl group which may have a-substituent); each of Ar₂ and Ar₃ independently represents a substituted or unsubstituted arylene group; each of Ar₄ and Ar₅ independently represents a substituted or unsubstituted aryl group; X represents a single bond, a substituted or unsubstituted alkylene group, a substituted or unsubstituted cycloalkylene group, a substituted or unsubstituted alkylene ether group, an oxygen atom, a sulfur atom, or a vinylene group; Z represents a substituted or unsubstituted alkylene group, a substituted or unsubstituted alkylene ether group, or an alkylene oxycarbonyl group; and each of m and n independently represents an integer of 0 to 3.

Specific examples of suitable alkyl groups for R₄₀ in the formulae (1) and (2) include, but are not limited to, methyl group, ethyl group, propyl group, and butyl group. Specific examples of suitable aryl groups for R₄₀ in the formulae (1) and (2) include, but are not limited to, phenyl group and naphthyl group. Specific examples of suitable aralkyl groups for R₄₀ in the formulae (1) and (2) include, but are not limited to, benzyl group, phenethyl group, and naphthylmethyl group. Specific examples of suitable alkoxy groups for R₄₀ in the formulae (1) and (2) include, but are not limited to, methoxy group, ethoxy group, and propoxy group. These groups may be further substituted with a halogen atom, nitro group, cyano group, an alkyl group such as methyl group and ethyl group, an alkoxy groups such as methoxy group and ethoxy group, an aryloxy group such as phenoxy group, an aryl group such as phenyl group and naphthyl group, an aralkyl group such as benzyl group and phenethyl group. Among these functional groups, a hydrogen atom and methyl group are preferable for R₄₀ in the formulae (1) and (2).

Specific examples of suitable aryl groups for Ar₄ and Ar₅ in the formulae (1) and (2) include, but are not limited to, a condensed polycyclic hydrocarbon group, a non-condensed cyclic hydrocarbon group, and a heterocyclic group.

A suitable condensed polycyclic hydrocarbon group may include a ring consisting of 18 or less carbon atoms. Specific examples of such condensed polycyclic hydrocarbon groups include, but are not limited to, pentanyl group, indenyl group, naphthyl group, azulenyl group, heptalenyl group, biphenylenyl group, as-indacenyl group, s-indacenyl group, fluorenyl group, acenaphthylenyl group, pleiadenyl group, acenaphthenyl group, phenalenyl group, phenanthryl group, anthryl group, fluoranthenyl group, acephenanthrylenyl group, aceanthrylenyl group, triphenylel group, pyrenyl group, chrysenyl group, and naphthacenyl group.

Specific examples of suitable non-condensed cyclic hydrocarbon groups include, but are not limited to, monovalent groups of monocyclic hydrocarbon compounds such as benzene, diphenyl ether, polyethylene diphenyl ether, diphenyl thioether, and diphenyl sulfone; monovalent groups of non-condensed polycyclic hydrocarbon compounds such as biphenyl, polyphenyl, diphenyl alkane, diphenyl alkene, diphenyl alkyne, triphenylmethane, distyrylbenzene, 1,1-diphenyl cycloalkane, polyphenyl alkane, and polyphenyl alkene; and monovalent groups of ring assembly hydrocarbon compounds such as 9,9-diphenylfluorene.

Specific examples of suitable heterocyclic groups include, but are not limited to, monovalent groups of carbazole, dibenzofuran, dibenzothiophene, oxadiazole, and thiadiazole.

Aryl groups represented by Ar₄ and Ar₅ may have the following substituents (1) to (8).
(1) Halogen atoms, cyano group, and nitro group.
(2) Alkyl groups, preferably straight-chain or branched-chain alkyl groups having 1 to 12 carbon atoms, preferably 1 to 8 carbon atoms, and more preferably 1 to 4 carbon atoms. The alkyl groups may be substituted with a fluorine atom, hydroxyl group, cyano group, an alkoxy group having 1 to 4 carbon atoms, phenyl group, or a phenyl group substituted with a halogen atom, an alkyl group having 1 to 4 carbon atoms, or an alkoxy group having 1 to 4 carbon atoms. Specific examples of suitable alkyl groups include, but are not limited to, methyl group, ethyl group, n-butyl group, i-propyl group, t-butyl group, s-butyl group, n-propyl group, trifluoromethyl group, 2-hydroxyethyl group, 2-ethoxyethyl group, 2-cyanoethyl group, 2-methoxyethyl group, benzyl group, 4-chlorobenzyl group, 4-methylbenzyl group, and 4-phenylbenzyl group.
(3) Alkoxy groups (—OR₈₂ wherein R₈₂ represents an alkyl group described in the above paragraph (2)). Specific examples of suitable alkoxy groups include, but are not limited to, methoxy group, ethoxy group, n-propoxy group, i-propoxy group, t-butoxy group, n-butoxy group, s-butoxy group, I-butoxy group, 2-hydroxyethoxy group, benzyloxy group, and trifluoromethoxy group.
(4) Aryloxy groups derived from aryl groups such as phenyl group and naphthyl group. The aryl groups may have a substituent such as an alkoxy group having 1 to 4 carbon atoms, an alkyl group having 1 to 4 carbon atoms, or a halogen atom. Specific examples of suitable aryloxy groups include, but are not limited to, phenoxy group, 1-naphthyloxy group, 2-naphthyloxy group, 4-methoxyphenoxy group, and 4-methylphenoxy group.
(5) Alkyl mercapto groups and aryl mercapto groups. Specific examples of suitable alkyl or aryl mercapto groups include, but are not limited to, methylthio group, ethylthio group, phenylthio group, and p-methyl phenylthio group.
(6) Substituents having the following formula:

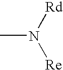

wherein each of R_{d} and Rₑ independently represents a hydrogen atom, an alkyl group described in the above paragraph (2), or an aryl group such as phenyl group, biphenyl group, and naphthyl group, which may have a substituent such as an alkoxy group having 1 to 4 carbon atoms, an alkyl group having 1 to 4 carbon atoms, or a halogen atom, and R_{d} and Rₑ may share bond connectivity. Specific examples of suitable substituents having the above formula include, but are not limited to, amino group, diethylamino group, N-methyl-N-phenylamino group, N,N-diphenylamino group, N,N-di(tolyl)amino group, dibenzylamino group, piperidino group, morpholino group, and pyrrolidino group.
(7) Alkylenedioxy groups and alkylenedithio groups such as methylenedioxy group and methylenedithio group.
(8) Substituted or unsubstituted styryl group, substituted or unsubstituted β-phenyl styryl group, diphenyl aminophenyl group, and ditolyl aminophenyl group.

Specific examples of suitable arylene groups represented by Ar₂ and Ar₃ include, but are not limited to, divalent groups derived from the aryl groups represented by Ar₄ and Ar₅.

As described above, X in the formulae (1) and (2) represents a single bond, a substituted or unsubstituted alkylene group, a substituted or unsubstituted cycloalkylene group, a substituted or unsubstituted alkylene ether group, an oxygen atom, a sulfur atom, or a vinylene group.

Specific examples of suitable substituted or unsubstituted alkylene groups include, but are not limited to, straight-chain or branched-chain alkylene groups having 1 to 12 carbon atoms, preferably 1 to 8 carbon atoms, and more preferably 1 to 4 carbon atoms, which may further have a fluorine atom, hydroxyl group, cyano group, an alkoxy group having 1 to 4 carbon atoms, phenyl group, or a phenyl group substituted with a halogen atom, an alkyl group having 1 to 4 carbon atom, or an alkoxy group having 1 to 4 carbon atoms. Specific preferred examples of such alkylene groups include, but are not limited to, methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-methoxyethylene group, benzylidene group, phenylethylene group, 4-chlorophenylethylene group, 4-methylphenylethylene group, and 4-biphenylethylene group.

Specific examples of suitable substituted or unsubstituted cycloalkylene groups include, but are not limited to, cyclic alkylene groups having 5 to 7 carbon atoms, which may have a fluorine atom, hydroxyl group, an alkyl group having 1 to 4 carbon atoms, or an alkoxy group having 1 to 4 carbon atoms. Specific preferred examples of such cyclic alkylene groups include, but are not limited to, cyclohexylidene group, cyclohexylene group, and 3,3-dimethylcyclohexylidene group.

Specific examples of suitable substituted or unsubstituted alkylene ether groups include, but are not limited to, alkyleneoxy groups such as ethyleneoxy group and propyleneoxy group, alkylenedioxy groups derived from ethylene glycol and propylene glycol, and di- or poly-(oxyalkylene)oxy groups derived from diethylene glycol, tetraethylene glycol, and tripropylene glycol. The alkylene groups in the alkylene ether groups may have a substituent such as hydroxyl group, methyl group, and ethyl group.

Specific examples of suitable vinylene groups include, but are not limited to, substituents having the following formula:

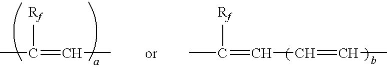

wherein R_{f} represents a hydrogen atom, an alkyl group described in the above paragraph (2), or an aryl group represented by Ar₄ and Ar₅ described above; a represents an integer of 1 or 2; and b represents an integer of 1 to 3.

As described above, Z in the formulae (1) and (2) represents a substituted or unsubstituted alkylene group, a substituted or unsubstituted alkylene ether group, or an alkylene oxycarbonyl group.

Specific examples of suitable substituted or unsubstituted alkylene groups include, but are not limited to, alkylene groups represented by X described above.

Specific examples of suitable substituted or unsubstituted alkylene ether groups include, but are not limited to, alkylene ether groups represented by X described above.

Specific examples of suitable alkylene oxycarbonyl groups include, but are not limited to, caprolactone-modified groups.

Specific preferred examples of suitable monofunctional radical-polymerizable compounds having a charge transport structure include, but are not limited to, compounds having the following formula (10):

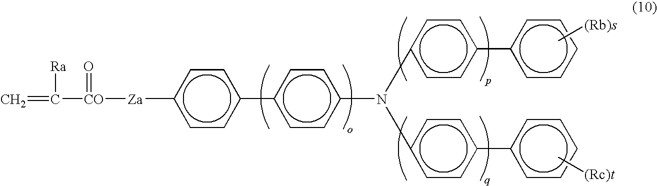

wherein each of o, p, and q independently represents an integer of 0 or 1; each of s and t independently represents an integer of 0 to 3; Rₐ represents a hydrogen atom or methyl group; each of R_{b} and R_{c} independently represents an alkyl group having 1 to 6 carbon atoms, wherein multiple R_{b} and/or R_{c} may be, but need not necessarily be, the same; and Za represents a single bond, methylene group, ethylene group, or the following groups:

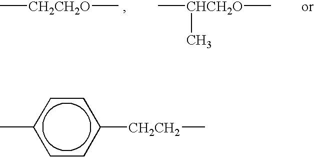

In the formula (10), R_{b} and R_{c} are preferably methyl group or ethyl group.

When the above described radical-polymerizable compounds having a charge transport structure represented by the formula (1), (2), or (10) are polymerized, carbon-carbon double bonds therein are opened. Accordingly, these compounds may be incorporated into the resultant polymer chain, not forming a terminal structure. When being polymerized with a radical-polymerizable monomer having no charge transport structure, such a radical-polymerizable compound having a charge transport structure is present in both a main chain of the resultant cross-linked polymer and a cross-linking chain formed between main chains. (The cross-linking chain includes both an intermolecular cross-linking chain that cross-links a polymer with another polymer, and an intramolecular cross-linking chain that cross-links a specific site in a folded main chain of a polymer with another site distant therefrom, which is originated from the monomer polymerized thereto.) In either cases in which the compound is present in a main chain or a cross-linking chain, a triarylamine structure, in which at least 3 aryl groups are radiated from a nitrogen atom, is pendant from the chain. Although such a triarylamine structure is bulky, the configuration thereof has flexibility because of being suspended from the chain via a carbonyl group, etc., not directly bonded to the chain. Accordingly, the triarylamine structures may be properly arranged in the polymer so as to be adjacent to one another, reducing intramolecular structural distortion. It is believed that a charge transport path is hardly broken in the resultant cross-linked charge transport layer including the above-described intramolecular structure.

Specific preferred examples of suitable monofunctional radical-polymerizable compounds having a charge transport structure include, but are not limited to, the following compounds Nos. 1 to 397.

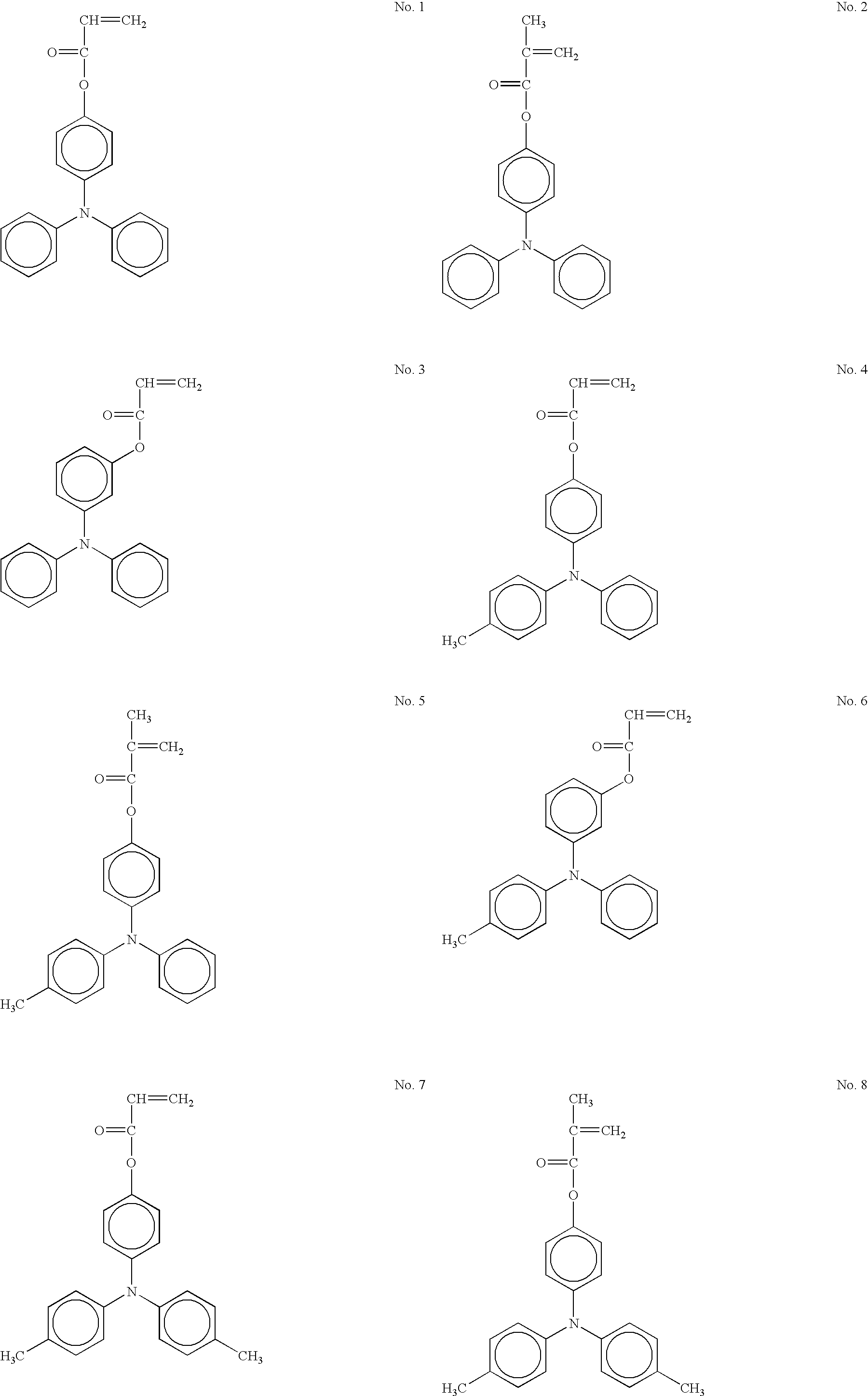

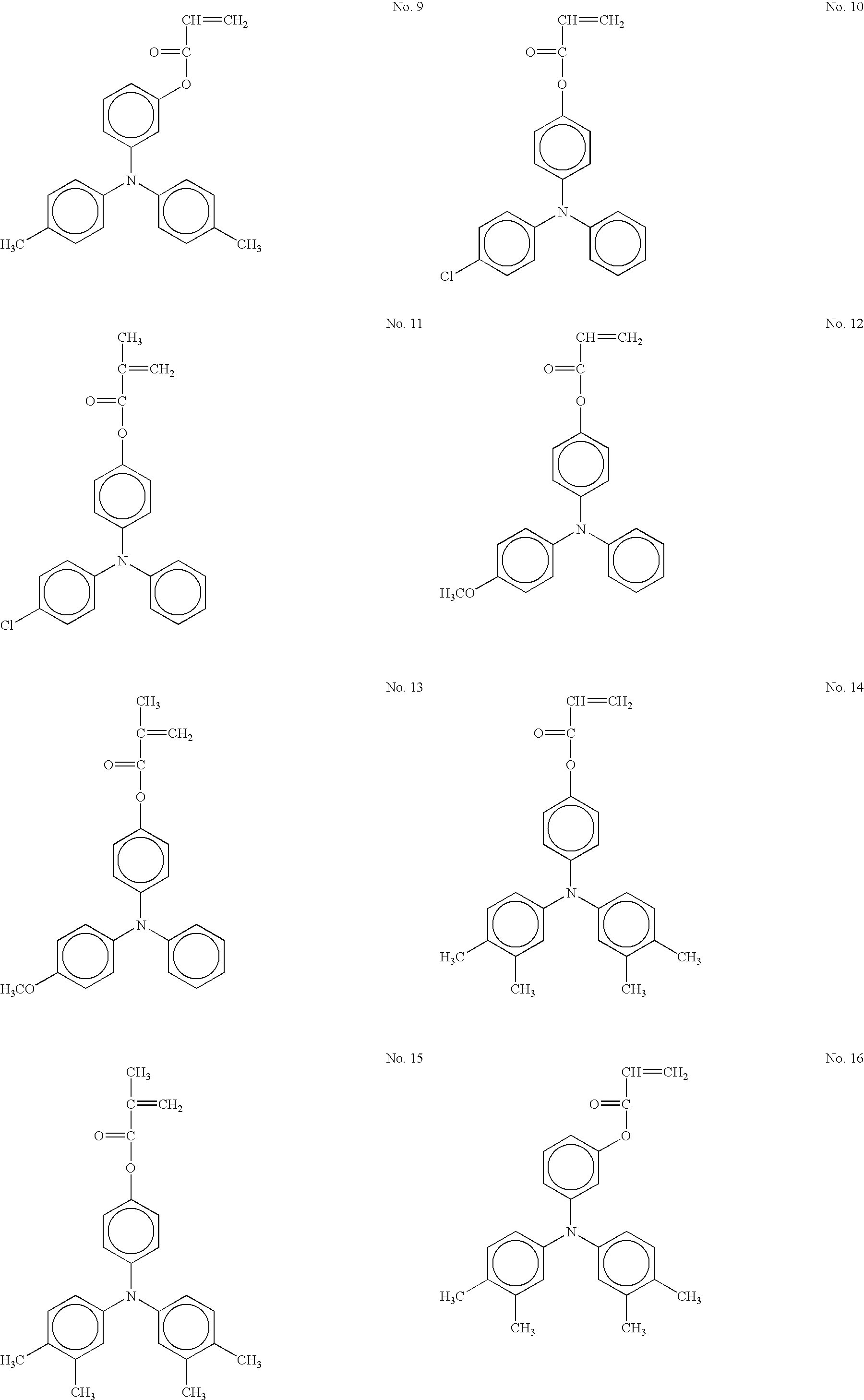

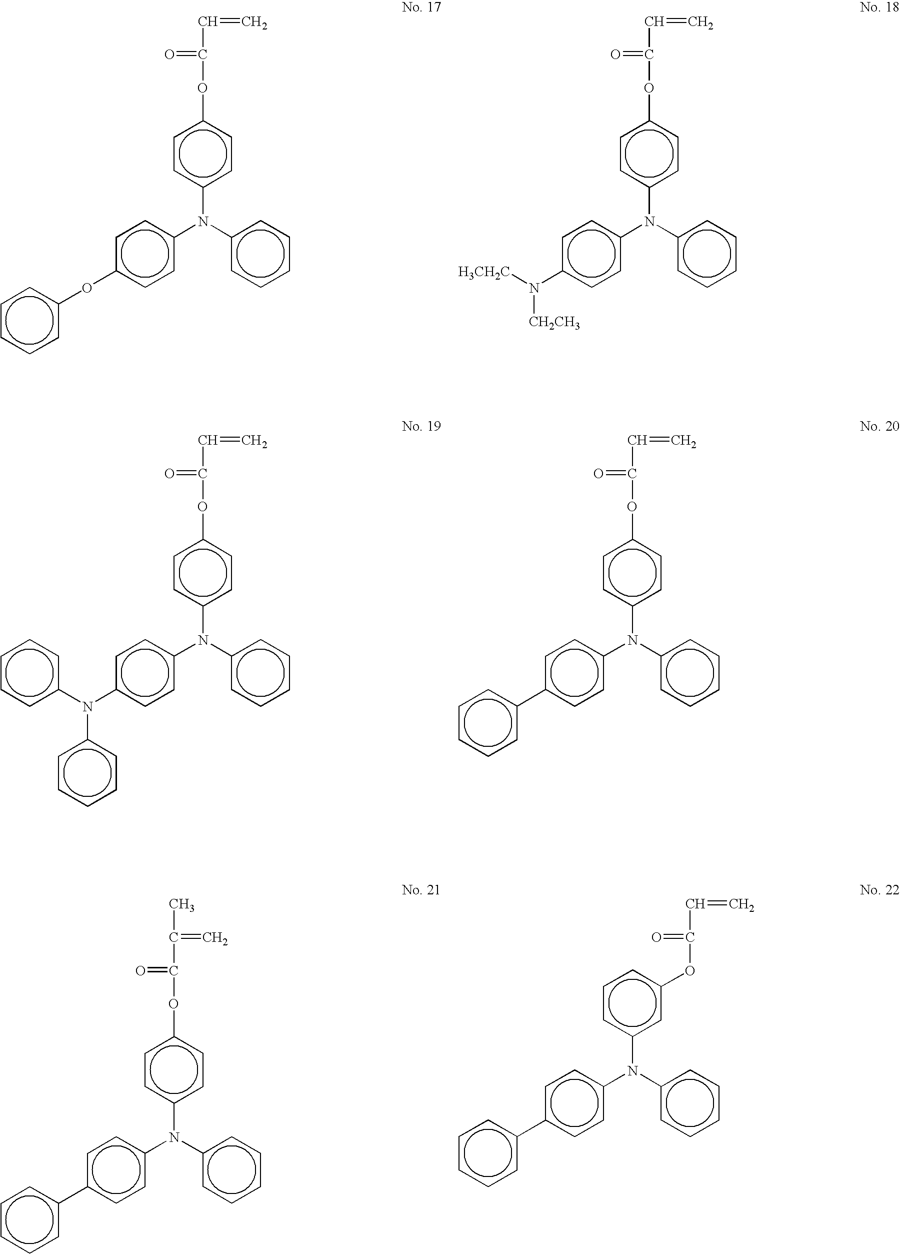

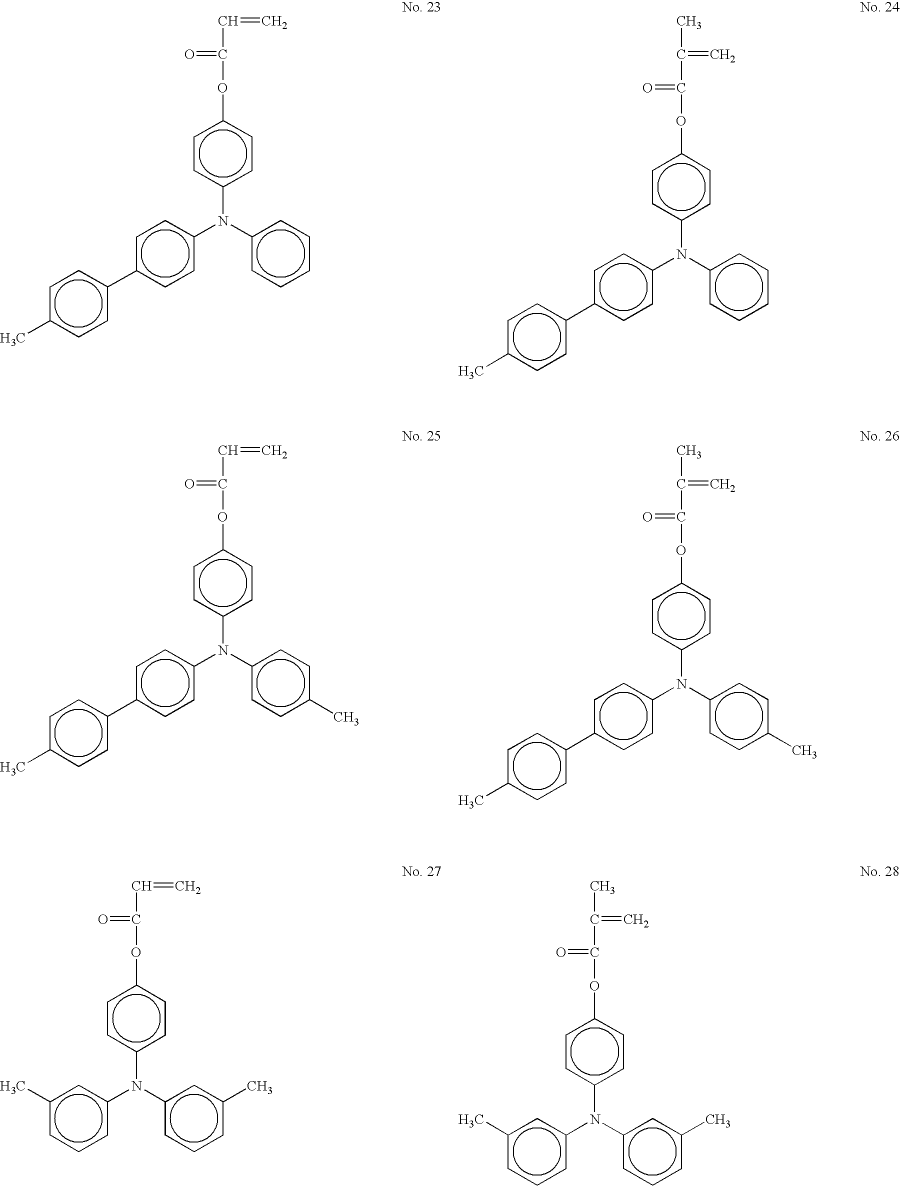

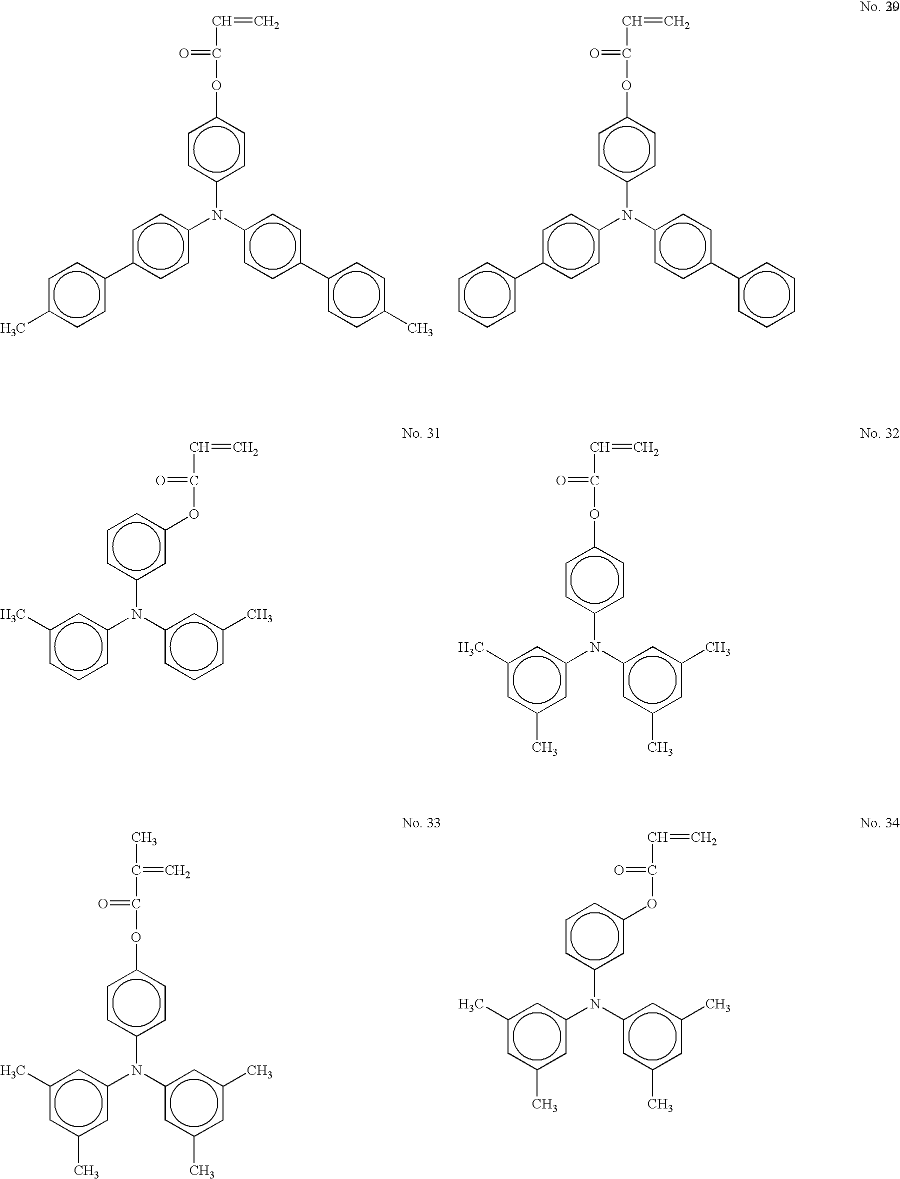

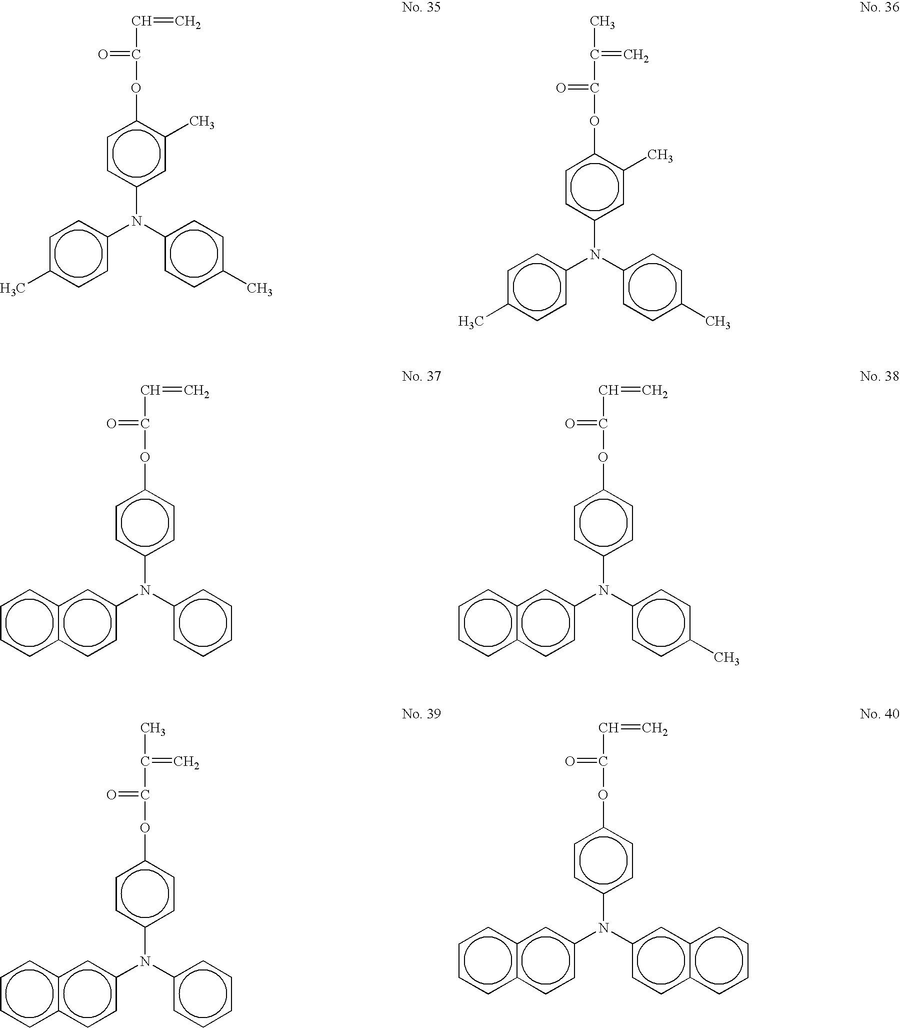

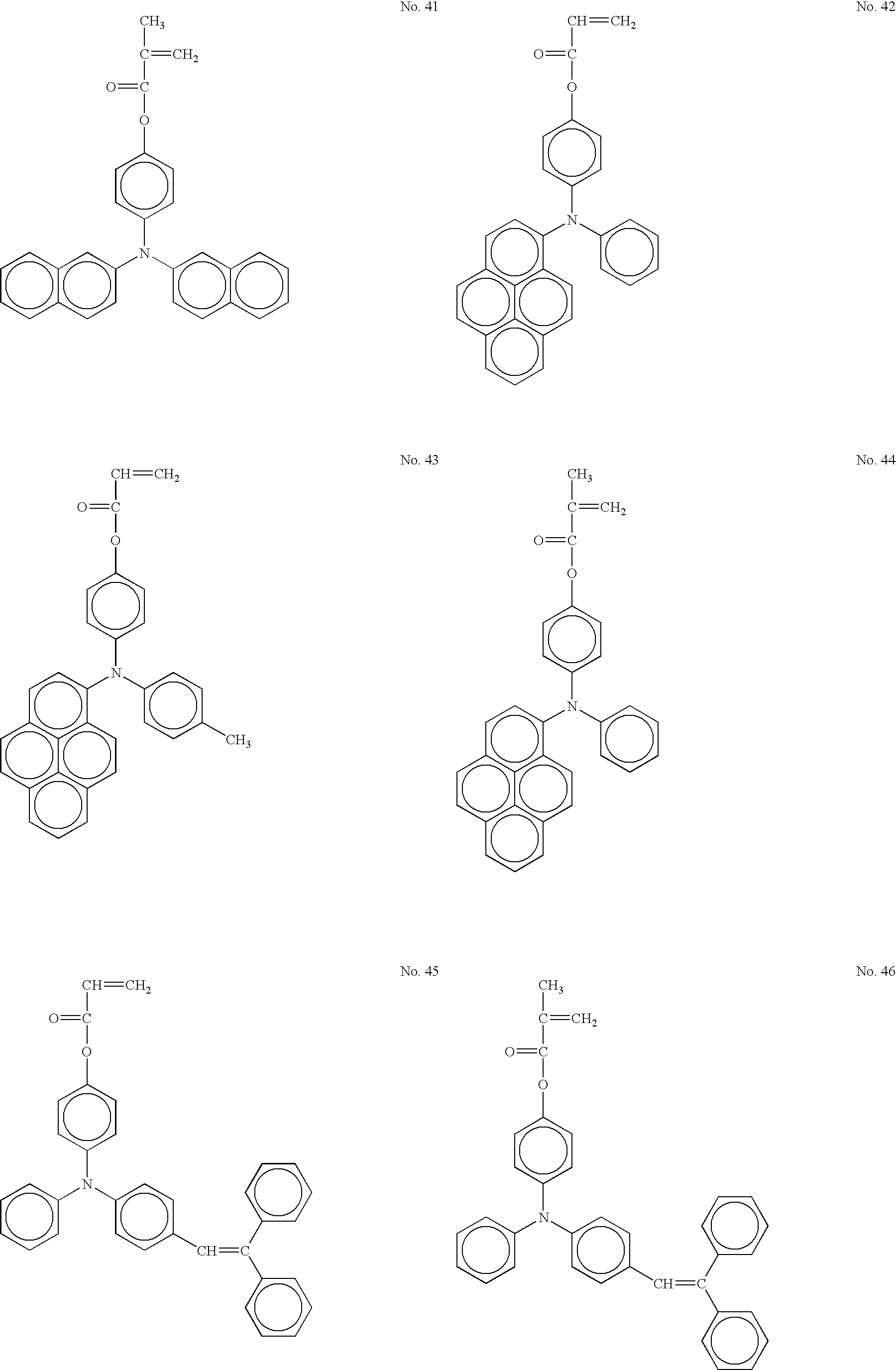

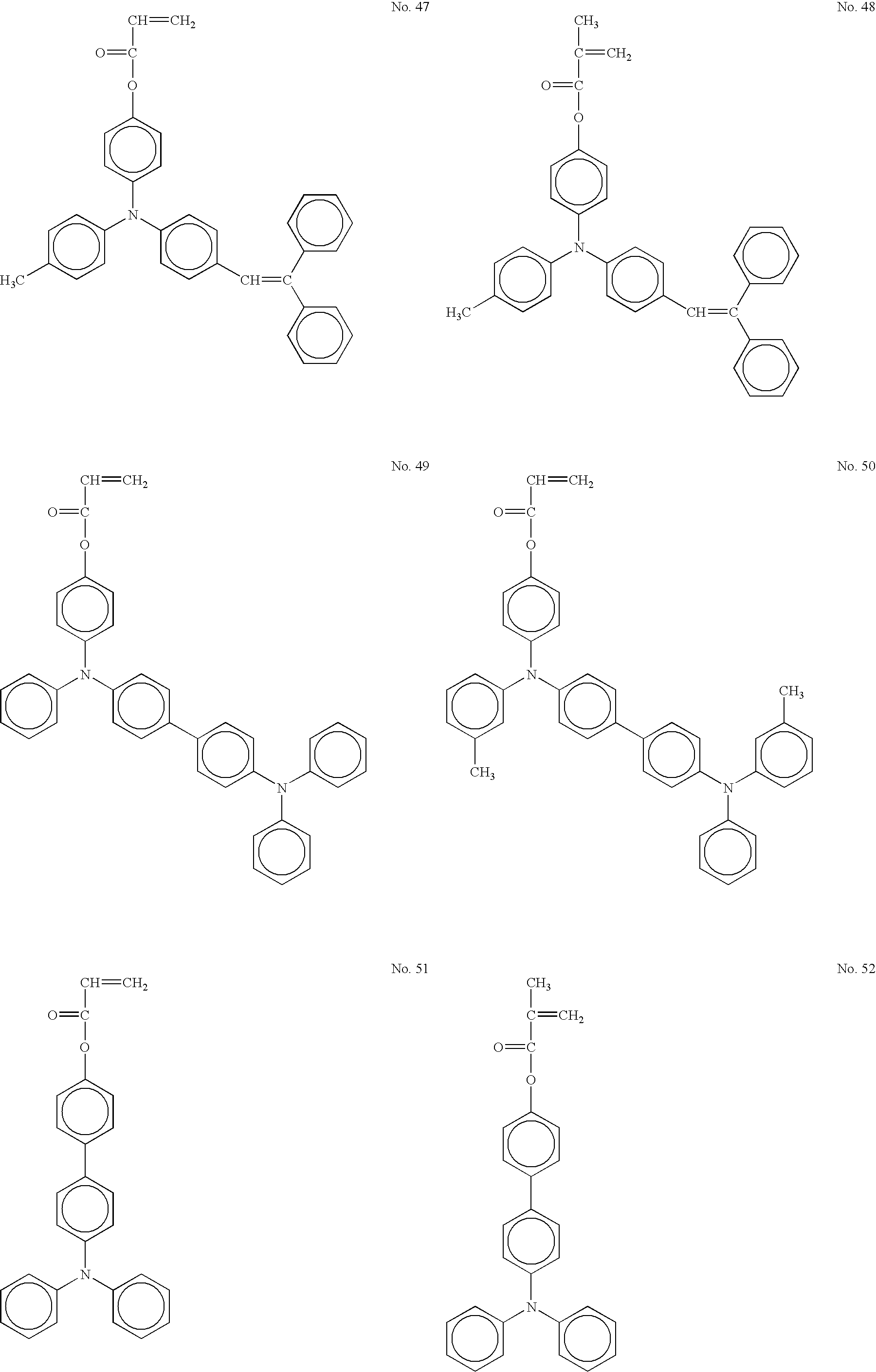

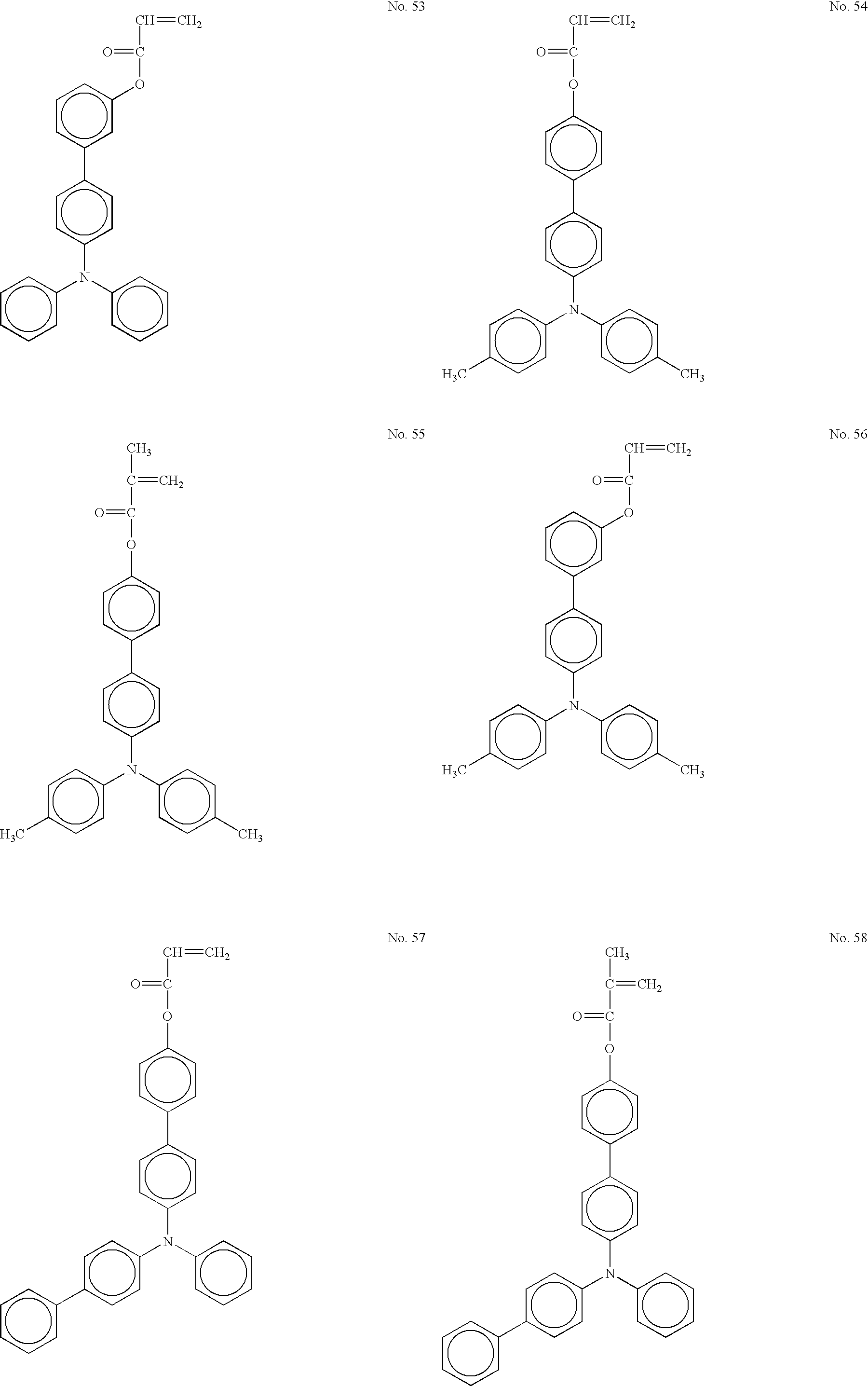

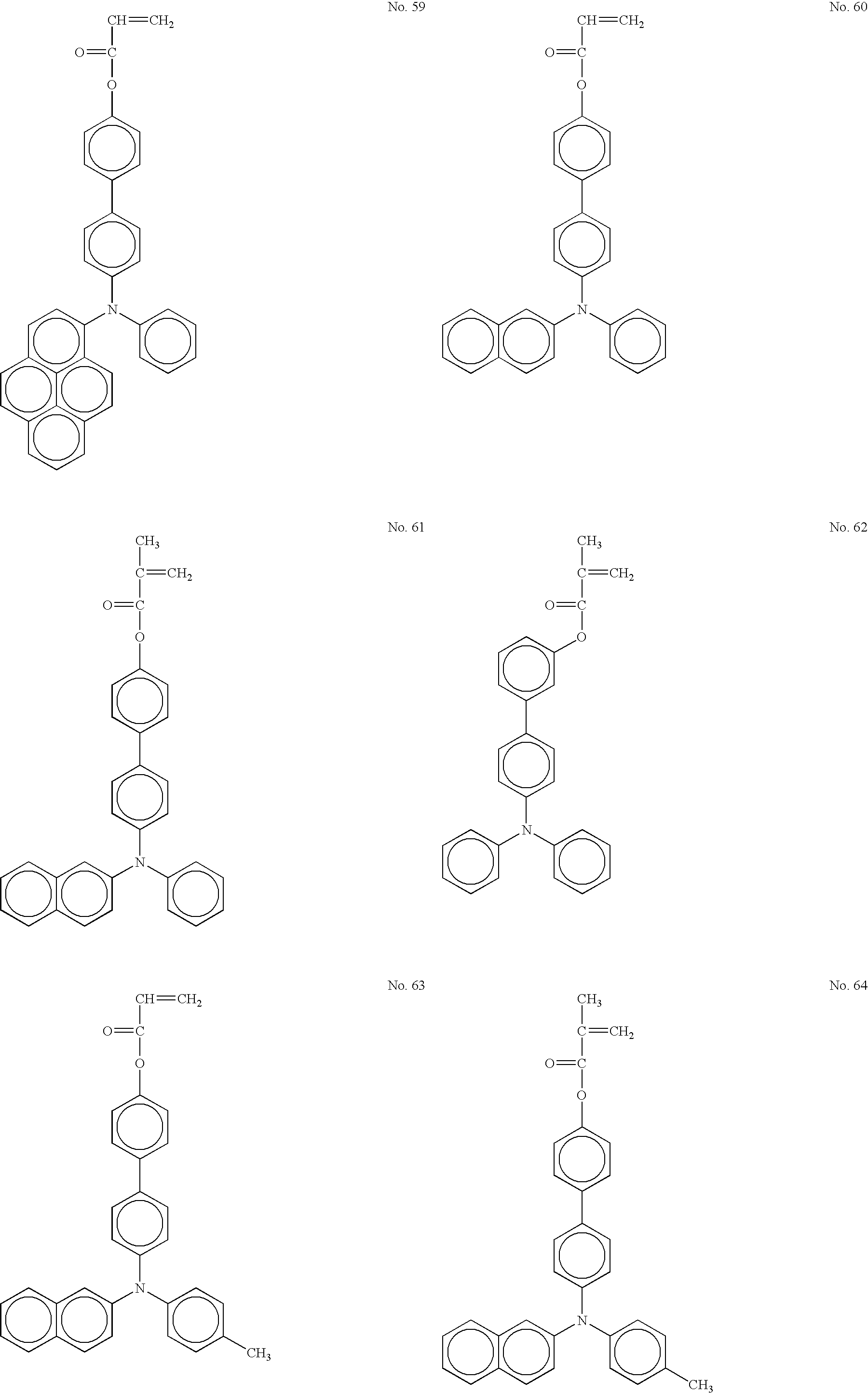

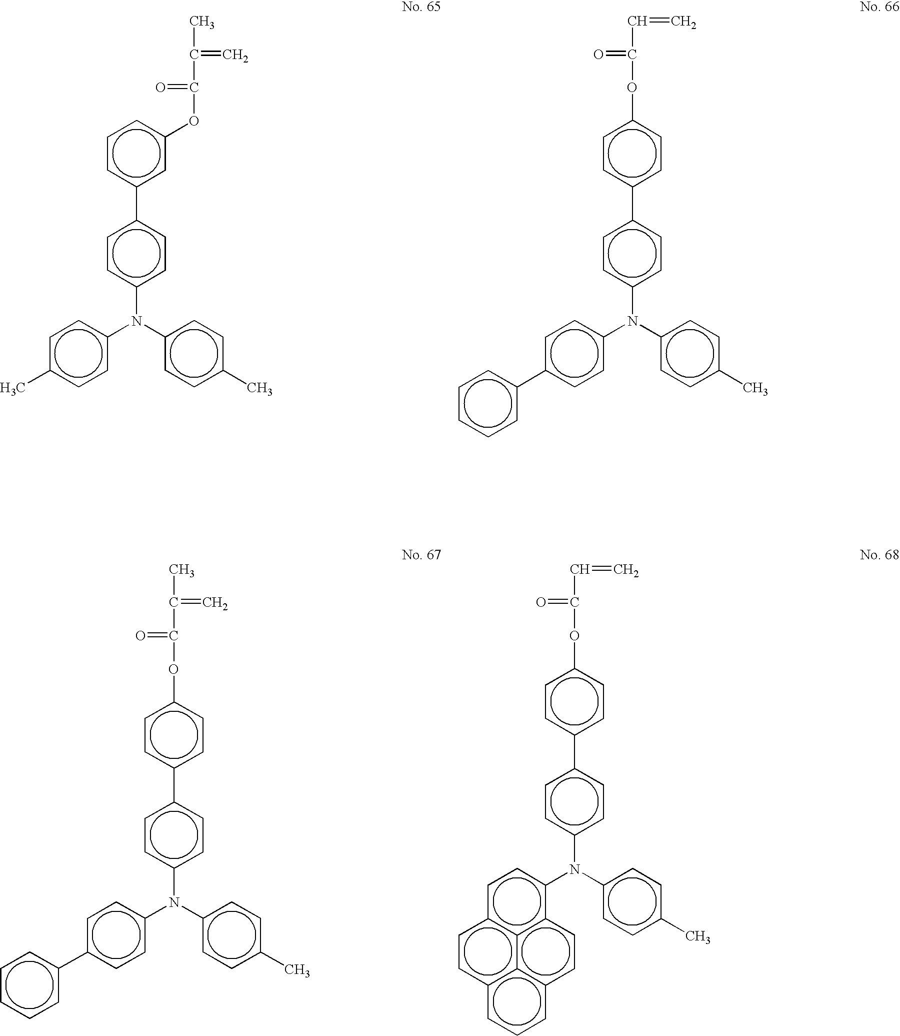

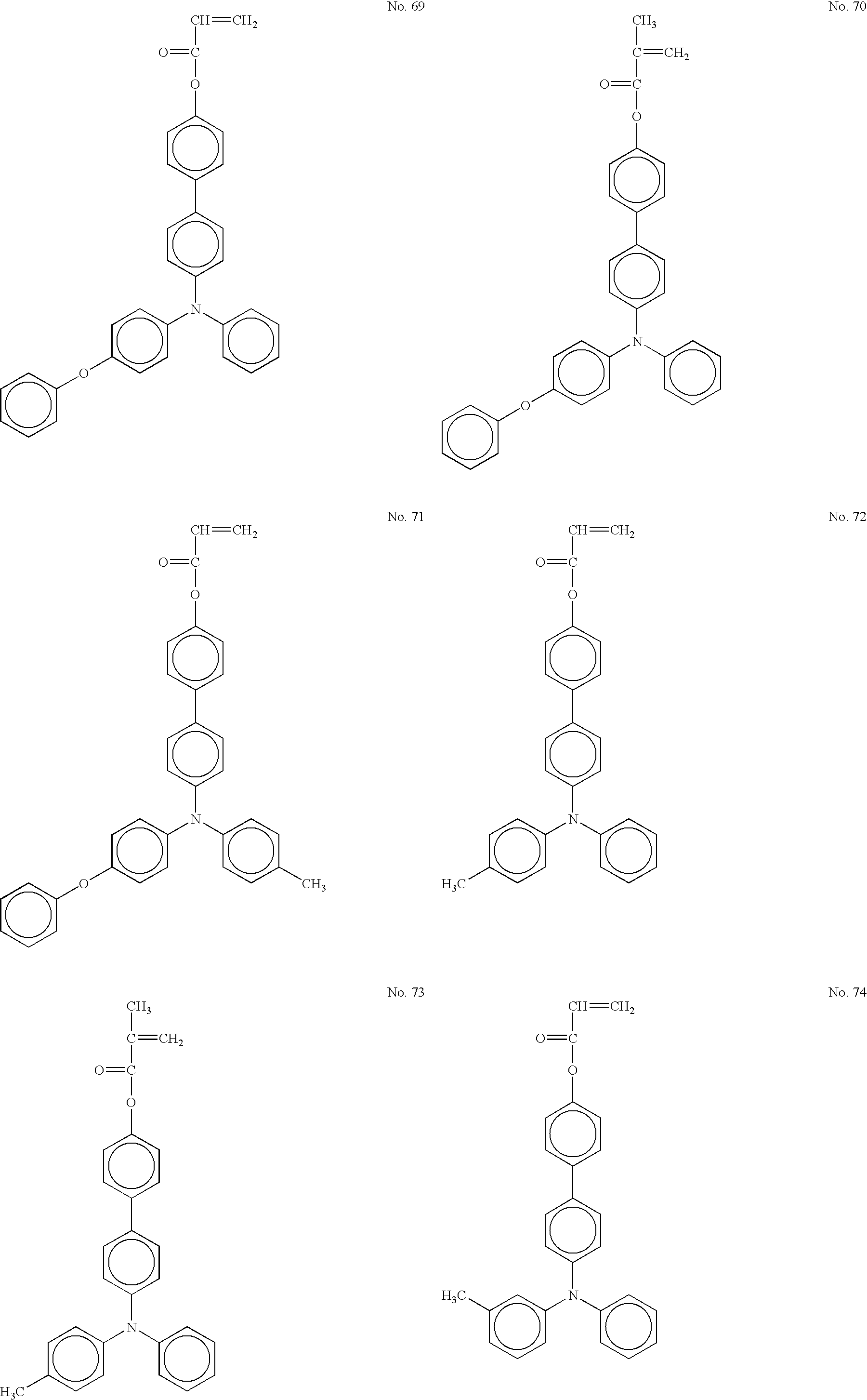

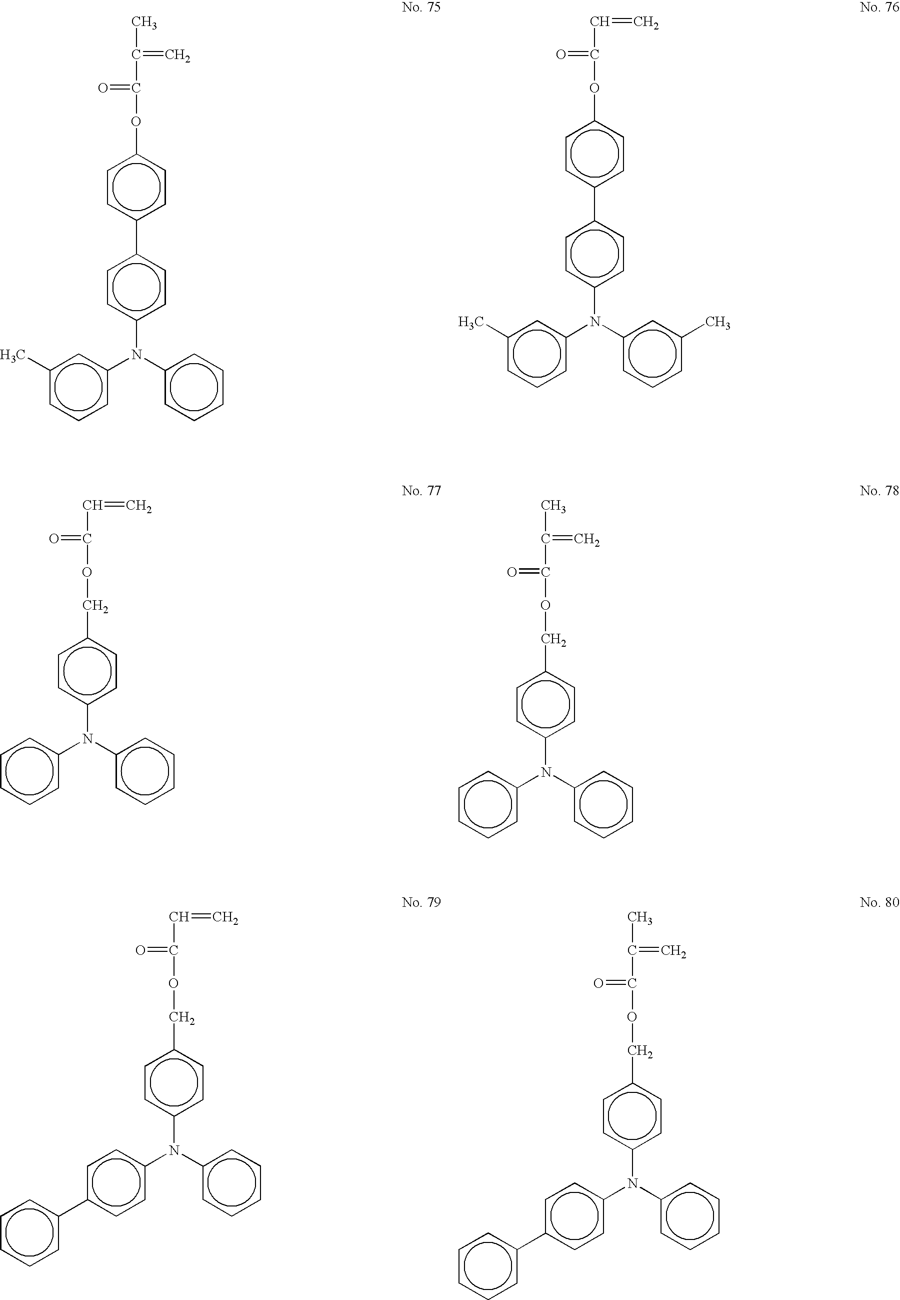

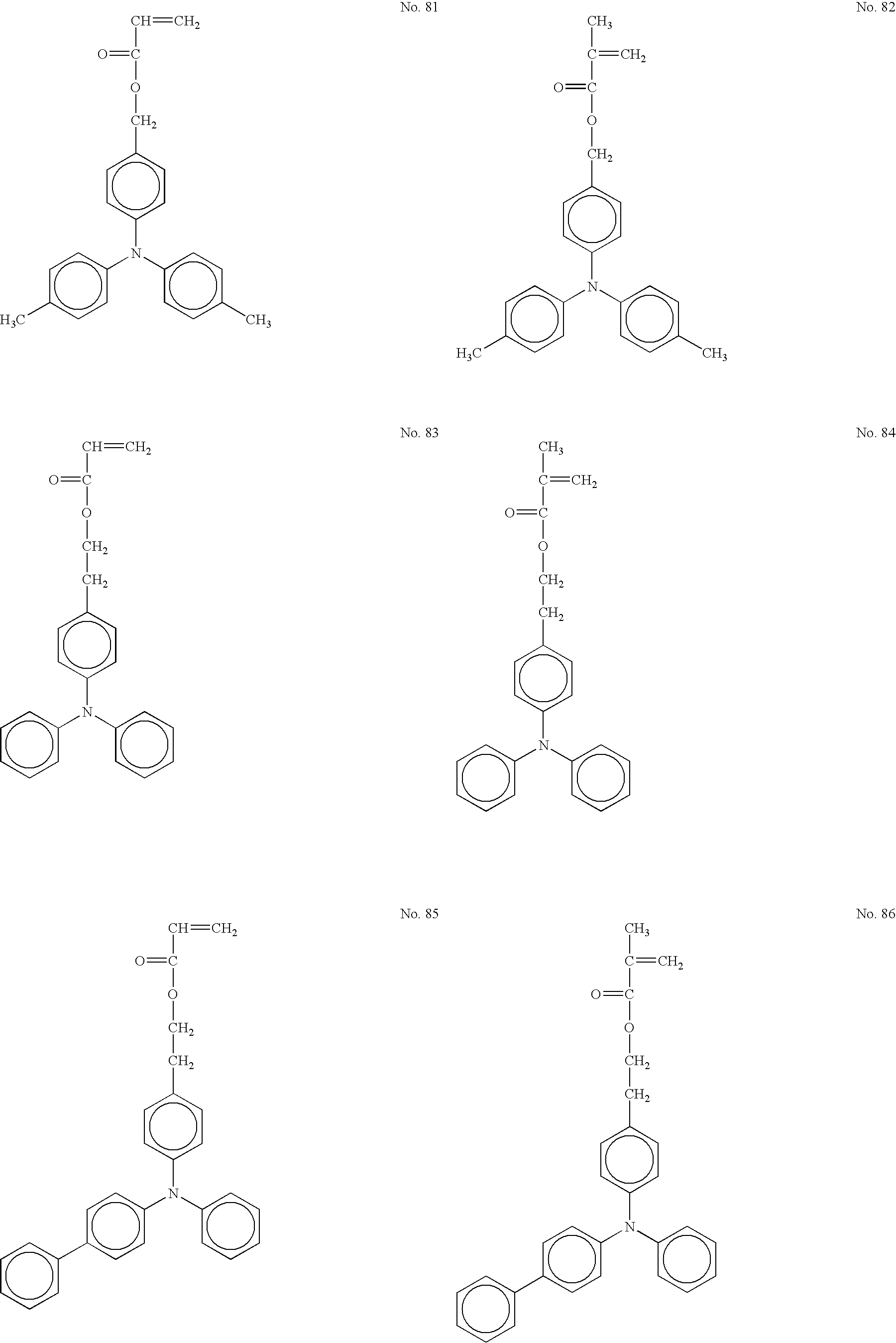

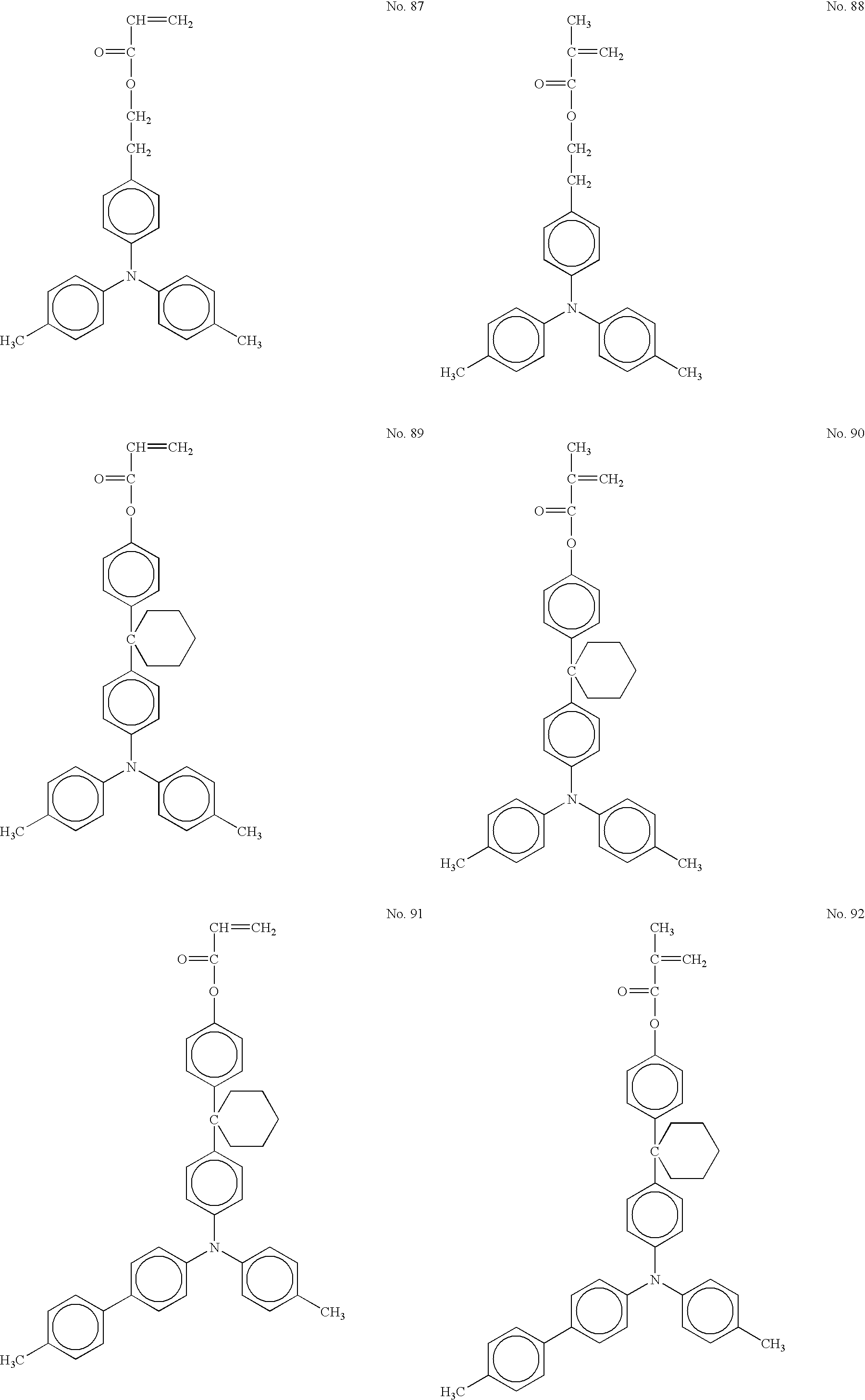

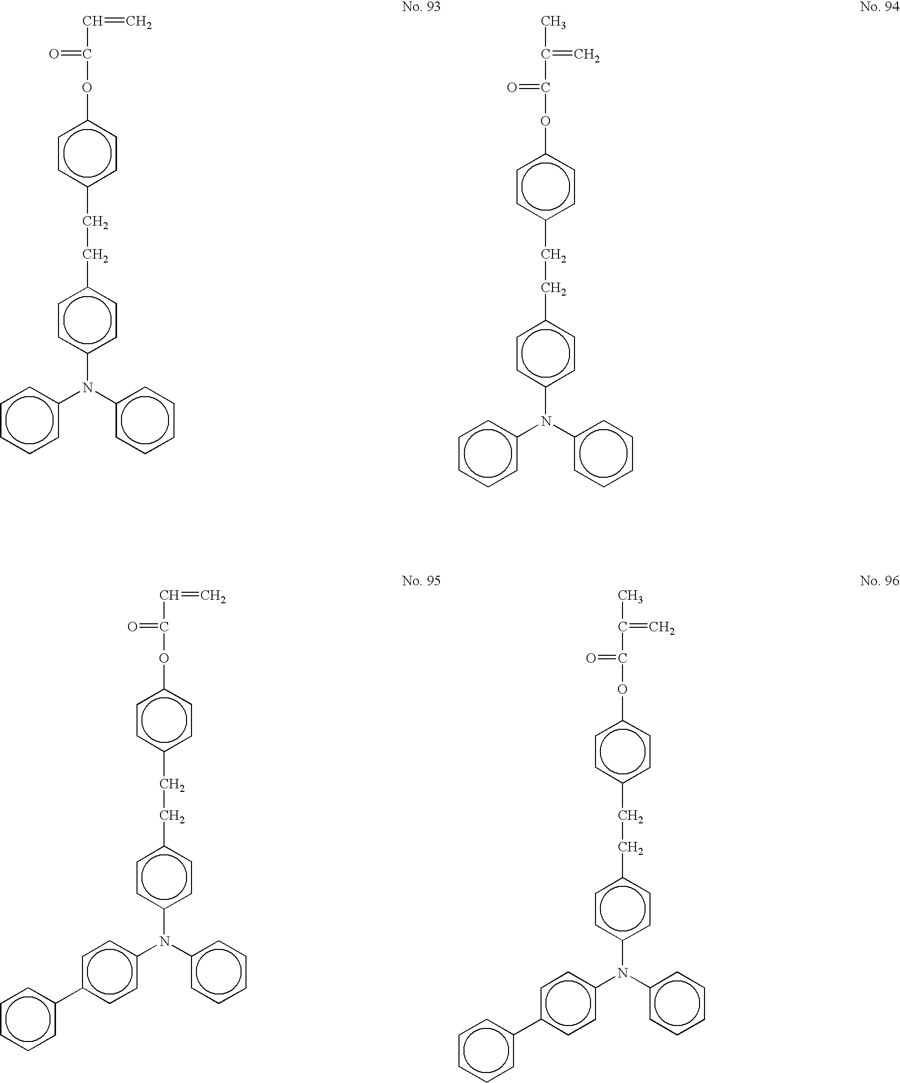

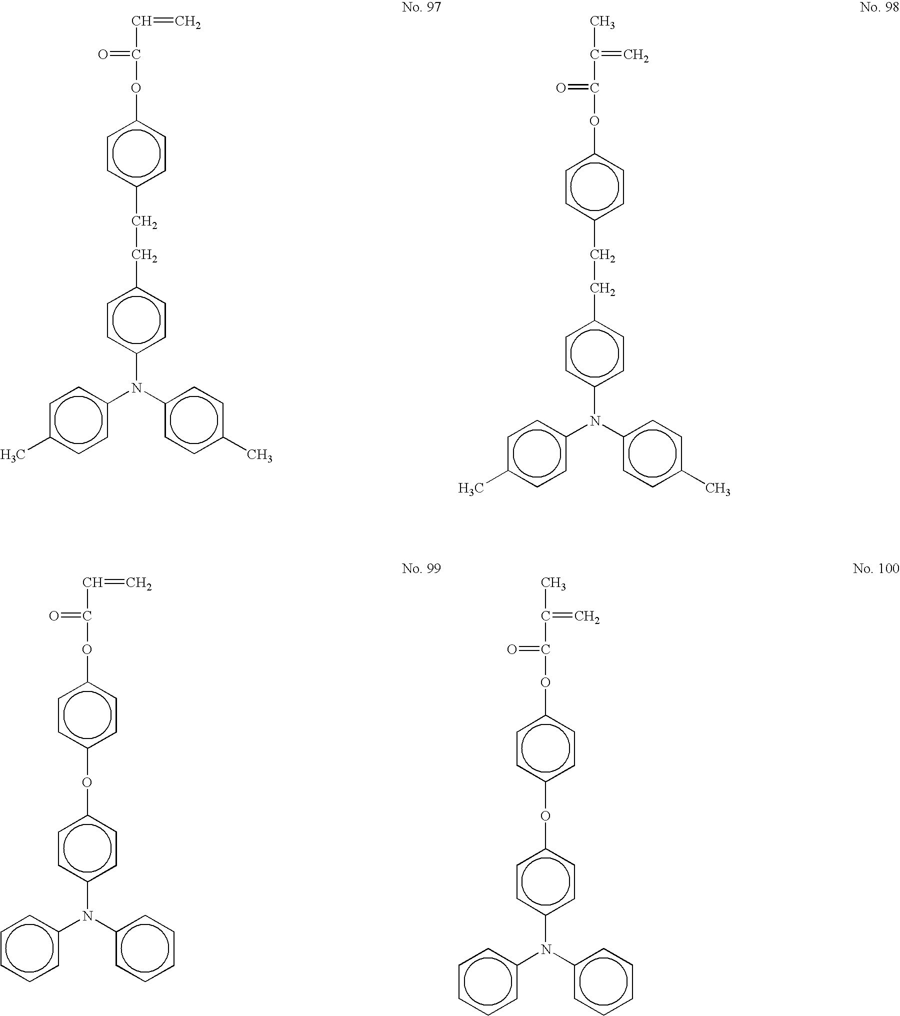

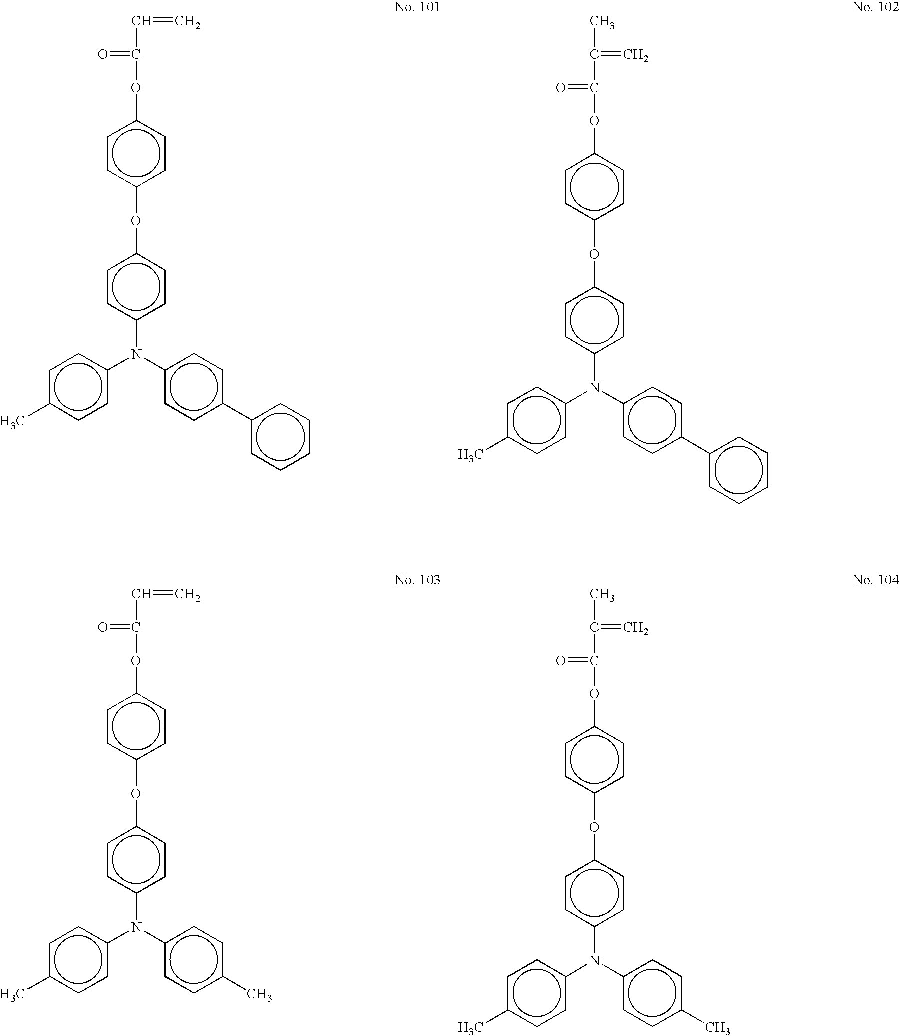

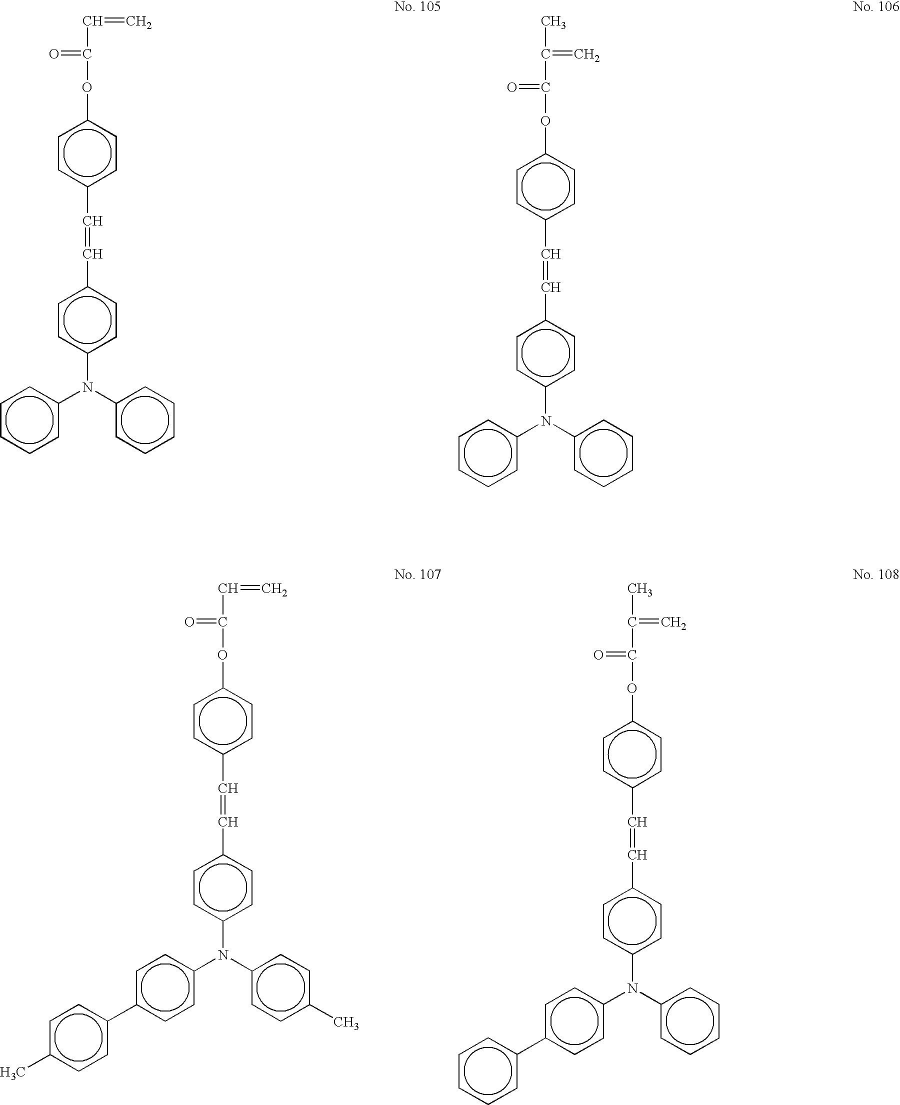

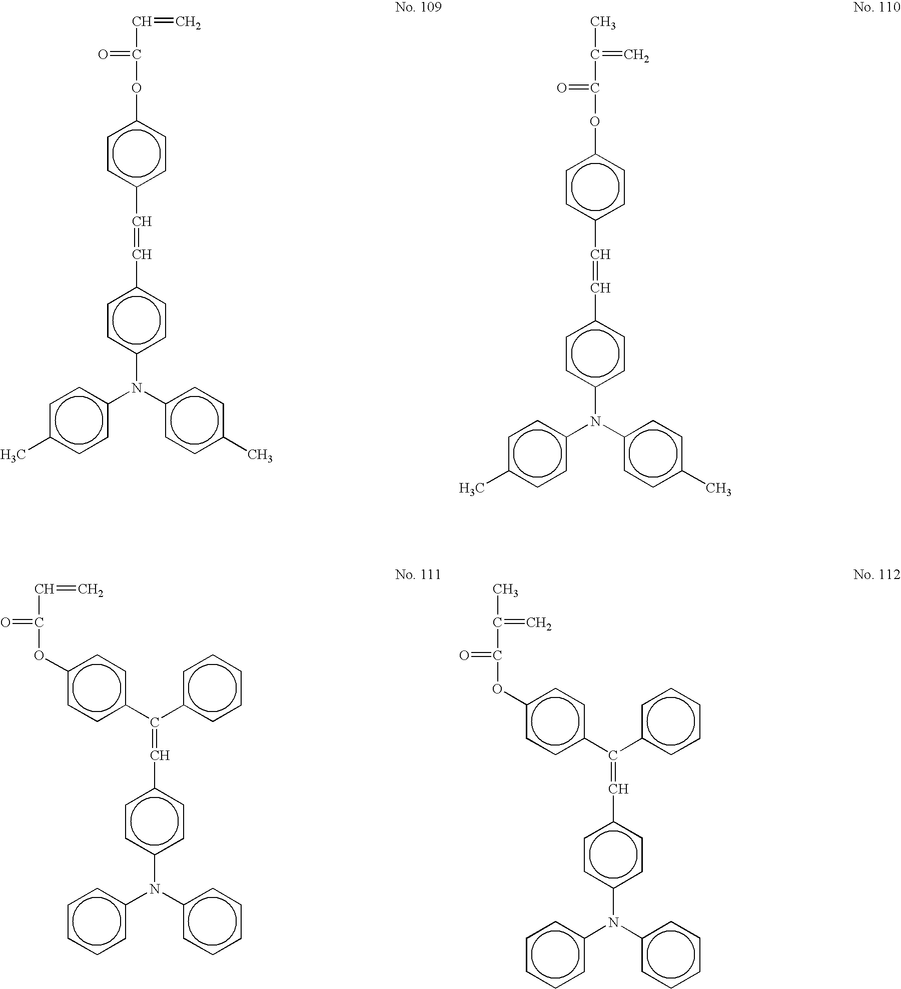

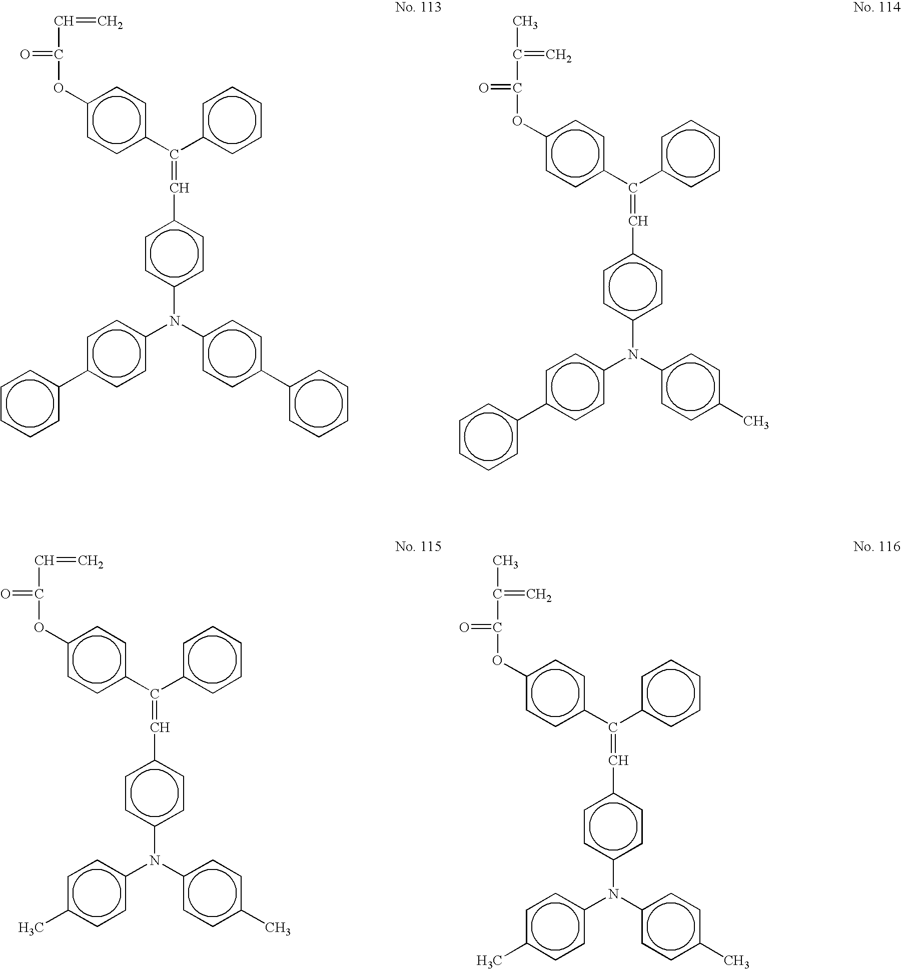

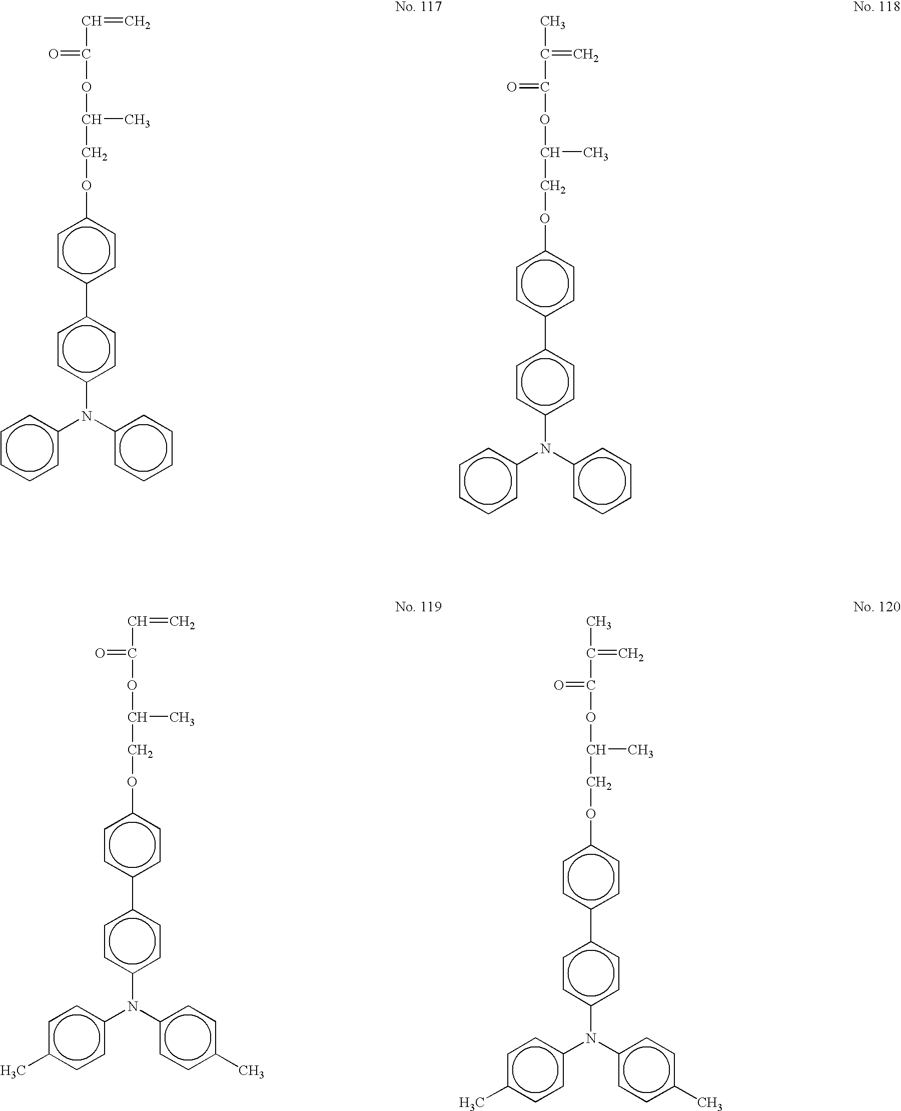

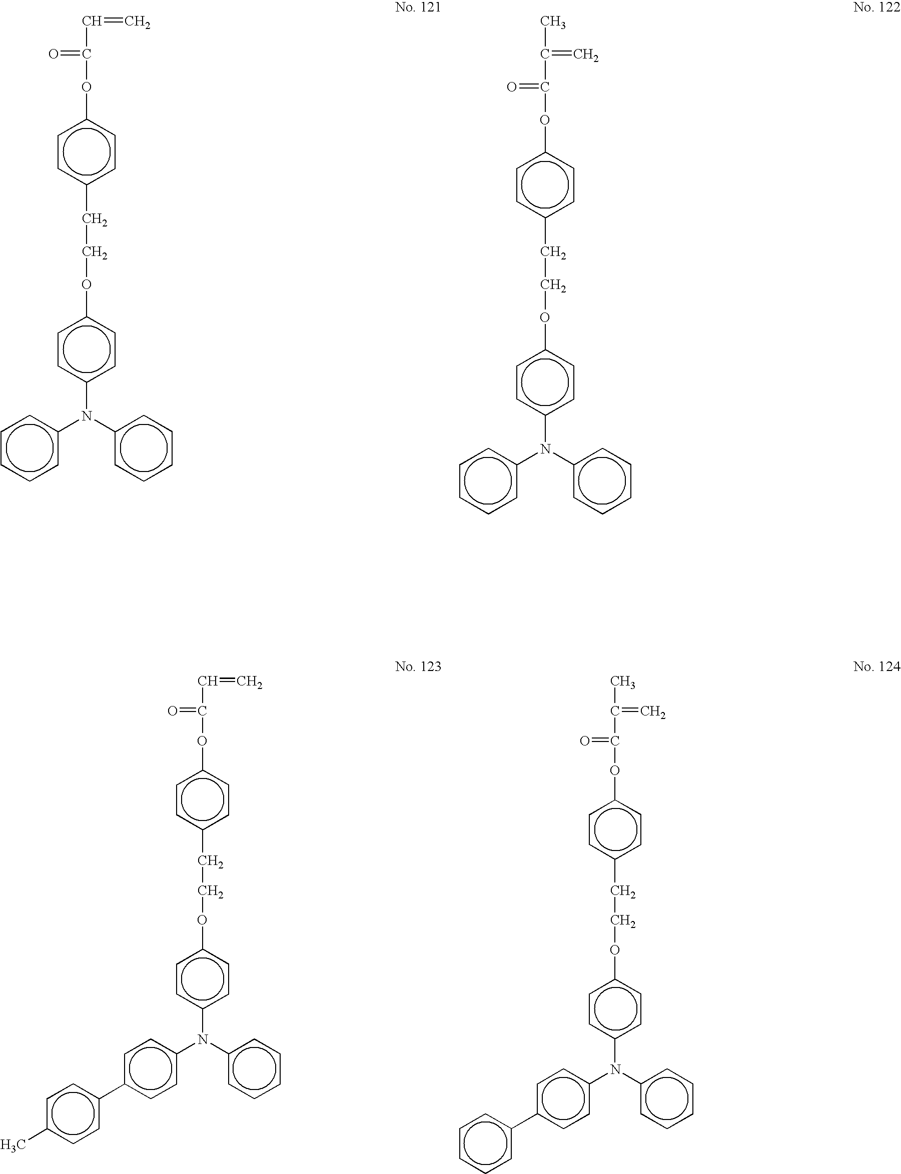

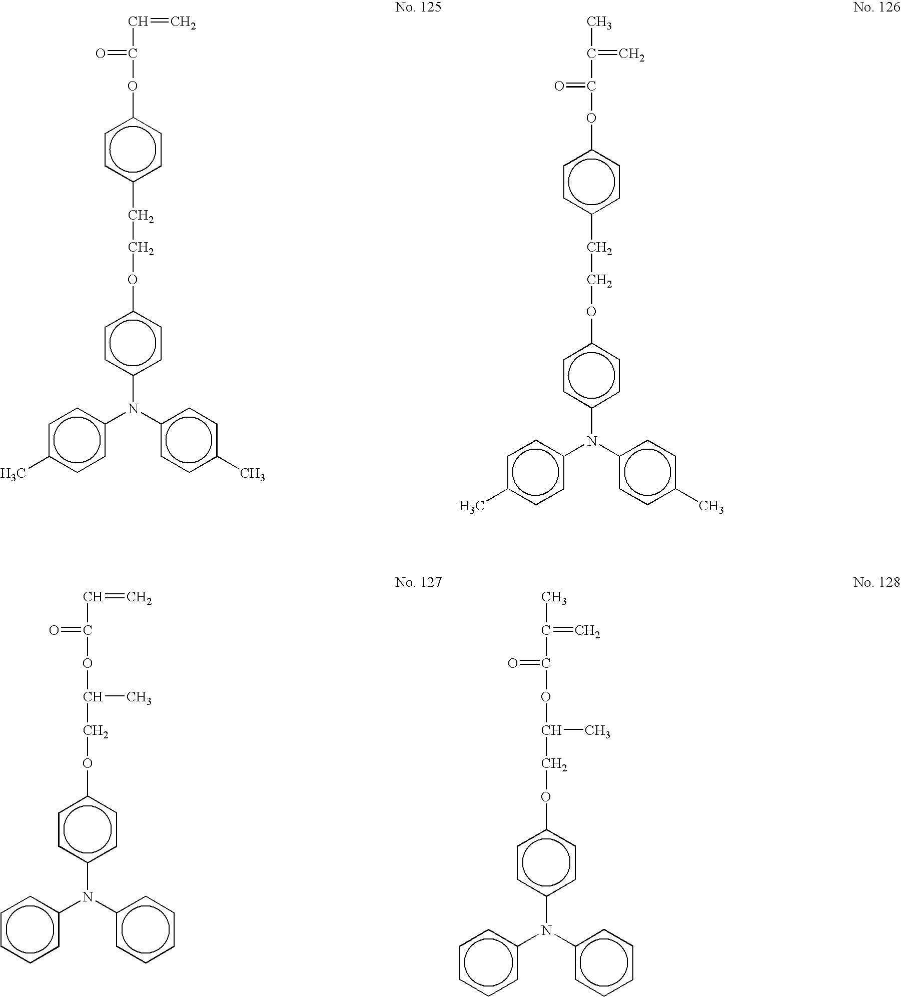

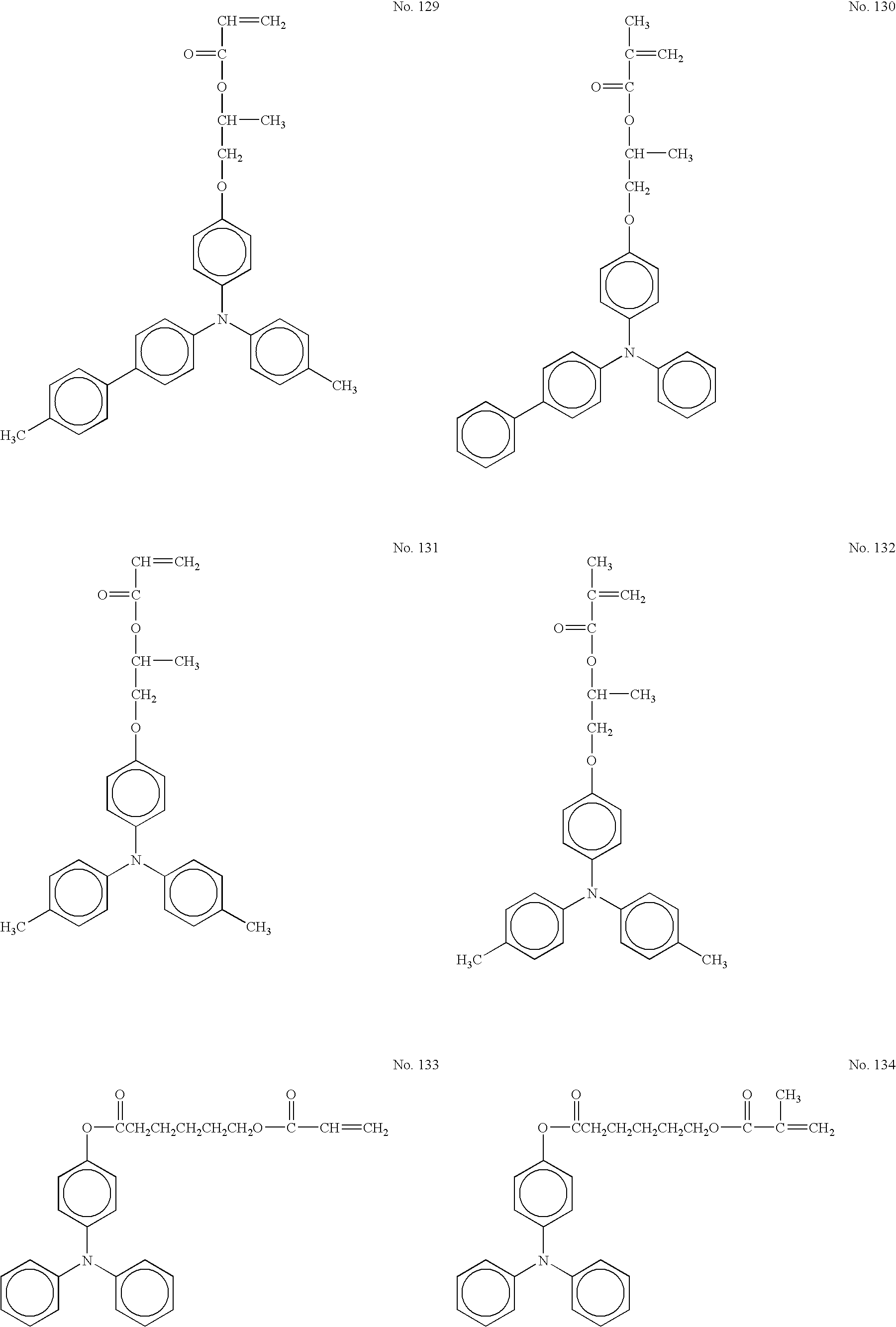

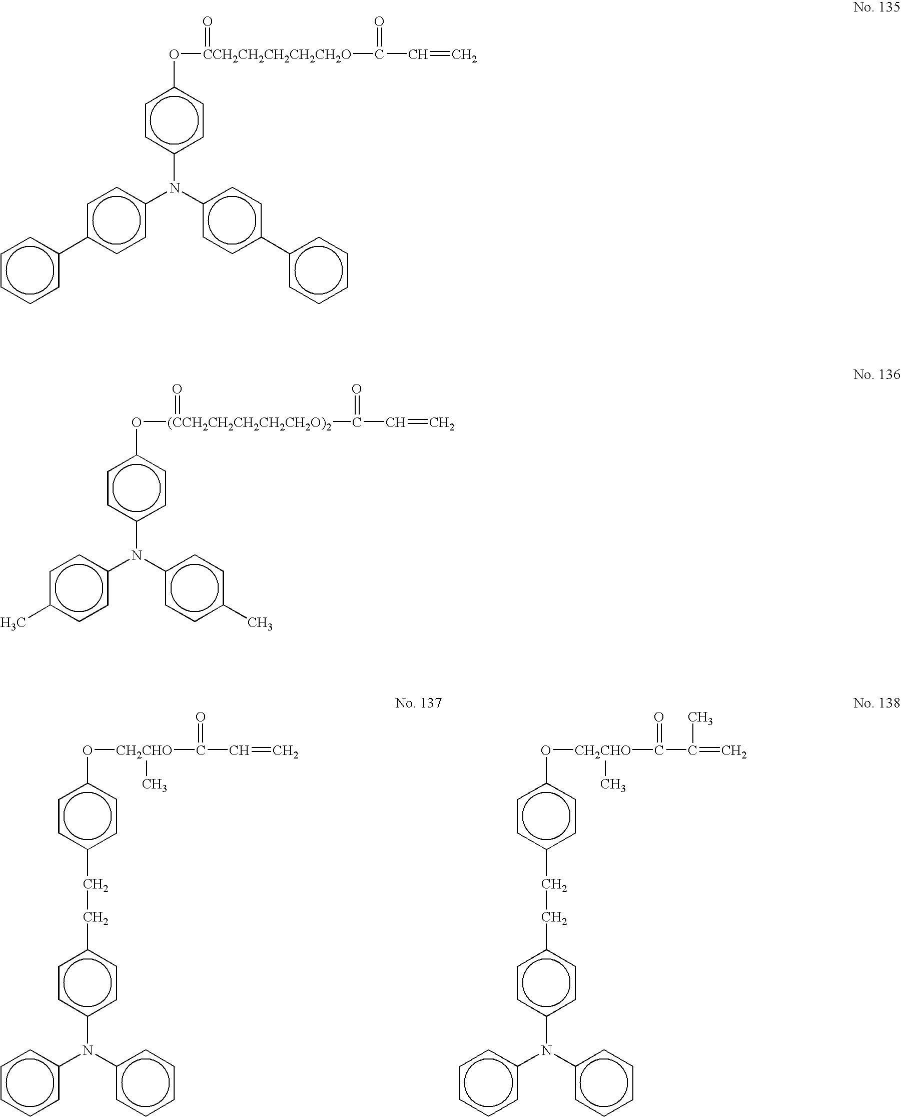

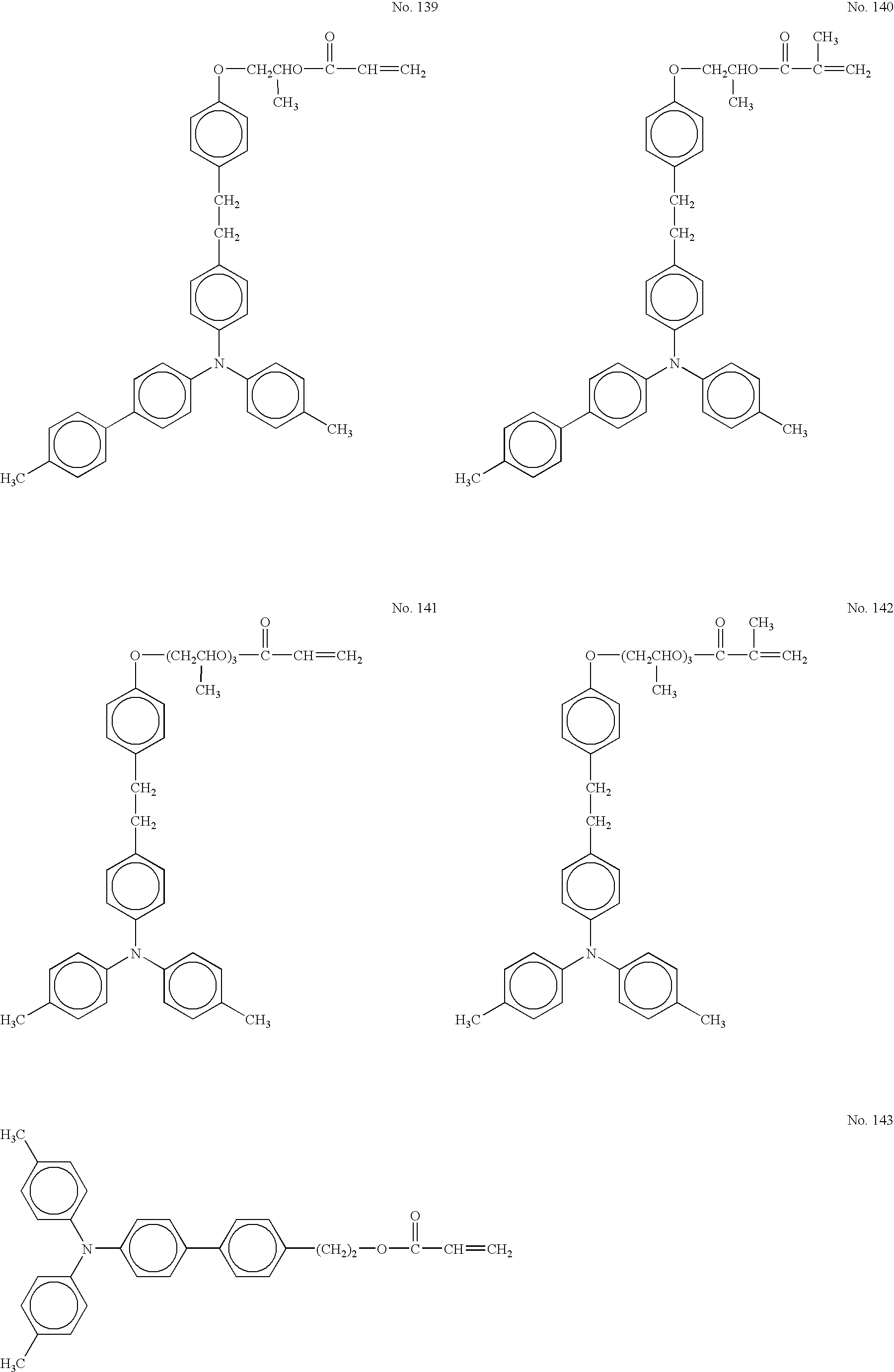

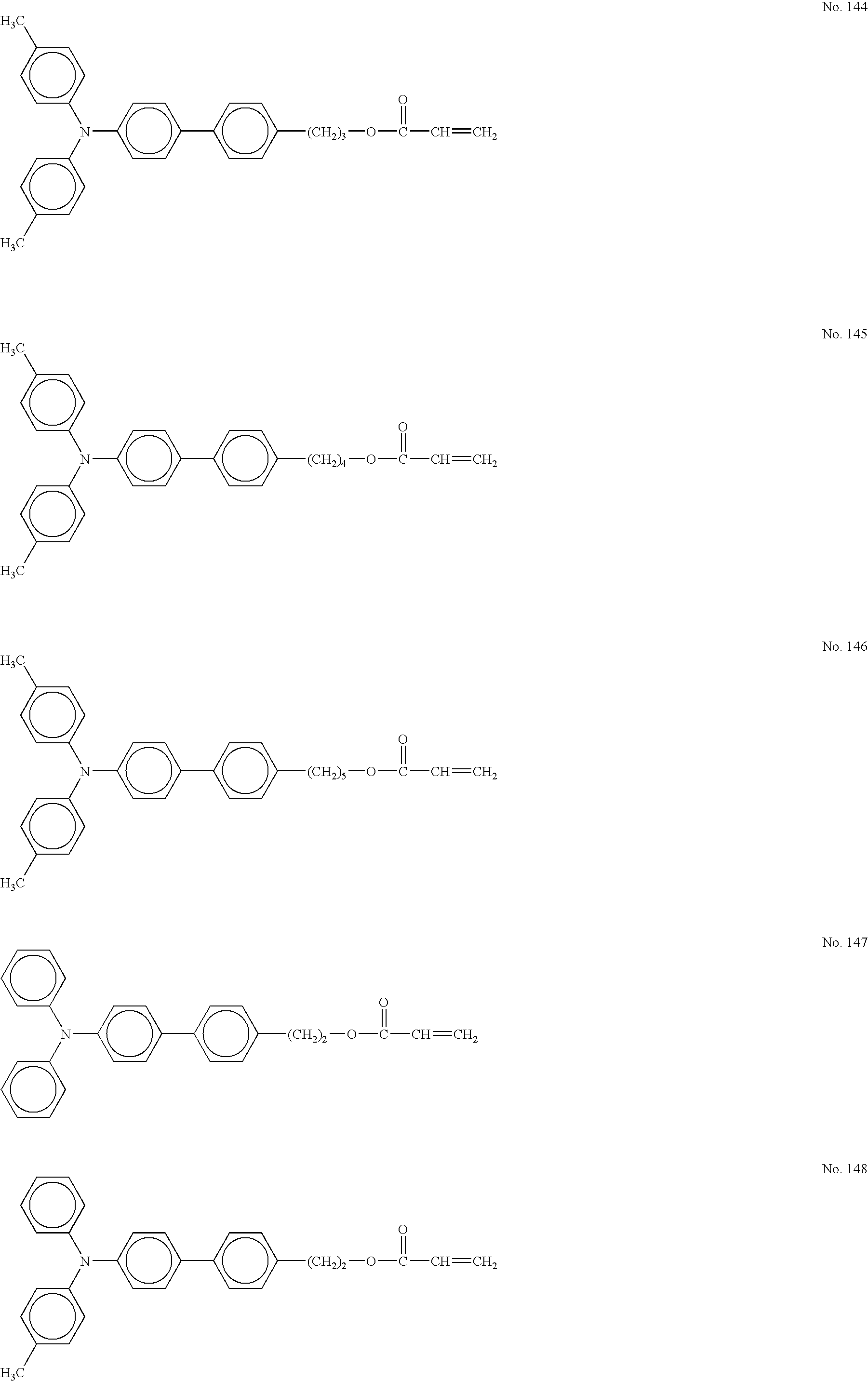

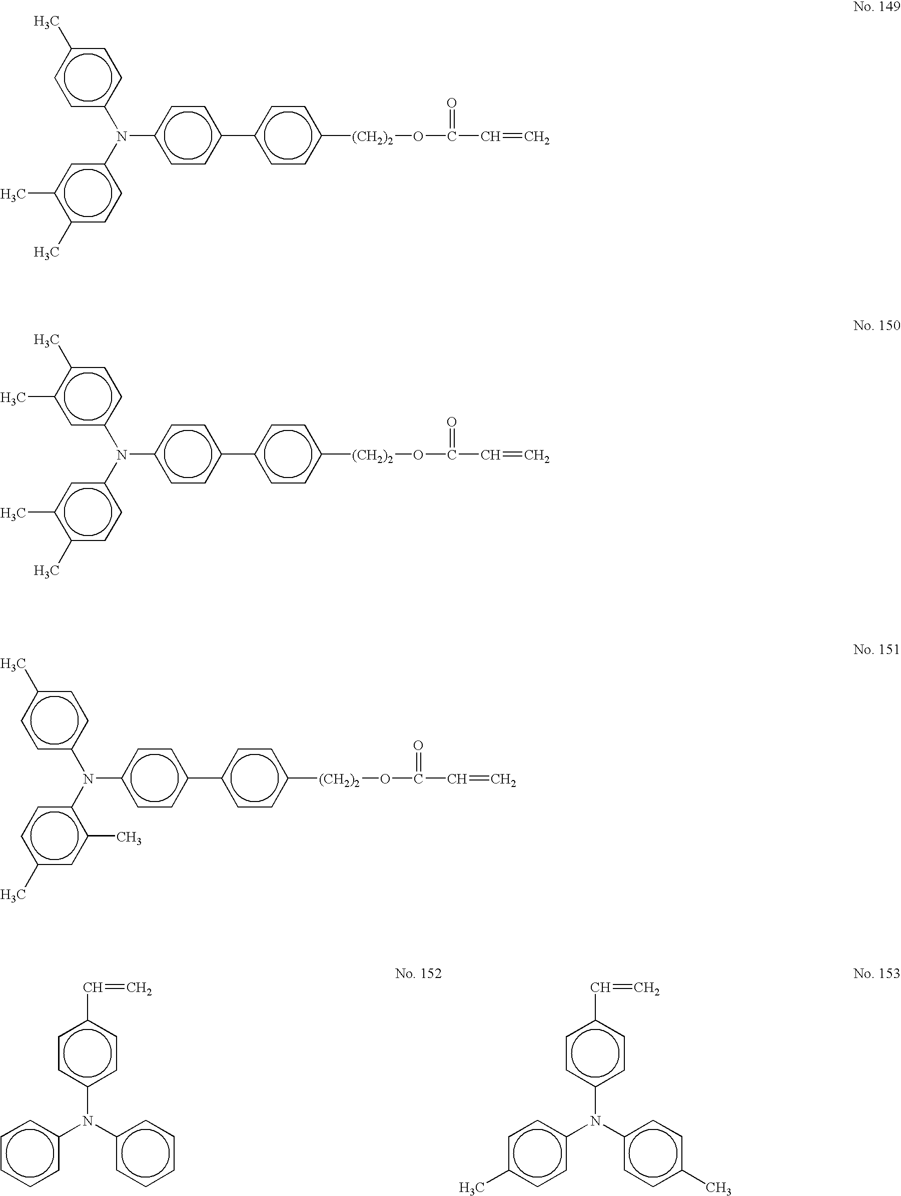

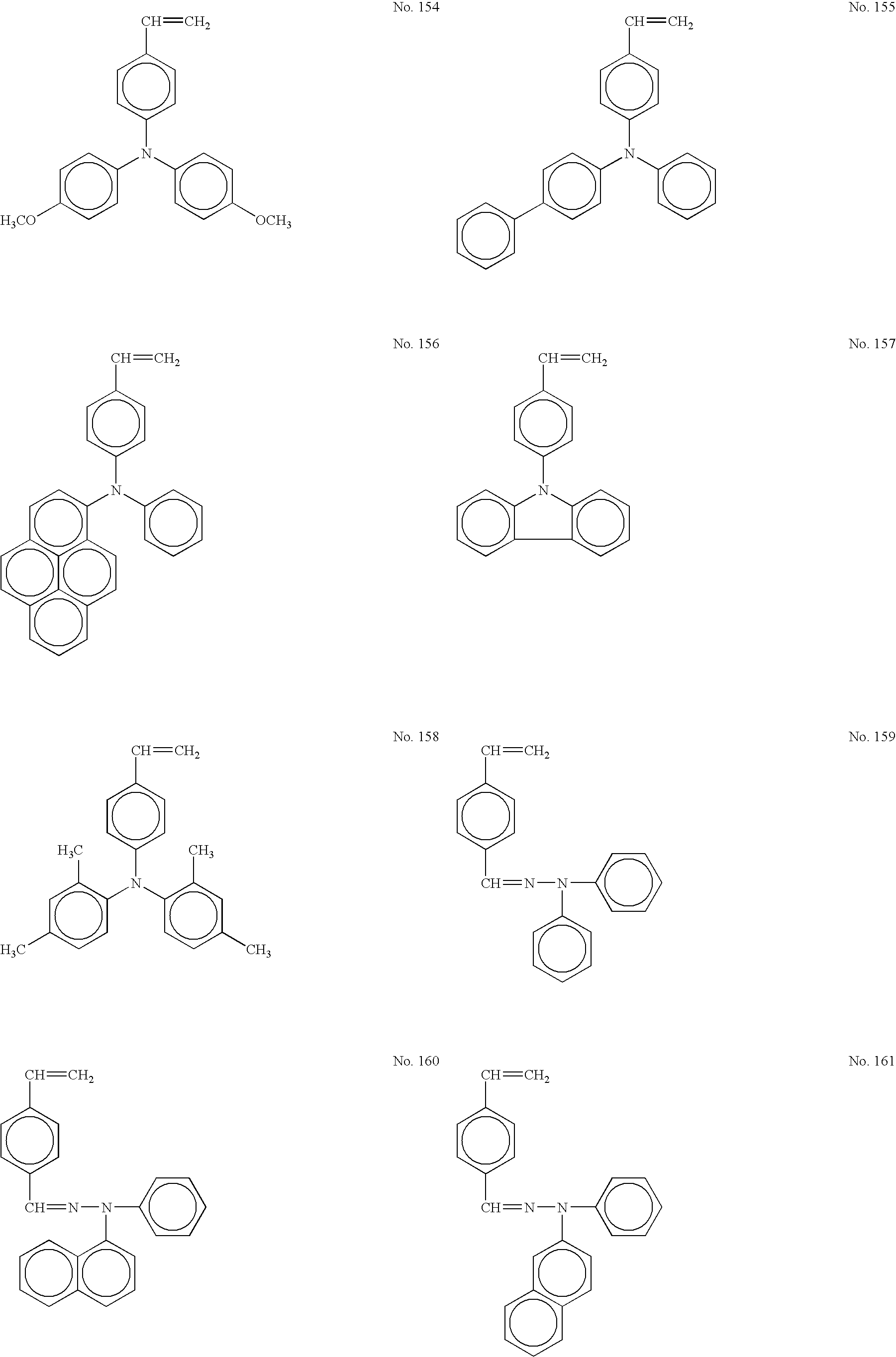

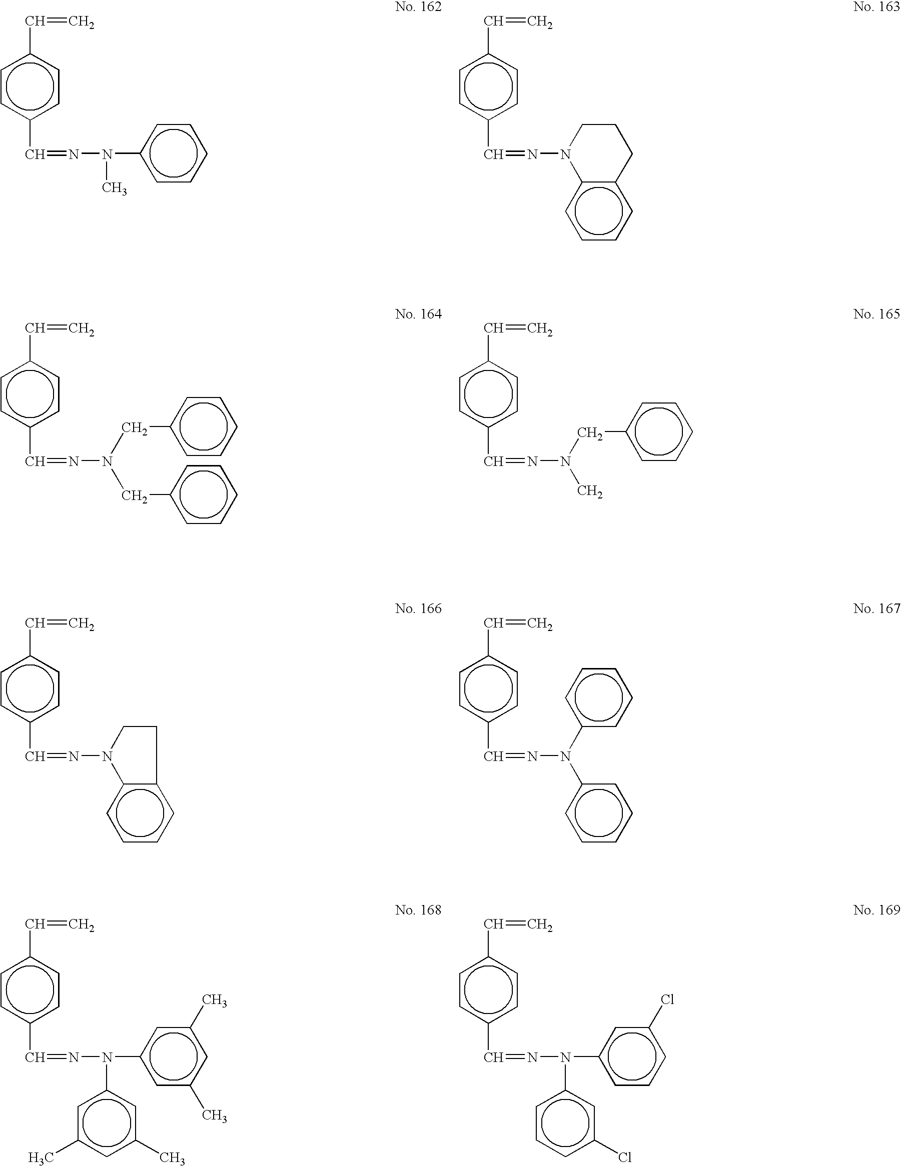

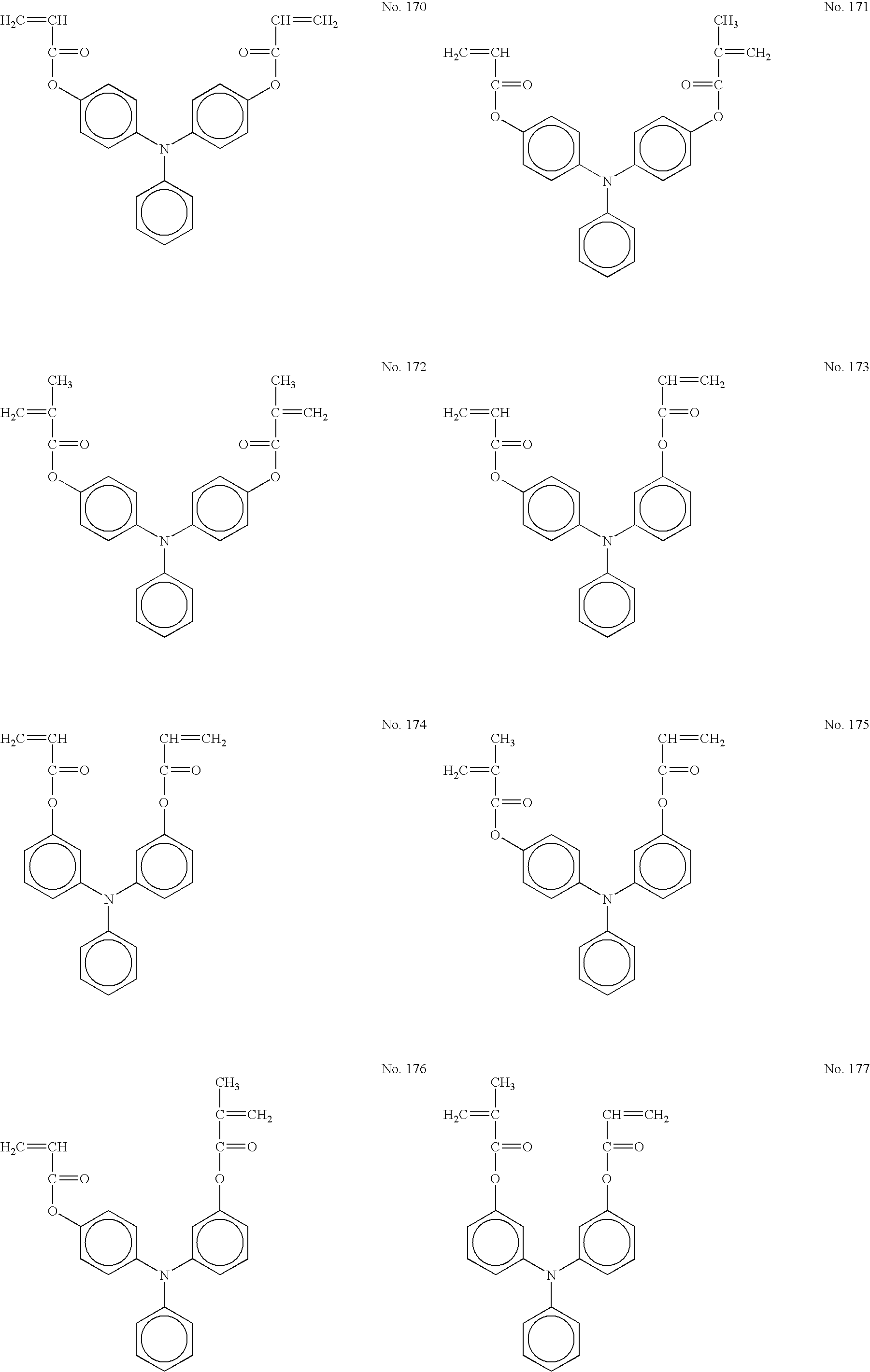

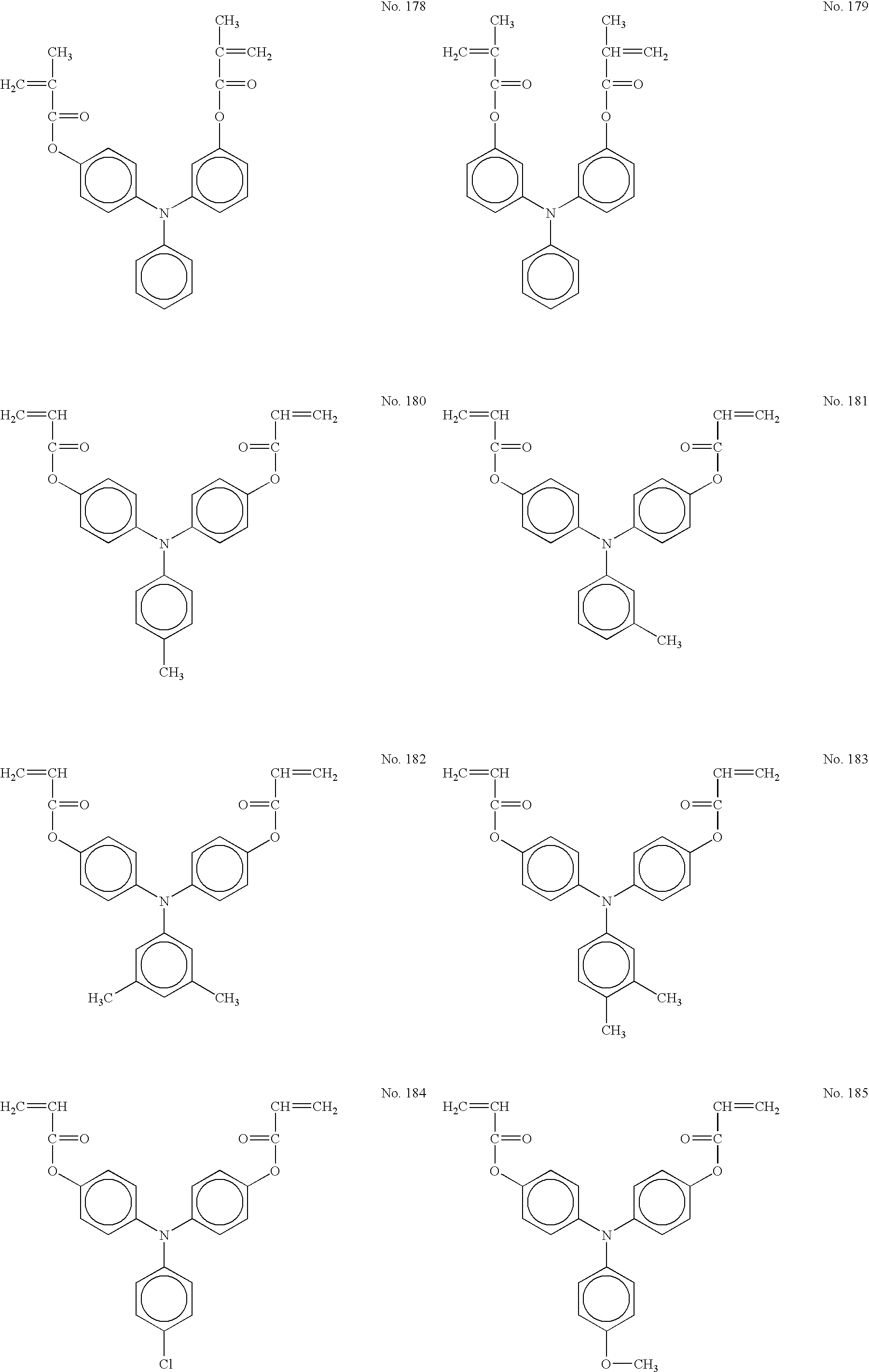

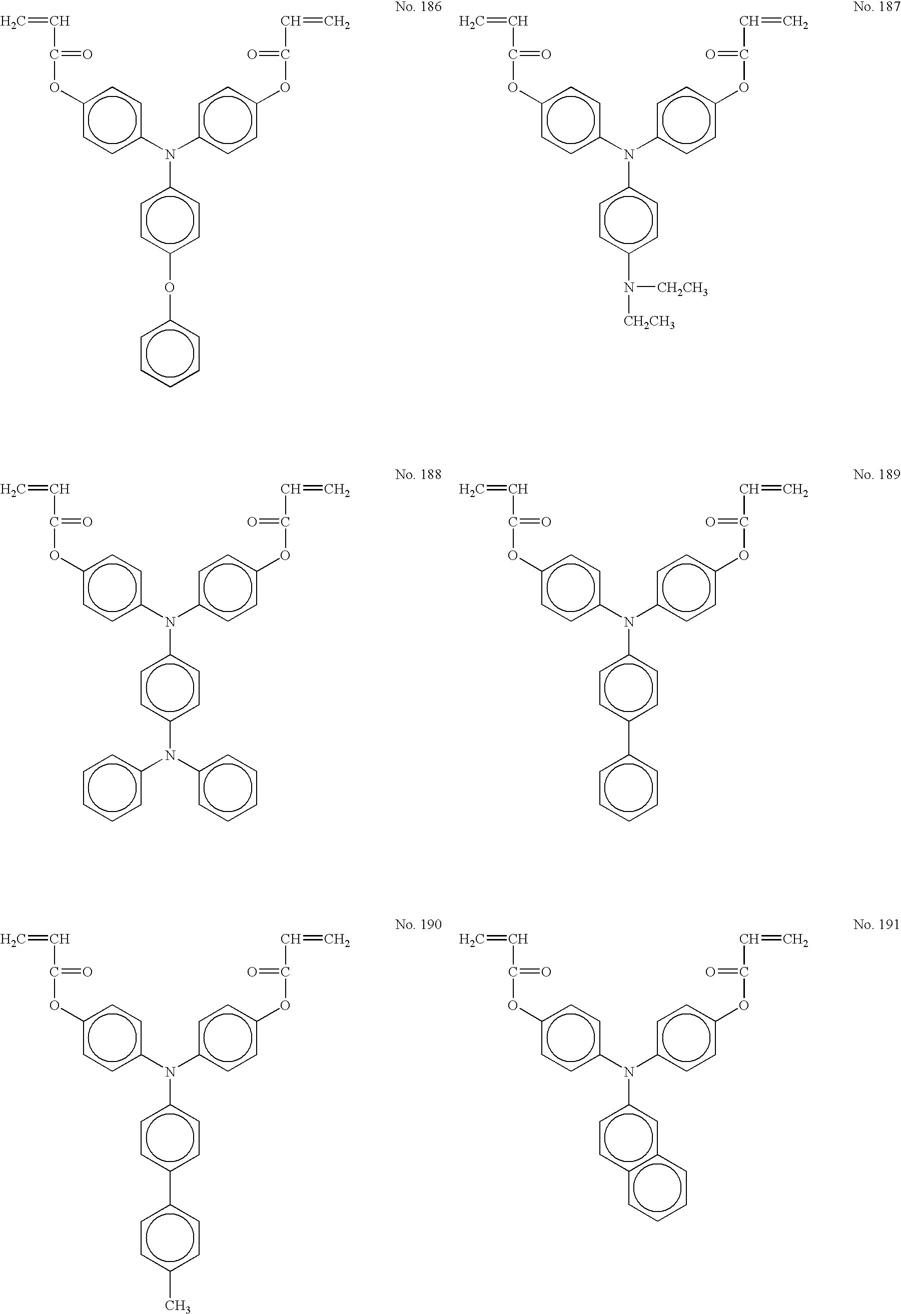

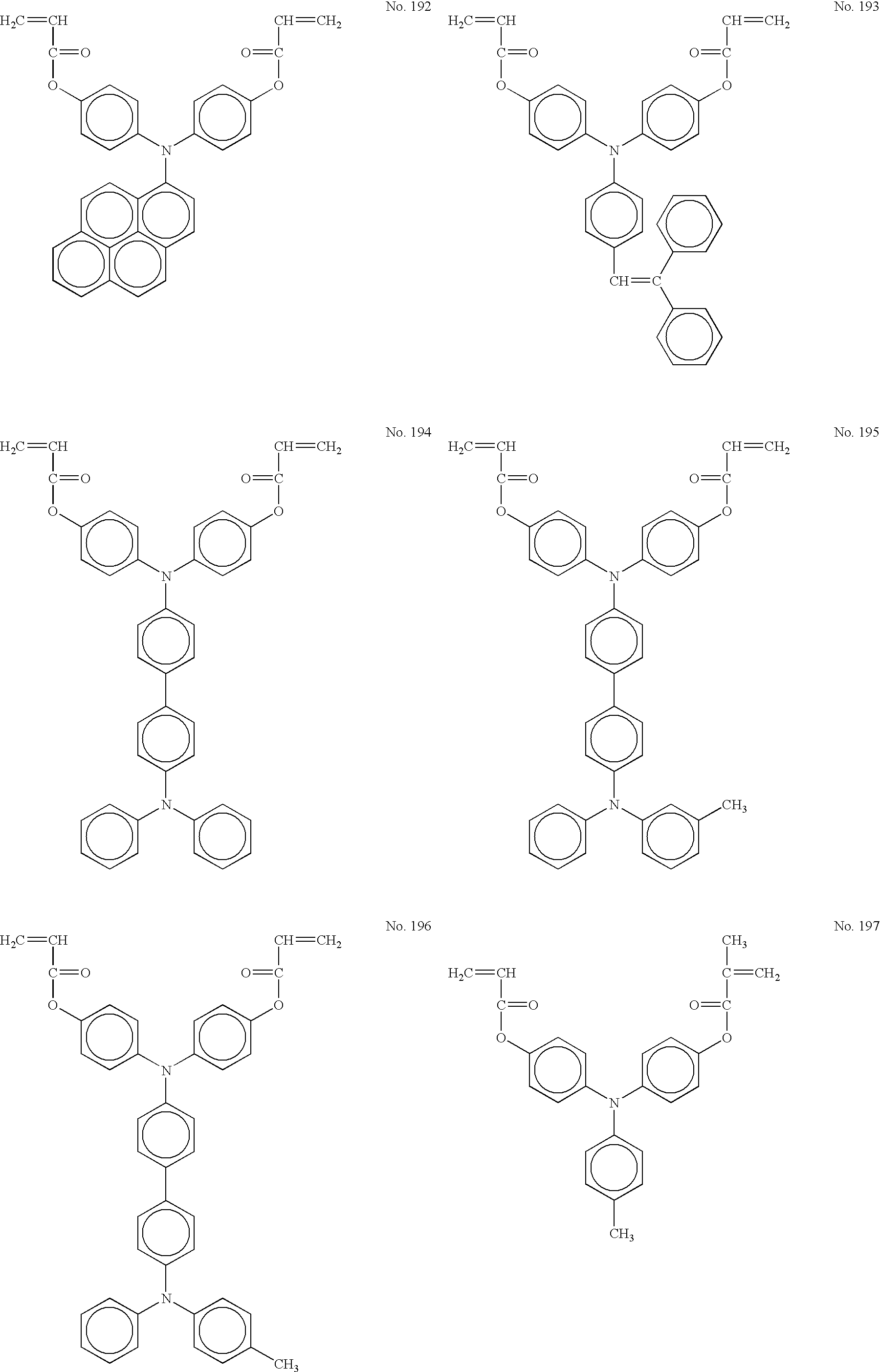

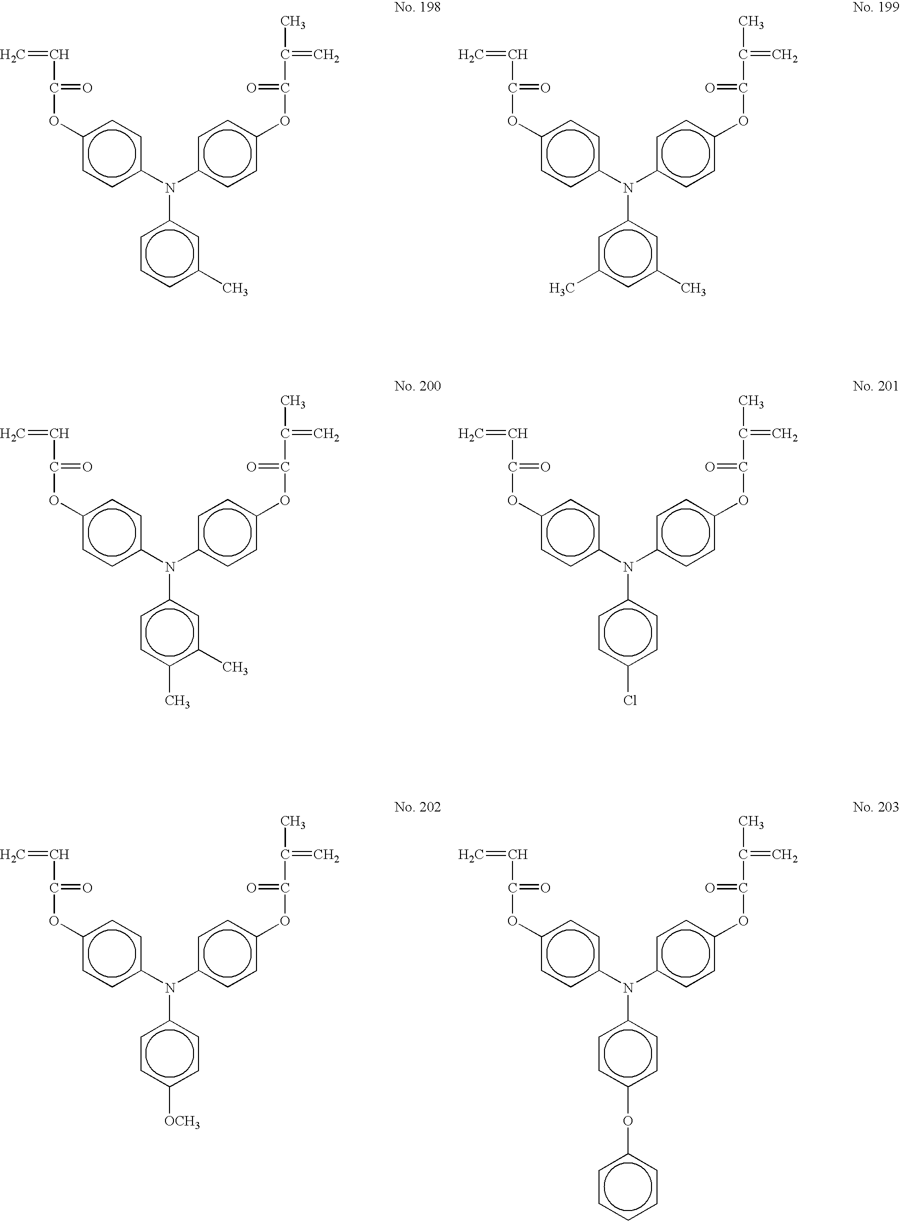

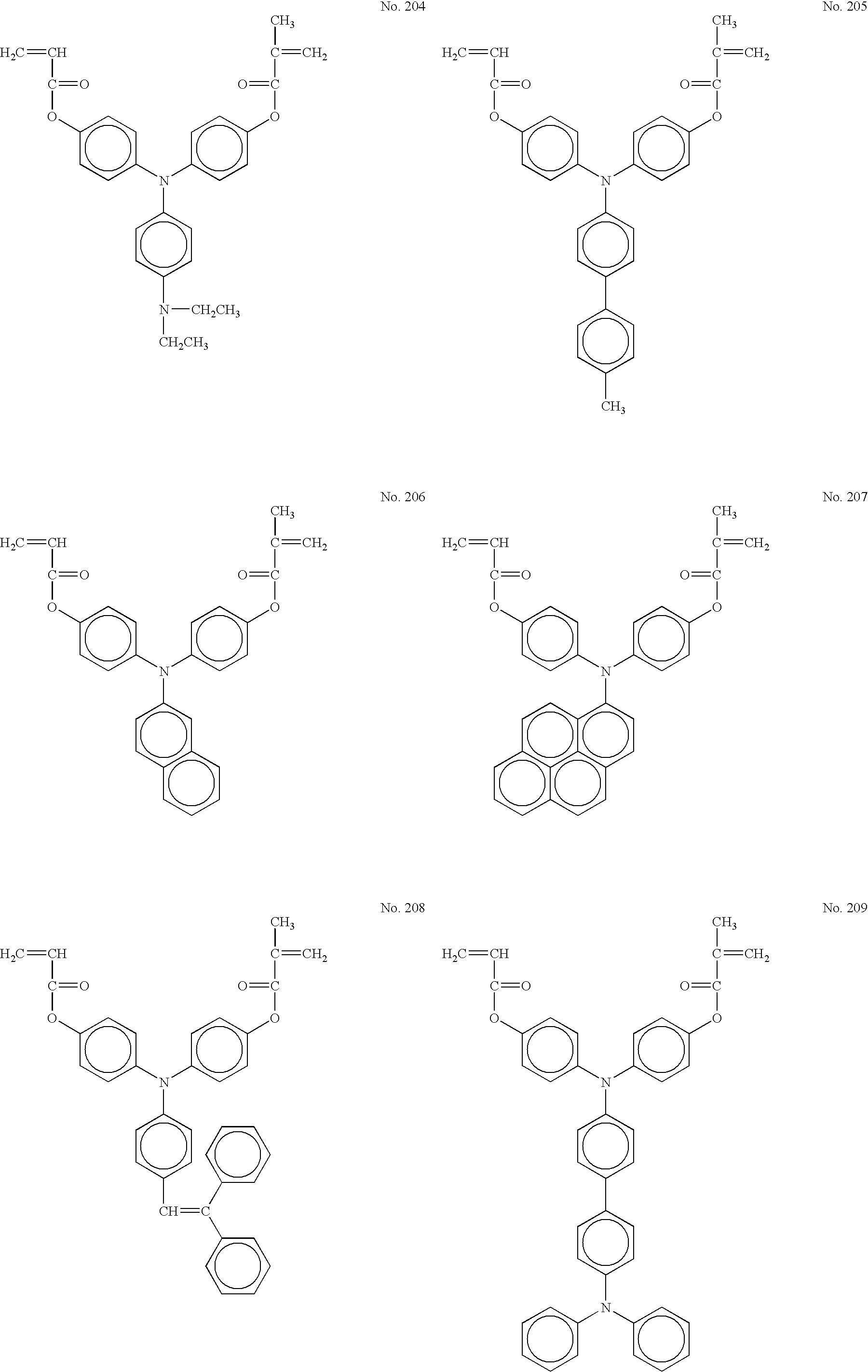

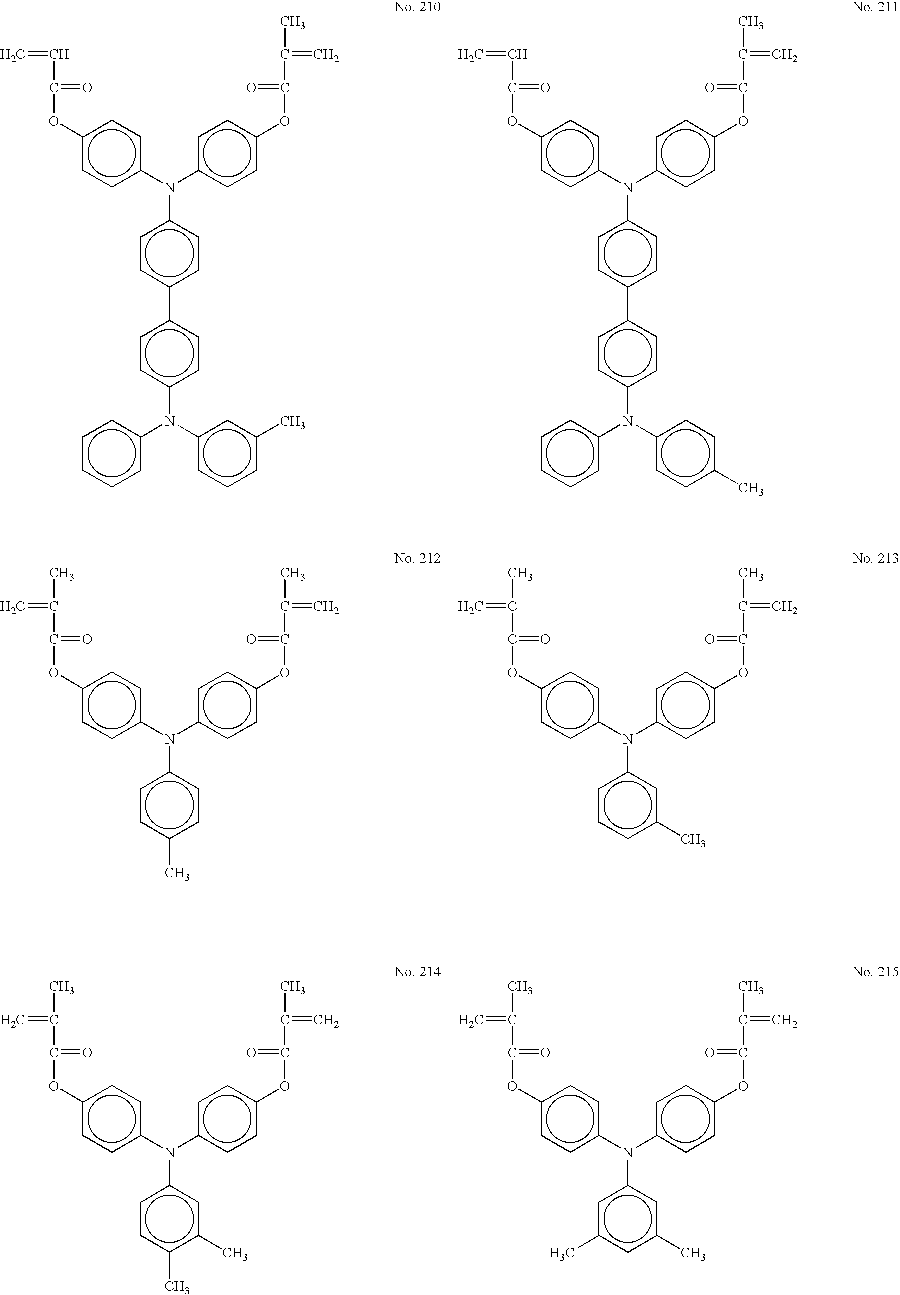

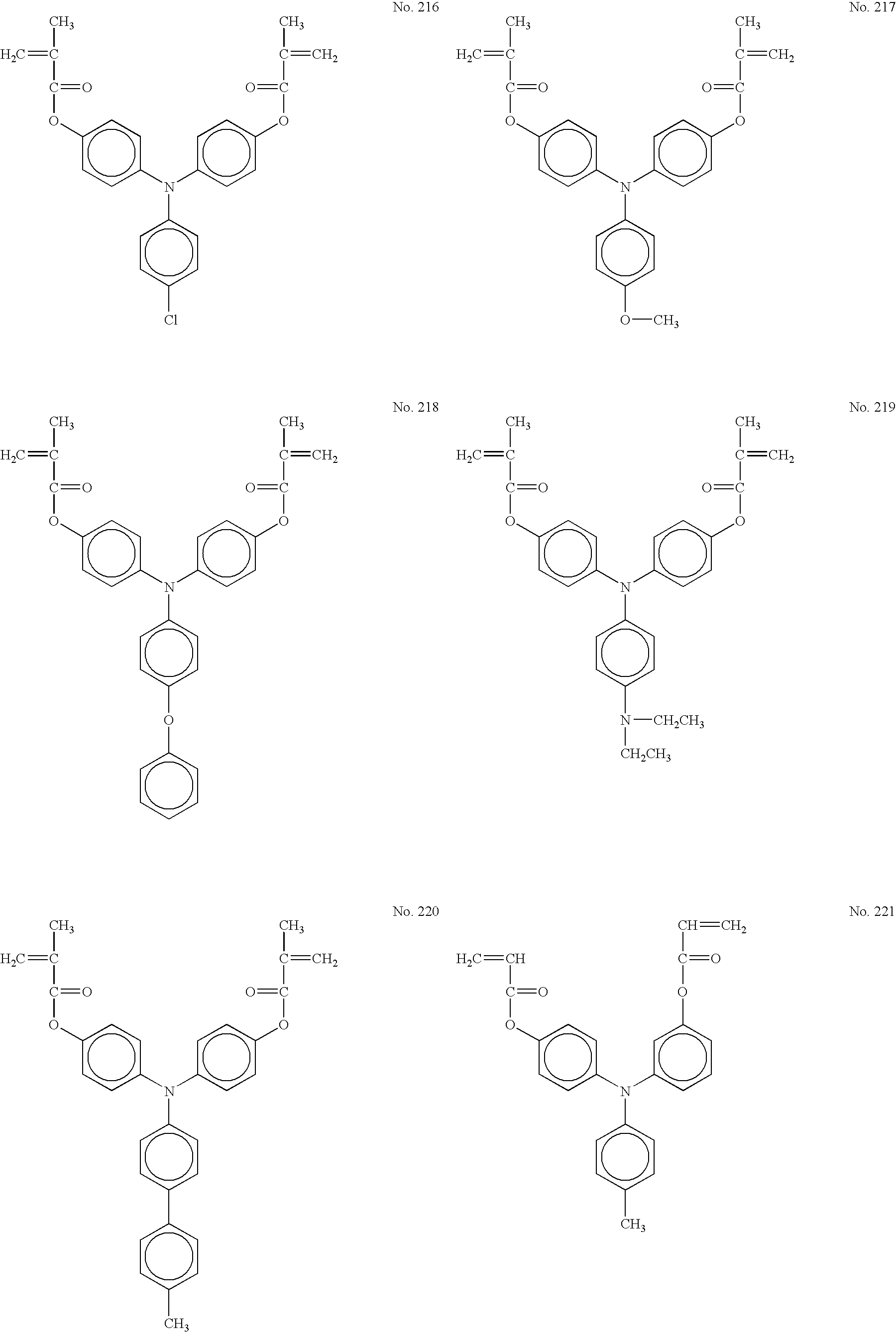

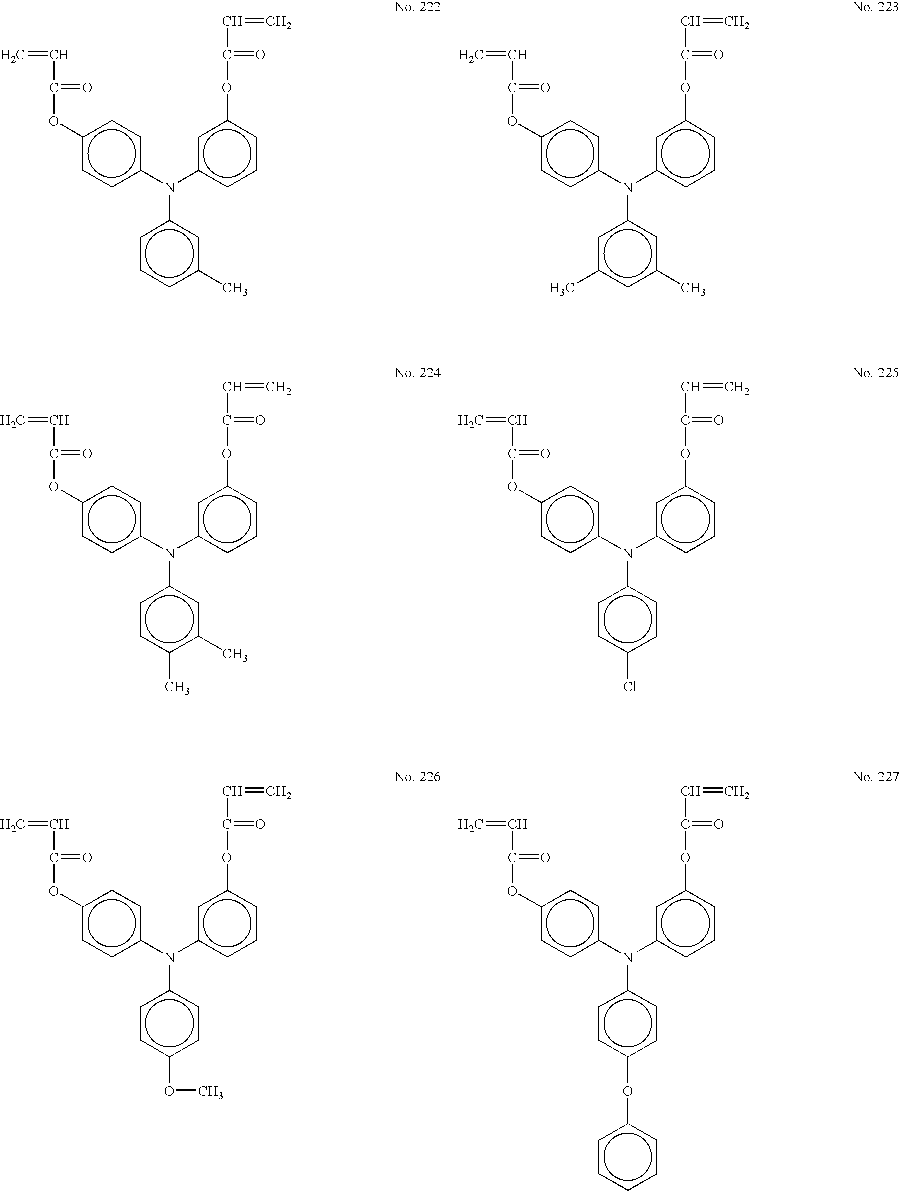

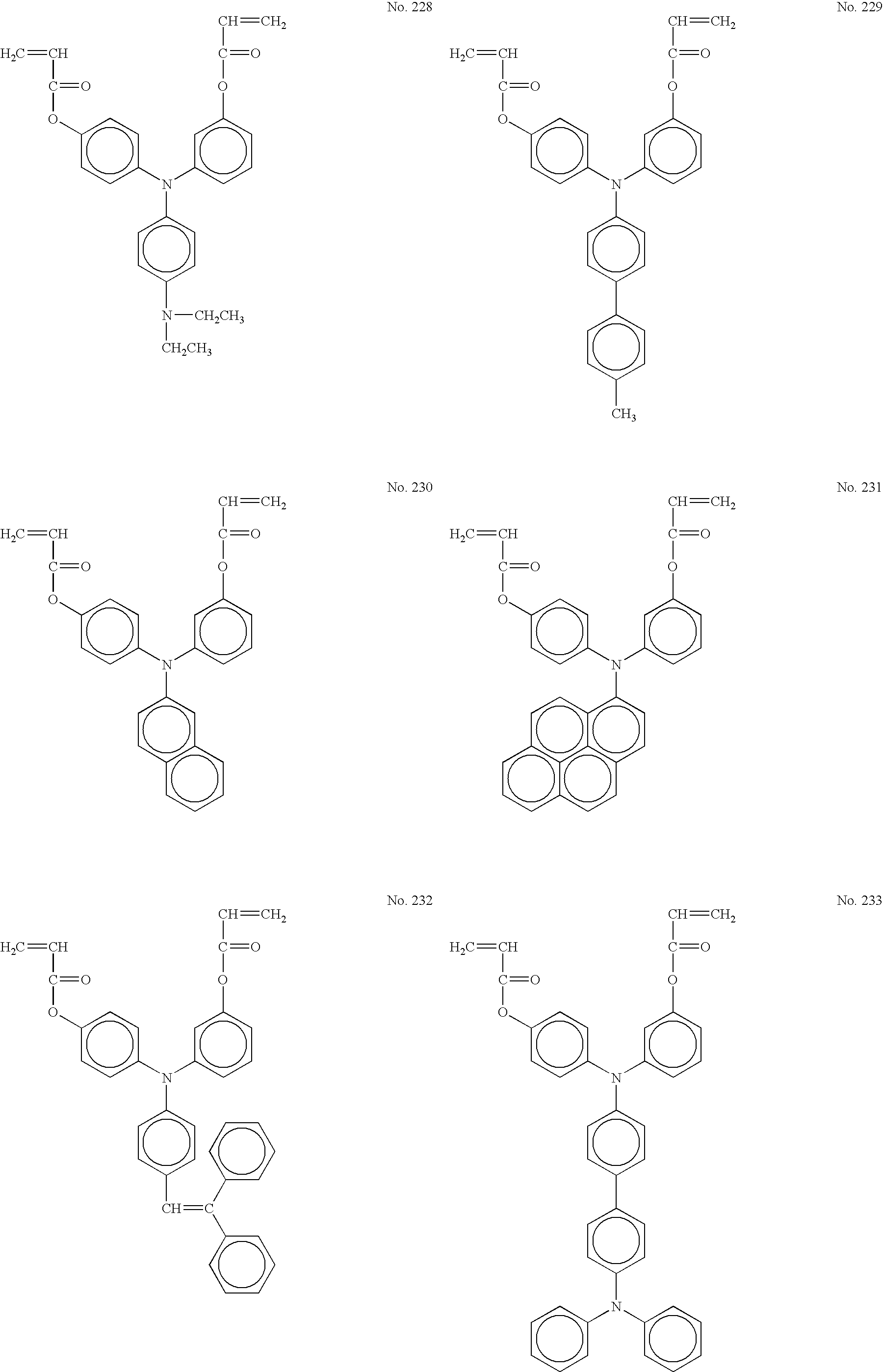

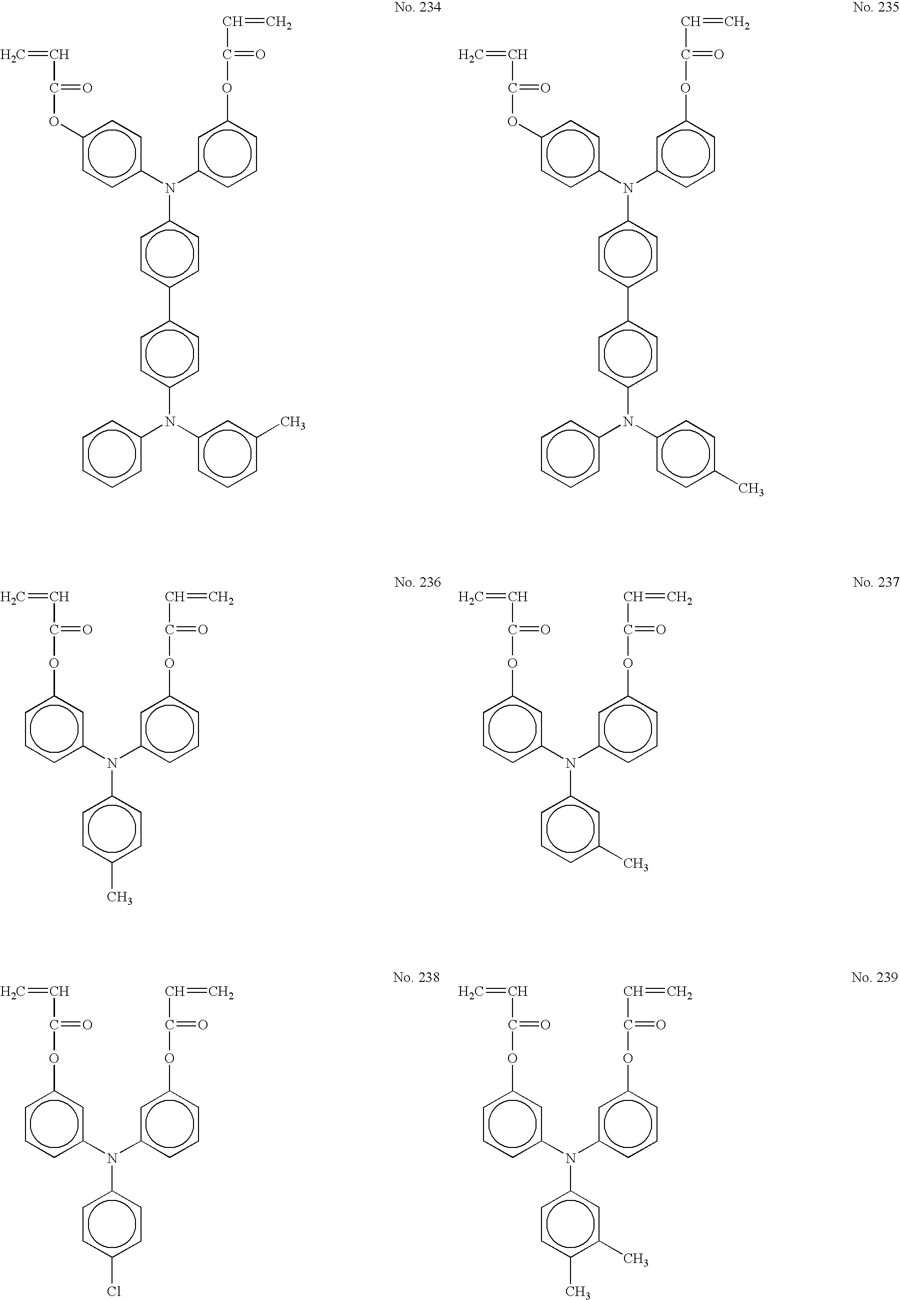

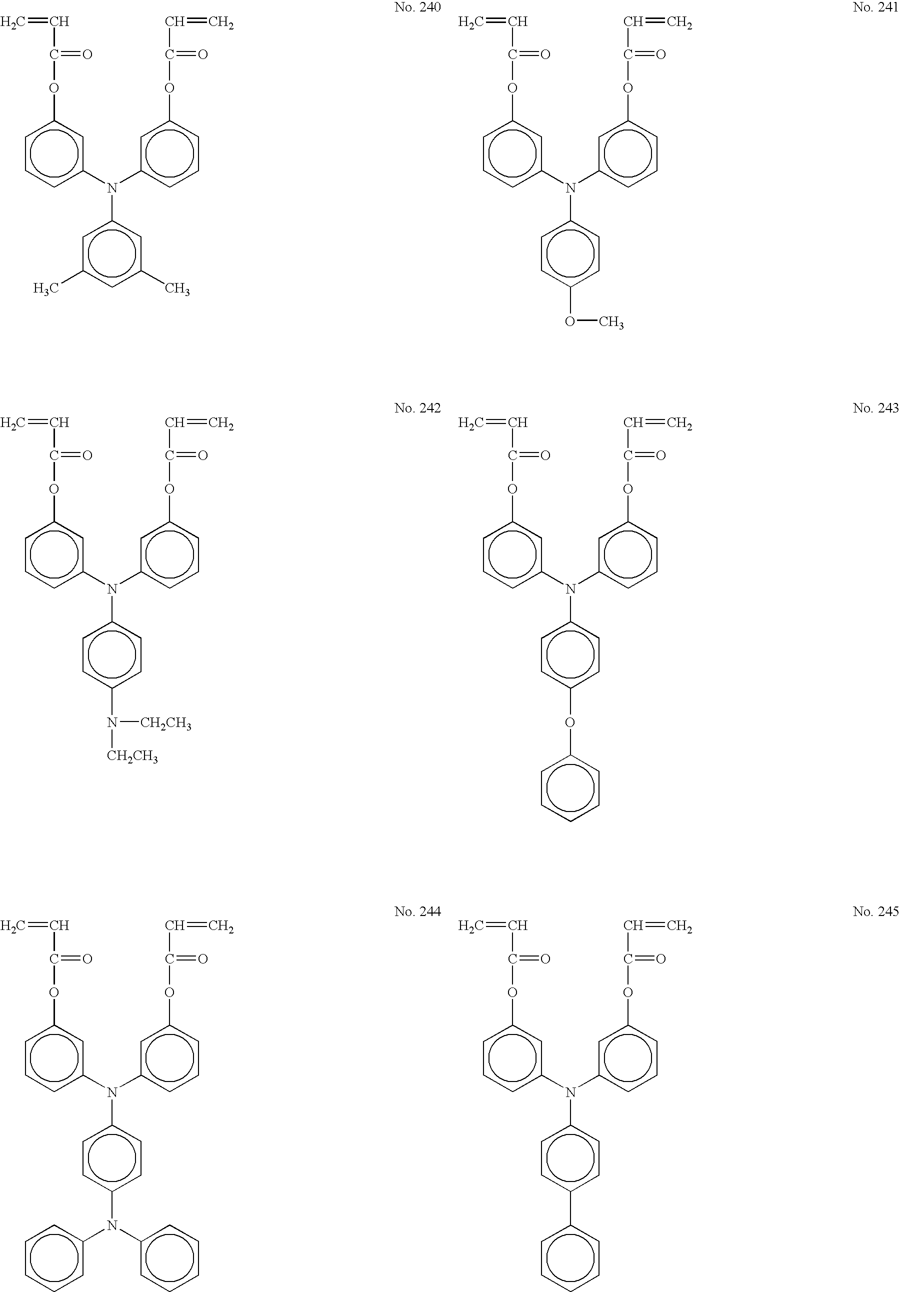

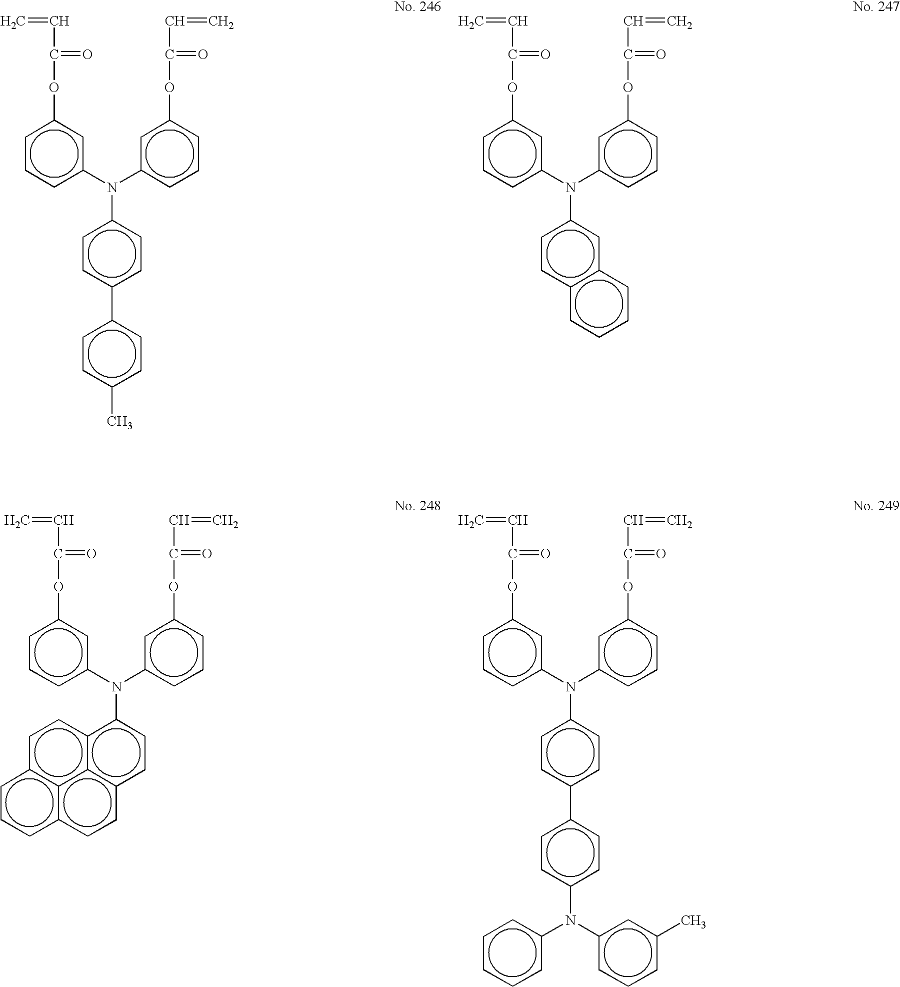

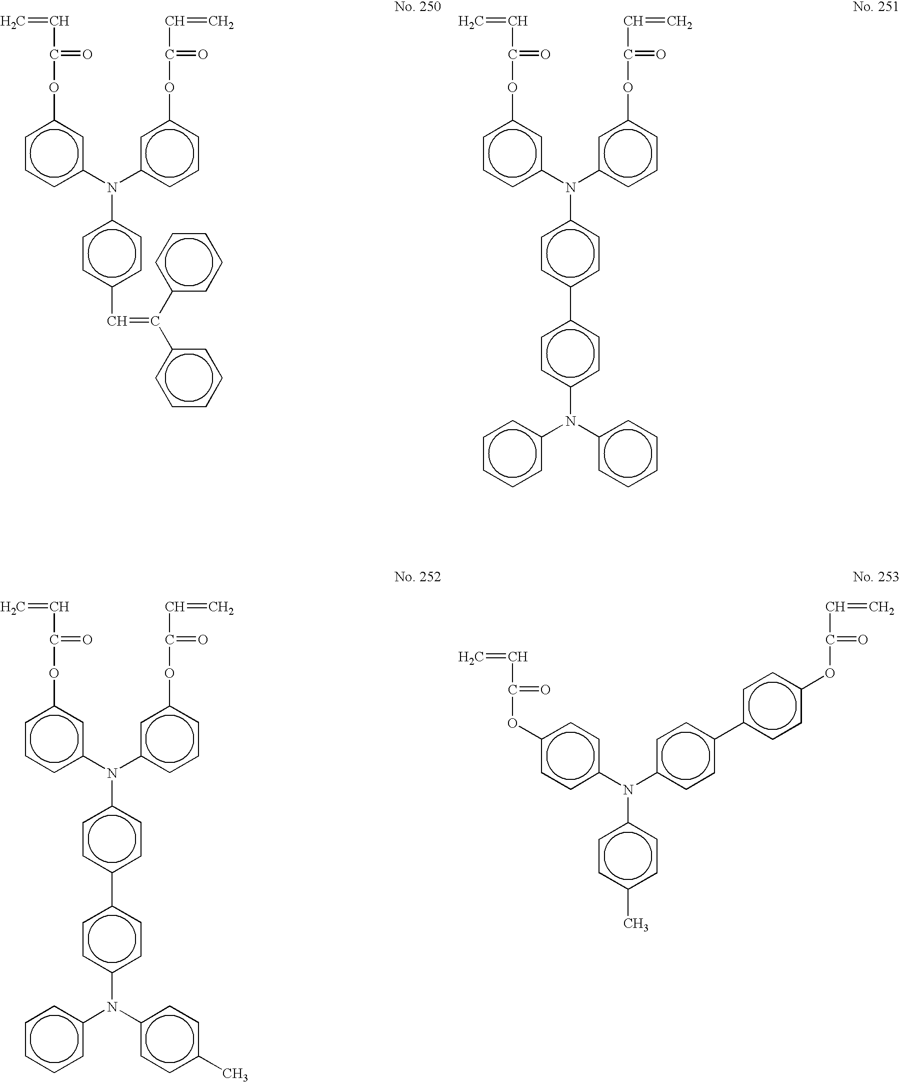

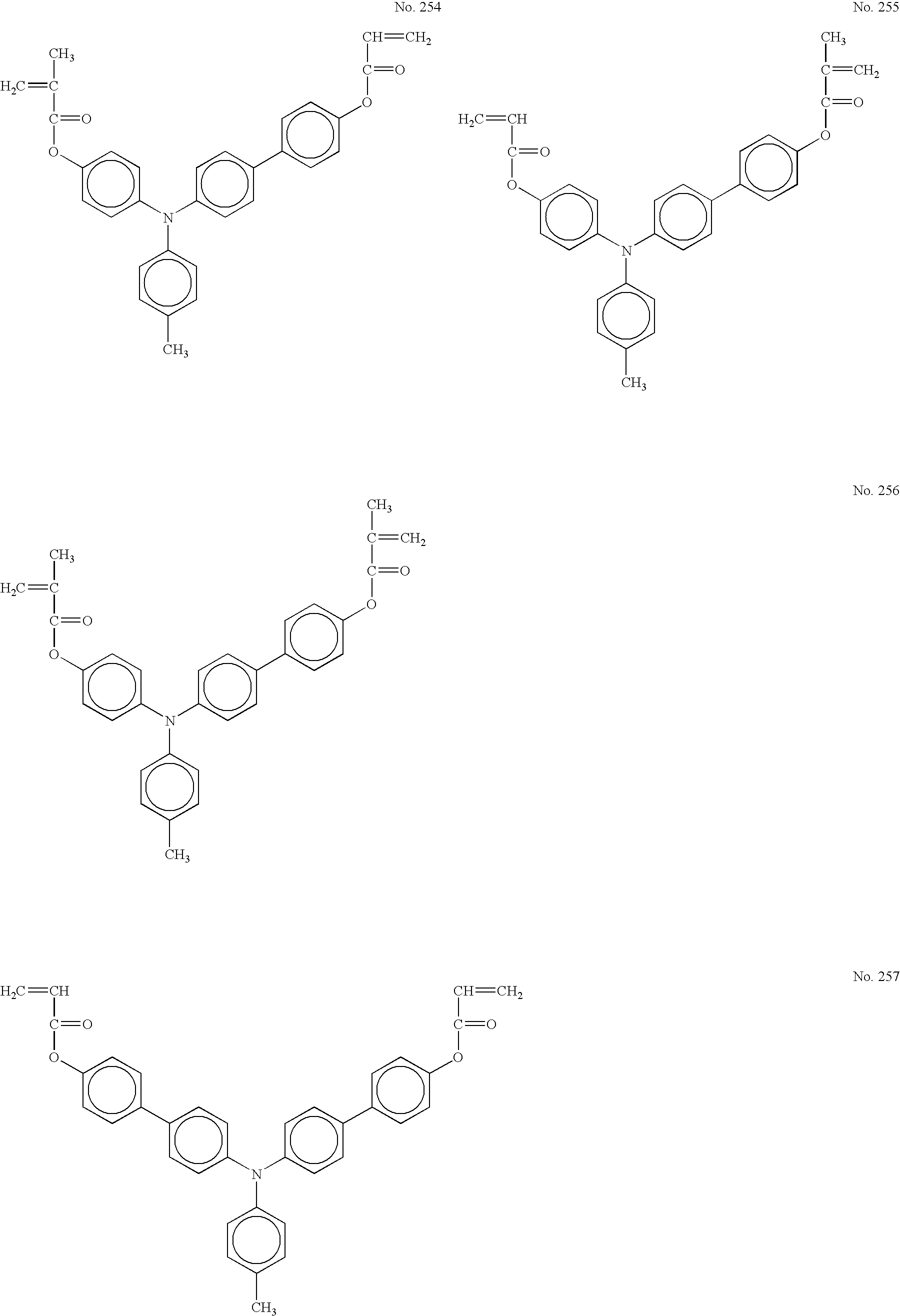

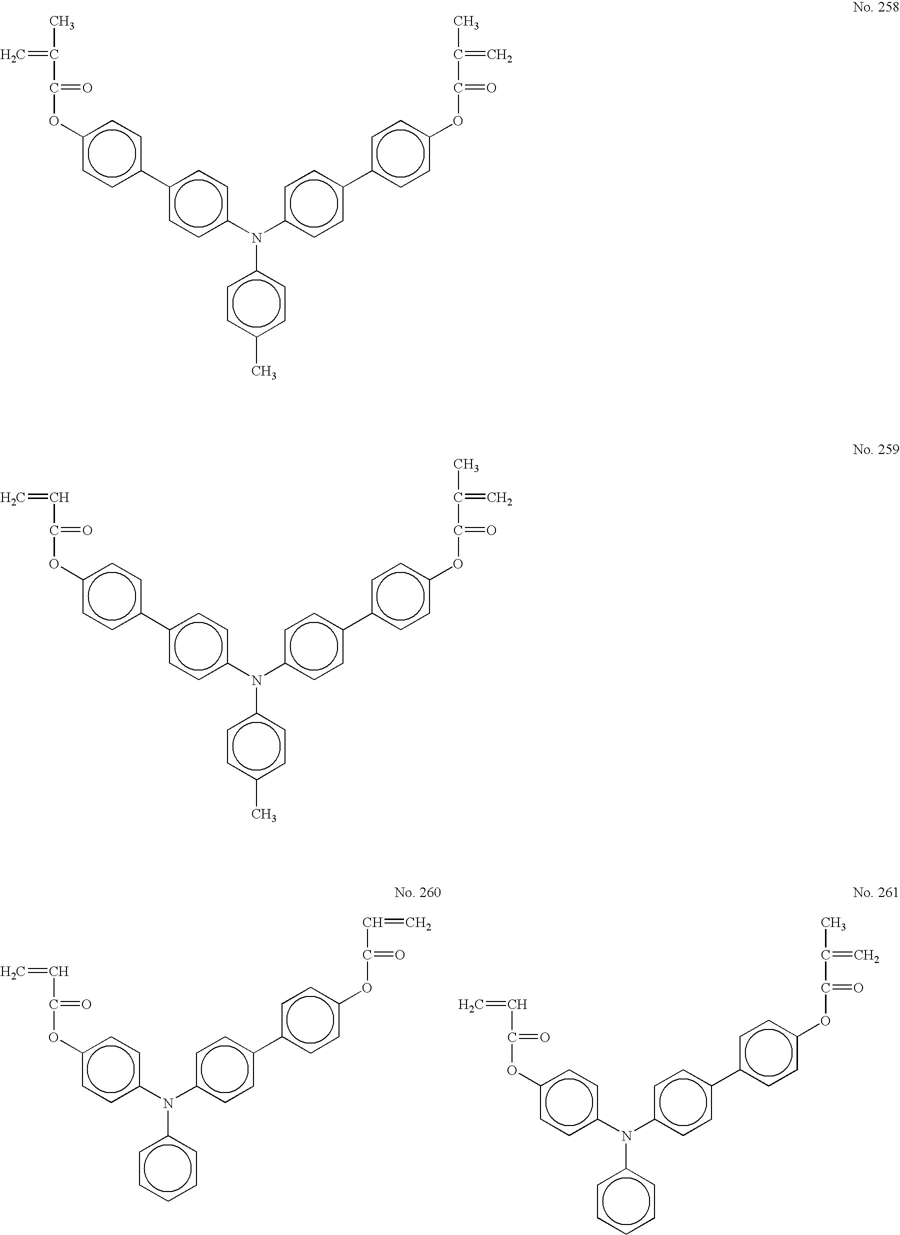

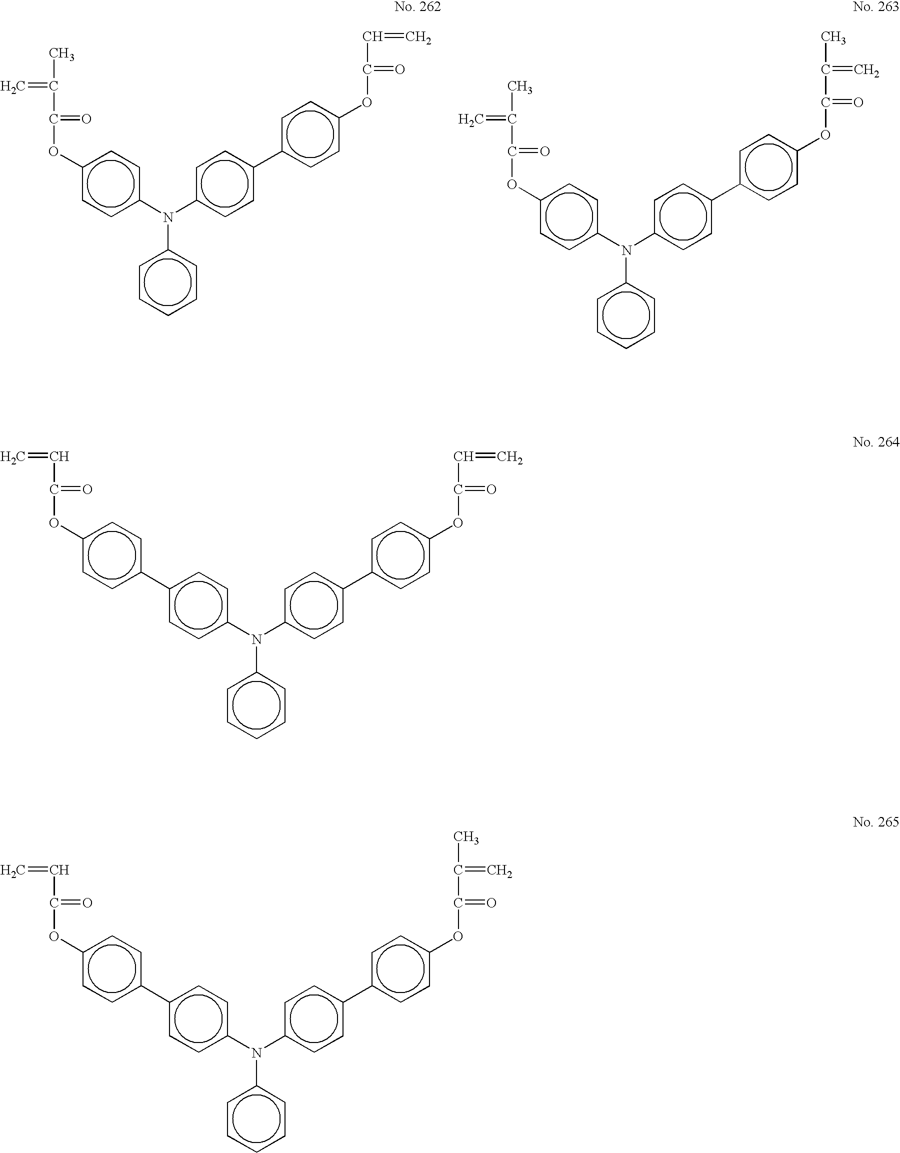

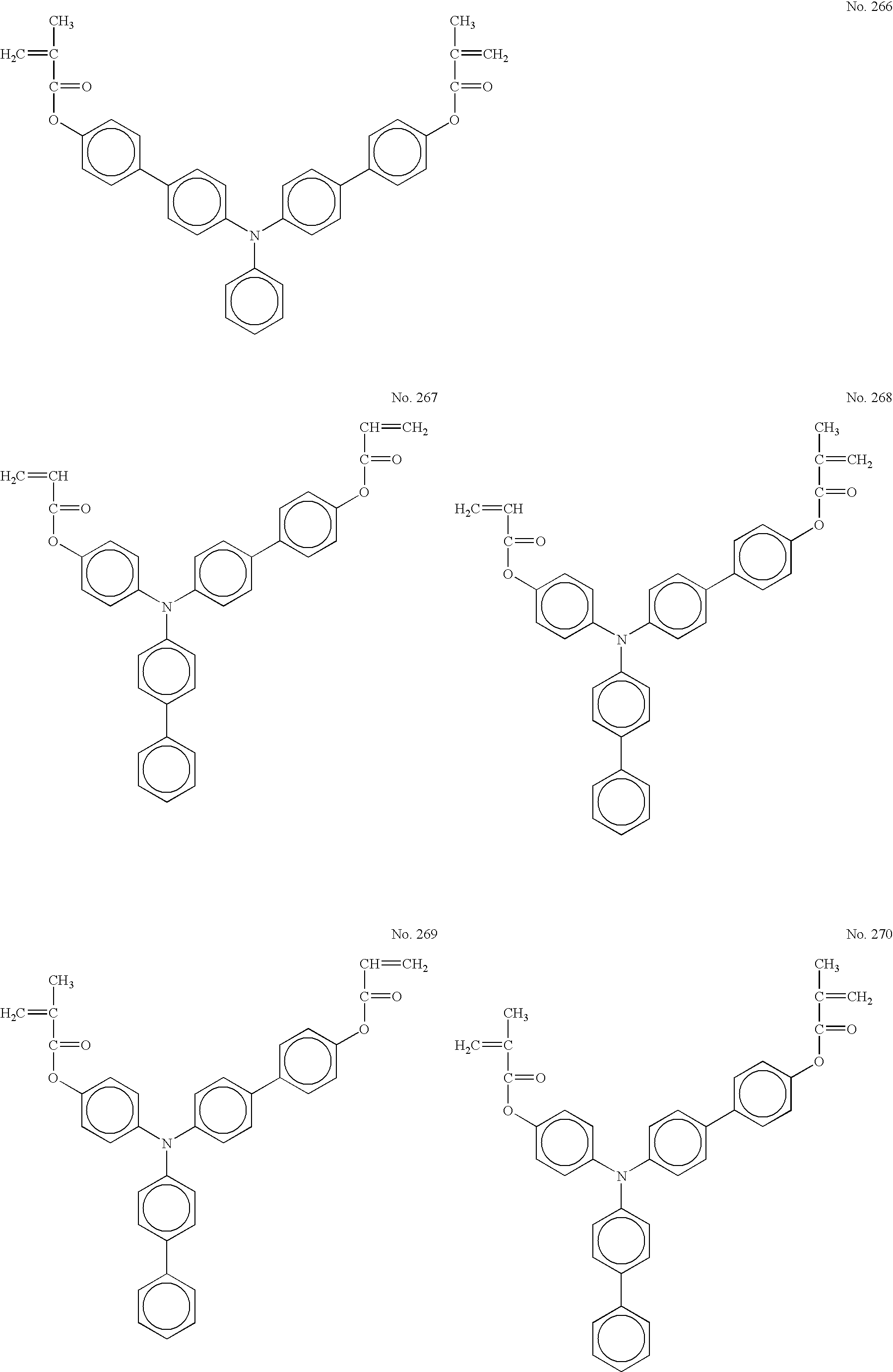

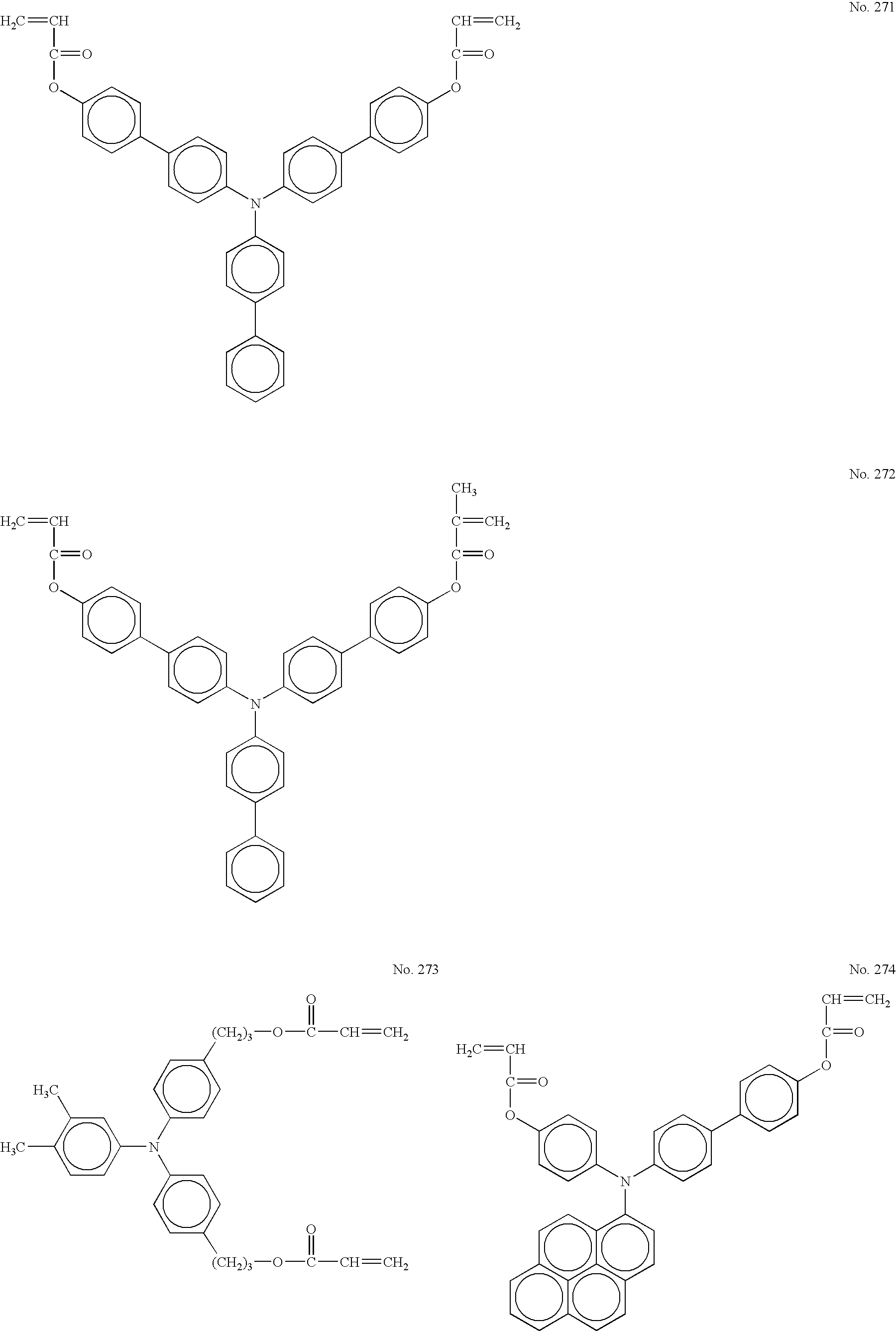

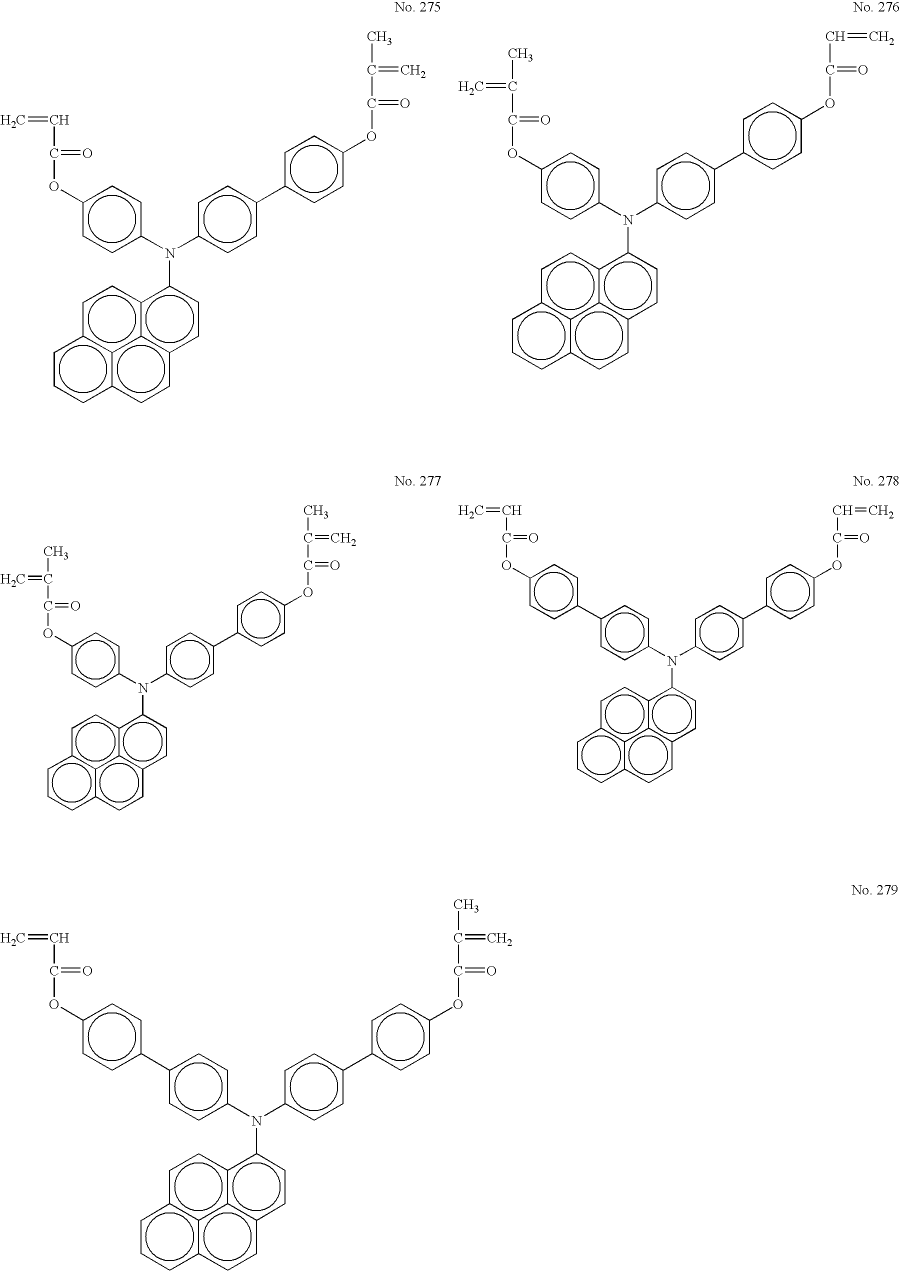

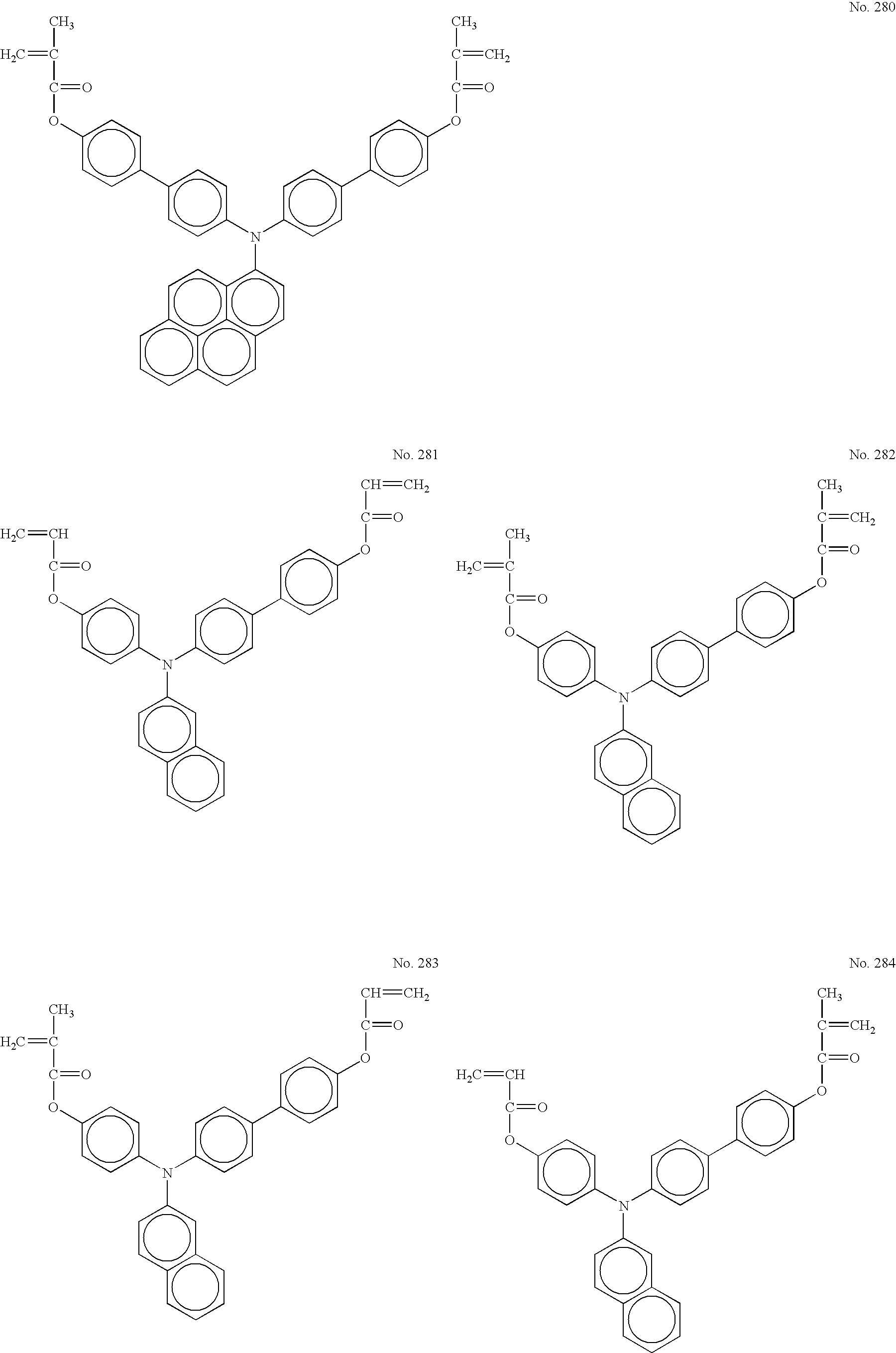

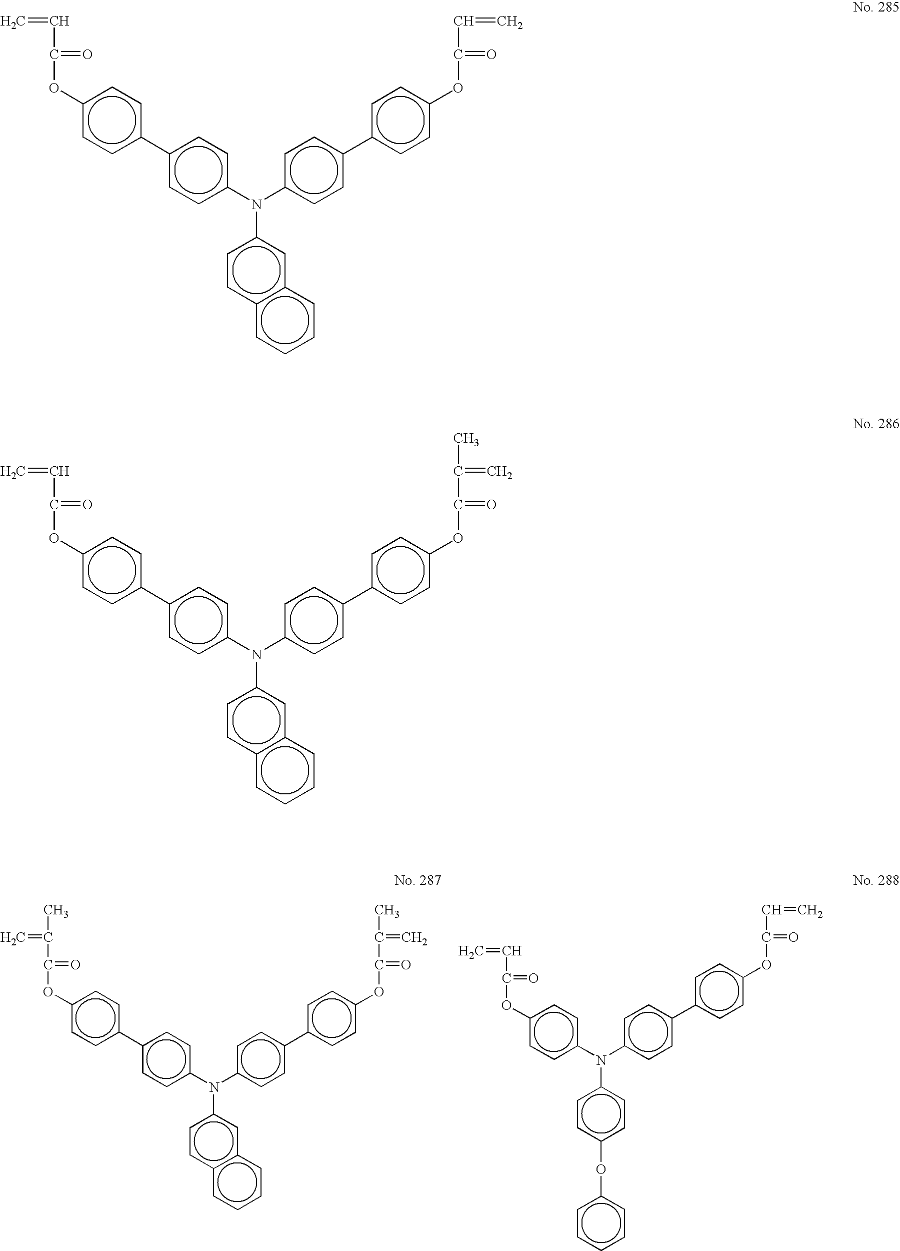

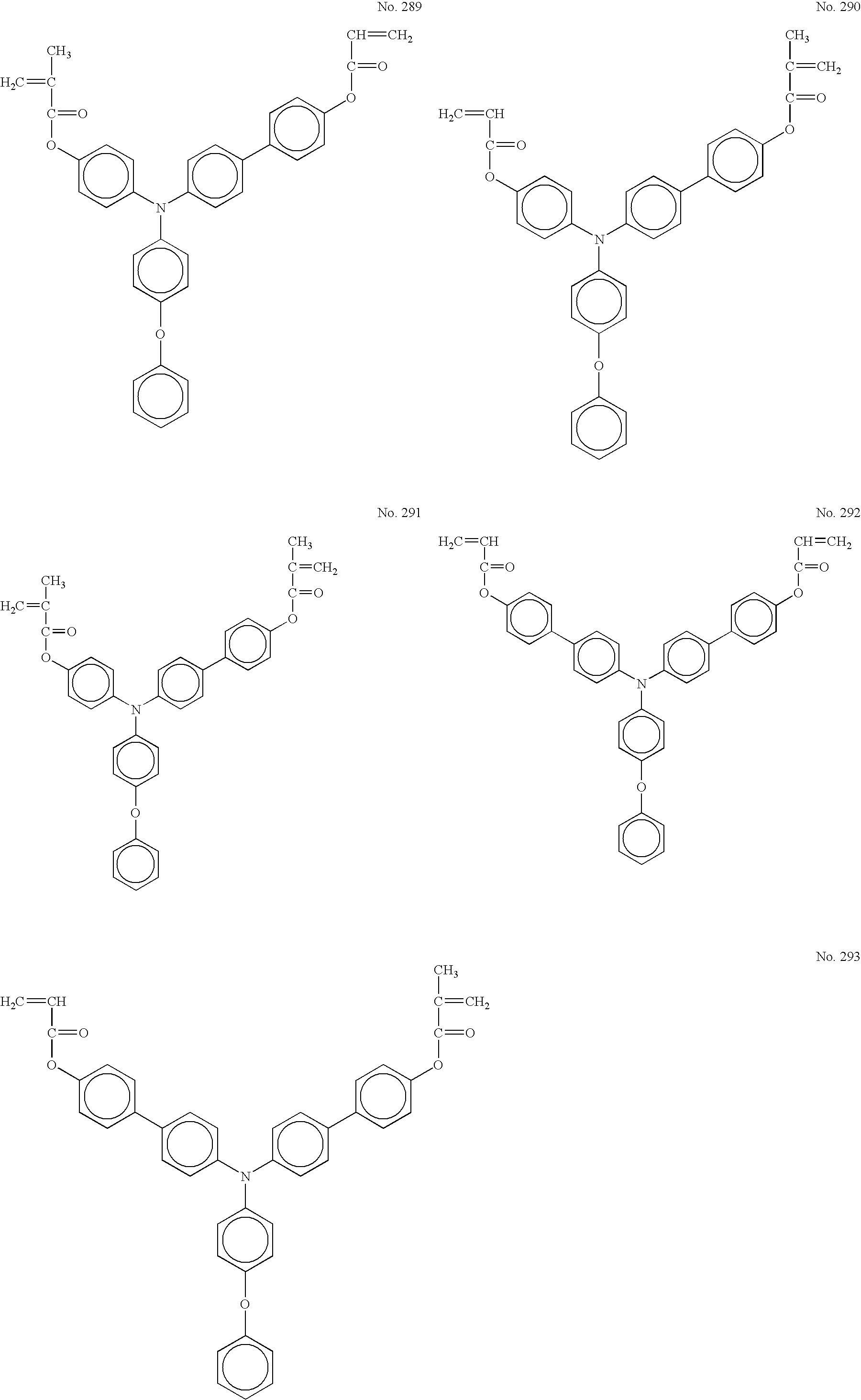

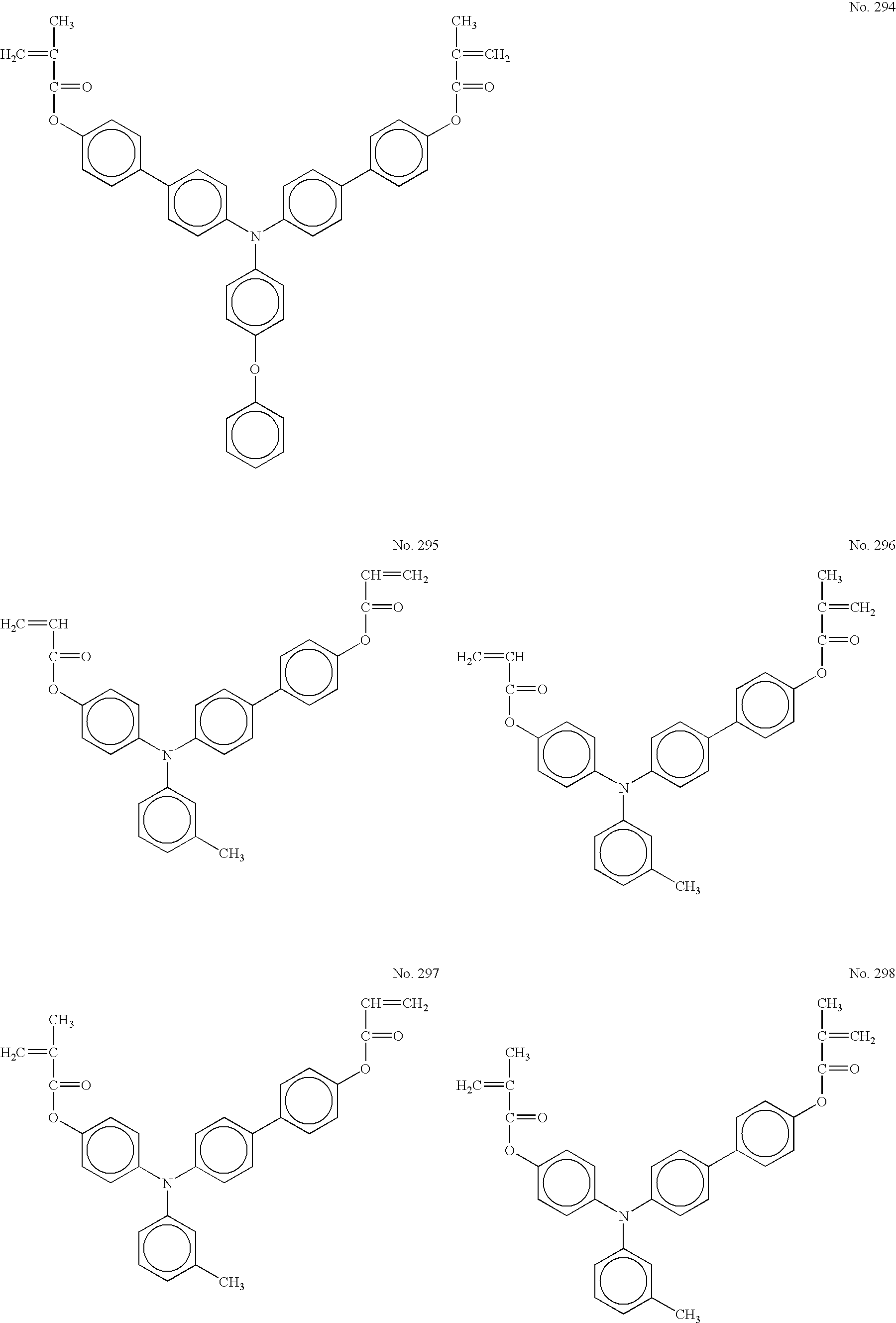

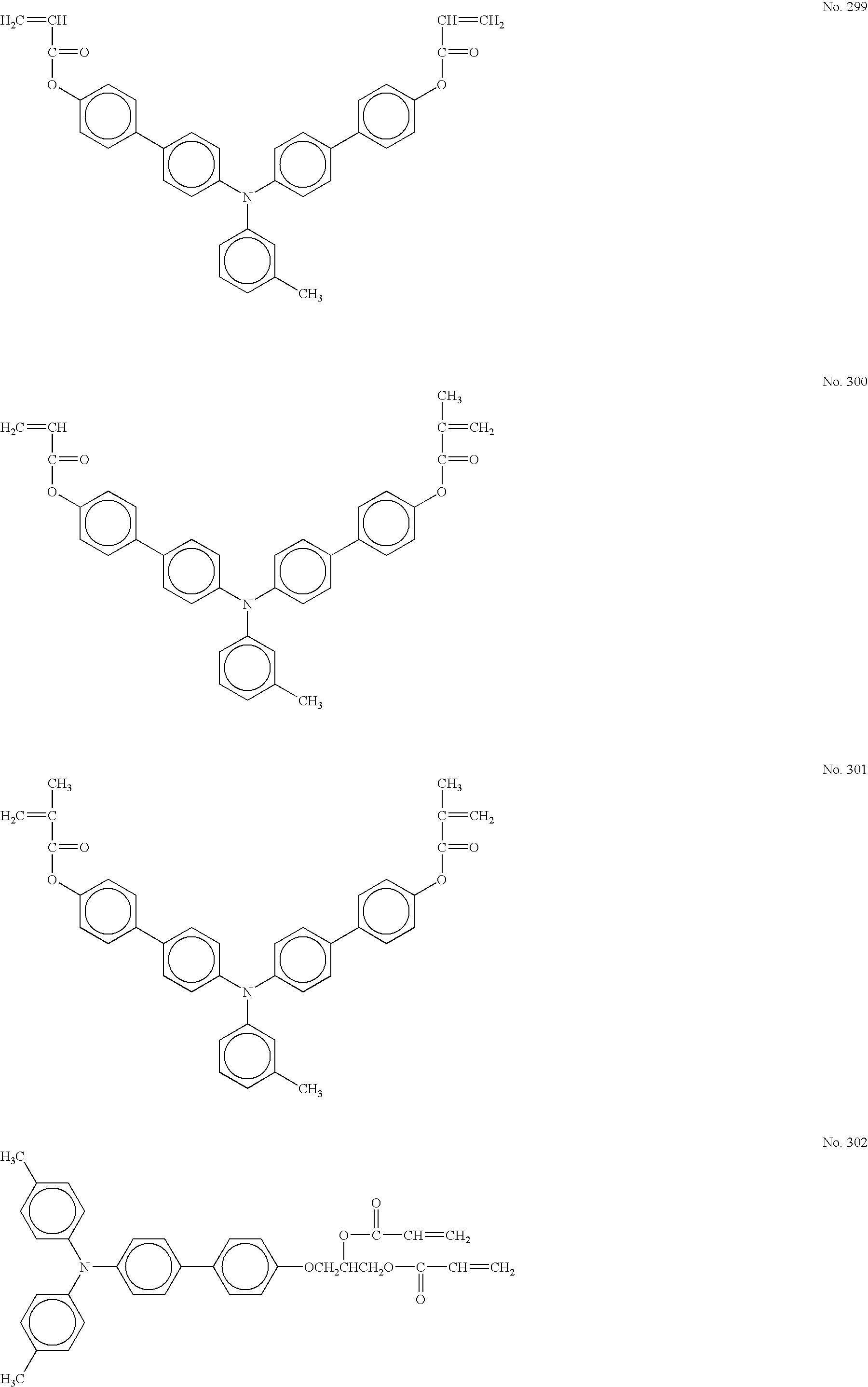

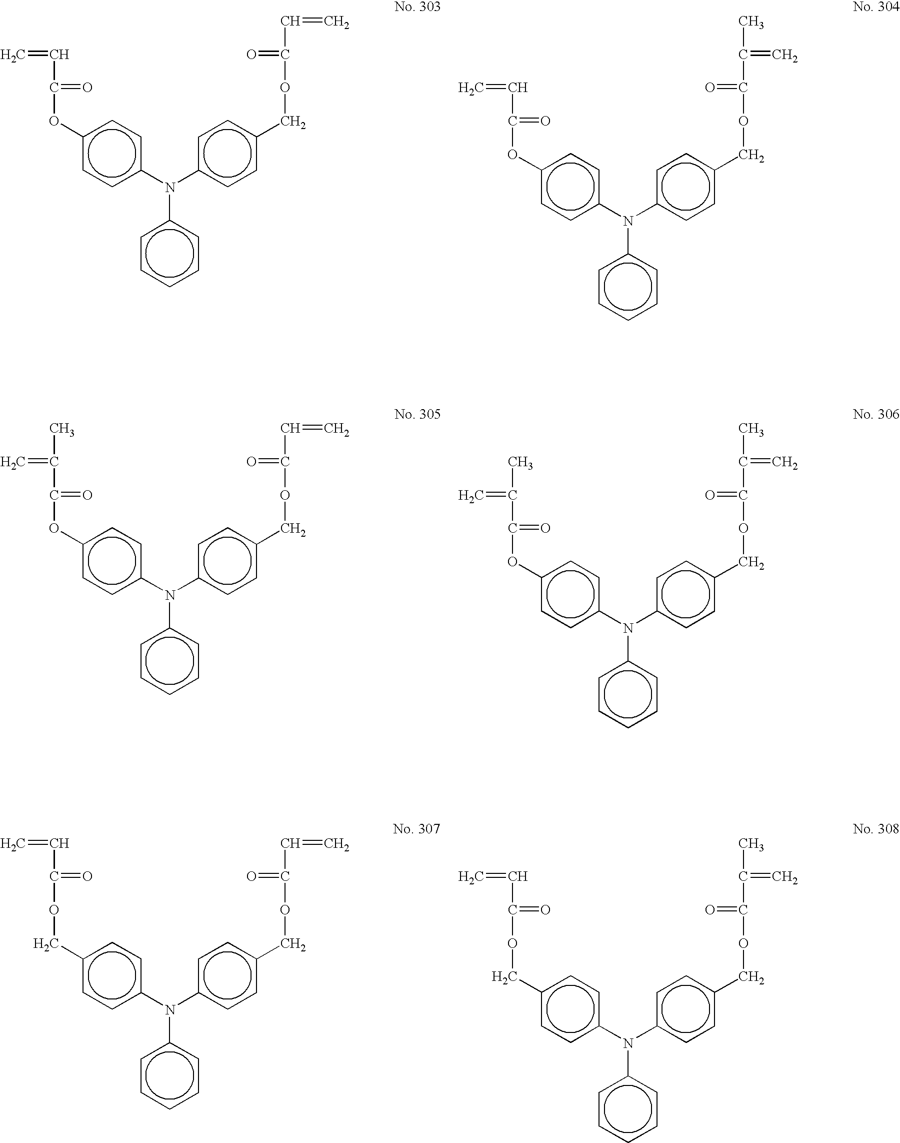

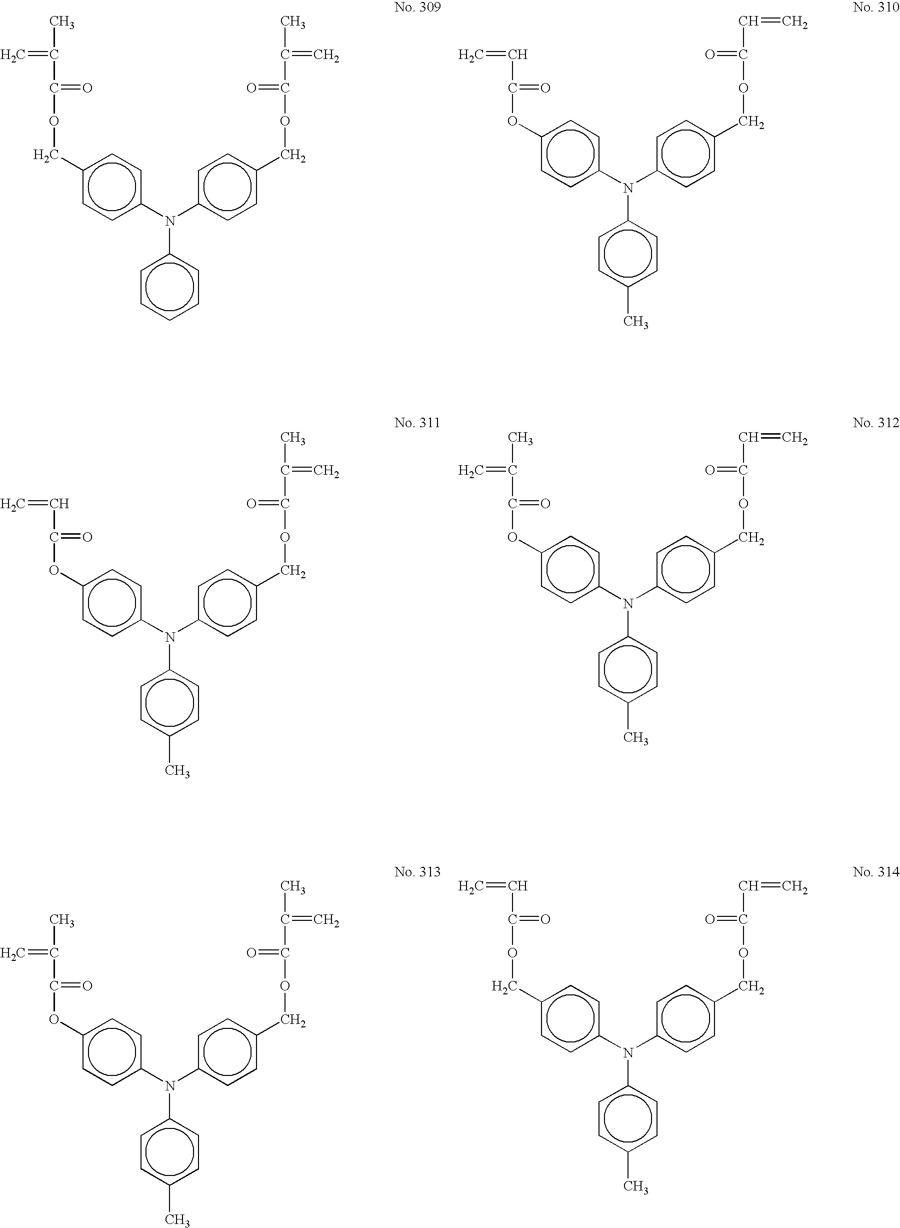

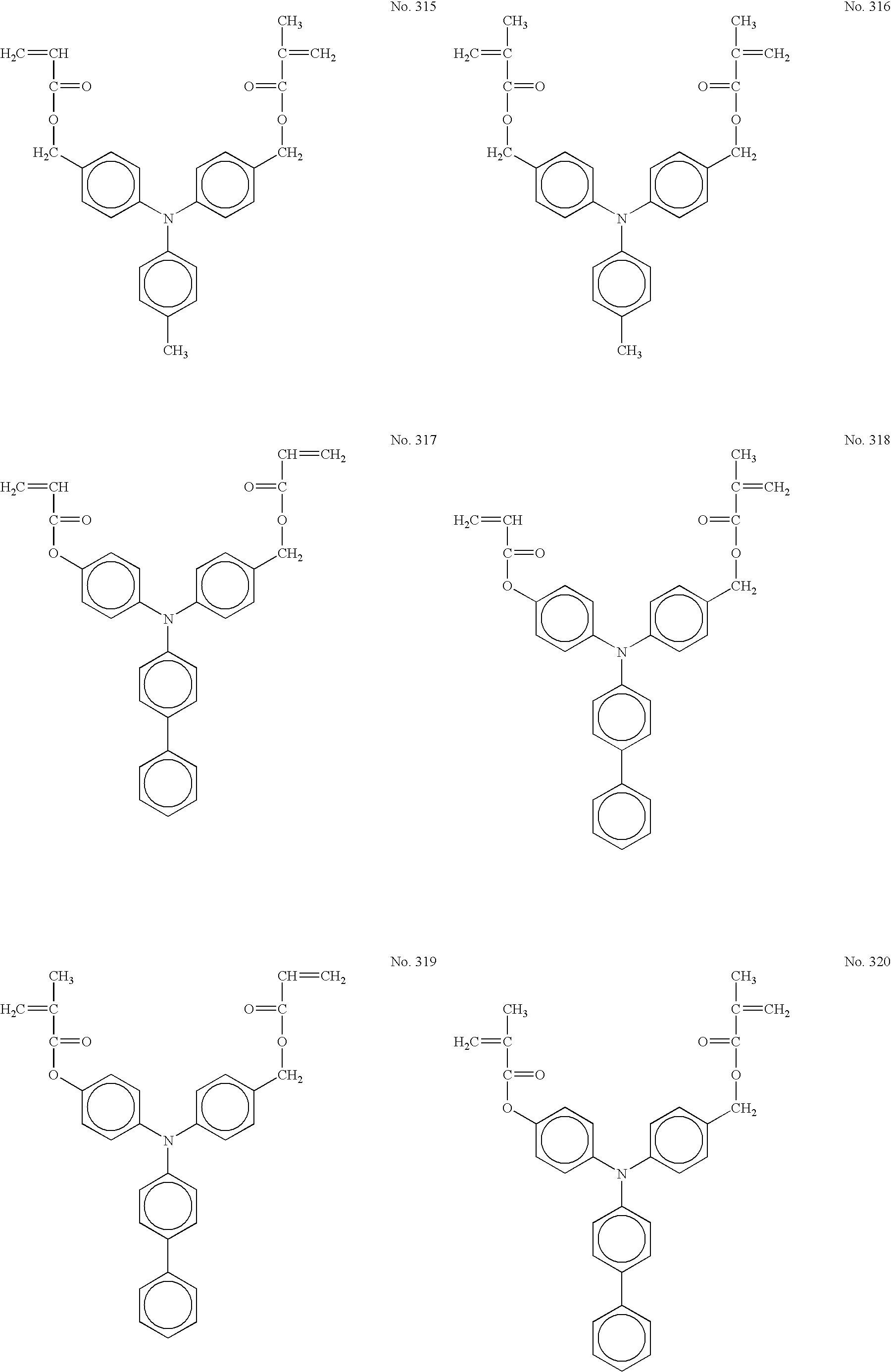

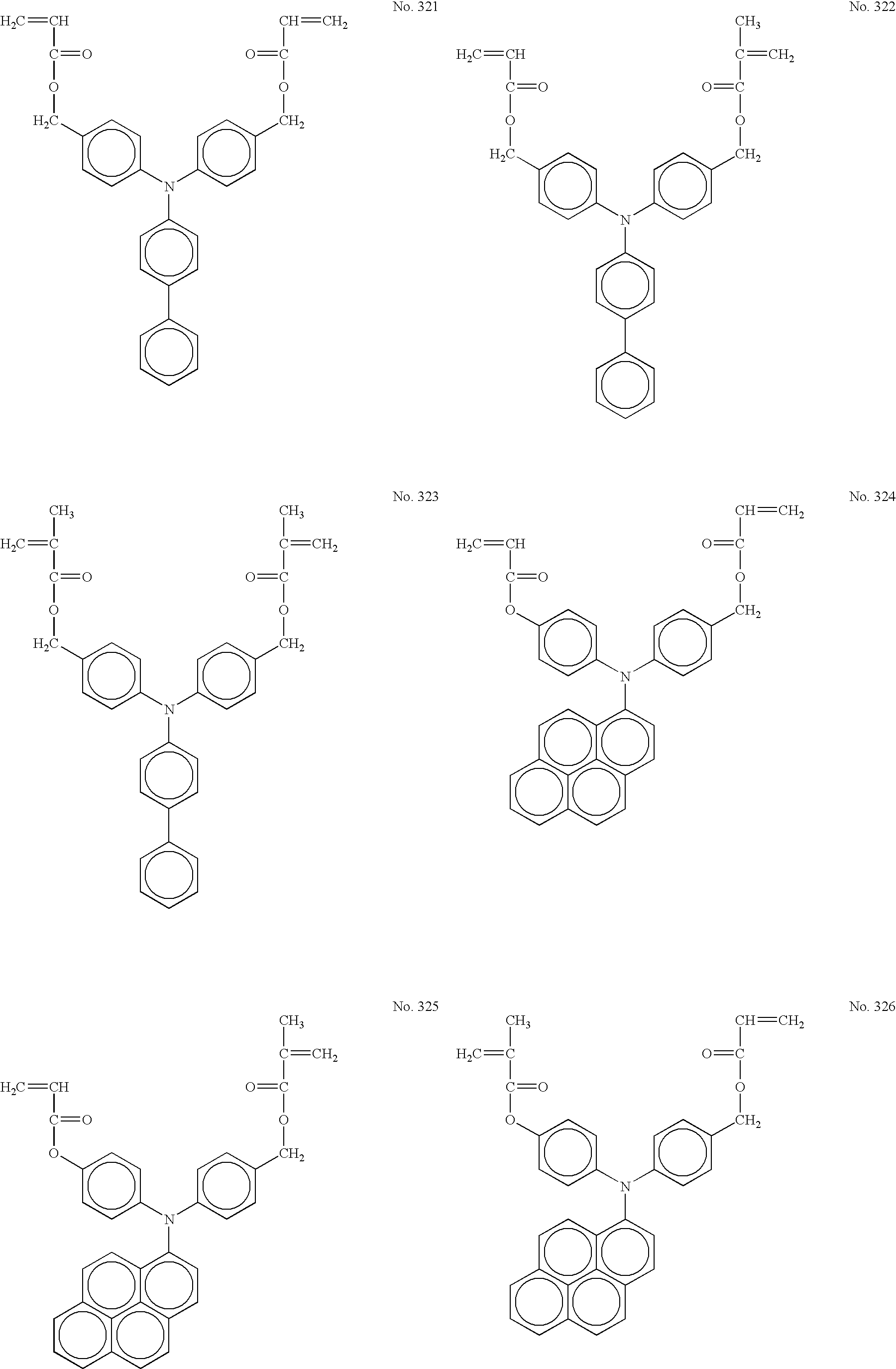

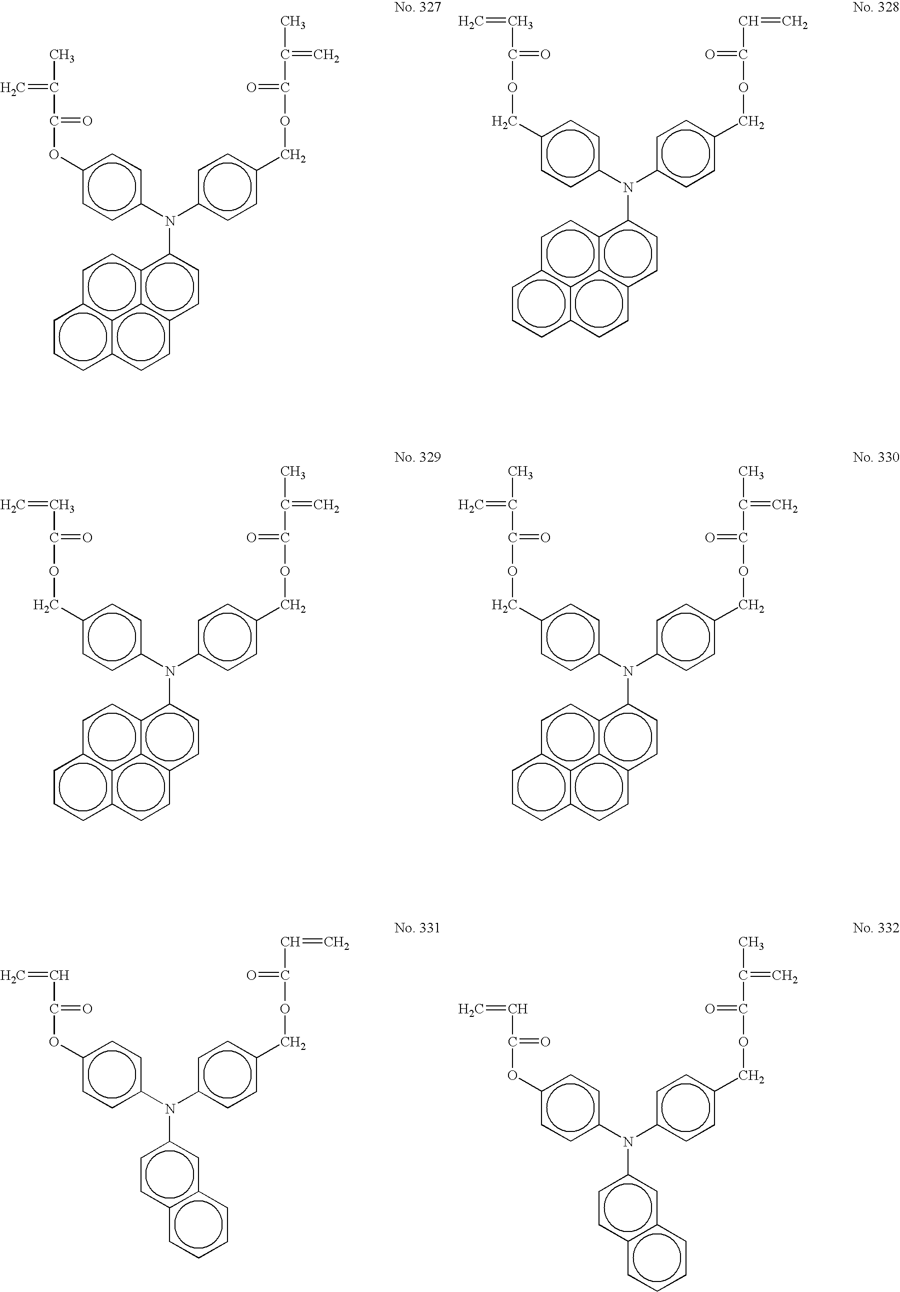

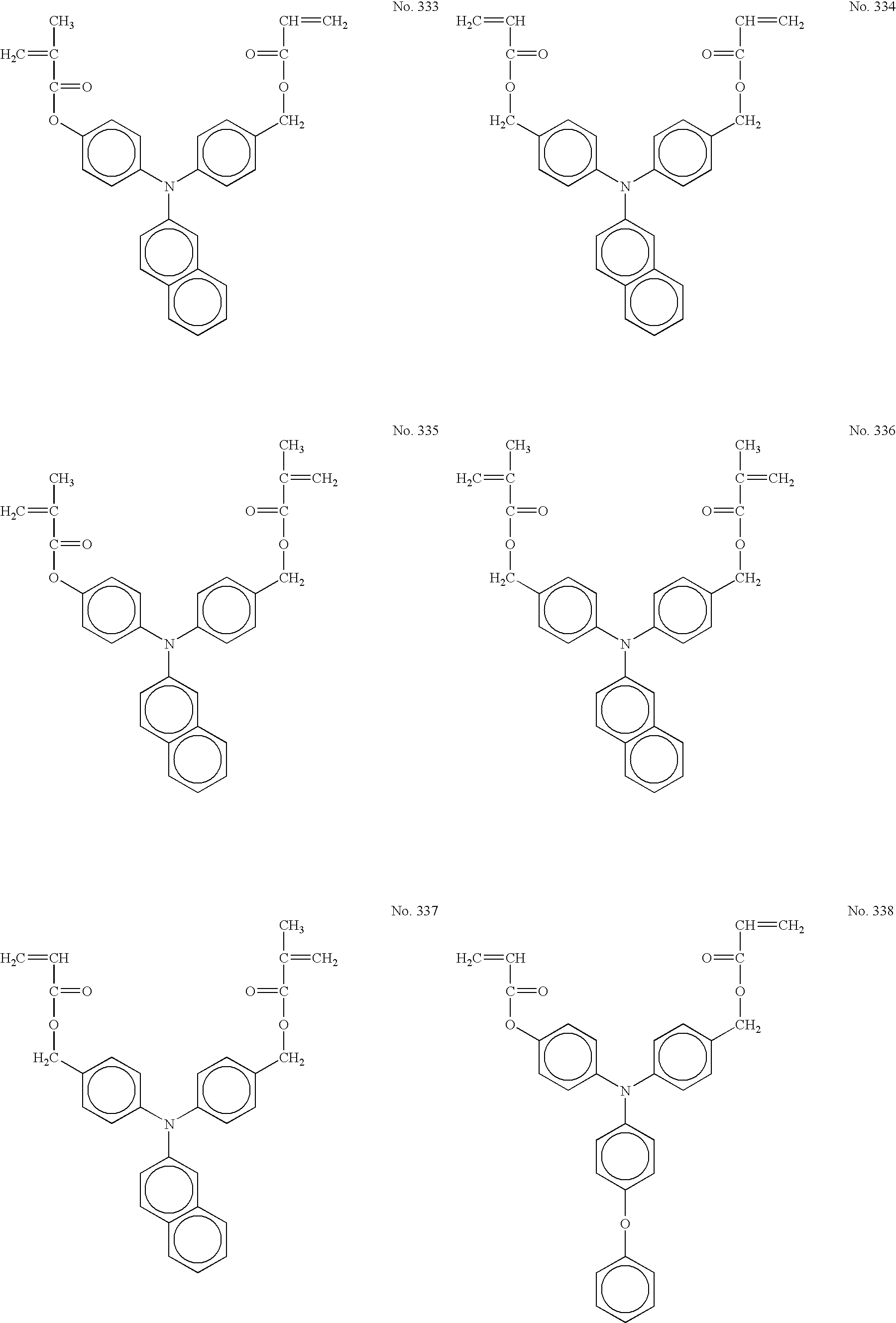

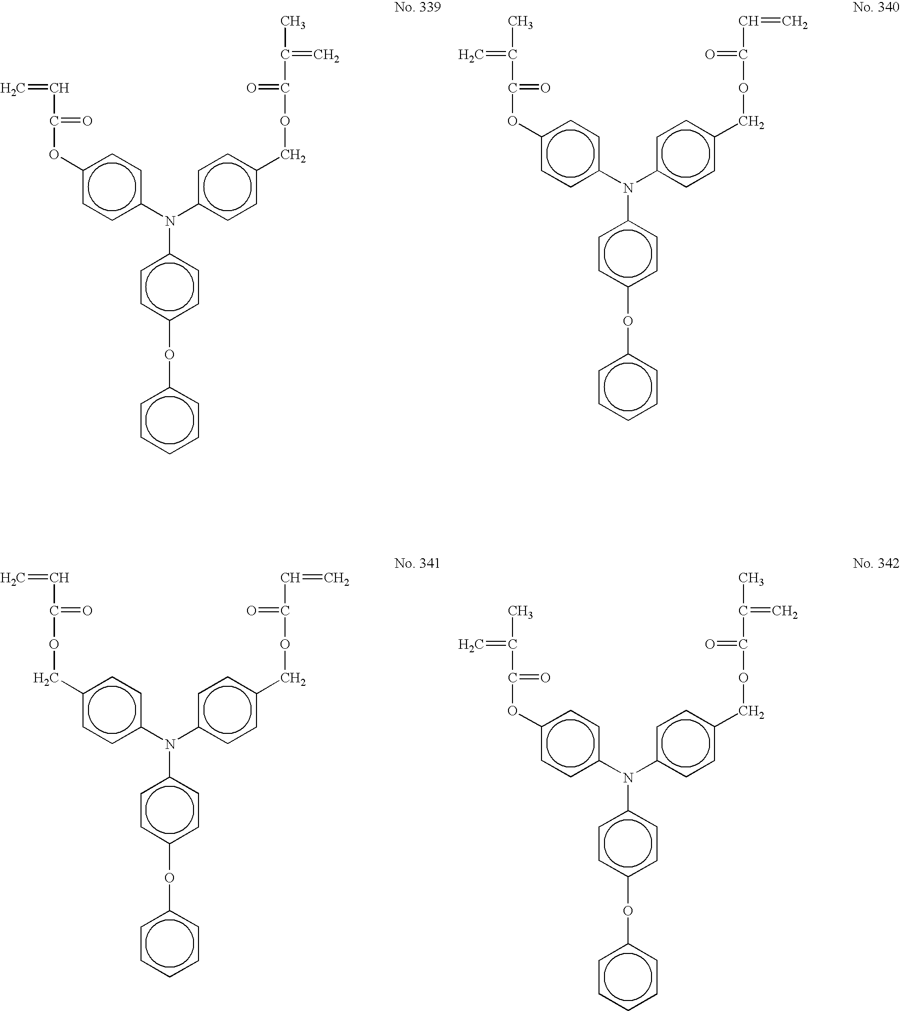

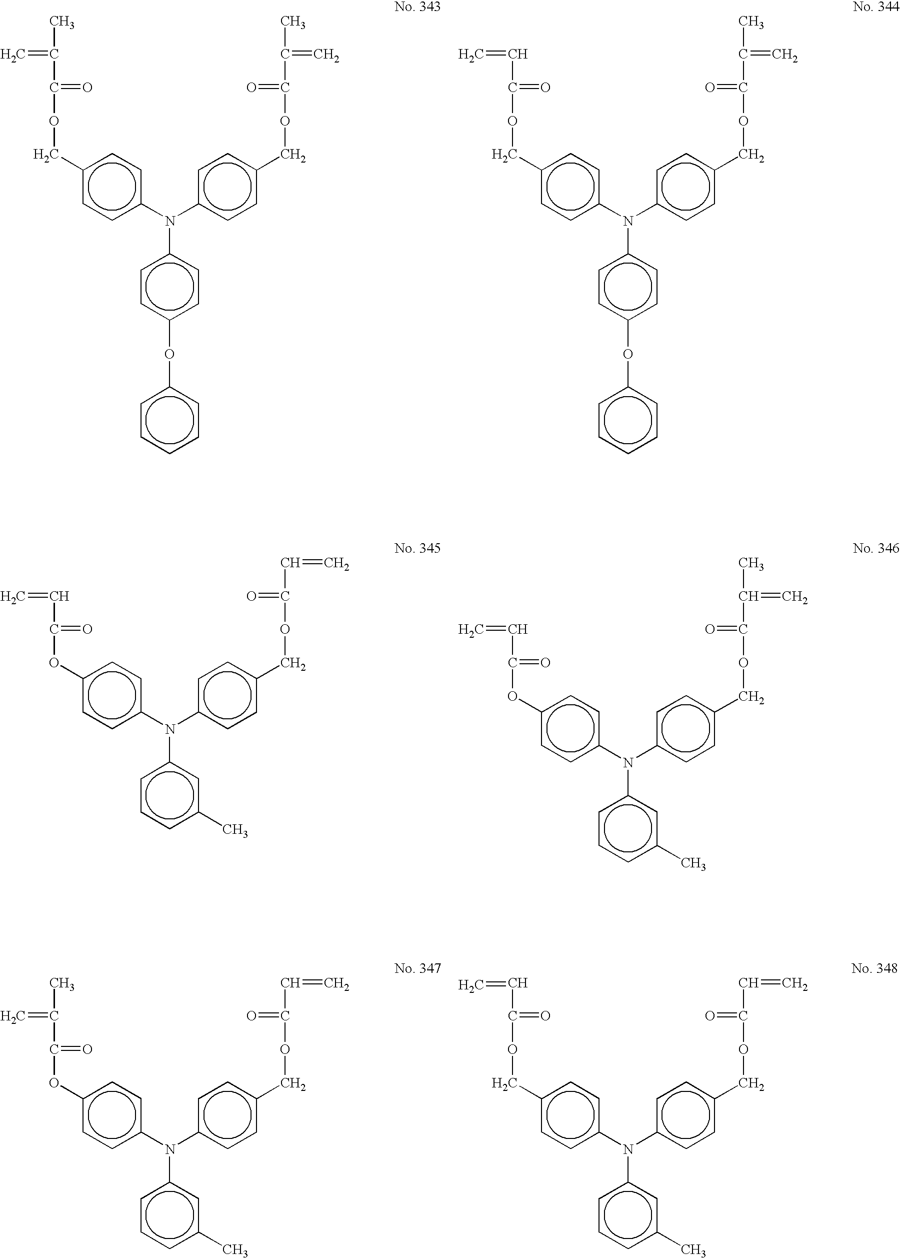

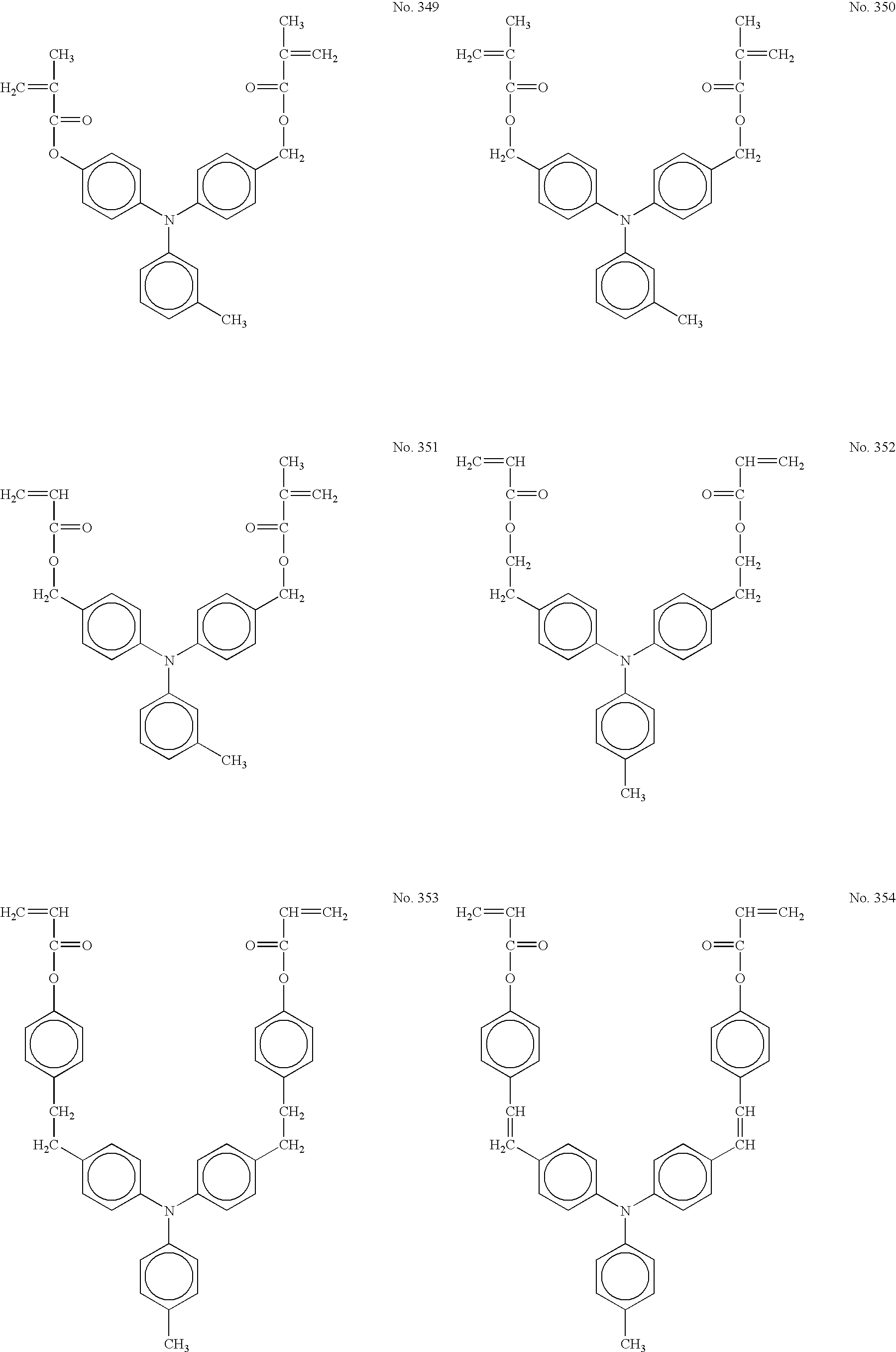

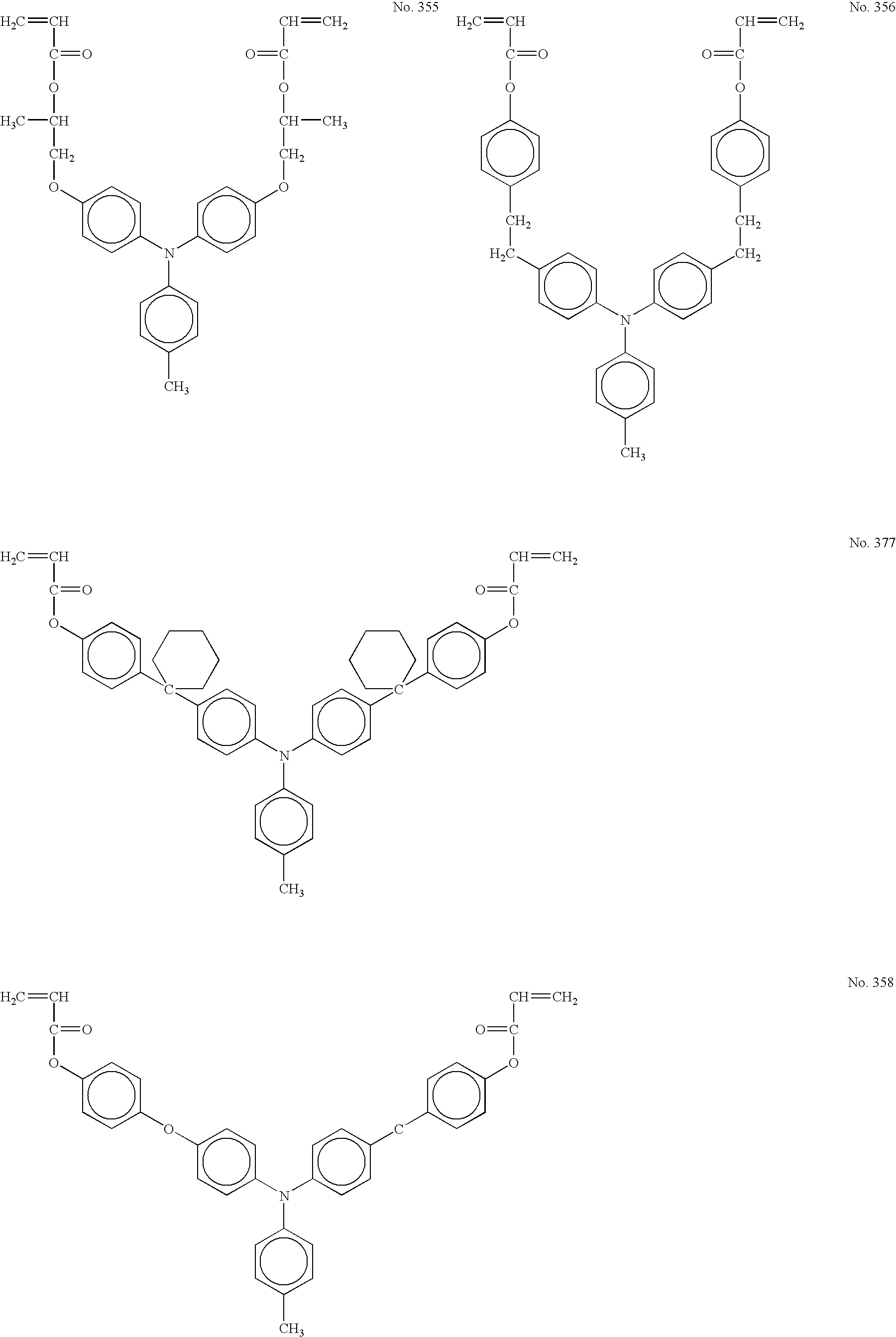

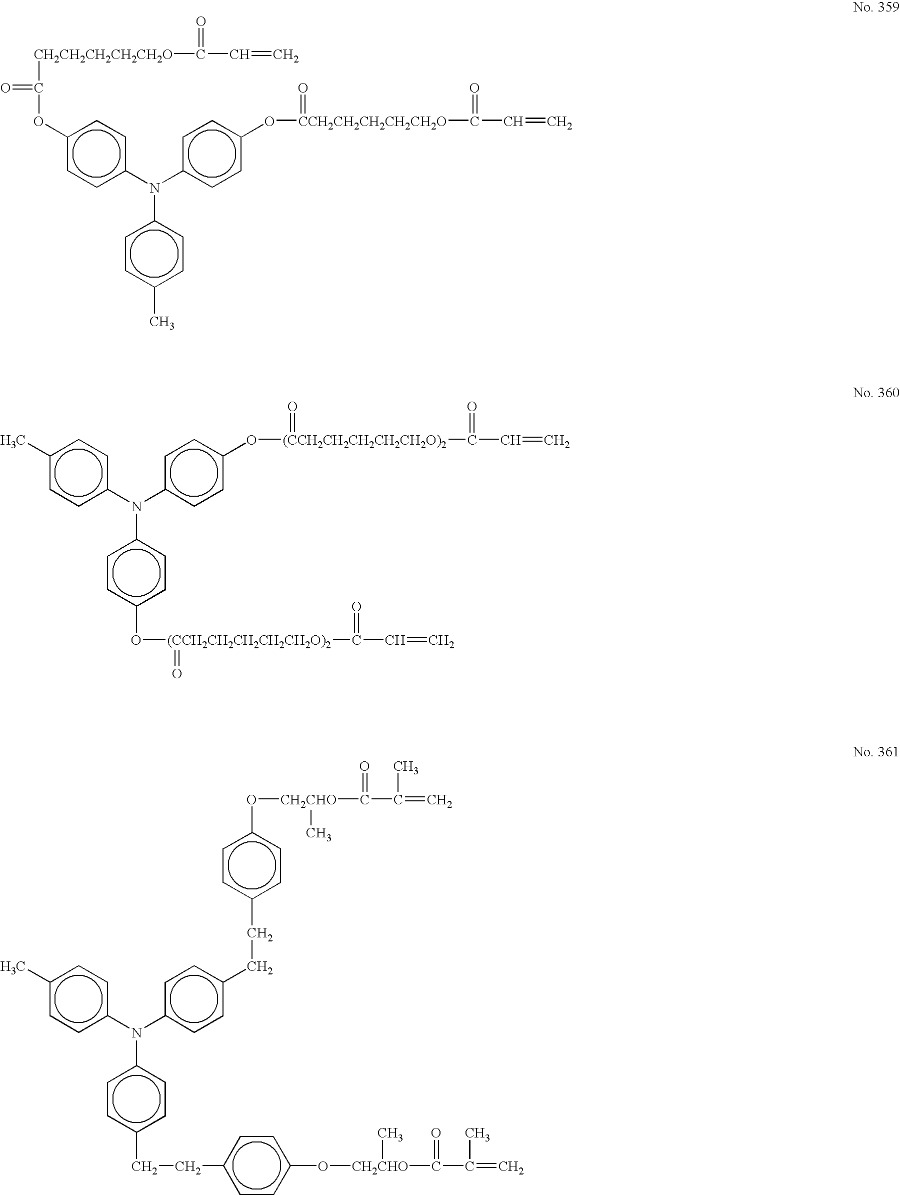

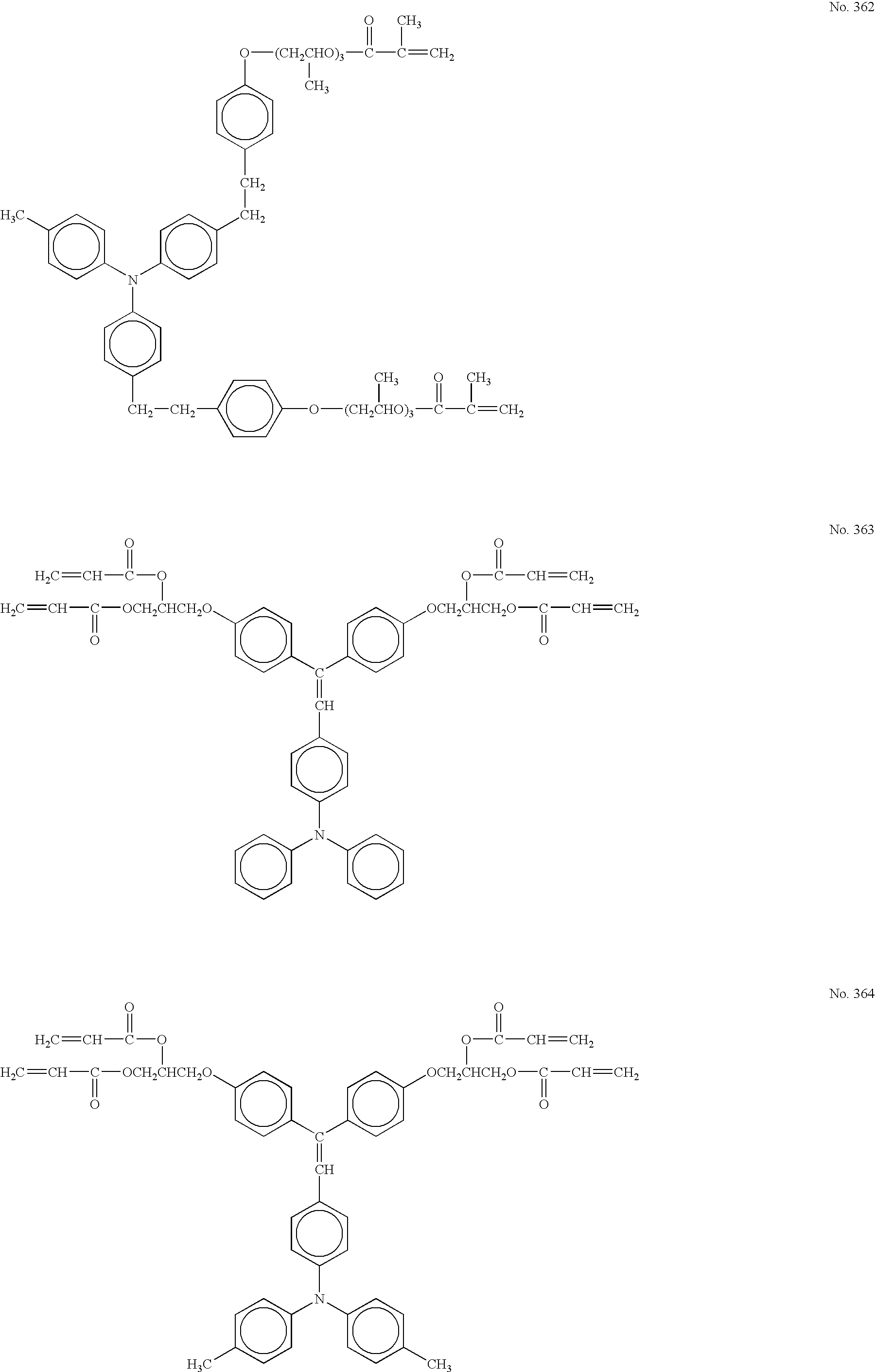

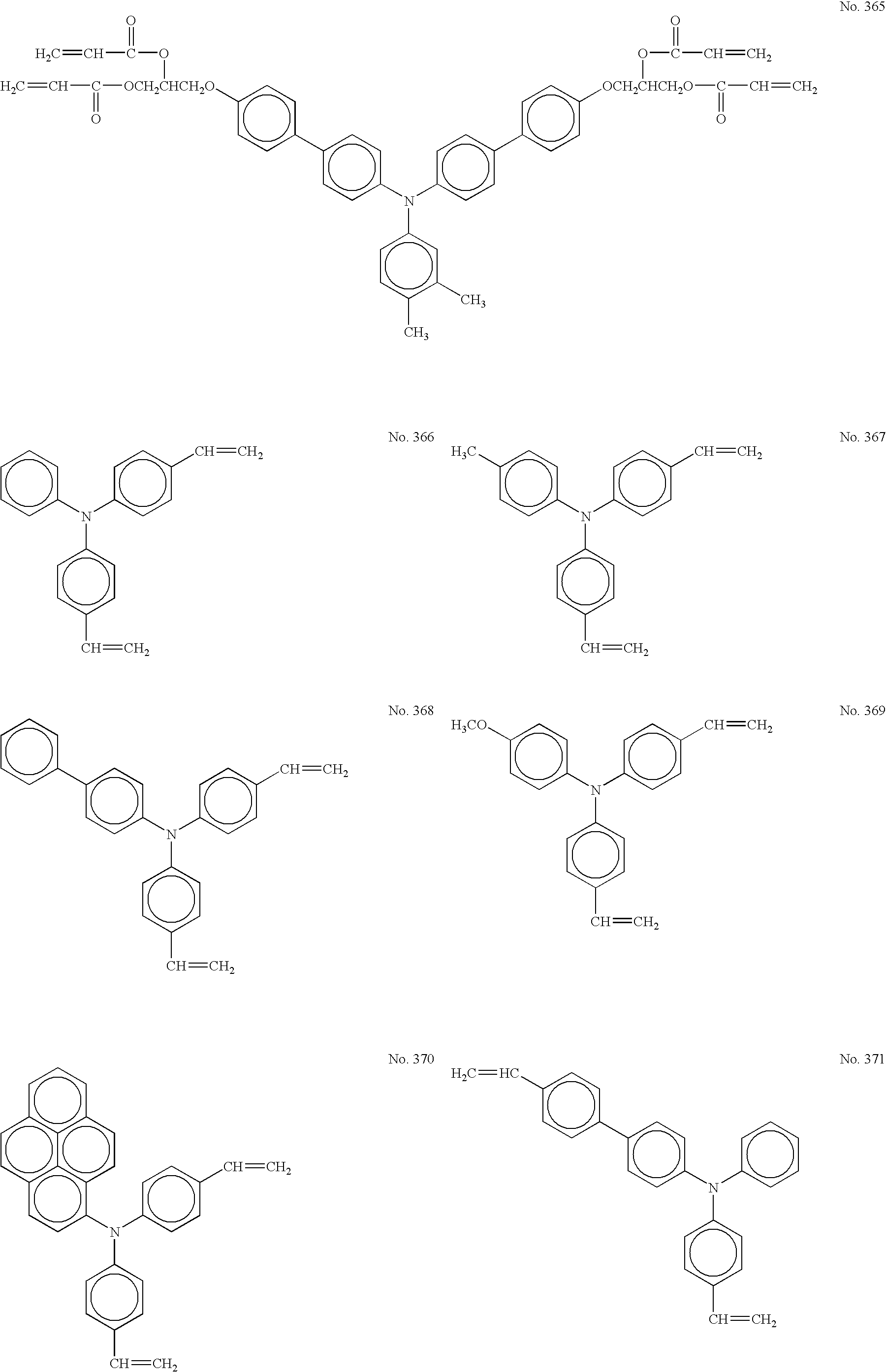

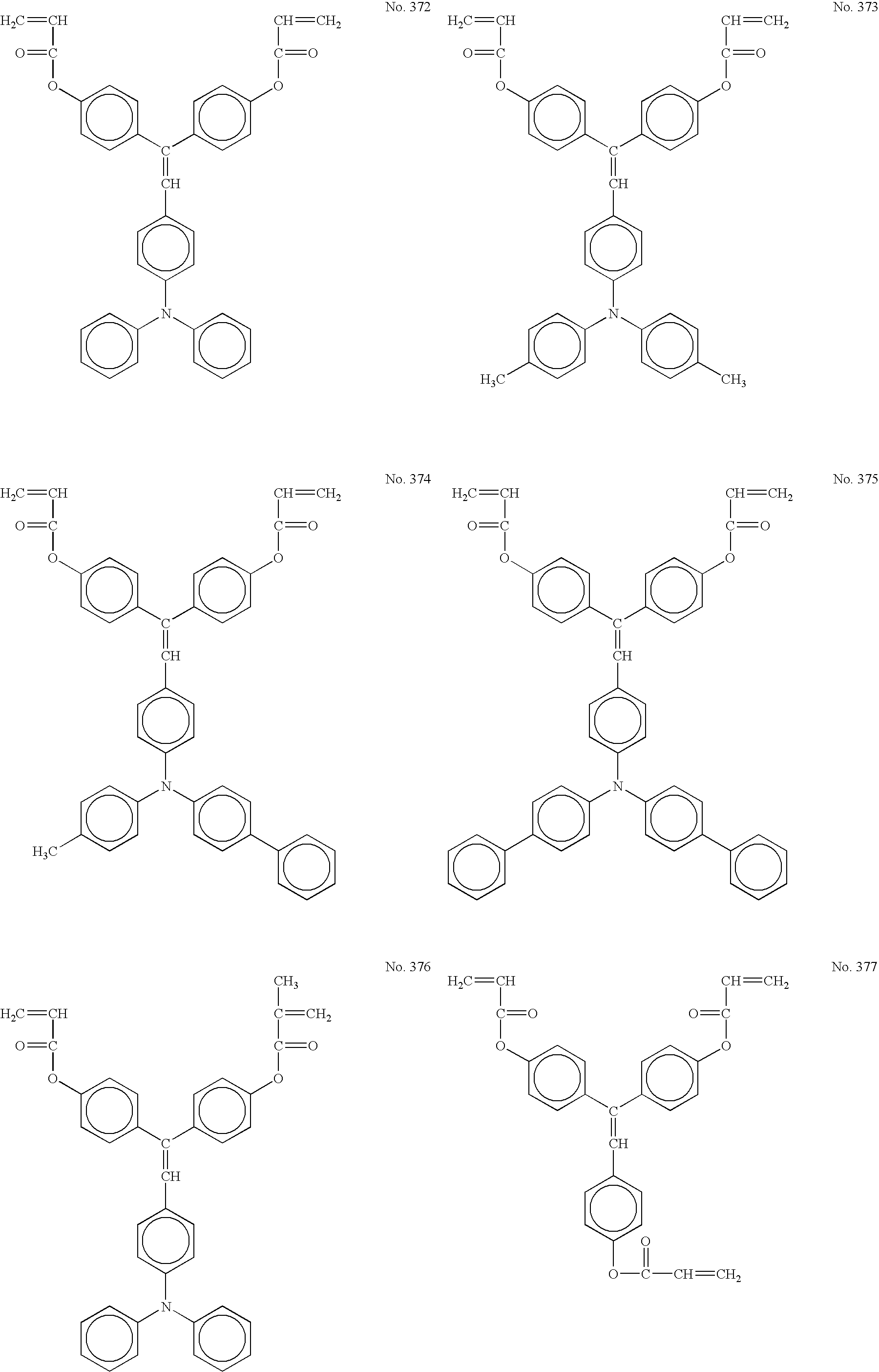

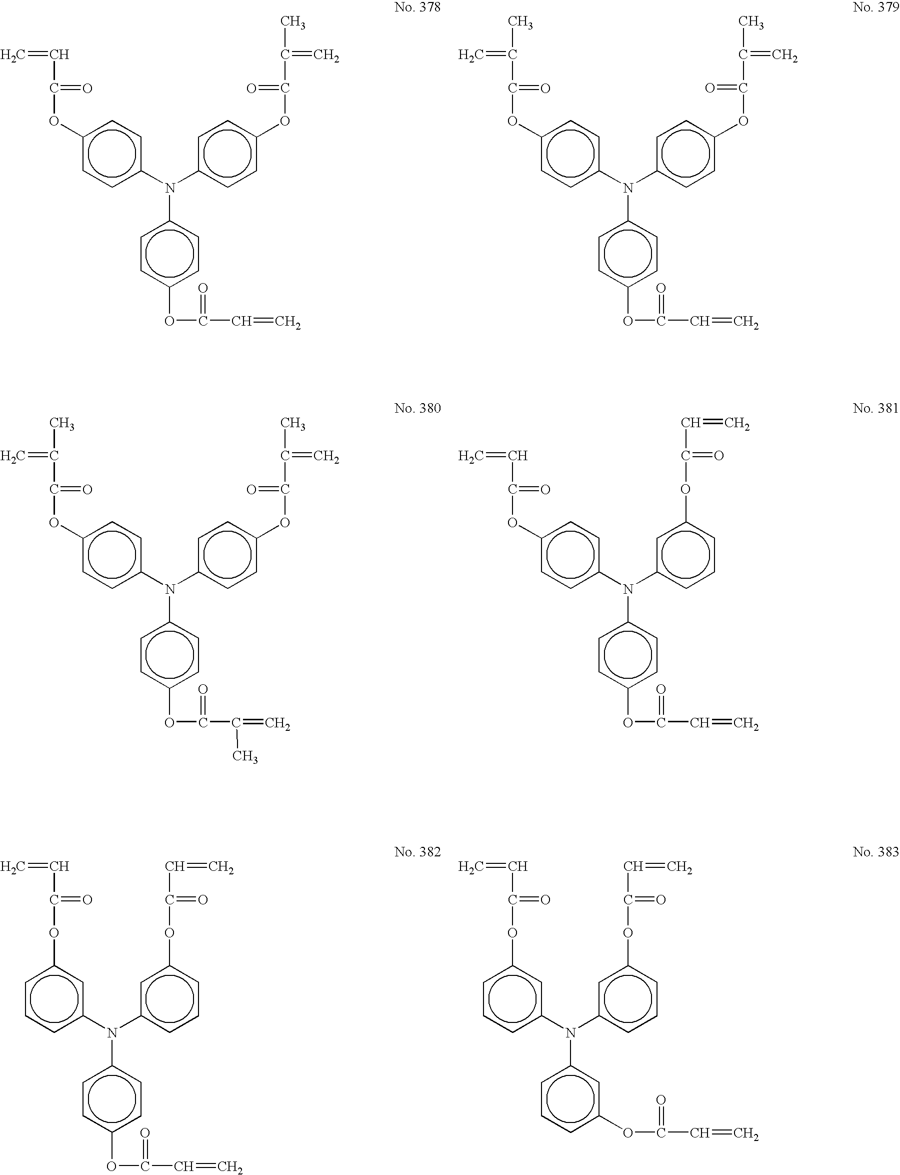

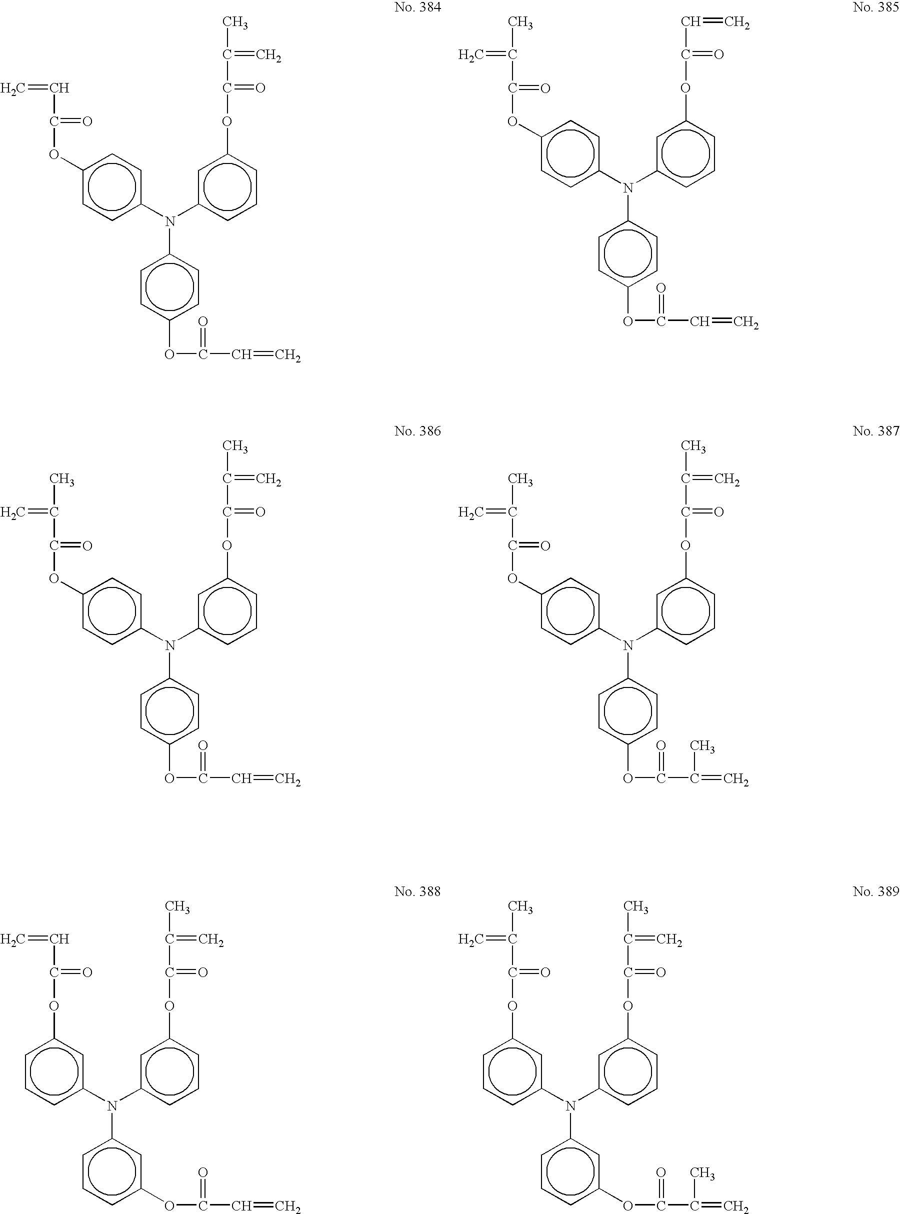

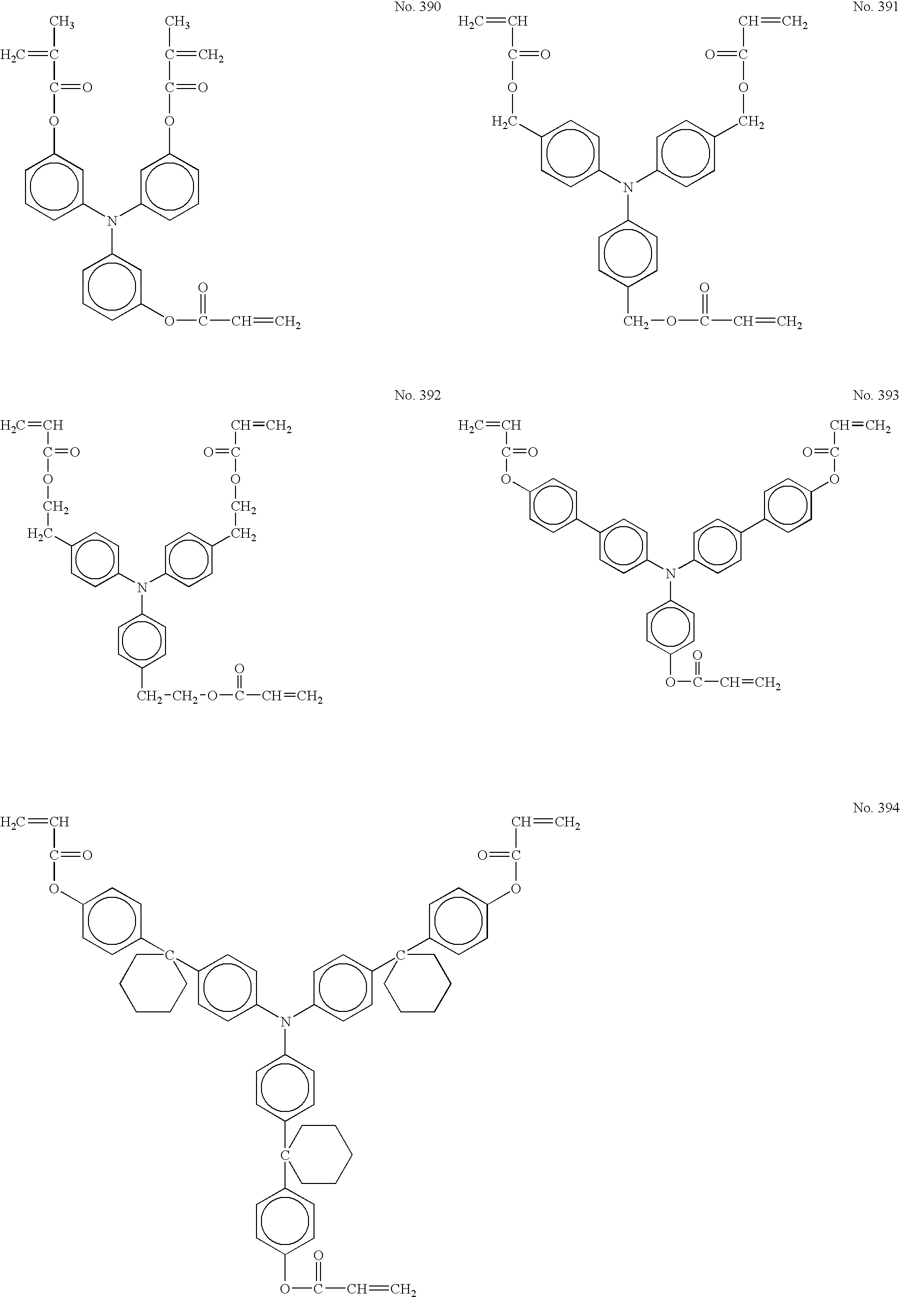

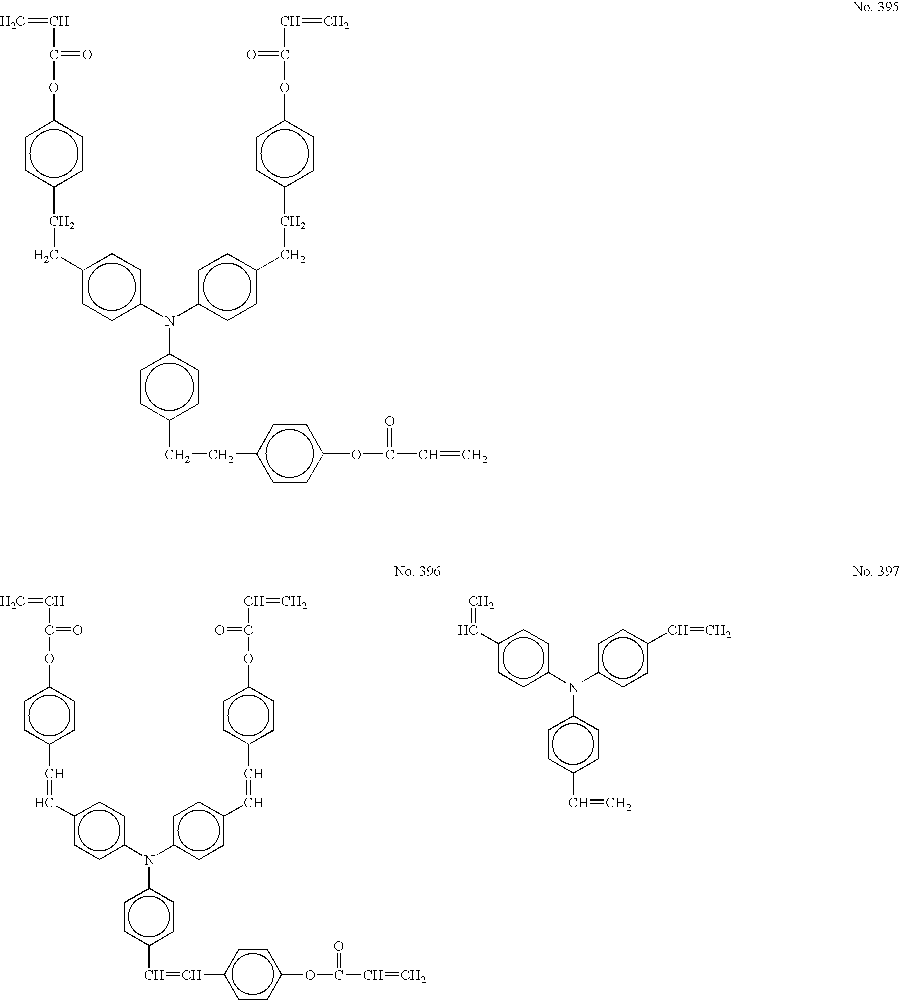

The cross-linked charge transport layer includes the radical-polymerizable compound having a charge transport structure components in an amount of 20 to 80% by weight, and preferably 30 to 70% by weight. When the amount is too small, the resultant cross-linked charge transport layer has poor charge transport ability, thereby degrading sensitivity and electric properties in repeated use. When the amount is too large, the resultant cross-linked charge transport layer includes too small an amount of the radical-polymerizable monomer having no charge transport structure, thereby reducing cross-linking density, that is, abrasion resistance. It is most preferable that the amount of the radical-polymerizable compound having a charge transport structure components is 30 to 70% by weight in perspective.

As described above, it is most preferable to harden a trifunctional or more functional radical-polymerizable monomer having no charge transport structure and a monofunctional radical-polymerizable compound having a charge transport structure. In addition, monofunctional or difunctional radical-polymerizable monomers and oligomers can also be used.

Specific examples of suitable monofunctional radical-polymerizable monomers include, but are not limited to, 2-ethylhexyl acrylate, 2-hydroxyethyl acrylate, 2-hydroxypropyl acrylate, tetrahydrofurfuryl acrylate, 2-ethylhexyl carbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate, and styrene monomer.

Specific examples of suitable difunctional radical-polymerizable monomers include, but are not limited to, 1,3-butanediol diacrylate, 1,4-butabediol diacrylate, 1,4-butanediol dimethacrylate, 1,6-hexanediol diacrylate, 1,6-hexanediol dimethacrylate, diethylene glycol diacrylate, neopentyl glycol diacrylate, bisphenol A EO-modified diacrylate, and bisphenol F EO-modified diacrylate.

Specific examples of suitable radical-polymerizable monomers further include, but are not limited to, fluorine-substituted monomers such as octafluoropentyl acrylate, 2-perfluorooctylethyl acrylate, 2-perfluorooctylethyl methacrylate, and 2-perfluoroisononylethyl acrylate; and vinyl monomers, acrylates, and methacrylates having polysiloxane groups such as acryloyl polydimethyl siloxane ethyl, methacryloyl polydimethyl siloxane ethyl, acryloyl polydimethyl siloxane propyl, acryloyl polydimethyl siloxane butyl, diacryloyl polydimethyl siloxane diethyl, which have siloxane repeating units of 20 to 70, disclosed in JP-05-60503-B and JP-06-45770-B.

Specific examples of suitable radical-polymerizable oligomers include, but are not limited to, epoxy acrylate oligomers, urethane acrylate oligomers, and polyester acrylate oligomers.

Description is now given of polymerization initiators. As described above, the cross-linked charge transport layer is formed by hardening a radical-polymerizable monomer having no charge transport structure, which is preferably trifunctional or more functional, and a radical-polymerizable compound having a charge transport structure, which is preferably monofunctional, upon application of at least one of heat, light, and ionizing radiation. At the time of hardening, a polymerization initiator may be optionally used to perform the hardening reaction effectively. In a case in which an ionizing radiation is applied, a cross-linking reaction can be generally performed without a polymerization initiator, and heat and/or light may be further applied to harden residual unhardened compositions. Even in this case, the following polymerization initiators can be used to perform the reaction effectively.

Specific examples of suitable thermal polymerization initiators include, but are not limited to, peroxide initiators such as 2,5-dimethylhexane-2,5-dihydroperoxide, dicumyl peroxide, benzoyl peroxide, t-butyl cumyl peroxide, 2,5-dimethyl-2,5-di(peroxybenzoyl)hexyne-3-di-t-butyl peroxide, t-butyl hydroperoxide, cumene hydroperoxide, and lauroyl peroxide; and azo initiators such as azobis isobutyronitrile, azobis cyclohexane carbonitrile, azobis methyl isobutyrate, azobis isobutylamidine hydrochloride, and 4,4′-azobis-4-cyano valeric acid.

Specific examples of suitable photopolymerization initiators include, but are not limited to, acetophenone and ketal initiators such as diethoxy acetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoine ether initiators such as benzoine, benzoine methyl ether, benzoine ethyl ether, benzoine isobutyl ether, and benzoine isopropyl ether; benzophenone initiators such as benzophenone, 4-hydroxy benzophenone, methyl o-benzoyl benzoate, 2-benzoyl naphthalene, 4-benzoyl biphenyl, 4-benzoyl phenyl ether, acrylic benzophenone, and 1,4-benzoyl benzene; thioxanthone initiators such as 2-isopropyl thioxanthone, 2-chloro thioxanthone, 2,4-dimethyl thioxanthone, 2,4-diethyl thioxanthone, and 2,4-dichloro thioxanthone; titanocene initiators such as bis(cyclopentadienyl)-di-chloro-titanium, bis(cyclopentadienyl)-di-phenyl-titanium, bis(cyclopentadienyl)-bis(2,3,4,5,6-pentafluorophenyl)titanium, and bis(cyclopentadienyl)-bis(2,6-difluoro-3-(pyrrol-1-yl)phenyl)titanium; and other initiators such as ethyl anthraquinone, 2,4,6-trimethylbenzoyl diphenylphosphine oxide, 2,4,6-trimethylbenzoyl phenyl ethoxy phosphine oxide, bis(2,4,6-trimethylbenzoyl)phenylphosphine oxide, bis(2,4-dimethoxybenzoyl)-2,4,4-trimethylpentylphosphine oxide, methylphenyl glyoxylate, 9,10-phenanthrene, acridine compounds, triazine compounds, and imidazole compounds.

Compounds that accelerate the photopolymerization can be used in combination with the above-described photopolymerization initiators. Specific examples of such compounds include, but are not limited to, triethanolamine, methyl diethanolamine, ethyl 4-dimetylaminobenzoate, isoamyl 4-dimetylaminobenzoate, (2-dimethylamino)ethyl benzoate, and 4,4′-dimethylamino benzophenone.

These polymerization initiators can be used alone or in combination. The useful amount of the polymerization initiator is 0.5 to 40 parts by weight, preferably 1 to 20 parts by weight, based on 100 parts by weight of the radical-polymerizable compounds.

Description is now given of fillers. The cross-linked charge transport layer may include fine particles of filler (hereinafter “filler particles”) for the purpose of improving abrasion resistance.

Because of having a high cross-linking density, the cross-linked charge transport layer generally has better abrasion resistance compared to a typical resin layer, thereby suppressing uneven abrasion. Filler particles dispersed in such a cross-linked charge transport layer are trapped in cross-linked resin matrix, which has a large retention. Accordingly, the filler particles are prevented from releasing off from the layer, resulting in improvement of abrasion resistance.

Specific examples of usable filler particles include organic filler materials such as fluorocarbon resin powders (e.g., polytetrafluoroethylene), silicone resin powders, and fine particles of carbon. Here, the fine particle of carbon is defined as a fine particle that has a structure mainly composed of carbon, more specifically, a fine particle having a structure of amorphous, diamond, graphite, amorphous carbon, fullerene, zeppelin, carbon nanotube, or carbon nanohorn. In particular, fine particles having either diamond-like carbon or amorphous carbon structure containing hydrogen have good mechanical and chemical durability. Here, the diamond-like carbon or amorphous carbon structure containing hydrogen is defined as a mixture of a diamond structure having SP3 orbit, a graphite structure having SP2 orbit, and an amorphous carbon structure. A fine particle having the diamond-like carbon or amorphous carbon structure is not necessarily composed of carbon only, and may include other elements such as hydrogen, oxygen, nitrogen, fluorine, boron, phosphor, chlorine, bromine, and iodine.

Specific examples of usable filler particles also include inorganic filler materials such as powders of metals (e.g., copper, tin, aluminum, indium), metal oxides (e.g., silicon oxide, tin oxide, zinc oxide, titanium oxide, indium oxide, antimony oxide, bismuth oxide), and inorganic materials (e.g., potassium titanate). From the viewpoint of hardness, inorganic filler materials have advantage over organic filler materials. In particular, metal oxides are preferable, and silicon oxide, aluminum oxide, and titanium oxide are further preferable. In addition, fine particles of colloidal silica and colloidal alumina are also preferable.

The filler particles preferably have an average primary particle diameter of 0.01 to 0.9 μm, more preferably 0.1 to 0.5 μm, from the viewpoint of light transmittance and abrasion resistance of the resultant cross-linked charge transport layer. When the average primary particle diameter is too small, the filler particles may not finely dispersed in the resultant cross-linked charge transport layer, possibly degrading abrasion resistance. When the average primary particle diameter is too large, precipitation of the filler particles in a coating liquid may be aggravated, and toner particles may undesirably adhered to the resultant layer.

From the viewpoint of abrasion resistance, the amount of the filler in the cross-linked charge transport layer is as large as possible. However, too large an amount of filler may cause side effects such as increase of residual potential and decrease of light transmittance. A useful amount of the filler is preferably 50% or less by weight, and more preferably 30% or less by weight, based on total weight of solid components. Further, the filler can be surface-treated with a surface treatment agent so as to improve dispersibility thereof. If the filler is not finely dispersed, significant problems such as increase of residual potential, decrease of transparency, film defect, and deterioration of abrasion resistance may be caused.

A surface treatment agent that can maintain insulation of the filler is preferable. Specific examples of such surface treatment agents include, but are not limited to, titanate coupling agents, aluminum coupling agents, zirco aluminate coupling agents, higher fatty acids, and mixtures thereof with silane coupling agents; and Al₂O₃, TiO₂, ZrO₂, silicone, aluminum stearate, and mixtures thereof. These agents have an advantage in improvement of dispersibility of the filler and prevention of image blurring. If a silane coupling agent is used alone, image blurring may occur in some cases, however, a combination of the above-described surface treatment agent and a silane coupling agent may prevent image blurring. A useful amount of the surface treatment depends on the average primary particle diameter of the filler, however, it is preferably 3 to 30% by weight, and more preferably 5 to 20% by weight. When the amount is too small, the filler may not be finely dispersed. When the amount is too large, residual potential may considerably increase. The filler materials can be used alone or in combination.

Description is now given of other additives. A coating liquid for forming the cross-linked charge transport layer may optionally include additives such as a plasticizer (for the purpose of stress relaxation and increase of adhesion), a leveling agent, and a non-radical-polymerizable low-molecular-weight charge transport material. Specific examples of usable plasticizers include, but are not limited to, dibutyltin phthalate and dioctyl phthalate, which are typically used for resins. The amount of the plasticizer is preferably 20 parts or less by weight, and more preferably 10 parts or less by weight, based on 1 part by weight of solid components in the coating liquid. Specific examples of usable leveling agents include, but are not limited to, silicone oils such as dimethyl silicone oil and methylphenyl silicone oil, and polymers and oligomers having a perfluoroalkyl chain on a side chain thereof. The amount of the leveling agent is preferably 3 parts or less by weight based on total weight of solid components in the coating liquid.

Description is now given of method of preparing the cross-linked charge transport layer. The cross-linked charge transport layer is generally formed by applying a coating liquid containing a radical-polymerizable monomer having no charge transport structure, which is preferably trifunctional or more functional, and a radical-polymerizable compound having a charge transport structure, which is preferably monofunctional, on the photosensitive layer, followed by hardening. In a case in which the radical-polymerizable monomer is liquid, the coating liquid can be prepared by dissolving other components therein, optionally in combination with a solvent for diluting. Specific examples of usable solvents include, but are not limited to, alcohols such as methanol, ethanol, propanol, and butanol; ketones such as acetone, methyl ethyl ketone, methyl isobutyl ketone, and cyclohexanone; esters such as ethyl acetate and butyl acetate; ethers such as tetrahydrofuran, dioxane, and propyl ether; halogen solvents such as dichloromethane, dichloroethane, trichloroethane, and chlorobenzene; aromatic solvents such as benzene, toluene, and xylene; and cellosolves such as methyl cellosolve, ethyl cellosolve, and cellosolve acetate. These solvents can be used alone or in combination.

A suitable coating method is selected considering the viscosity of the coating liquid and a desired thickness of the resultant cross-linked charge transport layer. For example, a dip coating method, a spray coating method, a bead coating method, and a ring coating method are preferable.

The coating liquid applied is then hardened upon application of energy such as heat energy, light energy, and ionizing radiation. There is a possibility that ionizing radiation degrades materials composing a photoreceptor because of its deep energy immersion and energy strength, resulting in deterioration of electrophotographic properties. Accordingly, heat energy and light energy are preferable. Light energy is more preferable because the amount of the solvent can be reduced and the strength of the cross-linked layer can be increased. Alternatively, 2 or more kinds of energies can be applied in combination.

Specific examples of the heat energies include, but are not limited to, gases such as air and nitrogen, vapors, heat media, infrared rays, and electromagnetic waves. The layer may be heated from either an application side or a substrate side. The heating temperature is preferably 100 to 170° C. When the heating temperature is too low, the reaction speed may be too low, resulting in decrease of productivity. Moreover, unreacted materials may remain in the resultant layer. When the heating temperature is too high, the resultant layer may considerably contracts by cross-linking, resulting in formation of an orange-peel-like uneven surface and cracks. Further, the resultant layer may peels off from an adjacent layer. Moreover, volatile components in the photosensitive layer may dissipate in the air, thereby degrading electrophotographic properties. In a case in which the layer is considerably contracts by cross-linking, such a layer may be preliminarily cross-linked at a low temperature of less than 100° C. and subsequently at a high temperature of 100° C. or more to complete cross-linking.

Suitable light energies are emitted from light sources such as ultrahigh pressure mercury lamps, high pressure mercury lamps, low pressure mercury lamps, carbon-arc lamps, and xenon-arc metal halide lamps. A suitable light sources is selected considering absorption properties of the radical-polymerizable monomer having no charge transport structure, the radical-polymerizable compound having a charge transport structure, and the photopolymerization initiator, etc. The light source preferably emits a light having a wavelength of 365 nm at an illumination intensity of 5 to 2000 mW/cm². More preferably, the light source emits a light having a maximum wavelength at the above-described illumination intensity. When the illumination intensity is too small, it takes a long time to complete hardening, decreasing productivity. When the illumination intensity is too large, the resultant layer may considerably contracts by cross-linking, resulting in formation of an orange-peel-like uneven surface and cracks. Further, the resultant layer may peels off from an adjacent layer.

Ionizing radiation has an ionization effect on a substance. Specific examples of the ionization radiations include, but are not limited to, direct ionization radiations such as alpha rays and electron beams and indirect ionization radiations such as X rays and neutron rays. Considering effects of radioactivity on the human body, electron beams are preferably used. Specific examples of usable electron beam irradiators include, but are not limited to, Cockcroft-Walton accelerator, van de Graaff accelerator, resonance transformer accelerator, insulated core transformer accelerator, linear accelerator, Dynamitron accelerator, and high-frequency accelerator. A suitable irradiance level may be determined depending on the thickness of the cross-linked charge transport layer. Preferably, the layer is irradiated with an electron having an energy of 100 to 1000 keV, preferably 100 to 3000 keV, at 0.1 to 30 Mrad. When the irradiance level is too small, the electron beam may not reach inside of the cross-linked charge transport layer, resulting in insufficient hardening in deep portions of the layer. When the irradiance level is too large, the electron beam may reach the charge transport layer or the charge generation layer, possibly adversely affecting materials therein.

When the cross-linked charge transport layer is irradiated with UV or ionization radiation, the temperature thereof generally increases. If the temperature increases too much, problems may arise such that the cross-linked charge transport layer considerably contracts by hardening, and low-molecular-weight components in adjacent layers migrate to the cross-linked charge transport layer to inhibit hardening. As a result, electric properties of the photoreceptor deteriorate. Accordingly, the temperature of the cross-linked charge transport layer is preferably 100° C. or less, and more preferably 80° C. or less, when irradiated with UV etc. One possible method of cooling the layer involves enclosing an auxiliary cooling agent inside the photoreceptor. Another possible method involves cooling gases and liquids inside the photoreceptor.

After completion of hardening, the cross-linked charge transport layer may be further heated, as needed. For example, in a case in which a large amount of solvents remain in the layer, it is preferable to volatize the remaining solvents by heating so as to prevent deterioration of electric properties and time degradation.

The cross-linked charge transport layer preferably has a thickness of 1 to 15 μm, and more preferably 3 to 10 μm, from the viewpoint of protection of photoreceptor. When the thickness is too small, the photoreceptor cannot be protected from mechanical abrasion caused by a contact member and adjacent electric discharge caused by a charger. Further, the layer may have an orange-peel-like uneven surface. When the thickness is too large, the total thickness of the photoreceptor is too large, causing charge diffusion. As a consequence, image reproducibility may deteriorate. When the thickness of the cross-linked charge transport layer is larger than that of the charge transport layer, the bright section potential tends to increase, which is undesirable. Accordingly, the following equation is preferably satisfied:

T1>T2×2

Wherein T1 and T2 represent thicknesses of the charge transport layer and the cross-linked charge transport layer, respectively.

### (Adhesion Layer)

An adhesion layer may be provided between the cross-linked charge transport layer and the photosensitive layer for the purpose of preventing interlayer peeling.

The adhesion layer may be formed using the above-described radical-polymerizable monomers or non-crosslinking polymer compounds. Specific examples of usable non-crosslinking polymer compounds include, but are not limited to, polyamide, polyurethane, epoxy resins, polyketone, polycarbonate, silicone resins, acrylic resins, polyvinyl butyral, polyvinyl formal, polyvinyl ketone, polystyrene, poly-N-vinylcarbazole, polyacrylamide, polyvinyl benzal, polyester, phenoxy resins, vinyl chloride-vinyl acetate copolymers, polyvinyl acetate, polyphenylene oxide, polyvinyl pyridine, cellulose resins, casein, polyvinyl alcohol, and polyvinyl pyrrolidone. The radical-polymerizable monomers can be used alone or in combination. The non-crosslinking polymer compounds can be used alone or in combination. Further, the radical-polymerizable monomers and non-crosslinking polymer compounds can be used in combination, so long as good adhesiveness is provided. In addition, the charge transport materials disclosed in this application and additives for improving adhesiveness are also usable.

The adhesion layer can be formed by applying a coating liquid in which specific components are dissolved or dispersed in a solvent such as tetrahydrofuran, dioxane, dichloroethane, and cyclohexane, by a typical coating method such as a dip coating method, a spray coating method, a bead coating method, and a ring coating method. The adhesion layer preferably has a thickness of 0.1 to 5 μm, and more preferably 0.1 to 3 μm.

### (Undercoat Layer)

An undercoat layer may be provided between the conductive substrate and the photosensitive layer. The undercoat layer includes a resin as a main component. Since the photosensitive layer is formed on the undercoat layer using a solvent, the resin is required to have high resistance to the solvent. Specific examples of such resins include, but are not limited to, water-soluble resins such as polyvinyl alcohol, casein, and sodium polyacrylate; alcohol-soluble resins such as copolymerized nylon and methoxymethylated nylon; hardening resins that form a three-dimensional network structure such as polyurethane, melamine resins, phenol resins, alkyd-melamine resins, and epoxy resins. Further, the undercoat layer may include fine powders of metal oxides such as titanium oxide, silica, alumina, zirconium oxide, tin oxide, and indium oxide, to prevent the occurrence of moire and to decrease residual potential.

The undercoat layer can be formed by a typical coating method using a proper solvent, in the same way as the formation of the photosensitive layer. Silane coupling agents, titan coupling agents, and chrome coupling agents are also usable for the undercoat layer. Further, Al₂O₃ formed by anodic oxidization, and thin films of organic materials such as polyparaxylene (parylene) and inorganic materials such as SiO₂, SnO₂, TiO₂, ITO and CeO₂ formed by a vacuum method are also usable as the undercoat layer. The undercoat layer preferably has a thickness of 0 to 5 μm.

### (Blocking Layer)

A blocking layer may be provided between the conductive substrate and the undercoat layer, or between the undercoat layer and the charge generation layer. The blocking layer prevents hole injection from the conductive substrate to prevent background fouling. The blocking layer generally includes a binder resin as a main component. Specific examples of usable binder resins include, but are not limited to, polyamide, alcohol-soluble polyamide, alcohol-soluble nylon, water-soluble polyvinyl butyral, polyvinyl butyral, and polyvinyl alcohol. The blocking layer can be formed by the typical coating method described above. The blocking layer typically has a thickness of 0.05 to 2 μm. A combination of the blocking layer and the undercoat layer drastically prevents background fouling, however, tends to increase residual potential. Accordingly, the composition and thickness of the blocking and undercoat layers should be optimized.

### (Measurement of Ionization Potential)

Ionization potential here refers to an energy amount needed for extracting one electron from a ground state.

In the present invention, the ionization potential can be measured as follows. A sample is irradiated with an ultraviolet ray that is spectroscopically dispersed by a monochromator while changing energy thereof, using an instrument PHOTOELECTRON SPECTROMETER SURFACE ANALYZER MODEL AC-1, AC-2, or AC-3 from Riken Keiki Co., Ltd., configured to emit ultraviolet ray in atmospheric pressure to measure photoelectron spectrum. A minimum energy needed for emitting photoelectron, that is, photoelectric effect, is measured and regarded as the ionization potential.

More specifically, each of the charge generation layer, charge transport layer, and cross-linked charge transport layer is formed on a smooth surface of an aluminum plate to measure the ionization potential. The measurement conditions are as follows.
(1) Quantity of light: 100 nw
(2) Energy range of incident light: 4.0 to 6.2 eV
(3) Light quantum per unit: 1×10¹¹ (cps)
(4) Measurement time: 10 sec

Suitable measurement instrument and conditions are not limited to the above-described instrument and conditions.

Generally, increase of the bright section potential is mainly caused by charge trapping in the interface between the charge generation layer and the charge transport layer, the interface between the charge transport layer and the cross-linked charge transport layer, or in the bulk of the charge transport layer or the cross-linked charge transport layer.

In particular, charge trapping in the interface between the charge generation layer and the charge transport layer or the interface between the charge transport layer and the cross-linked charge transport layer has a great effect. Accordingly, one possible approach to reduce the bright section potential involves decreasing the difference in ionization potential between the charge transport material in the charge transport layer and the charge generation material in the chare generation layer so that charge injection barrier is decreased.

In a case in which a titanyl phthalocyanine pigment, which generally has a low ionization potential, is included as a charge generation material, a charge transport material needs to have an ionization potential equal to or less than that of the titanyl phthalocyanine pigment.

In a case in which a protective layer is further provided thereon, the ionization potential of the protective layer should be equal to or less than that of the charge transport layer for the purpose of preventing increase of the bright section potential. Accordingly, related-art photoreceptors generally have a configuration in which an outermost layer has the lowest ionization potential. However, such a configuration causes a side effect of image blurring when being exposed to oxidizing gases. Generally, it is difficult to reduce the bright section potential and to prevent image blurring caused by oxidizing gases simultaneously.

The photoreceptor of the present invention satisfies the following equations (1) and (2):

−0.16≦Ip(T)−Ip(G)≦0.07 (1)

0.07<Ip(O)−Ip(G)≦0.33 (2)

wherein Ip(G), Ip(T), and Ip(O) represent ionization potentials of the charge generation layer, the charge transport layer, and the cross-linked charge transport layer, respectively.

When the equations (1) and (2) are satisfied, the bright section potential can be reduced and image blurring caused by oxidizing gases is prevented simultaneously. In addition, generation of ghost images is prevented and abrasion resistance of the photoreceptor improves.

When Ip(T)−Ip(G) is less than −0.16, charge injection barrier between the charge generation layer and the charge transport layer can be reduced, however, charge amount is drastically reduced. As a consequence, the resultant image may have fogging and low resolution, and image blurring may be caused when the concentration of oxidizing gases is high. Generally, Ip(T)−Ip(G) is −0.16 or more, and preferably −0.1 or more.

When Ip(T)−Ip(G) is greater than 0.07, the bright section potential considerably increases. Since the photoreceptor of the present invention includes the cross-linked charge transport layer in which a radical-polymerizable monomer having no charge transport structure and a radical-polymerizable compound having a charge transport structure are hardened, increase of the bright section potential depends on charge trapping in the interface between the charge generation layer and the charge transport layer considerably, and in the interface between the charge transport layer and the cross-linked charge transport layer only slightly. Generally, Ip(T)−Ip(G) is 0.07 or less, and preferably 0.04 or less.

When Ip(O)−Ip(G) is greater than 0.33, the bright section potential considerably increases, even if the charge generation layer and the charge transport layer satisfy the equation (1). Further, even if the difference in ionization potential between the charge transport layer and the cross-linked charge transport layer is decreased, the difference in ionization potential between the charge generation layer and the charge transport layer is increased, resulting in increase of the bright section potential. Accordingly, it is necessary that the difference in ionization potential between the cross-linked charge transport layer and the charge generation layer is 0.33 or less. Generally, Ip(O)−Ip(G) is 0.33 or less, and preferably 0.27 or less.

When Ip(O)−Ip(G) is 0.07 or less, image blurring easily occurs. In a case in which a metal phthalocyanine pigment, which generally has a small ionization potential, is used as a charge generation layer, a charge transport material included in an outermost layer of the photoreceptor inevitably has a small ionization potential. As a consequence, image blurring may occur with repeated use. When a surface of the photoreceptor is exposed to oxidizing gases such as ozone produced at a time of charging the photoreceptor, the charge transport material in the outermost layer may deteriorate and the resistance thereof may decrease. As the ionization potential of the charge transport material becomes smaller, such a phenomenon more easily occurs, casing image blurring with repeated use. When Ip(O)−Ip(G) is greater than 0.07, image blurring is suppressed and oxidizing gases are less influential.

Neither the equations (1) nor (2) refer to the difference between Ip(O) and Ip(T). For example, image blurring may occur even if the difference between Ip(O) and Ip(T) is defined, in other words, Ip(O) is greater than Ip(T), in a case in which a charge transport material having a low ionization potential, which leads to the minimum value of Ip(T)−Ip(G), is included in the charge transport layer. Since increase of the bright section potential does not depend on the difference between Ip(O) and Ip(T), the bright section potential can be reduced and image blurring can be prevented simultaneously when the difference in ionization potential between the cross-linked charge transport layer and the charge generation layer, i.e., Ip(O)−Ip(G) has a specific value.

### (Protective Material)

A protective material may be evenly applied to a surface of the photoreceptor for the purpose of improving cleanability of the photoreceptor by lowering the surface energy, and protecting the photoreceptor from electric and mechanical hazards. Specific examples of usable protective materials include, but are not limited to, waxes, silicone oils, and fatty acid salts. Fatty acid salts are most preferable because they do not reduce electric properties of the photoreceptor and are capable of forming a thin layer thereof. Specific examples of usable fatty acids for the fatty acid salts include, but are not limited to, undecyl acid, lauric acid, tridecyl acid, myristic acid, palmitic acid, pentadecyl acid, stearic acid, heptadecyl acid, arachic acid, montanic acid, oleic acid, arachidonic acid, caprylic acid, capric acid, and caproic acid. Specific examples of usable metals for the fatty acid salts include, but are not limited to, zinc, iron, magnesium, aluminum, and calcium.

A suitable protective material may be a lamella crystal such as zinc stearate. A lamella crystal generally has a laminar structure in which amphipathic molecules are self-assembled. Such a structure easily cracks along the layers upon application of shearing force, causing delamination. Such a property of the lamella crystal causes effective covering of the surface of the photoreceptor upon application of shearing force with a small amount. The delamination of the lamella crystal contributes to both lowering of the surface friction coefficient of the photoreceptor and protection of the photoreceptor from electric discharge.

One proposed method of applying protective material involves previously applying a protective material to a member that contacts the photoreceptor, such as a cleaning member. Another proposed method of applying protective material involves mounting an applicator in a process cartridge. The latter method is preferable because the protective material can be reliably applied to the photoreceptor for an extended period of time.

### (Image Forming Apparatus)

Next, the image forming apparatus of the present invention will be described in detail.

The image forming apparatus of the present invention includes the photoreceptor of the present invention including the cross-linked charge transport layer, a charging device configured to charge the photoreceptor, an irradiating device configured to form an electrostatic latent image on the photoreceptor, a developing device configured to develop the electrostatic latent image to form a toner image, a transfer device configured to transfer the toner image onto a transfer sheet, and optionally includes a fixing device configured to fix the toner image on the transfer sheet and a cleaning device configured to clean the surface of the photoreceptor. The image forming apparatus does not necessarily include all of the above-described devices in a case in which the electrostatic latent image is directly transferred onto the transfer sheet, for example.

FIG. 2 is a schematic view illustrating an embodiment of an image forming apparatus of the present invention. First, a charger 3 evenly charges a photoreceptor 1. Specific examples of usable devices for the charger 3 include, but are not limited to, a corotron device, a scorotron device, a solid discharge element, a catwhisker device, a roller charging device, and a conductive brush device.

Next, an irradiator 5 forms an electrostatic latent image on the charged photoreceptor 1. Specific examples of usable light sources for the irradiator 5 include, but are not limited to, fluorescent lamps, tungsten lamps, halogen lamps, mercury lamps, sodium lamps, light-emitting diodes (LED), laser diodes (LD), and electro luminescence (EL). In order to obtain lights having a desired wavelength, filters such as sharp-cut filters, band pass filters, near-infrared filters, dichroic filters, interference filters, and color temperature converting filters can be used.

The electrostatic latent image formed on the photoreceptor 1 is then formed into a toner image by a developing unit 6. The developing unit 6 generally employs a one-component or two-component developing method that uses a dry toner or a wet developing method that uses a wet toner. When the photoreceptor 1 is positively (negatively) charged, a positive (negative) electrostatic latent image is formed thereon. When the positive (negative) electrostatic latent image is developed with a negative (positive) toner, a positive image is produced. By contrast, when the positive (negative) electrostatic latent image is developed with a positive (negative) toner, a negative image is produced.

The toner image formed on the photoreceptor 1 is then transferred onto a transfer member 9 by a transfer charger 10. To more reliably perform the transfer, a pre-transfer charger 7 may be provided in combination with the transfer charger 10. In addition to the transfer charger, devices employing a mechanical transfer method such as an electrostatic transfer method using a bias roller, an adhesive transfer method, and a pressure transfer method, or a magnetic transfer method are preferably used.

The transfer member 9 having the toner image thereon is then separated from the photoreceptor 1 by a separation charger 11 and a separation pick 12. Alternatively, the separation may be performed using electrostatic adsorption induction, side edges of belt, gripping of leading edge, or curvature. As the separation charger 11, the above-described usable devices for the charger 3 can be used.

Residual toner particles remaining on the photoreceptor 1 without being transferred are removed by a fur brush 14 and a cleaning blade 15. To more reliably perform the cleaning, a pre-cleaning charger 13 may be provided. In addition to the fur brush 14 and the cleaning blade 15, a web or a magnet brush can also be used as cleaning members. These cleaning members can be used alone or in combination.

Residual electrostatic latent image remaining on the photoreceptor 1 is removed by a decharging lamp 2 and a decharger, not shown. The above-described usable light sources for the irradiator 5 and usable devices for the charger 3 can be used for the decharging lamp 2 and the decharger, respectively. In FIG. 2, a numeral 4 denotes an eraser, and a numeral 8 denotes registration rollers.

The image forming apparatus further includes a document reading device, a sheet feeding device, a fixing device, a sheet discharging device, etc., not shown.

### (Process Cartridge)

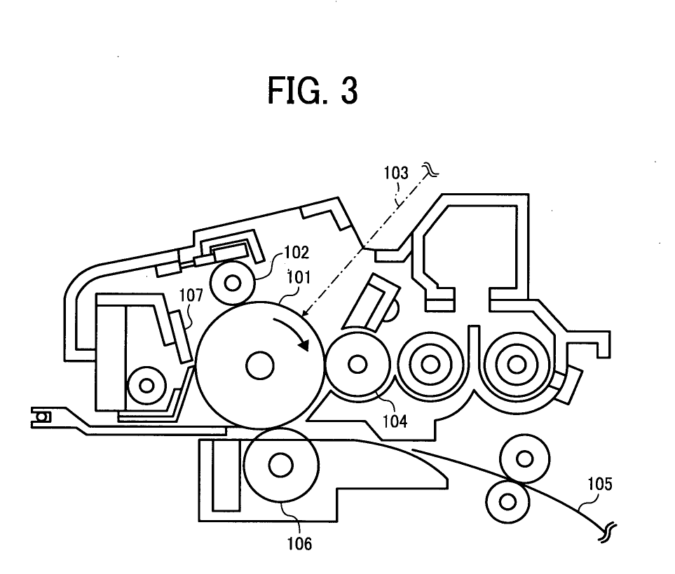

The process cartridge of the present invention includes the photoreceptor of the present invention, and is detachably attachable to an image forming apparatus such as copier, facsimile, and printer. FIG. 3 is a schematic view illustrating an embodiment of a process cartridge of the present invention.

A process cartridge illustrated in FIG. 3 includes a photoreceptor 101, and at least one of a charger 102, a developing device 104, a transfer device 106, a cleaning device 107, and a decharging device, not shown.

An image forming operation is performed as follows. The photoreceptor 101 rotates in a direction in a direction indicated by an arrow in FIG. 3. A surface of the photoreceptor 101 is charged by the charger 102, and is then irradiated with a light beam 103 emitted from an irradiator, not shown, so that an electrostatic latent image is formed thereon. The electrostatic latent image is developed with a toner by the developing device 104 to form a toner image. The toner image is transferred onto a transfer member 105 by the transfer device 106. The surface of the photoreceptor 101 from which the toner image is transferred is cleaned by the cleaning device 107, and is then decharged by the decharging device, not shown. A series of this image forming operation is repeated.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis Example 1

### Preparation of Charge Generation Material

A titanyl phthalocyanine crystal was prepared with reference to the method disclosed in JP-2004-83859-A, the disclosure of which is incorporated herein by reference.

First, 292 parts of 1,3-diiminoisoindoline and 1800 parts of sulfolane were mixed, and 204 parts of titanium tetrabutoxide were dropped therein under nitrogen gas flow. The mixture was gradually heated to 180° C. and subjected to a reaction for 5 hours at 170 to 180° C. while being agitated. After termination of the reaction, the mixture stood to cool. The cooled mixture was filtered and the deposits were washed with chloroform until expressing blue color, then washed with methanol for several times, and further washed with hot water of 80° C. for several times, followed by drying. Thus, a crude titanyl phthalocyanine was prepared.

The crude titanyl phthalocyanine was dissolved in concentrated sulfuric acid 20 times the amount thereof, and subsequently dropped in ice water 100 times the amount thereof while being agitated. The mixture was filtered, and the deposited crystal was washed with ion-exchange water having a pH of 7.0 and a specific conductance of 1.0 μS/cm until the used ion-exchange water became neutral, in other words, had a pH of 6.8 and a specific conductance of 2.6 μS/cm. Thus, a wet cake (i.e., water paste) of a titanyl phthalocyanine was prepared.

Next, 40 parts of the wet cake (i.e., water paste) were poured into 200 parts of tetrahydrofuran, and the mixture was strongly agitated at room temperature at a revolution of 200 rpm using a HOMOMIXER (MARK II f model from Kenis Ltd.) until the color of the paste changed from navy blue to pale blue, resulting in 20-minutes agitation. Subsequently, the mixture was filtered under reduced pressure, and the deposited crystal was washed with tetrahydrofuran, resulting in a wet cake of a pigment. The wet cake was then dried for 2 days at 70° C. under reduced pressure of 5 mmHg. Thus, 8.5 parts of a titanyl phthalocyanine crystal were prepared.

The wet cake included solid components in an amount of 15% by weight. The amount of the crystal conversion solvent was 33 times the amount of the wet cake. It is to be noted that no halogen-containing compound was used in the present example.

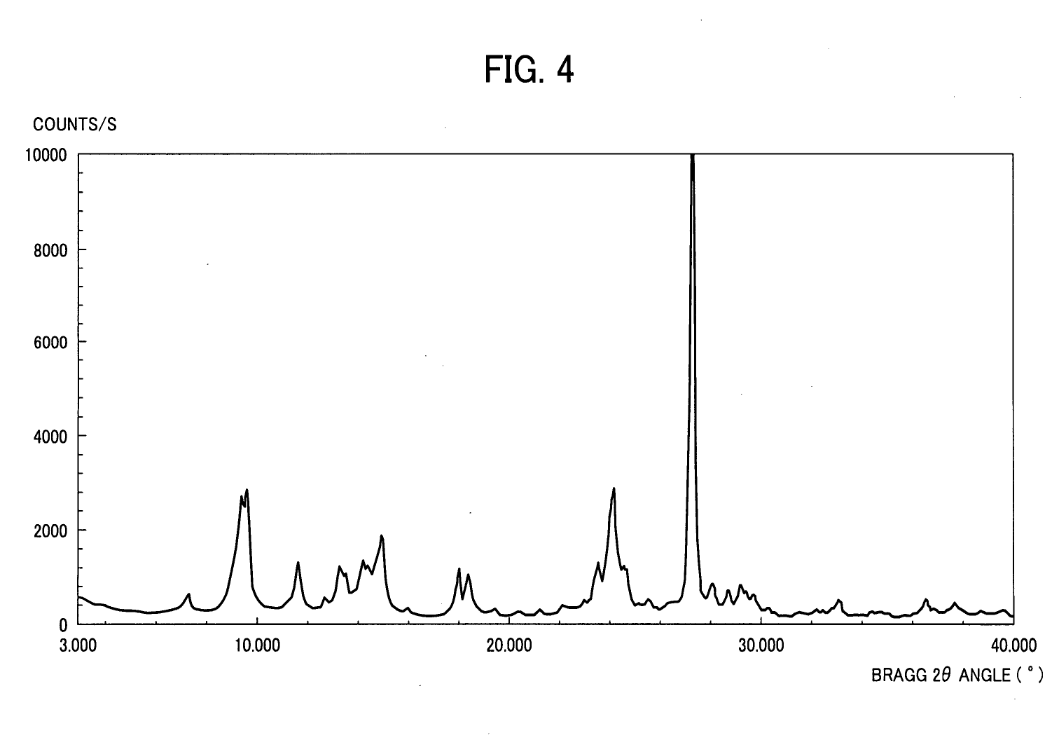

FIG. 4 is an X-ray diffraction spectrum of the above-prepared titanyl phthalocyanine, obtained with a characteristic X-ray specific to CuKα having a wavelength of 1.542. Referring to FIG. 4, the titanyl phthalocyanine has a maximum diffraction peak at 27.2±0.2°, main peaks at 9.4±0.2°, 9.6±0.2°, and 24.0±0.2°, a lowest-side-angle diffraction peak at 7.3±0.2°, and no diffraction peak within a range between 7.3° and 9.4° and at 26.3°, as diffraction peaks of Bragg angle 2θ.

The X-ray diffraction spectrum was obtained under the following conditions:

X-ray tube: Cu

Voltage: 50 kV

Current: 30 mA

Scanning velocity: 2°/min

Scanning range: 3° to 40°

Time constant: 2 seconds

### Synthesis Example 2

### Preparation of Charge Generation Material

A hydroxygallium phthalocyanine was prepared with reference to the method disclosed in Synthesis Example and Example 1 of JP 3166293, the disclosure of which is incorporated herein by reference.

First, 30 parts of 1,3-diiminoisoindoline and 9.1 parts of gallium trichloride were added to 230 parts of quinoline. The mixture was subjected to a reaction for 3 hours at 200° C. After termination of the reaction, the mixture was filtered. The reaction products were successively washed with acetone and methanol, followed by drying. Thus, 28 parts of a chlorogallium phthalocyanine crystal were prepared.

Next, 3 parts of the chlorogallium phthalocyanine crystal prepared above were dissolved in 60 parts of concentrated sulfuric acid at 0° C. The solution was dropped into 450 parts of distilled water of 5° C. so that crystals were deposited. The deposited crystals were washed with distilled water and diluted ammonia water, followed by drying. Thus, 2.5 parts of a hydroxygallium phthalocyanine crystal were prepared.

Further, 0.5 parts of the hydroxygallium phthalocyanine crystal prepared above were subjected to milling for 24 hours in 15 parts of dimethylformamide using 30 parts of glass beads having a diameter of 1 mm. The milled crystal was washed with methanol, followed by drying. Thus, a desired hydroxygallium phthalocyanine crystal was prepared.

The hydroxygallium phthalocyanine crystal was subjected to a measurement of the X-ray diffraction spectrum obtained with a characteristic X-ray specific to CuKα having a wavelength of 1.542, as the same manner in Synthesis Example 1. The X-ray diffraction spectrum thus obtained is illustrated in FIG. 8 of JP 3166293. Referring to FIG. 8 of JP 3166293, the hydroxygallium phthalocyanine has strong diffraction peaks at 7.5°, 9.9°, 12.5°, 16.3°, 18.6°, 25.1°, and 28.3°, as diffraction of Bragg angle 2θ.

### Synthesis Example 3

### Preparation of Charge Generation Material

A chlorogallium phthalocyanine was prepared with reference to the method disclosed in Synthesis Example and Example 2 of JP 3123185, the disclosure of which is incorporated herein by reference.

First, 30 parts of 1,3-diiminoisoindoline and 9.1 parts of gallium trichloride were added to 230 parts of quinoline. The mixture was subjected to a reaction for 3 hours at 200° C. After termination of the reaction, the mixture was filtered. The reaction products were successively washed with acetone and methanol, followed by drying. Thus, a chlorogallium phthalocyanine crystal was prepared.

The chlorogallium phthalocyanine crystal prepared above was subjected to dry grinding for 3 hours using an automatic mortar. Further, 0.5 parts of the grinded crystal were subjected to ball-milling treatment for 24 hours in 20 parts of a water/chlorobenzene (1/10) mixed solvent using 60 parts of glass beads having a diameter of 1 mm at room temperature, followed by filtering. The milled crystal was washed with 10 parts of methanol and then dried. Thus, a desired chlorogallium phthalocyanine crystal was prepared.

The chlorogallium phthalocyanine crystal was subjected to a measurement of the X-ray diffraction spectrum obtained with a characteristic X-ray specific to CuKα having a wavelength of 1.542, as the same manner in Synthesis Example 1. The X-ray diffraction spectrum thus obtained is illustrated in FIG. 7 of JP 3123185. Referring to FIG. 7 of JP 3123185, the chlorogallium phthalocyanine has strong diffraction peaks at 7.4°, 16.6°, 25.5°, and 28.3°, as diffraction peaks of Bragg angle 2θ.

### Synthesis Example 4

### Preparation of Charge Generation Material

An X-form metal-free phthalocyanine was prepared with reference to the method disclosed in Synthesis Example and Example 1 of JP-2001-247786-A, the disclosure of which is incorporated herein by reference.

First, 100 parts of o-phthalodinitrile and 10 parts of piperidine were reacted in 300 parts of chlorotoluene for 10 hours at 200° C. while being agitated. Thus, a purple-red crystal was prepared. The purple-red crystal was successively washed with an acid and an alkaline, and further successively washed with methanol, N,N-dimethylformamide, and N-methylpyrrolidone, followed by drying. Thus, a crude metal-free phthalocyanine was prepared.

Next, 12 parts of the crude metal-free phthalocyanine prepared above were dissolved in 200 parts of sulfuric acid (having a concentration of 97%) of 0 to 5° C. The solution was dropped into 2000 parts of pure water so that crystals were redeposited. The redeposited crystals were successively washed with an alkaline, methanol, N,N-dimethylformamide, and N-methylpyrrolidone, followed by drying. Thus, 10 parts of an α-form metal-free phthalocyanine pigment were prepared. The 10 parts of the α-form metal-free phthalocyanine pigment and 0.5 parts of an X-form metal-free phthalocyanine were subjected to milling for 4 days using a magnetic ball mill. Thus, an X-form metal-free phthalocyanine pigment was prepared.

Next, 5 parts of the X-form metal-free phthalocyanine pigment prepared above were poured in an aluminum pot together with 50 parts of zirconia beads having a diameter of 5 mm. The pot was set to a compact vibration mill (MB-0 from Chuo Kakohki Co., Ltd.) and subjected to dry pulverization for 5 minutes.

The pulverized X-form metal-free phthalocyanine pigment was subjected to a measurement of the X-ray diffraction spectrum as the same manner in Synthesis Example 1 of JP-2001-247786-A. The X-ray diffraction spectrum thus obtained is illustrated in FIG. 3 of JP 3123185.

### Synthesis Example 5

### Preparation of Monofunctional Compound Having Charge Transport Structure

A monofunctional compound having a charge transport structure can be prepared with reference to the method disclosed in JP 3164426, the disclosure of which is incorporated herein by reference.

(1) Synthesis of Triarylamine Compound Substituted with Hydroxyl Group (Compound Having Formula (B))

First, 113.85 parts (0.3 mol) of a triarylamine compound substituted with methoxy group, having the following formula (A), 138 parts (0.92 mol) of sodium iodide, and 240 parts of sulfolane were mixed and heated to 60° C. under nitrogen gas flow. Next, 99 parts (0.91 mol) of trimethyl chlorosilane were dropped therein over a period of 1 hour. The mixture was agitated for 4.5 hours at about 60° C. to terminate the reaction.

About 1500 parts of toluene were added to the reaction mixture and cooled to room temperature. Subsequently, the reaction mixture was washed with water and a sodium carbonate aqueous solution repeatedly.

Finally, solvents were removed from the reaction mixture. The reaction mixture was then subjected to a column chromatography (adsorption medium: silica gel, solvent: toluene/ethyl acetate (20/1)) to be refined. Cyclohexane was added to the resultant light-yellow oil so that crystals were deposited. Thus, 88.1 parts of a white crystal having the following formula (B) was prepared. The yield is 80.4%. The crystal has a melting point of 64.0 to 66.0° C. The ultimate analysis results are shown below.

| | C (%) | H (%) | N (%) |
|---|---|---|---|
| Measured Value | 85.06 | 6.41 | 3.73 |
| Calculated Value | 85.44 | 6.34 | 3.83 |

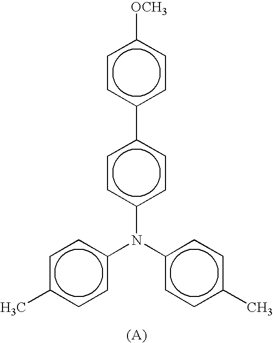

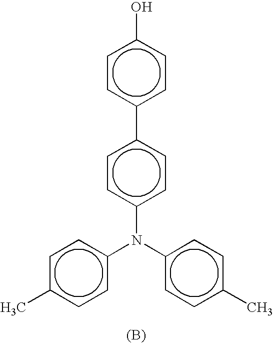

(2) Synthesis of Acrylate Compound Substituted with Triarylamino Group (Compound No. 54)

First, 2.9 parts (0.227 mol) of the above-prepared triarylamine compound substituted with hydroxyl group having formula (B) were dissolved in 400 ml of tetrahydrofuran, and a sodium hydroxide aqueous solution (including 12.4 parts of NaOH and 100 ml of water) was dropped therein under nitrogen gas flow. The mixture was then cooled to 5° C., and 25.2 parts (0.272 mol) of chloride acrylate were dropped therein over a period of 40 minutes. The mixture was agitated for 3 hours at 5° C. to terminate the reaction. Water was poured therein, and the reaction mixture was extracted by toluene. The extracted liquid was repeatedly washed with a sodium hydrogen carbonate aqueous solution and water.

Finally, solvents were removed from the reaction mixture. The reaction mixture was then subjected to a column chromatography (adsorption medium: silica gel, solvent: toluene) to be refined. n-Hexane was added to the resultant colorless oil so that crystals were deposited. Thus, 80.73 parts of a white crystal of the compound No. 54 was prepared. The yield is 84.8%. The crystal has a melting point of 117.5 to 119.0° C. The ultimate analysis results are shown below.

| | C (%) | H (%) | N (%) |
|---|---|---|---|
| Measured Value | 83.13 | 6.01 | 3.16 |
| Calculated Value | 83.02 | 6.00 | 3.33 |

### Example 1

An undercoat layer coating liquid including 50 parts of a titanium oxide (CR-EL from Ishihara Sangyo Kaisha Ltd., having an average primary diameter of about 0.25 μm), 14 parts of an alkyd resin (BECKOLITE M6401-50 from DIC Corporation, containing 50% of solid components), 8 parts of a melamine resin (L-145-60 from DIC Corporation, containing 60% of solid components), and 70 parts of 2-butanone was applied on an aluminum cylinder having a diameter of 100 mm, serving as a conductive substrate, and dried for 20 minutes at 130° C. Thus, an undercoat layer having a thickness of about 3.5 μm was formed.

To prepare a charge generation layer coating liquid, 15 parts of a titanyl phthalocyanine crystal, 10 parts of a polyvinyl butyral (BX-1 from Sekisui Chemical Co., Ltd.), and 280 parts of 2-butanone were subjected to a dispersion treatment using a commercially available bead mill disperser filled with PSZ balls having a diameter of 0.5 mm at a revolution of 1200 rpm for 30 minutes.

The charge generation layer coating liquid thus prepared was applied on the undercoat layer and dried for 20 minutes at 95° C. Thus, a charge generation layer having a thickness of about 0.2 μm was formed. The thickness of the charge generation layer was controlled so that the transmittance at 780 nm was 25%. Specifically, the charge generation layer coating liquid was applied on an aluminum cylinder covered with a polyethylene terephthalate film in the same manner as above, and the resultant film was subjected to a measurement of transmittance at 780 nm using a commercially available spectrophotometer (UV-3100 from Shimadzu Corporation) with a blank polyethylene terephthalate film as a reference.

A charge transport layer coating liquid including 10 parts of a bisphenol Z polycarbonate (PANLITE TS-2050 from Teijin Chemicals Ltd.), 10 parts of a low-molecular-weight charge transport material having the following formula, 80 parts of tetrahydrofuran, and 0.2 parts of a 1% tetrahydrofuran solution of a silicone oil (KF-50-1CS from Shin-Etsu Chemical Co., Ltd.) was applied on the charge generation layer and dried for 20 minutes at 120° C. Thus, a charge transport layer having a thickness of about 23 μm was formed.

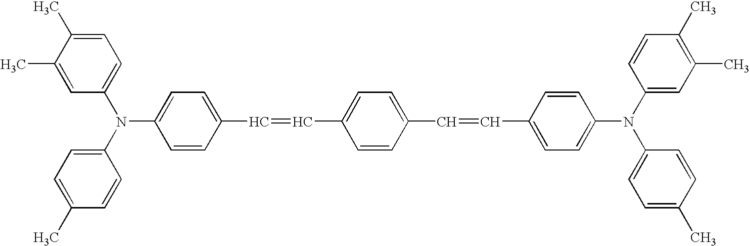

A cross-linked charge transport layer coating liquid including 10 parts of a radical-polymerizable monomer having no charge transport structure, which is a trimethylolpropane triacrylate (KAYARAD TMPTA from Nippon Kayaku Co., Ltd., wherein the molecular weight is 296, the number of functional groups is 3, and the ratio of the molecular weight to the number of functional groups is 99), 10 parts of a radical-polymerizable compound having a charge transport structure (Compound No. 54), 1 part of a photopolymerization initiator, which is 1-hydroxy-cyclohexyl-phenyl-ketone (IRGACURE 184 from Ciba Specialty Chemicals Inc.), and 100 parts of tetrahydrofuran was applied on the charge transport layer, and exposed to a light beam emitted from a UV lamp with H bulb (from Fusion UV Systems Japan KK) at a power of 200 W/cm and an intensity of 450 mW/cm² for 30 seconds, followed by drying for 20 minutes at 130° C. Thus, a cross-linked charge transport layer having a thickness of about 5 μm was formed.

Thus, a multilayer photoreceptor including, in order from an innermost side thereof, the conductive substrate, undercoat layer, charge generation layer, charge transport layer, and cross-linked charge transport layer was prepared.

### Example 2

The procedure for preparation of the photoreceptor in Example 1 was repeated except that the radical-polymerizable monomer having no charge transport structure in the cross-linked charge transport layer coating liquid was changed to a pentaerythritol tetraacrylate (SR-295 from Nippon Kayaku Co., Ltd., wherein the molecular weight is 352, the number of functional groups is 4, and the ratio of the molecular weight to the number of functional groups is 88).

### Example 3

The procedure for preparation of the photoreceptor in Example 1 was repeated except that the charge generation material in the charge generation layer coating liquid was changed to the chlorogallium phthalocyanine prepared in Synthesis Example 3.

### Example 4

The procedure for preparation of the photoreceptor in Example 1 was repeated except that the charge generation material in the charge generation layer coating liquid was changed to the hydroxygallium phthalocyanine prepared in Synthesis Example 2, and the radical-polymerizable compound having a charge transport structure in the cross-linked charge transport layer coating liquid was changed to the following compound.

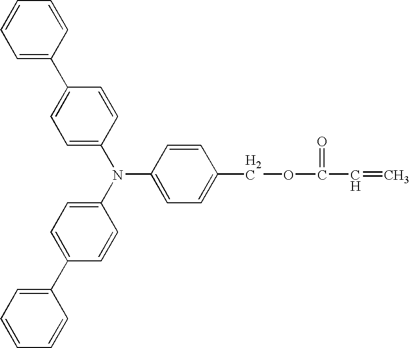

### Example 5

The procedure for preparation of the photoreceptor in Example 1 was repeated except that the charge transport material in the charge transport layer coating liquid was changed to the following compound.

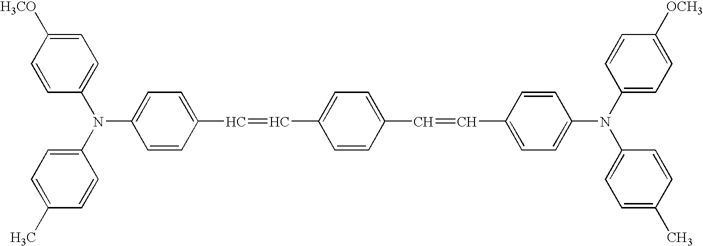

### Example 6

The procedure for preparation of the photoreceptor in Example 1 was repeated except that the charge transport material in the charge transport layer coating liquid was changed to the following compound.

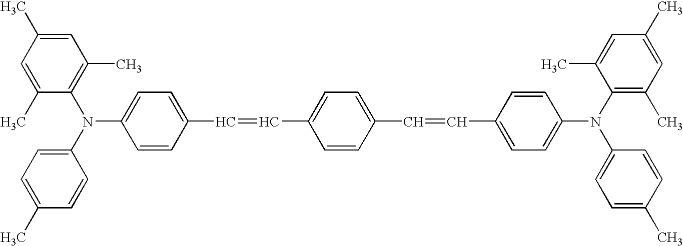

### Example 7

The procedure for preparation of the photoreceptor in Example 1 was repeated except that the charge transport material in the charge transport layer coating liquid was changed to the following compound.

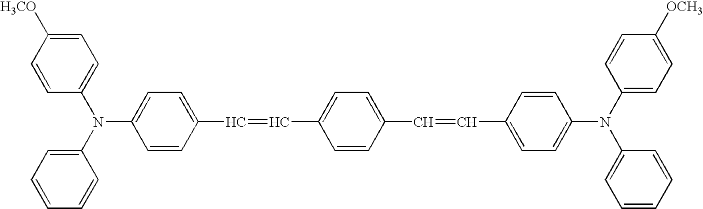

### Example 8

The procedure for preparation of the photoreceptor in Example 7 was repeated except that the charge generation material in the charge generation layer coating liquid was changed to the chlorogallium phthalocyanine prepared in Synthesis Example 3, and the radical-polymerizable compound having a charge transport structure in the cross-linked charge transport layer coating liquid was changed to the following compound.

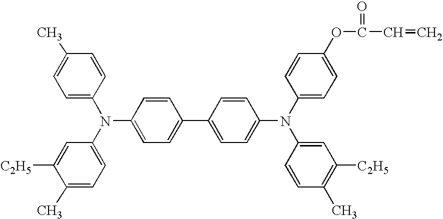

### Example 9

The procedure for preparation of the photoreceptor in Example 3 was repeated except that the charge transport material in the charge transport layer coating liquid was changed to the following compound.

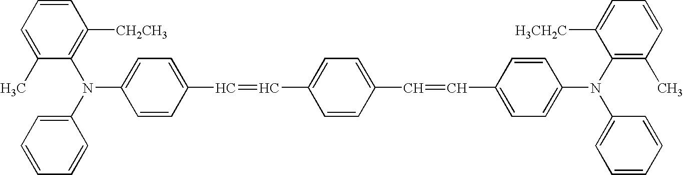

### Example 10

The procedure for preparation of the photoreceptor in Example 4 was repeated except that the charge transport material in the charge transport layer coating liquid was changed to the following compound.

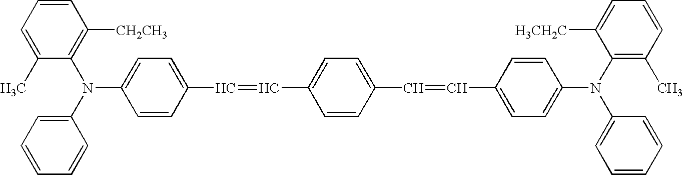

### Example 11

The procedure for preparation of the photoreceptor in Example 9 was repeated except that the charge transport material in the charge transport layer coating liquid was changed to the following compound.

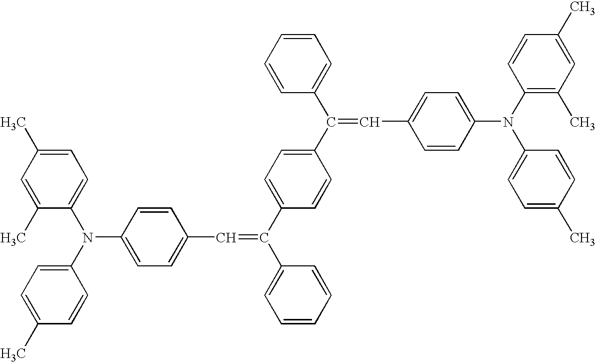

### Example 12

The procedure for preparation of the photoreceptor in Example 1 was repeated except that the charge transport material in the charge transport layer coating liquid was changed to the following compound, the radical-polymerizable monomer having no charge transport structure in the cross-linked charge transport layer coating liquid was changed to a 6-hexanediol diacrylate (from Wako Pure Chemical Industries Ltd., wherein the molecular weight is 226, the number of functional groups is 2, and the ratio of the molecular weight to the number of functional groups is 113), and the radical-polymerizable compound having a charge transport structure in the cross-linked charge transport layer coating liquid was changed to Compound No. 157.

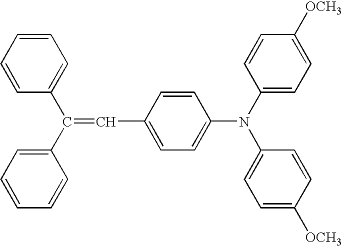

### Example 13

The procedure for preparation of the photoreceptor in Example 12 was repeated except that the radical-polymerizable monomer having no charge transport structure in the cross-linked charge transport layer coating liquid was changed to a dipentaerythritol caprolactone-modified hexaacrylate (KAYARAD DPCA-120 from Nippon Kayaku Co., Ltd., wherein the molecular weight is 1947, the number of functional groups is 6, and the ratio of the molecular weight to the number of functional groups is 325).

### Example 14

The procedure for preparation of the photoreceptor in Example 12 was repeated except that the radical-polymerizable monomer having no charge transport structure in the cross-linked charge transport layer coating liquid was changed to a trimethylolpropane triacrylate (KAYARAD TMPTA from Nippon Kayaku Co., Ltd., wherein the molecular weight is 296, the number of functional groups is 3, and the ratio of the molecular weight to the number of functional groups is 99).

### Example 15

The procedure for preparation of the photoreceptor in Example 14 was repeated except that the radical-polymerizable compound having a charge transport structure in the cross-linked charge transport layer coating liquid was changed to the following compound.

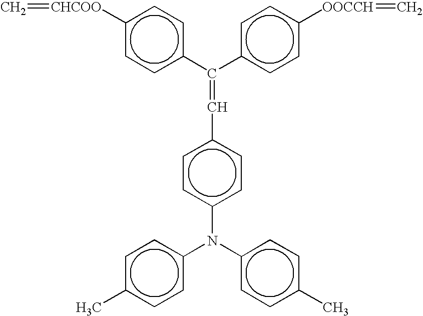

### Example 16

The procedure for preparation of the photoreceptor in Example 14 was repeated except that the radical-polymerizable compound having a charge transport structure in the cross-linked charge transport layer coating liquid was changed to the following compound.

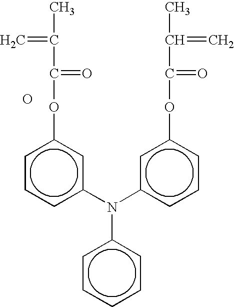

### Example 17

The procedure for preparation of the photoreceptor in Example 14 was repeated except that the radical-polymerizable compound having a charge transport structure in the cross-linked charge transport layer coating liquid was changed to the following compound.

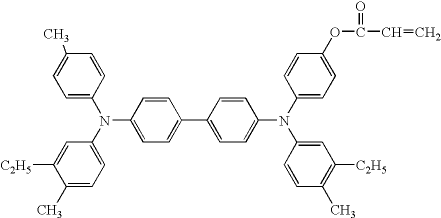

### Example 18

The procedure for preparation of the photoreceptor in Example 14 was repeated except that the radical-polymerizable compound having a charge transport structure in the cross-linked charge transport layer coating liquid was changed to Compound No. 54.

### Example 19

The procedure for preparation of the photoreceptor in Example 18 was repeated except that the charge generation material in the charge generation layer coating liquid was changed to the chlorogallium phthalocyanine prepared in Synthesis Example 3, and the charge transport material in the charge transport layer coating liquid was changed to the following compound.

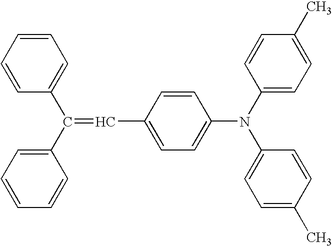

### Example 20

The procedure for preparation of the photoreceptor in Example 18 was repeated except that the charge transport material in the charge transport layer coating liquid was changed to the following compound.

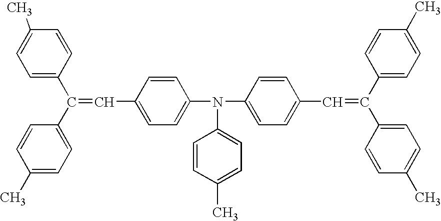

### Example 21

The procedure for preparation of the photoreceptor in Example 1 was repeated except that the thickness of the charge transport layer and the cross-linked charge transport layer were changed to 19.0 μm and 10.3 μm, respectively.

### Example 22

The procedure for preparation of the photoreceptor in Example 1 was repeated except that the thickness of the charge transport layer and the cross-linked charge transport layer were changed to 20.1 μm and 8.5 μm, respectively.

### Example 23

The procedure for preparation of the photoreceptor in Example 1 was repeated except that the charge transport material in the charge transport layer coating liquid was changed to the following compound.

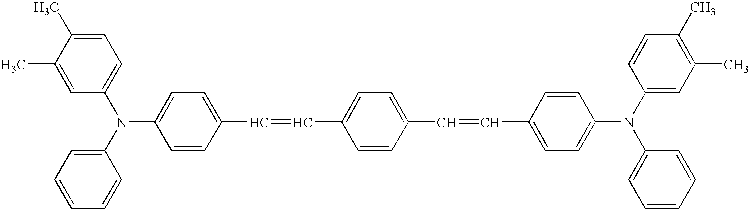

### Example 24

The procedure for preparation of the photoreceptor in Example 1 was repeated except that the charge transport layer coating liquid further included 1 part of the following compound, and the amount of the tetrahydrofuran in the charge transport layer coating liquid was changed to 84 parts.

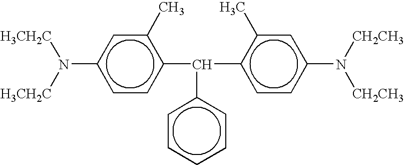

### Example 25

The procedure for preparation of the photoreceptor in Example 1 was repeated except that the charge transport layer coating liquid further included 1 part of the following compound, and the amount of the tetrahydrofuran in the charge transport layer coating liquid was changed to 84 parts.

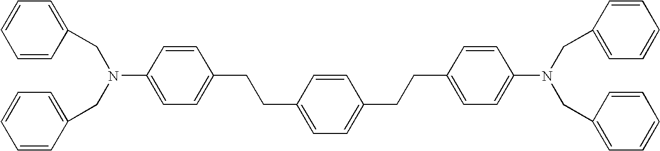

### Example 26

The procedure for preparation of the photoreceptor in Example 1 was repeated except that the charge transport layer coating liquid further included 1 part of the following compound, and the amount of the tetrahydrofuran in the charge transport layer coating liquid was changed to 84 parts.

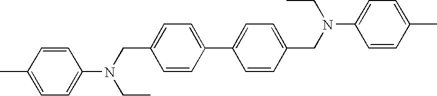

### Example 27

The procedure for preparation of the photoreceptor in Example 1 was repeated except that the charge transport layer coating liquid further included 0.5 parts of the following compound (SANOL LS 2626 from Sanyo), and the amount of the tetrahydrofuran in the charge transport layer coating liquid was changed to 82 parts.

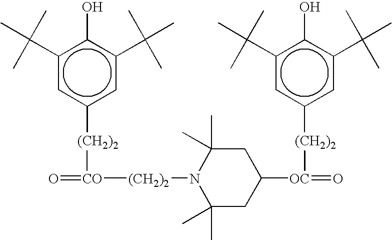

### Example 28

The procedure for preparation of the photoreceptor in Example 1 was repeated except that the charge transport layer coating liquid further included 0.5 parts of the following compound (BHT from Kanto Chemical Co., Inc.), and the amount of the tetrahydrofuran in the charge transport layer coating liquid was changed to 82 parts.

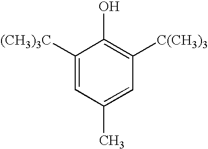

### Example 29

The procedure for preparation of the photoreceptor in Example 1 was repeated except that the cross-linked charge transport layer coating liquid further included 2 parts of an alumina (SUMICORUNDUM AA03 from Sumitomo Chemical Co., Ltd., having an average primary diameter of 0.3 μm).

### Example 30

The procedure for preparation of the photoreceptor in Example 1 was repeated except that the cross-linked charge transport layer coating liquid further included 2 parts of an alumina (SUMICORUNDUM AA05 from Sumitomo Chemical Co., Ltd., having an average primary diameter of 0.5 μm).

### Example 31

The procedure for preparation of the photoreceptor in Example 1 was repeated except that the charge transport layer coating liquid further included 1 part of the following compound:

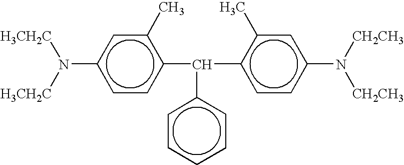

and 0.5 parts of the following compound (SANOL LS 2626 from Sanyo):

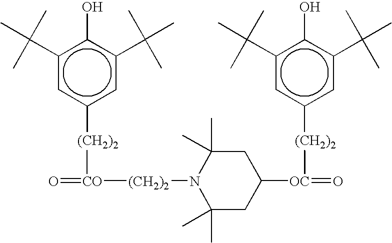

and the amount of the tetrahydrofuran in the charge transport layer coating liquid was changed to 86 parts.

### Example 32

The procedure for preparation of the photoreceptor in Example 1 was repeated except that the charge transport layer coating liquid further included 1 part of the following compound:

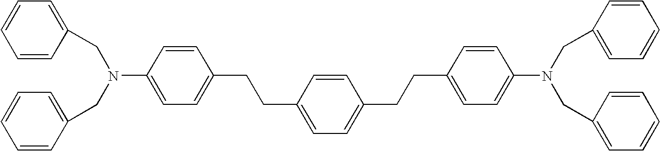

and 0.5 parts of the following compound (SANOL LS 2626 from Sanyo):

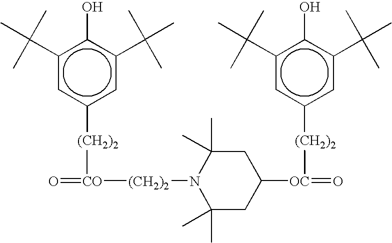

and the amount of the tetrahydrofuran in the charge transport layer coating liquid was changed to 86 parts.

### Example 33

The procedure for preparation of the photoreceptor in Example 1 was repeated except that the charge transport layer coating liquid further included 1 part of the following compound:

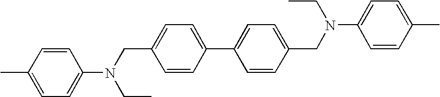

and 0.5 parts of the following compound (SANOL LS 2626 from Sanyo):

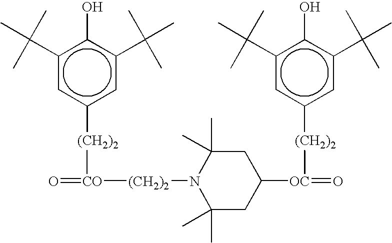

and the amount of the tetrahydrofuran in the charge transport layer coating liquid was changed to 86 parts.

### Example 34

The procedure for preparation of the photoreceptor in Example 1 was repeated except that the charge transport layer coating liquid further included 1 part of the following compound:

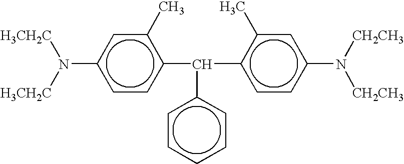

and 0.5 parts of the following compound (BHT from Kanto Chemical Co., Inc.):

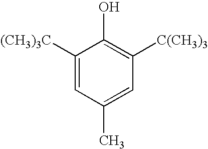

and the amount of the tetrahydrofuran in the charge transport layer coating liquid was changed to 86 parts.

### Example 35

The procedure for preparation of the photoreceptor in Example 1 was repeated except that the charge transport layer coating liquid further included 1 part of the following compound:

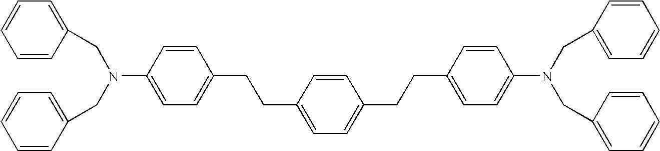

and 0.5 parts of the following compound (BHT from Kanto Chemical Co., Inc.):

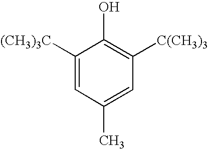

and the amount of the tetrahydrofuran in the charge transport layer coating liquid was changed to 86 parts.

### Example 36

The procedure for preparation of the photoreceptor in Example 1 was repeated except that the charge transport layer coating liquid further included 1 part of the following compound:

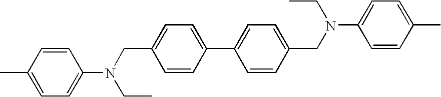

and 0.5 parts of the following compound (BHT from Kanto Chemical Co., Inc.):

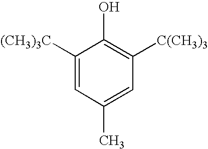

and the amount of the tetrahydrofuran in the charge transport layer coating liquid was changed to 86 parts.

### Example 37

The procedure for preparation of the photoreceptor in Example 1 was repeated except that the charge transport layer coating liquid further included 1 part of the following compound:

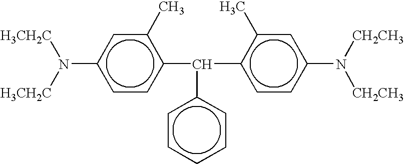

and 0.5 parts of the following compound (SANOL LS 2626 from Sanyo):

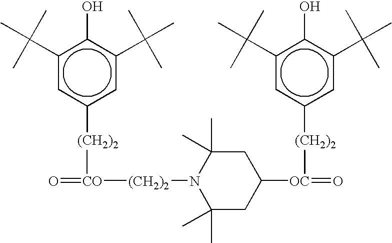

and the amount of the tetrahydrofuran in the charge transport layer coating liquid was changed to 86 parts; and the cross-linked charge transport layer coating liquid further included 2 parts of an alumina (SUMICORUNDUM AA03 from Sumitomo Chemical Co., Ltd., having an average primary diameter of 0.3 μm).

### Example 38

The procedure for preparation of the photoreceptor in Example 1 was repeated except that the charge transport layer coating liquid further included 1 part of the following compound:

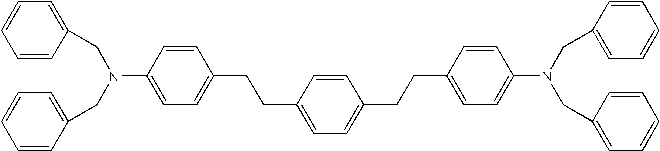

and 0.5 parts of the following compound (SANOL LS 2626 from Sanyo):

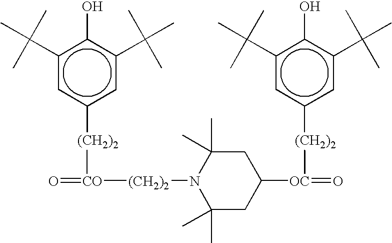

and the amount of the tetrahydrofuran in the charge transport layer coating liquid was changed to 86 parts; and the cross-linked charge transport layer coating liquid further included 2 parts of an alumina (SUMICORUNDUM AA03 from Sumitomo Chemical Co., Ltd., having an average primary diameter of 0.3 μm).

### Example 39

The procedure for preparation of the photoreceptor in Example 1 was repeated except that the charge transport layer coating liquid further included 1 part of the following compound:

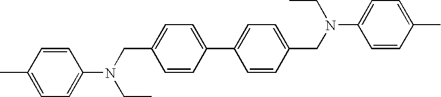

and 0.5 parts of the following compound (SANOL LS 2626 from Sanyo):

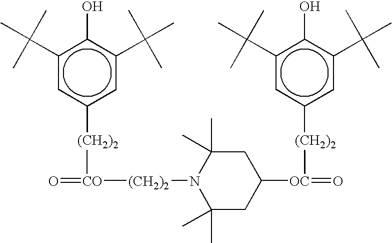

and the amount of the tetrahydrofuran in the charge transport layer coating liquid was changed to 86 parts; and the cross-linked charge transport layer coating liquid further included 2 parts of an alumina (SUMICORUNDUM AA03 from Sumitomo Chemical Co., Ltd., having an average primary diameter of 0.3 μm).

### Example 40

The procedure for preparation of the photoreceptor in Example 39 was repeated except that the charge generation material in the charge generation layer coating liquid was changed to the hydroxygallium phthalocyanine prepared in Synthesis Example 2.

### Example 41

The procedure for preparation of the photoreceptor in Example 39 was repeated except that the charge generation material in the charge generation layer coating liquid was changed to the chlorogallium phthalocyanine prepared in Synthesis Example 3.

### Example 42

The procedure for preparation of the photoreceptor in Example 39 was repeated except that the charge transport material in the charge transport layer coating liquid was changed to the following compound.

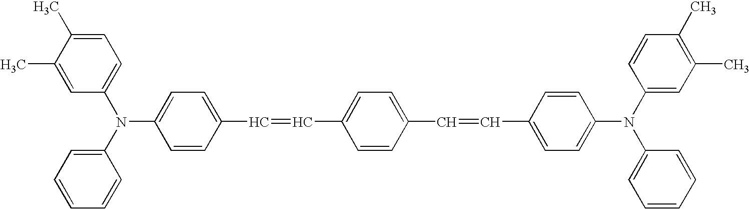

### Example 43

The procedure for preparation of the photoreceptor in Example 40 was repeated except that the charge transport material in the charge transport layer coating liquid was changed to the following compound.

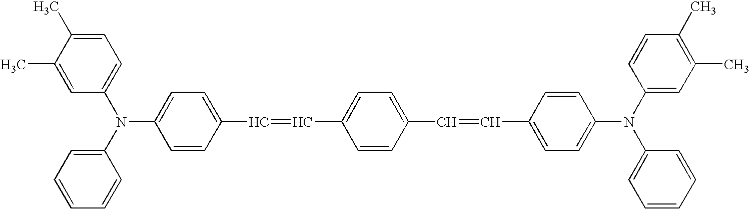

### Example 44

The procedure for preparation of the photoreceptor in Example 41 was repeated except that the charge transport material in the charge transport layer coating liquid was changed to the following compound.

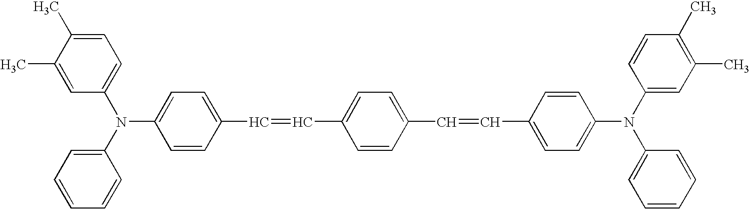

### Example 45

The procedure for preparation of the photoreceptor in Example 1 was repeated except that the charge transport layer coating liquid further included 1 part of the following compound, and the amount of the tetrahydrofuran in the charge transport layer coating liquid was changed to 84 parts.

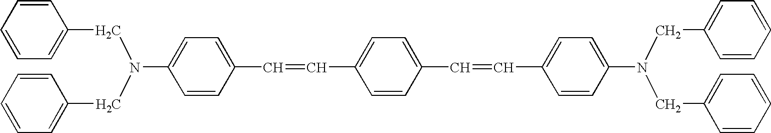

### Example 46

The procedure for preparation of the photoreceptor in Example 1 was repeated except that the charge transport layer coating liquid further included 1 part of the following compound:

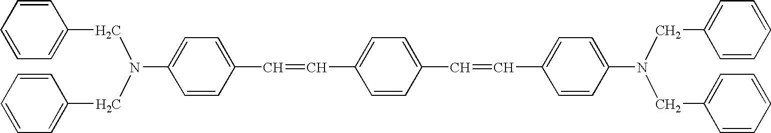

and 0.5 parts of the following compound (SANOL LS 2626 from Sanyo):

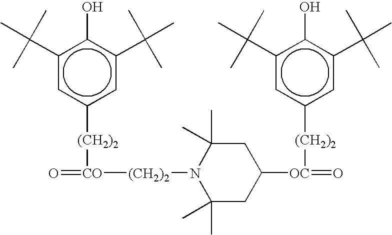

and the amount of the tetrahydrofuran in the charge transport layer coating liquid was changed to 84 parts.

### Example 47

The procedure for preparation of the photoreceptor in Example 1 was repeated except that the charge transport layer coating liquid further included 1 part of the following compound:

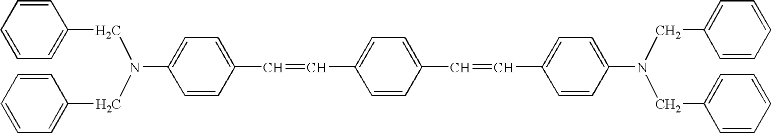

and 0.5 parts of the following compound (SANOL LS 2626 from Sanyo):

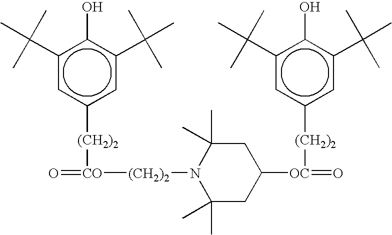

and the amount of the tetrahydrofuran in the charge transport layer coating liquid was changed to 86 parts; and the cross-linked charge transport layer coating liquid further included 2 parts of an alumina (SUMICORUNDUM AA03 from Sumitomo Chemical Co., Ltd., having an average primary diameter of 0.3 μm).

### Example 48

The procedure for preparation of the photoreceptor in Example 1 was repeated except that the radical-polymerizable compound having a charge transport structure in the cross-linked charge transport layer coating liquid was changed to the following compound.

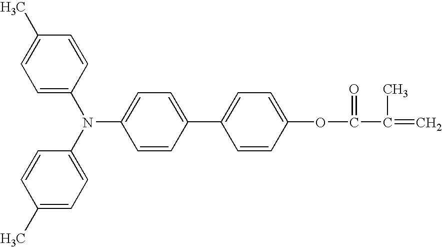

### Example 49

The procedure for preparation of the photoreceptor in Example 33 was repeated except that the radical-polymerizable compound having a charge transport structure in the cross-linked charge transport layer coating liquid was changed to the following compound.

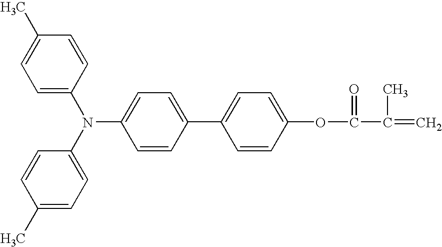

### Example 50

The procedure for preparation of the photoreceptor in Example 29 was repeated except that the radical-polymerizable compound having a charge transport structure in the cross-linked charge transport layer coating liquid was changed to the following compound.

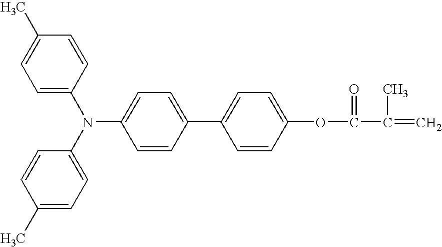

### Example 51

The procedure for preparation of the photoreceptor in Example 42 was repeated except that the radical-polymerizable compound having a charge transport structure in the cross-linked charge transport layer coating liquid was changed to the following compound.

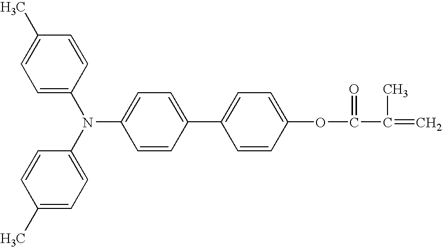

### Comparative Example 1

The procedure for preparation of the photoreceptor in Example 1 was repeated except that the radical-polymerizable compound having a charge transport structure in the cross-linked charge transport layer coating liquid was changed to the following compound.

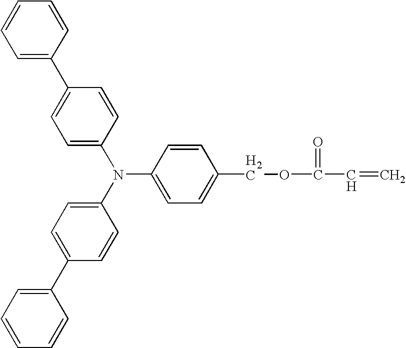

### Comparative Example 2

The procedure for preparation of the photoreceptor in Example 5 was repeated except that the charge generation material in the charge generation layer coating liquid was changed to the chlorogallium phthalocyanine prepared in Synthesis Example 3.

### Comparative Example 3

The procedure for preparation of the photoreceptor in Comparative Example 2 was repeated except that the radical-polymerizable compound having a charge transport structure in the cross-linked charge transport layer coating liquid was changed to the following compound.

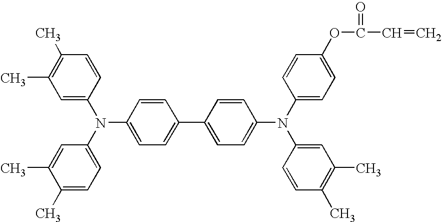

### Comparative Example 4

The procedure for preparation of the photoreceptor in Example 7 was repeated except that the charge generation material in the charge generation layer coating liquid was changed to the X-form metal-free phthalocyanine prepared in Synthesis Example 4.

### Comparative Example 5

The procedure for preparation of the photoreceptor in Comparative Example 4 was repeated except that the radical-polymerizable compound having a charge transport structure in the cross-linked charge transport layer coating liquid was changed to the following compound.

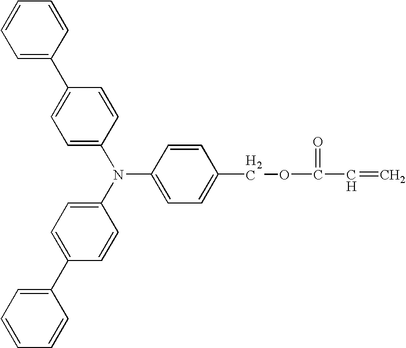

### Comparative Example 6

The procedure for preparation of the photoreceptor in Example 9 was repeated except that the charge generation material in the charge generation layer coating liquid was changed to the titanyl phthalocyanine prepared in Synthesis Example 1.

### Comparative Example 7

The procedure for preparation of the photoreceptor in Example 9 was repeated except that the radical-polymerizable compound having a charge transport structure in the cross-linked charge transport layer coating liquid was changed to the following compound.

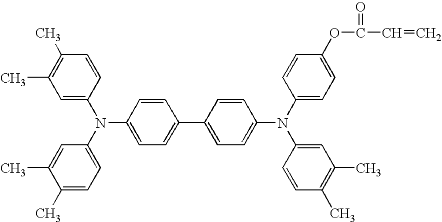

### Comparative Example 8

The procedure for preparation of the photoreceptor in Example 19 was repeated except that the charge generation material in the charge generation layer coating liquid was changed to the titanyl phthalocyanine prepared in Synthesis Example 1.

### Comparative Example 9

The procedure for preparation of the photoreceptor in Example 1 was repeated except that the amounts of the radical-polymerizable monomer having no charge transport structure and the radical-polymerizable compound having a charge transport structure in the cross-linked transport layer coating liquid were changed to 0 part and 20 parts, respectively.

### Comparative Example 10

The procedure for preparation of the photoreceptor in Example 1 was repeated except that the amounts of the radical-polymerizable monomer having no charge transport structure and the radical-polymerizable compound having a charge transport structure in the cross-linked transport layer coating liquid were changed to 20 parts and 0 part, respectively.

### Comparative Example 11

The procedure for preparation of the photoreceptor in Example 1 was repeated except that the radical-polymerizable monomer having no charge transport structure in the cross-linked transport layer coating liquid was replaced with a bisphenol Z polycarbonate (PANLITE TS-2050 from Teijin Chemicals Ltd.).

### Comparative Example 12

The procedure for preparation of the photoreceptor in Example 1 was repeated except that the radical-polymerizable compound having a charge transport structure in the cross-linked transport layer coating liquid was replaced with the following compound.

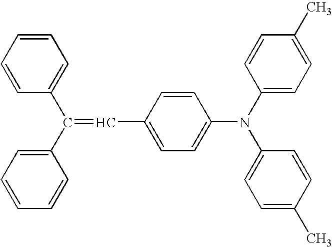

### Comparative Example 13

The procedure for preparation of the photoreceptor in Example 1 was repeated except that no cross-linked charge transport layer was formed on the charge transport layer, and the thickness of the charge transport layer was changed to about 28 μm.

### Comparative Example 14

The procedure for preparation of the photoreceptor in Comparative Example 13 was repeated except that the charge transport material in the charge transport layer coating liquid was changed to the following compound.

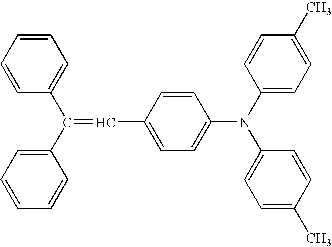

### Comparative Example 15

The procedure for preparation of the photoreceptor in Comparative Example 13 was repeated except that the charge transport material in the charge transport layer coating liquid was changed to the following compound.

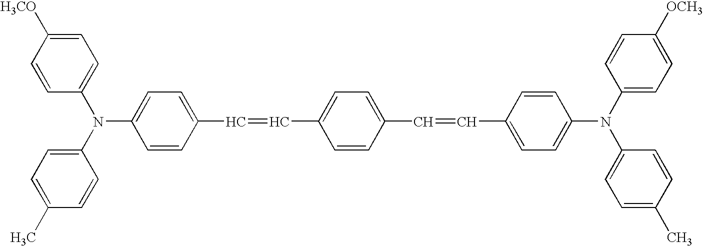

### Comparative Example 16

The procedure for preparation of the photoreceptor in Comparative Example 13 was repeated except that the charge transport material in the charge transport layer coating liquid was changed to the following compound.

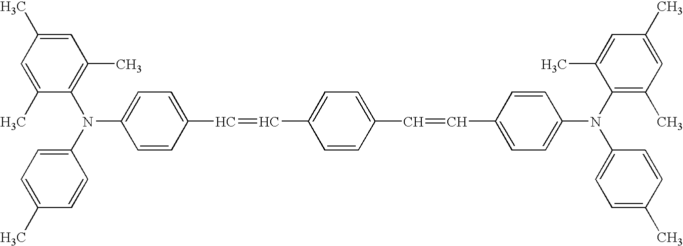

### Comparative Example 17

The procedure for preparation of the photoreceptor in Example 1 was repeated except that the charge transport material in the charge transport layer coating liquid was changed to the following compound.

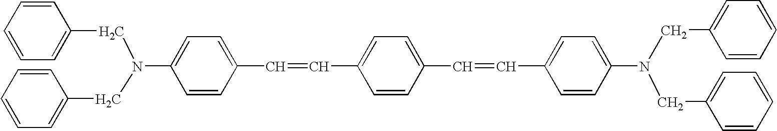

### Comparative Example 18

The procedure for preparation of the photoreceptor in Example 1 was repeated except that the charge transport material in the charge transport layer coating liquid was changed to the following compound.

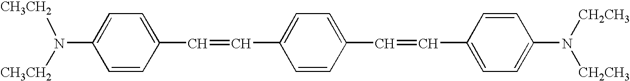

### Comparative Example 19

The procedure for preparation of the photoreceptor in Example 1 was repeated except that a filler-dispersed protective layer was formed on the charge transport layer in replace of the cross-linked charge transport layer. A filler-dispersed protective layer coating liquid included 3 parts of an alumina (SUMICORUNDUM AA03 from Sumitomo Chemical Co., Ltd., having an average primary diameter of 0.3 μm), 5.5 parts of a polycarbonate (Z polycarbonate from Teijin Chemicals Ltd.), 220 parts of tetrahydrofuran, 80 parts of cyclohexanone, and 4 parts of the following charge transport material.

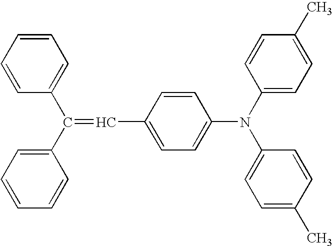

### Comparative Example 20

The procedure for preparation of the photoreceptor in Comparative Example 19 was repeated except that the charge transport material in the filler-dispersed protective layer coating liquid was changed to the following compound.

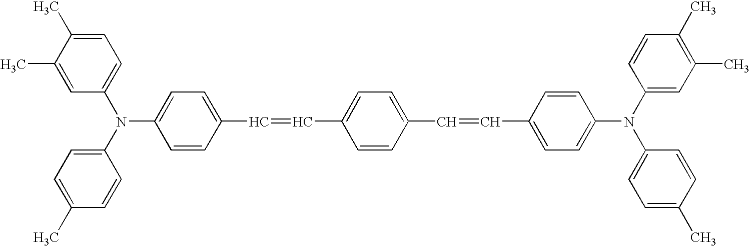

### Comparative Example 21

The procedure for preparation of the photoreceptor in Comparative Example 6 was repeated except that a filler-dispersed protective layer was formed on the charge transport layer in replace of the cross-linked charge transport layer. A filler-dispersed protective layer coating liquid included 3 parts of an alumina (SUMICORUNDUM AA03 from Sumitomo Chemical Co., Ltd., having an average primary diameter of 0.3 μm), 5.5 parts of a polycarbonate (Z polycarbonate from Teijin Chemicals Ltd.), 220 parts of tetrahydrofuran, 80 parts of cyclohexanone, and 4 parts of the following charge transport material.

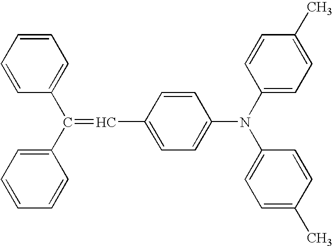

### Comparative Example 22

The procedure for preparation of the photoreceptor in Example 19 was repeated except that a filler-dispersed protective layer was formed on the charge transport layer in replace of the cross-linked charge transport layer. A filler-dispersed protective layer coating liquid included 3 parts of an alumina (SUMICORUNDUM AA03 from Sumitomo Chemical Co., Ltd., having an average primary diameter of 0.3 μm), 5.5 parts of a polycarbonate (Z polycarbonate from Teijin Chemicals Ltd.), 220 parts of tetrahydrofuran, 80 parts of cyclohexanone, and 4 parts of the following charge transport material.

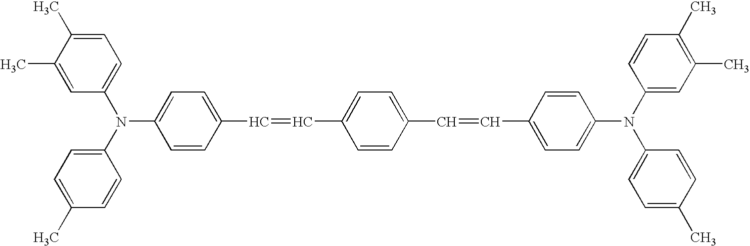

### Comparative Example 23

The procedure for preparation of the photoreceptor in Example 1 was repeated except that the charge generation material in the charge generation layer coating liquid was changed to the X-form metal-free phthalocyanine prepared in Synthesis Example 4.

### Comparative Example 24

The procedure for preparation of the photoreceptor in Comparative Example 13 was repeated except that the charge transport layer coating liquid further included 0.5 parts of the following compound (SANOL LS 2626 from Sanyo), and the amount of the tetrahydrofuran in the charge transport layer coating liquid was changed to 82 parts.

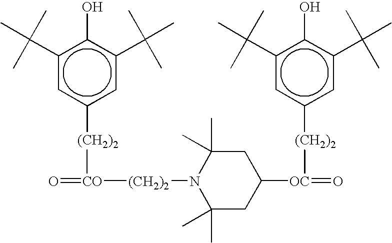

### Measurement of Ionization Potential

Each of the charge generation layers, charge transport layers, and cross-linked charge transport layers formed in the above Examples and Comparative Examples was subjected to a measurement of the ionization potential. Specifically, each of the layers was formed on a smooth surface of an aluminum plate to prepare a sample piece for measurement of the ionization potential. In some cases, a part of a surface of each of the photoreceptors was cut therefrom, and was used for measurement of the ionization potential. It was confirmed that the sample piece and the cut surface have the same ionization potential. The measurement was repeated for 5 times for each sample piece, and the measured values were averaged. The measurement results are shown in Table 1.

TABLE 1

| | | | | | | Thickness of | Thickness of |
|---|---|---|---|---|---|---|---|
| | | | | | | CTL** | CCTL*** |
| | Ip(G) | Ip(T) | Ip(O) | Ip(T) − Ip(G) | Ip(O) − Ip(G) | (μm) | (μm) |
| Ex. 1 | 5.27 | 5.24 | 5.53 | −0.03 | 0.26 | 23.2 | 5.2 |
| Ex. 2 | 5.27 | 5.24 | 5.53 | −0.03 | 0.26 | 22.5 | 5.0 |
| Ex. 3 | 5.40 | 5.24 | 5.53 | −0.16 | 0.13 | 22.5 | 5.6 |
| Ex. 4 | 5.34 | 5.24 | 5.67 | −0.10 | 0.33 | 23.0 | 4.7 |
| Ex. 5 | 5.27 | 5.20 | 5.53 | −0.07 | 0.26 | 23.0 | 5.0 |
| Ex. 6 | 5.27 | 5.24 | 5.53 | −0.03 | 0.26 | 22.9 | 5.0 |
| Ex. 7 | 5.27 | 5.31 | 5.53 | 0.04 | 0.26 | 23.3 | 4.8 |
| Ex. 8 | 5.40 | 5.31 | 5.48 | −0.09 | 0.08 | 22.8 | 5.8 |
| Ex. 9 | 5.40 | 5.39 | 5.53 | −0.01 | 0.13 | 22.4 | 4.8 |
| Ex. 10 | 5.34 | 5.39 | 5.67 | 0.05 | 0.33 | 22.7 | 4.8 |
| Ex. 11 | 5.40 | 5.39 | 5.53 | −0.01 | 0.13 | 22.1 | 4.7 |
| Ex. 12 | 5.27 | 5.26 | 5.47 | −0.01 | 0.20 | 23.1 | 5.1 |
| Ex. 13 | 5.27 | 5.26 | 5.47 | −0.01 | 0.20 | 23.6 | 5.1 |
| Ex. 14 | 5.27 | 5.26 | 5.47 | −0.01 | 0.20 | 22.8 | 5.0 |
| Ex. 15 | 5.27 | 5.26 | 5.52 | −0.01 | 0.25 | 22.7 | 5.2 |
| Ex. 16 | 5.27 | 5.26 | 5.42 | −0.01 | 0.15 | 23.0 | 5.1 |
| Ex. 17 | 5.27 | 5.26 | 5.48 | −0.01 | 0.21 | 23.0 | 5.1 |
| Ex. 18 | 5.27 | 5.26 | 5.53 | −0.01 | 0.26 | 22.7 | 5.0 |
| Ex. 19 | 5.40 | 5.39 | 5.53 | −0.01 | 0.13 | 22.6 | 4.8 |
| Ex. 20 | 5.27 | 5.34 | 5.53 | 0.07 | 0.26 | 23.6 | 4.9 |
| Ex. 21 | 5.27 | 5.24 | 5.53 | −0.03 | 0.26 | 19.0 | 10.3 |
| Ex. 22 | 5.27 | 5.24 | 5.53 | −0.03 | 0.26 | 20.1 | 8.5 |
| Ex. 23 | 5.27 | 5.24 | 5.53 | −0.03 | 0.26 | 22.5 | 5.0 |
| Ex. 24 | 5.27 | 5.24 | 5.53 | −0.03 | 0.26 | 23.6 | 5.2 |
| Ex. 25 | 5.27 | 5.24 | 5.53 | −0.03 | 0.26 | 24.1 | 5.1 |
| Ex. 26 | 5.27 | 5.24 | 5.53 | −0.03 | 0.26 | 23.6 | 5.1 |
| Ex. 27 | 5.27 | 5.24 | 5.53 | −0.03 | 0.26 | 22.4 | 5.4 |
| Ex. 28 | 5.27 | 5.24 | 5.53 | −0.03 | 0.26 | 22.7 | 5.1 |
| Ex. 29 | 5.27 | 5.24 | 5.53 | −0.03 | 0.26 | 24.0 | 4.8 |
| Ex. 30 | 5.27 | 5.24 | 5.53 | −0.03 | 0.26 | 22.7 | 4.8 |
| Ex. 31 | 5.27 | 5.24 | 5.53 | −0.03 | 0.26 | 23.1 | 4.9 |
| Ex. 32 | 5.27 | 5.24 | 5.53 | −0.03 | 0.26 | 23.6 | 5.0 |
| Ex. 33 | 5.27 | 5.24 | 5.53 | −0.03 | 0.26 | 22.8 | 4.8 |
| Ex. 34 | 5.27 | 5.24 | 5.53 | −0.03 | 0.26 | 22.9 | 4.8 |
| Ex. 35 | 5.27 | 5.24 | 5.53 | −0.03 | 0.26 | 23.6 | 4.8 |
| Ex. 36 | 5.27 | 5.24 | 5.53 | −0.03 | 0.26 | 23.0 | 4.7 |
| Ex. 37 | 5.27 | 5.24 | 5.53 | −0.03 | 0.26 | 23.0 | 5.1 |
| Ex. 38 | 5.27 | 5.24 | 5.53 | −0.03 | 0.26 | 22.7 | 4.7 |
| Ex. 39 | 5.27 | 5.24 | 5.53 | −0.03 | 0.26 | 25.1 | 5.0 |
| Ex. 40 | 5.34 | 5.24 | 5.53 | −0.10 | 0.19 | 23.2 | 5.0 |
| Ex. 41 | 5.40 | 5.24 | 5.53 | −0.16 | 0.13 | 22.5 | 4.8 |
| Ex. 42 | 5.34 | 5.31 | 5.53 | −0.03 | 0.19 | 22.5 | 5.8 |
| Ex. 43 | 5.40 | 5.31 | 5.53 | −0.09 | 0.13 | 23.0 | 5.3 |
| Ex. 44 | 5.34 | 5.31 | 5.53 | −0.03 | 0.19 | 24.4 | 5.6 |
| Ex. 45 | 5.27 | 5.24 | 5.53 | −0.03 | 0.26 | 23.6 | 5.1 |
| Ex. 46 | 5.27 | 5.24 | 5.53 | −0.03 | 0.26 | 22.8 | 4.8 |
| Ex. 47 | 5.27 | 5.24 | 5.53 | −0.03 | 0.26 | 22.7 | 4.7 |
| Ex. 48 | 5.27 | 5.24 | 5.52 | −0.03 | 0.25 | 23.2 | 4.9 |
| Ex. 49 | 5.27 | 5.24 | 5.52 | −0.03 | 0.25 | 23.2 | 4.9 |
| Ex. 50 | 5.27 | 5.24 | 5.52 | −0.03 | 0.25 | 23.2 | 4.9 |
| Ex. 51 | 5.27 | 5.24 | 5.52 | −0.03 | 0.25 | 23.2 | 4.9 |
| Comp. Ex. 1 | 5.27 | 5.24 | 5.67 | −0.03 | 0.40 | 22.8 | 5.6 |
| Comp. Ex. 2 | 5.40 | 5.20 | 5.53 | −0.20 | 0.13 | 22.6 | 4.9 |
| Comp. Ex. 3 | 5.40 | 5.20 | 5.47 | −0.20 | 0.07 | 22.8 | 4.9 |
| Comp. Ex. 4 | 5.22 | 5.31 | 5.53 | 0.09 | 0.31 | 22.5 | 5.1 |
| Comp. Ex. 5 | 5.22 | 5.31 | 5.67 | 0.09 | 0.45 | 22.5 | 5.5 |
| Comp. Ex. 6 | 5.27 | 5.39 | 5.53 | 0.12 | 0.26 | 23.4 | 4.8 |
| Comp. Ex. 7 | 5.40 | 5.39 | 5.47 | −0.01 | 0.07 | 23.1 | 5.8 |
| Comp. Ex. 8 | 5.27 | 5.39 | 5.53 | 0.12 | 0.26 | 23.0 | 5.3 |
| Comp. Ex. 9 | CCTL cannot be formed | | | | | | |
| Comp. Ex. 10 | 5.27 | 5.24 | — | −0.03 | — | 23.5 | 4.7 |
| Comp. Ex. 11 | 5.27 | 5.24 | 5.45 | −0.03 | 0.18 | 22.8 | 4.8 |
| Comp. Ex. 12 | 5.27 | 5.24 | 5.39 | −0.03 | 0.12 | 23.4 | 5.2 |
| Comp. Ex. 13 | 5.27 | 5.24 | — | −0.03 | — | 28.4 | — |
| Comp. Ex. 14 | 5.27 | 5.39 | — | 0.12 | — | 28.3 | — |
| Comp. Ex. 15 | 5.27 | 5.20 | — | −0.07 | — | 28.1 | — |
| Comp. Ex. 16 | 5.27 | 5.24 | — | −0.03 | — | 27.7 | — |
| Comp. Ex. 17 | 5.27 | 5.16 | 5.53 | −0.11 | 0.26 | 22.6 | 5.6 |
| Comp. Ex. 18 | 5.27 | 5.01 | 5.53 | −0.26 | 0.26 | 22.5 | 5.2 |
| Comp. Ex. 19 | 5.27 | 5.24 | 5.39 | −0.03 | 0.12 | 22.3 | *5.4 |
| Comp. Ex. 20 | 5.27 | 5.24 | 5.24 | −0.03 | −0.03 | 23.4 | *5.5 |
| Comp. Ex. 21 | 5.27 | 5.39 | 5.39 | 0.12 | 0.12 | 22.8 | *4.9 |
| Comp. Ex. 22 | 5.40 | 5.39 | 5.24 | −0.01 | −0.16 | 23.0 | *4.8 |
| Comp. Ex. 23 | 5.22 | 5.24 | 5.53 | 0.02 | 0.31 | 22.5 | 5.1 |
| Comp. Ex. 24 | 5.27 | 5.24 | — | −0.03 | — | 28.4 | — |

*Filler-dispersed protective layer
**CTL: Charge Transport Layer
***CCTL: Cross-linked Charge Transport Layer

### Evaluation 1

Each of the photoreceptors prepared in Examples 1 to 23 and 48 and Comparative Examples 1 to 24 was mounted on an electrophotographic process cartridge. The process cartridge was attached to a modified image forming apparatus IMAGIO NEO 751 (from Ricoh Co., Ltd.) in which the linear speed (i.e., process speed) of photoreceptor was 350 mm/sec. A running test in which an image is continuously produced on 300,000 sheets of an A4-size paper MY PAPER (from NBS Ricoh) was performed. The initial potential was −800 V. The following evaluations were performed during the running test.

### 1-1 Measurement of Abrasion Quantity

The photoreceptor was taken out of the apparatus after each of 100,000^{th} and 300,000^{th} sheets was produced, and subjected to a measurement of the thickness of the coating layer using an eddy-current film thickness meter FISHERSCOPE MMS (from Fisher). By comparing the thicknesses at before and after the running test, the abrasion quantity was calculated. The results are shown in Table 2.

TABLE 2

Abrasion Quantity (μm)

| | After 100,000th | After 300,000th |
|---|---|---|
| | image is produced | image is produced |
| Ex. 1 | 0.3 | 0.9 |
| Ex. 2 | 0.4 | 1.2 |
| Ex. 3 | 0.3 | 0.9 |
| Ex. 4 | 0.4 | 1.1 |
| Ex. 5 | 0.3 | 0.9 |
| Ex. 6 | 0.4 | 1.0 |
| Ex. 7 | 0.4 | 1.2 |
| Ex. 8 | 0.5 | 1.5 |
| Ex. 9 | 0.4 | 1.2 |
| Ex. 10 | 0.5 | 1.5 |
| Ex. 11 | 0.3 | 0.9 |
| Ex. 12 | 1.1 | 3.5 |
| Ex. 13 | 1.2 | 3.4 |
| Ex. 14 | 0.9 | 2.8 |
| Ex. 15 | 1.2 | 3.1 |
| Ex. 16 | 1.1 | 3.2 |
| Ex. 17 | 0.6 | 1.9 |
| Ex. 18 | 0.6 | 1.8 |
| Ex. 19 | 0.7 | 2.0 |
| Ex. 20 | 0.6 | 1.7 |
| Ex. 21 | 0.6 | 1.8 |
| Ex. 22 | 0.6 | 1.8 |
| Ex. 23 | 0.5 | 1.1 |
| Ex. 48 | 0.5 | 1.3 |
| Comp. Ex. 1 | 0.5 | 1.6 |
| Comp. Ex. 2 | 0.3 | 1.0 |
| Comp. Ex. 3 | 0.5 | 1.5 |
| Comp. Ex. 4 | 0.4 | 1.4 |
| Comp. Ex. 5 | 0.5 | 1.5 |
| Comp. Ex. 6 | 0.4 | 1.2 |
| Comp. Ex. 7 | 0.5 | 1.5 |
| Comp. Ex. 8 | 0.3 | 0.9 |

| | |
|---|---|
| Comp. Ex. 9 | CCTL cannot be formed |
| Comp. Ex. 10 | Not evaluated |

| | | |
|---|---|---|
| Comp. Ex. 11 | 2.5 | 7.7 |
| Comp. Ex. 12 | 2.0 | 6.1 |
| Comp. Ex. 13 | 2.7 | 8.2 |
| Comp. Ex. 14 | 2.6 | 8.6 |
| Comp. Ex. 15 | 2.8 | 7.9 |
| Comp. Ex. 16 | 2.9 | 8.5 |

| | |
|---|---|
| Comp. Ex. 17 | Not evaluated |
| Comp. Ex. 18 | Not evaluated |

| | | |
|---|---|---|
| Comp. Ex. 19 | 0.6 | 1.9 |
| Comp. Ex. 20 | 0.6 | 1.8 |
| Comp. Ex. 21 | 0.7 | 2.2 |
| Comp. Ex. 22 | 0.7 | 2.3 |
| Comp. Ex. 23 | 0.4 | 1.4 |
| Comp. Ex. 24 | 2.7 | 8.2 |

### 1-2 Measurement of Bright Section Potential

An electrometer probe connected to a surface electrometer (TREK MODEL 344) was attached to the developing unit, to which the photoreceptor was set. The grid bias was controlled so that the dark section potential was −800 V. After a black solid image was produced, the bright section potential was measured before starting the running test. Similarly, the bright section potential was also measured after each of 100,000^{th} and 300,000^{th} sheets was produced. The same evaluation was also performed at 10° C., 15% RH, to evaluate resistance to environmental variation. The results are shown in Table 3.

TABLE 3

| | Bright Section Potential (−V) | | | |
|---|---|---|---|---|
| | Initial | After 100,000th | After 300,000th | at 10° C., |
| | Stage | image is produced | image is produced | 15% RH |
| Ex. 1 | 100 | 95 | 90 | 145 |
| Ex. 2 | 100 | 90 | 85 | 145 |
| Ex. 3 | 90 | 80 | 70 | 100 |
| Ex. 4 | 120 | 130 | 155 | 180 |
| Ex. 5 | 95 | 90 | 80 | 145 |
| Ex. 6 | 110 | 100 | 95 | 150 |
| Ex. 7 | 115 | 110 | 105 | 155 |
| Ex. 8 | 105 | 95 | 70 | 130 |
| Ex. 9 | 125 | 135 | 145 | 150 |
| Ex. 10 | 130 | 135 | 150 | 165 |
| Ex. 11 | 135 | 130 | 145 | 155 |
| Ex. 12 | 170 | 175 | 185 | 190 |
| Ex. 13 | 165 | 175 | 185 | 195 |
| Ex. 14 | 160 | 180 | 190 | 195 |
| Ex. 15 | 150 | 145 | 160 | 185 |
| Ex. 16 | 150 | 155 | 175 | 190 |
| Ex. 17 | 140 | 150 | 155 | 185 |
| Ex. 18 | 145 | 145 | 155 | 195 |
| Ex. 19 | 140 | 150 | 165 | 180 |
| Ex. 20 | 150 | 170 | 185 | 195 |
| Ex. 21 | 110 | 125 | 140 | 180 |
| Ex. 22 | 105 | 115 | 125 | 155 |
| Ex. 23 | 110 | 100 | 95 | 155 |
| Ex. 48 | 100 | 95 | 90 | 145 |
| Comp. Ex. 1 | 150 | 165 | 215 | 255 |
| Comp. Ex. 2 | 75 | 60 | 50 | 80 |
| Comp. Ex. 3 | 70 | 55 | 45 | 80 |
| Comp. Ex. 4 | 210 | 270 | 320 | 330 |
| Comp. Ex. 5 | 235 | 300 | 350 | 380 |
| Comp. Ex. 6 | 160 | 180 | 220 | 290 |
| Comp. Ex. 7 | 120 | 110 | 90 | 145 |
| Comp. Ex. 8 | 180 | 185 | 190 | 275 |
| Comp. Ex. 9 | CCTL cannot be formed | | | |
| Comp. Ex. 10 | 390 | Not evaluated | | |
| Comp. Ex. 11 | 210 | 235 | 110 | 305 |
| Comp. Ex. 12 | 180 | 195 | 120 | 235 |
| Comp. Ex. 13 | 70 | 50 | 45 | 110 |
| Comp. Ex. 14 | 140 | 160 | 180 | 220 |
| Comp. Ex. 15 | 60 | 50 | 35 | 100 |
| Comp. Ex. 16 | 75 | 65 | 55 | 120 |
| Comp. Ex. 17 | 360 | Not evaluated | | |
| Comp. Ex. 18 | 330 | Not evaluated | | |
| Comp. Ex. 19 | 140 | 130 | 115 | 230 |
| Comp. Ex. 20 | 120 | 110 | 100 | 200 |
| Comp. Ex. 21 | 210 | 230 | 270 | 310 |
| Comp. Ex. 22 | 170 | 180 | 190 | 250 |
| Comp. Ex. 23 | 200 | 250 | 290 | 320 |
| Comp. Ex. 24 | 70 | 50 | 45 | 110 |

### 1-3 Evaluation of Image

A halftone image having an image density of 50% was produced before and after the running test to evaluate change in image density.

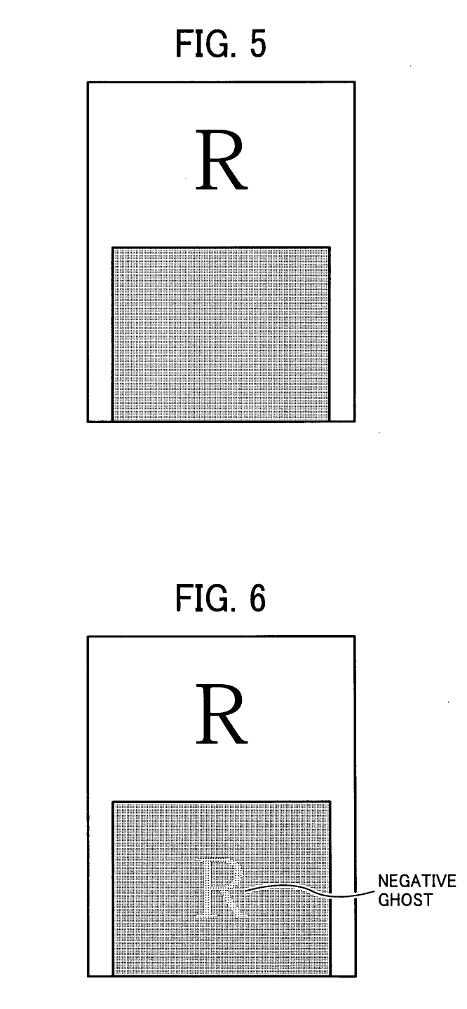

In addition, an image for evaluating negative ghost illustrated in FIG. 5 was produced before and after the running test to evaluate the degree of negative ghost as illustrated in FIG. 6.

Further, a white solid image was produced before and after the running test to visually observe the degree of background fouling.

Image quality was graded into the following 4 levels. The results are shown in Table 4.

A: Very good.

B: Good. No problem in visual observation.

C: Slightly poor.

D: Poor.

TABLE 4

| | Image Evaluation | |
|---|---|---|
| | Before | |
| | Running Test | After Running Test |
| Ex. 1 | A | A |
| Ex. 2 | A | A |
| Ex. 3 | A | B |
| Ex. 4 | A | B |
| Ex. 5 | A | A |
| Ex. 6 | A | A |
| Ex. 7 | A | A |
| Ex. 8 | A | B |
| Ex. 9 | A | A |
| Ex. 10 | A | B |
| Ex. 11 | A | A |
| Ex. 12 | B | B |
| Ex. 13 | B | B |
| Ex. 14 | B | B |
| Ex. 15 | A | B |
| Ex. 16 | A | B |
| Ex. 17 | A | B |
| Ex. 18 | A | B |
| Ex. 19 | A | B |
| Ex. 20 | A | B |
| Ex. 21 | A | B |
| Ex. 22 | A | A |
| Ex. 23 | A | A |
| Ex. 48 | A | A |
| Comp. Ex. 1 | A | C |
| | | Image density is low. |
| | | Negative ghost appears. |
| Comp. Ex. 2 | A | C |
| | | Image density is high. |
| | | Background fouling occurs. |
| | | Image blurring occurs. |
| Comp. Ex. 3 | A | D |
| | | Image density is high. |
| | | Background fouling |
| | | considerably occurs. |
| | | Image blurring considerably occurs. |
| Comp. Ex. 4 | C | C |
| | Image density | Image density is low. |
| | is low. | Negative ghost appears. |
| Comp. Ex. 5 | C | D |
| | Image density | Image density is considerably low. |
| | is low. | Negative ghost considerably appears. |
| Comp. Ex. 6 | A | C |
| | | Image density is low. |
| | | Negative ghost appears. |
| Comp. Ex. 7 | A | C |
| | | Image density is high. |
| | | Background fouling occurs. |
| | | Image blurring occurs. |
| Comp. Ex. 8 | B | C |
| | | Image density is low. |
| | | Negative ghost appears. |
| Comp. Ex. 9 | CCTL cannot be formed | |
| Comp. Ex. 10 | D | Not evaluated |
| | Image density is | |
| | considerably low. | |
| | Negative ghost | |
| | considerably | |
| | appears. | |
| Comp. Ex. 11 | B | D |
| | | Image density is high. |
| | | Background fouling |
| | | considerably occurs. |
| Comp. Ex. 12 | B | C |
| | | Image density is low. |
| | | Negative ghost appears. |
| | | Background fouling |
| | | considerably occurs. |
| Comp. Ex. 13 | A | D |
| | | Image density is high. |
| | | Background fouling occurs. |
| | | Image blurring considerably occurs. |
| Comp. Ex. 14 | A | C |
| | | Image density is low. |
| | | Negative ghost appears. |
| Comp. Ex. 15 | A | D |
| | | Image density is high. |
| | | Background fouling occurs. |
| | | Image blurring considerably occurs. |
| Comp. Ex. 16 | A | D |
| | | Image density is high. |
| | | Background fouling occurs. |
| | | Image blurring considerably occurs. |
| Comp. Ex. 17 | D | Not evaluated |
| | Image density is | |
| | considerably low. | |
| | Negative ghost | |
| | considerably | |
| | appears. | |
| Comp. Ex. 18 | D | Not evaluated |
| | Image density is | |
| | considerably low. | |
| | Negative ghost | |
| | considerably | |
| | appears. | |
| Comp. Ex. 19 | A | D |
| | | Image density is low. |
| | | Image blurring considerably occurs. |
| Comp. Ex. 20 | A | D |
| | | Image blurring considerably occurs. |
| | | Background fouling occurs. |
| Comp. Ex. 21 | C | D |
| | Image density | Image density is low. |
| | is low. | Image blurring considerably occurs. |
| Comp. Ex. 22 | C | D |
| | Image density | Image density is low. |
| | is low. | Image blurring considerably occurs. |
| Comp. Ex. 23 | B | D |
| | | Image density is considerably low. |
| | | Negative ghost considerably appears. |
| Comp. Ex. 24 | A | D |
| | | Image density is high. |
| | | Background fouling occurs. |
| | | Image blurring considerably occurs. |

### Evaluation 2

Each of the photoreceptors prepared in Examples 1, 24 to 47, and 49 to 51 was subjected to the same running test in Evaluation 1 except for producing 1,000,000 sheets.

### 2-1 Measurement of Abrasion Quantity

The photoreceptor was taken out of the apparatus after 1,000,000^{th} sheets was produced, and subjected to a measurement of the thickness of the coating layer in the same manner as 1-1. The results are shown in Table 5.

TABLE 5

| | Abrasion Quantity (μm) |
|---|---|
| | After 1,000,000th image is produced |
| Ex. 1 | 2.6 |
| Ex. 24 | 2.7 |
| Ex. 25 | 2.8 |
| Ex. 26 | 2.4 |
| Ex. 27 | 2.5 |
| Ex. 28 | 2.6 |
| Ex. 29 | 0.5 |
| Ex. 30 | 0.5 |
| Ex. 31 | 2.5 |
| Ex. 32 | 2.6 |
| Ex. 33 | 2.7 |
| Ex. 34 | 3.0 |
| Ex. 35 | 2.5 |
| Ex. 36 | 2.4 |
| Ex. 37 | 0.5 |
| Ex. 38 | 0.6 |
| Ex. 39 | 0.5 |
| Ex. 40 | 0.4 |
| Ex. 41 | 0.5 |
| Ex. 42 | 0.6 |
| Ex. 43 | 0.5 |
| Ex. 44 | 0.5 |
| Ex. 45 | 2.4 |
| Ex. 46 | 2.7 |
| Ex. 47 | 0.6 |
| Ex. 49 | 3.4 |
| Ex. 50 | 0.7 |
| Ex. 51 | 0.7 |

### 2-2 Measurement of Bright Section Potential

The bright section potential was measured after 1,000,000^{th} sheet was produced in the same manner as 1-2. The results are shown in Table 6.

TABLE 6

Bright Section Potential (−V)

| | Initial Stage | After 1,000,000th image is produced |
|---|---|---|
| Ex. 1 | 100 | 65 |
| Ex. 24 | 100 | 85 |
| Ex. 25 | 100 | 85 |
| Ex. 26 | 100 | 85 |
| Ex. 27 | 100 | 90 |
| Ex. 28 | 100 | 80 |
| Ex. 29 | 105 | 80 |
| Ex. 30 | 115 | 95 |
| Ex. 31 | 105 | 100 |
| Ex. 32 | 105 | 100 |
| Ex. 33 | 105 | 100 |
| Ex. 34 | 105 | 95 |
| Ex. 35 | 105 | 95 |
| Ex. 36 | 105 | 95 |
| Ex. 37 | 110 | 105 |
| Ex. 38 | 110 | 105 |
| Ex. 39 | 110 | 105 |
| Ex. 40 | 115 | 115 |
| Ex. 41 | 105 | 105 |
| Ex. 42 | 125 | 120 |
| Ex. 43 | 120 | 115 |
| Ex. 44 | 120 | 115 |
| Ex. 45 | 100 | 85 |
| Ex. 46 | 105 | 100 |
| Ex. 47 | 110 | 105 |
| Ex. 49 | 105 | 100 |
| Ex. 50 | 105 | 80 |
| Ex. 51 | 110 | 105 |

### 2-3 Evaluation of Image

Each of the images produced before and after the running test was subjected to image evaluations in the same manner as 1-3. The results are shown in Table 7.

TABLE 7

Image Evaluation

| | Before Running Test | After Running Test |
|---|---|---|
| Ex. 1 | A | B |
| Ex. 24 | A | B |
| Ex. 25 | A | B |
| Ex. 26 | A | B |
| Ex. 27 | A | B |
| Ex. 28 | A | B |
| Ex. 29 | A | B |
| Ex. 30 | A | B |
| Ex. 31 | A | A |
| Ex. 32 | A | A |
| Ex. 33 | A | A |
| Ex. 34 | A | A |
| Ex. 35 | A | A |
| Ex. 36 | A | A |
| Ex. 37 | A | A |
| Ex. 38 | A | A |
| Ex. 39 | A | A |
| Ex. 40 | A | A |
| Ex. 41 | A | A |
| Ex. 42 | A | A |
| Ex. 43 | A | A |
| Ex. 44 | A | A |
| Ex. 45 | A | B |
| Ex. 46 | A | A |
| Ex. 47 | A | A |
| Ex. 49 | A | A |
| Ex. 50 | A | B |
| Ex. 51 | A | A |

### 2-4 Oxidizing Gas Exposure Test

A piece of tape having a substantially square shape with each side having a length of 5 cm was adhered to each of the photoreceptors prepared in Examples 1, 24 to 47, and 49 to 51, to mask a surface. These photoreceptors were put in a chamber filled with 40 ppm of NO gas and 10 ppm of NO₂ gas for 96 hours. Then, each of the photoreceptors was mounted on a modified image forming apparatus IMAGIO NEO 751 (Ricoh Co., Ltd.) to produce an image. The produced image was subjected to a measurement of a difference in image density between areas corresponding to the exposed portion and to the unexposed portion (i.e., masked portion). The difference in image density was graded as follows. The results are shown in Table 8.

5: No difference is visually observed.

4: A slight difference is observed.

3: A difference is visually observed, but no problem in practical use.

2: A difference is clearly observed.

1: A considerable difference is observed.

TABLE 8

| | Image Evaluation | |
|---|---|---|
| | Before Exposure to NOx | After 96-hour Exposure to NOx |
| Ex. 1 | 5 | 3 |
| Ex. 24 | 5 | 4 |
| Ex. 25 | 5 | 4 |
| Ex. 26 | 5 | 4 |
| Ex. 27 | 5 | 4 |
| Ex. 28 | 5 | 4 |
| Ex. 29 | 5 | 3 |
| Ex. 30 | 5 | 3 |
| Ex. 31 | 5 | 5 |
| Ex. 32 | 5 | 5 |
| Ex. 33 | 5 | 5 |
| Ex. 34 | 5 | 5 |
| Ex. 35 | 5 | 5 |
| Ex. 36 | 5 | 5 |
| Ex. 37 | 5 | 5 |
| Ex. 38 | 5 | 5 |
| Ex. 39 | 5 | 5 |
| Ex. 40 | 5 | 5 |
| Ex. 41 | 5 | 5 |
| Ex. 42 | 5 | 5 |
| Ex. 43 | 5 | 5 |
| Ex. 44 | 5 | 5 |
| Ex. 45 | 5 | 4 |
| Ex. 46 | 5 | 5 |
| Ex. 47 | 5 | 5 |
| Ex. 49 | 5 | 5 |
| Ex. 50 | 5 | 3 |
| Ex. 51 | 5 | 5 |

It is apparent from the above results that a photoreceptor having a cross-linked surface that formed from a radical-polymerizable monomer having no charge transport structure and a radical-polymerizable compound having a charge transport structure and that satisfies the equations (1) and (2) is capable of reliably producing high quality images for an extended period of time. Specifically, such a photoreceptor has high abrasion resistance and is capable of reliably suppressing increase of the bright section potential, formation of negative ghost, image blurring, and background fouling. In particular, when the number of functional groups in the radical-polymerizable monomer having no charge transport structure is 3 or more, the ratio of the molecular weight thereof to the number of functional groups is 250 or less, and the radical-polymerizable compound having a charge transport structure is monofunctional, abrasion resistance is more improved, resulting in extended lifetime of the photoreceptor.

It is also apparent from the above results that a photoreceptor including a distyryl compound, in particular, a distyryl benzene derivative, as a charge transport material is capable of reliably suppressing increase of the bright section potential and formation of negative ghost. In a case in which the distyryl benzene derivative is included in an outermost layer of the photoreceptor, image blurring may considerably occurs due to exposure to NOx. By providing the cross-linked charge transport layer thereon, image blurring may be suppressed. Further, increase of the bright section potential, formation of negative ghost, and background fouling are also suppressed due to improvement of abrasion resistance. On the other hand, the filler-dispersed protective layer cannot suppress image blurring caused by Nox exposure.

It is also apparent from the above results that when the thickness of the charge transport layer is thinner than twice the thickness of the cross-linked charge transport layer, the bright section potential tends to increase. Accordingly, it is confirmed that the thicknesses of both the charge transport layer and the cross-linked charge transport layer have a great effect on image quality.

It is also apparent from the above results that when at least one of R₃, R₈, R₁₉, and R₂₄ in a distyrylbenzene derivative having the formula (3) is methyl group, the bright section potential is effectively decreased.

It is also apparent from the above results that when the charge transport layer includes the compound having the formula (4), (5-1), (5-2), or (6), potential variation is suppressed during the running test. Accordingly, images are reliably produced even under NOx exposure.

It is also apparent from the above results that when an antioxidant is included in the charge transport layer, potential variation is suppressed during the running test. Accordingly, images are reliably produced even under NOx exposure.

Further, when a combination of the compound having the formula (4), (5-1), (5-2), or (6) and an antioxidant is included in the charge transport layer, potential variation is suppressed during the running test and images are more reliably produced even under NOx exposure. These compounds do not contribute to increase of the bright section potential.

It is also apparent from the above results that when a filler is included in the cross-linked charge transport layer, abrasion resistance considerably increases.

Further, when a combination of the compound having the formula (4), (5-1), (5-2), or (6) and an antioxidant is included in the cross-linked charge transport layer, potential variation is suppressed during the running test and images are more reliably produced even under NOx exposure. In addition, abrasion resistance considerably increases.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Applications Nos. 2008-003116 and 2008-292899, filed on Jan. 10, 2008 and Nov. 17, 2008, respectively, the entire contents of which are herein incorporated by reference.

What is claimed is:

1. An electrophotographic photoreceptor, comprising:
a conductive substrate;
a charge generation layer comprising a metal phthalocyanine pigment as a charge generation material, located overlying the conductive substrate;
a charge transport layer comprising a charge transport material having a triarylamine structure, located overlying the charge generation layer; and
a cross-linked charge transport layer formed by hardening a radical-polymerizable monomer having no charge transport structure and a radical-polymerizable compound having a charge transport structure, located overlying the charge transport layer,
wherein the following equations (1) and (2) are satisfied:
−0.16≦Ip(T)−Ip(G)≦0.07 (1)
0.07<Ip(O)−Ip(G)≦0.33 (2)
wherein Ip(G), Ip(T), and Ip(O) represent ionization potentials of the charge generation layer, the charge transport layer, and the cross-linked charge transport layer, respectively.

2. The electrophotographic photoreceptor according to claim 1, wherein at least one of the radical-polymerizable monomer having no charge transport structure and the radical-polymerizable compound having a charge transport structure has a functional group selected from the group consisting of acryloyloxy group and methacryloyloxy group.

3. The electrophotographic photoreceptor according to claim 1, wherein a number of functional groups in the radical-polymerizable monomer having no charge transport structure is 3 or more, and a ratio of a molecular weight to the number of functional groups is 250 or less.

4. The electrophotographic photoreceptor according to claim 1, wherein the charge transport structure in the radical-polymerizable compound is a triarylamine structure.

5. The electrophotographic photoreceptor according to claim 1, wherein the radical-polymerizable compound having a charge transport structure is selected from the group consisting of compounds having the following formulae (1) and (2): 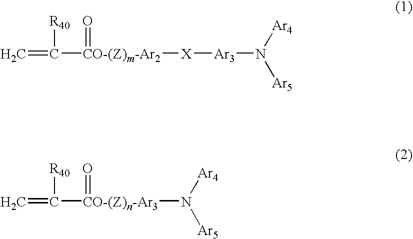
wherein R₄₀ represents a hydrogen atom, a halogen atom, an alkyl group which may have a substituent, an aralkyl group which may have a substituent, an aryl group which may have a substituent, cyano group, nitro group, an alkoxy group, —COOR₄₁ (wherein R₄₁ represents a hydrogen atom, an alkyl group which may have a substituent, an aralkyl group which may have a substituent, or an aryl group which may have a substituent), a halogenated carbonyl group, or —CONR₄₂R₄₃ (wherein each of R₄₂ and R₄₃ independently represents a hydrogen atom, a halogen atom, an alkyl group which may have a substituent, an aralkyl group which may have a substituent, or an aryl group which may have a substituent); each of Ar₂ and Ar₃ independently represents a substituted or unsubstituted arylene group; each of Ar₄ and Ar₅ independently represents a substituted or unsubstituted aryl group; X represents a single bond, a substituted or unsubstituted alkylene group, a substituted or unsubstituted cycloalkylene group, a substituted or unsubstituted alkylene ether group, an oxygen atom, a sulfur atom, or a vinylene group; Z represents a substituted or unsubstituted alkylene group, a substituted or unsubstituted alkylene ether group, or an alkylene oxycarbonyl group; and each of m and n independently represents an integer of 0 to 3.

6. The electrophotographic photoreceptor according to claim 1, wherein the charge transport material having a triarylamine structure is a distyryl compound.

7. The electrophotographic photoreceptor according to claim 6, wherein the distyryl compound is a distyrylbenzene derivative having the following formula (3): 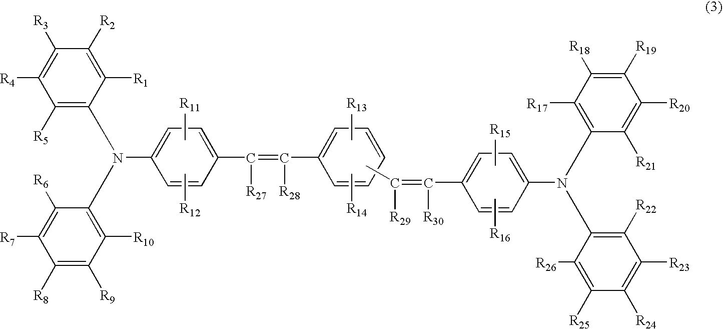
wherein each of R₁ to R₃₀ independently represents a hydrogen atom, an alkyl group having 1 to 4 carbon atoms, an alkoxy group having 1 to 4 carbon atoms, or an aryl group which is substituted with a hydrogen atom, an alkyl group having 1 to 4 carbon atoms, or an alkoxy group having 1 to 4 carbon atoms.

8. The electrophotographic photoreceptor according to claim 7, wherein at least one of R₃, R₈, R₁₉, and R₂₄ is methyl group.

9. The electrophotographic photoreceptor according to claim 1, wherein the cross-linked charge transport layer comprises a filler.

10. The electrophotographic photoreceptor according to claim 1, wherein the charge transport layer comprises an antioxidant.

11. The electrophotographic photoreceptor according to claim 1, wherein the charge transport layer further comprises a compound having the following formula (4): 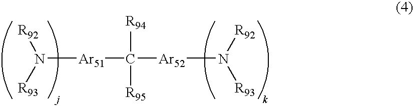
wherein each of R₉₂ and R₉₃ independently represents an alkyl group having 1 to 4 carbon atoms which may be substituted with an aromatic group, and R₉₂ and R₉₃ may share bond connectivity to form a heterocyclic ring containing a nitrogen atom; each of j and k independently represents an integer of 0 to 3 wherein both j and k do not represent 0 simultaneously; each of R₉₄ and R₉₅ independently represents a hydrogen atom, a substituted or unsubstituted alkyl group having 1 to 11 carbon atoms, or a substituted or unsubstituted aromatic group; and each of Ar₅₁ and Ar₅₂ independently represents a substituted or unsubstituted aromatic group.

12. The electrophotographic photoreceptor according to claim 1, wherein the charge transport layer further comprises a compound having the following formula (5-1): 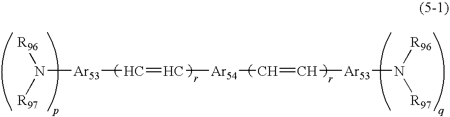
wherein each of R₉₆ and R₉₇ independently represents a substituted or unsubstituted aromatic hydrocarbon group or a substituted or unsubstituted alkyl group, and R₉₆ and R₉₇ may share bond connectivity to form a heterocyclic group containing a nitrogen atom; each of Ar₅₃ and Ar₅₄ independently represents a substituted or unsubstituted aromatic group; each of p and q independently represents an integer of 0 to 3 wherein both p and q do not represent 0 simultaneously; and r represents an integer of 1 to 3.

13. The electrophotographic photoreceptor according to claim 1, wherein the charge transport layer further comprises a compound having the following formula (5-2): 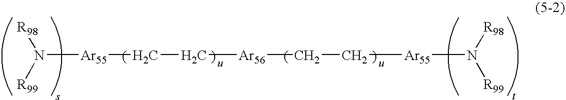
wherein each of R₉₈ and R₉₉ independently represents a substituted or unsubstituted aromatic hydrocarbon group or a substituted or unsubstituted alkyl group, and R₉₈ and R₉₉ may share bond connectivity to form a heterocyclic group containing a nitrogen atom; each of Ar₅₅ and Ar₅₆ independently represents a substituted or unsubstituted aromatic group; each of s and t independently represents an integer of 0 to 3 wherein both s and t do not represent 0 simultaneously; and u represents an integer of 1 to 3.

14. The electrophotographic photoreceptor according to claim 1, wherein the charge transport layer further comprises a compound having the following formula (6): 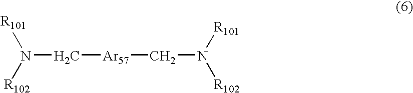
wherein each of R₁₀₁ and R₁₀₂ independently represents a substituted or unsubstituted alkyl group or a substituted or unsubstituted aromatic group wherein at least one of R₁₀₁ and R₁₀₂ is a substituted or unsubstituted aromatic group, and R₁₀₁ and R₁₀₂ may share bond connectivity to form a substituted or unsubstituted heterocyclic group containing a nitrogen atom; and Ar₅₇ represents a substituted or unsubstituted aromatic group.

15. The electrophotographic photoreceptor according to claim 1, wherein the following equation (3) is further satisfied:
T1>T2×2 (3)
Wherein T1 represents a thickness of the charge transport layer and T2 represents a thickness of the cross-linked charge transport layer.

16. An image forming apparatus, comprising:
the electrophotographic photoreceptor according to claim 1;
a charger configured to charge a surface of the electrophotographic photoreceptor;
an irradiator configured to irradiate the charged surface of the electrophotographic photoreceptor to form an electrostatic latent image thereon;
a developing device configured to develop the electrostatic latent image with a toner to form a toner image; and
a transfer device configured to transfer the toner image onto a transfer member.

17. An image forming apparatus comprising a plurality of image forming units each comprising:
the electrophotographic photoreceptor according to claim 1;
a charger configured to charge a surface of the electrophotographic photoreceptor;
an irradiator configured to irradiate the charged surface of the electrophotographic photoreceptor to form an electrostatic latent image thereon;
a developing device configured to develop the electrostatic latent image with a toner to form a toner image; and
a transfer device configured to transfer the toner image onto a transfer member.

18. An image forming apparatus comprising a process cartridge that is detachable therefrom, comprising:
the electrophotographic photoreceptor according to claim 1; and
at least one member selected from a charger configured to charge the electrophotographic photoreceptor, an irradiator configured to irradiate the electrophotographic photoreceptor, a developing device configured to develop an electrostatic latent image formed on the electrophotographic photoreceptor, a transfer device configured to transfer a toner image from the electrophotographic photoreceptor, and a cleaning device configured to clean the electrophotographic photoreceptor.

19. A process cartridge detachably attachable to an image forming apparatus, comprising:
the electrophotographic photoreceptor according to claim 1; and
at least one member selected from a charger configured to charge the electrophotographic photoreceptor, an irradiator configured to irradiate the electrophotographic photoreceptor, a developing device configured to develop an electrostatic latent image formed on the electrophotographic photoreceptor, a transfer device configured to transfer a toner image from the electrophotographic photoreceptor, and a cleaning device configured to clean the electrophotographic photoreceptor.
